(19) United States
(12) Patent Application Publication
(10) Pub. No.: US 2022/0292543 A1
(43) Pub. Date: Sep. 15, 2022

(54) POP-UP RETIAL FRANCHISING AND COMPLEX ECONMIC SYSTEM

(71) Applicant: Alexandra Valentina Henderson, Dallas, TX (US)

(72) Inventor: Alexandra Valentina Henderson, Dallas, TX (US)

(73) Assignee: Alexandra Valentina Henderson, Dallas, TX (US)

(21) Appl. No.: 17/249,683

(22) Filed: Mar. 9, 2021

(51) Int. Cl. G06Q 30/02; G06Q 10/06; G06N 20/00; G06K 9/62

(52) U.S. Cl. CPC G06Q 30/0252; G06Q 30/0269; G06Q 30/0261; G06Q 10/06316; G06N 20/00; G06K 9/6259

(57) ABSTRACT

This invention is directed to a system and method of the virtual creation and subsequent, automated or semiautomated, development or construction of popup retail storefronts, popup events, mobile popup shops, food trucks, popup storefront modular high rise smart buildings, or popup retail franchises, which include the machine learning interoperation or integration of various virtual marketplace environments, blockchain & block-lattice architectures, interactive data engineering geographic information systems, and interactive data visualization devices. Embodiments of this present invention may include an interoperative or integrated real property search mechanism, a virtual design environment, social graph networking graph learning generated frameworks for retailers by which a joint-usership experience or popup event co-sponsorship may be facilitated in the creation and launch of one or more popup shops or popup events at one or more remote locations, a commercial shelf space or commercial space marketplace environment or auction place environment, and other integrated user interfaces.

### FIELD OF INVENTION

The present invention relates generally to a system, method, and device for the virtual creation and subsequent real-world development of popup social commercial events, popup commercial events, popup retail storefronts, popup restaurants, mobile popup shops, food trucks, interactive modular popup storefront high-rise or midrise smart buildings, and popup franchises, via the interoperation or integration of various virtual marketplace environment generated frameworks, blockchain or block-lattice architectures, graph learning or machine learning generated frameworks, selective content dissemination techniques, and virtual design or virtual development environment mechanisms. More specifically, this invention relates to a system, method or device for facilitating the creation or development of popup social commercial events, popup commercial events, popup retail storefronts, popup restaurants, mobile popup shops, food trucks, interactive modular popup storefront high-rise or midrise smart buildings, and popup franchises that may further include the facilitation of commercial shelf space trading or commercial space trading for the placement of real-world products, or of real-world popup shop concept items, and the facilitation of augmented reality advertisement space (ARAS) trading for the selective content dissemination of digital content or computer perceptual programming content to a plurality of target market nodes or devices within or proximal to remote geotargeted locations, according to relative dataset objects of data engineering or statistics module data extractions; therefore, an “ARAS” is a geographic location denoted as a dataset object defined by a plurality of nodes representing a target public.

### BACKGROUND OF INVENTION

Various technologies have been developed that provide order submissions, for customized modular construction units, which may be provided for a commercial use. There are also technologies that have been developed that include interactive geographic information maps that provide an aggregated real estate shopping experience. Technologies that allow the user to design a virtual space or to virtually apply interior design product items onto a scaled digital background or virtual environment have also been developed. There are also existing technologies that provide geospatial data maps or interactive GIS data visualization maps that show user data based upon social media user activity and conversation tracking, as well as systems that allow users to shop virtual stores based upon geophysical locations of a mobile device. However, there are no known technologies that integrate such systems to facilitate shelf space, commercial space, and ARAS trades via the interoperation of various block-lattice or blockchain economic systems, that are further implemented to create popup social commercial events, popup commercial events, popup retail storefronts, popup restaurants, mobile popup shops, food trucks, interactive modular popup storefront high-rise or midrise smart buildings, and popup franchises. The definition of a “popup event” or “popup retail store” is to be understood as a storefront, event, or retail location that is opened temporarily to take advantage of a faddish trend or of a seasonal demand, in which various temporary land use permits or laws or special event permits, or laws may apply. The definition of “social commerce” is to be understood as a subset of electronic commerce that involves social media. The definition of a “social commercial event” is to be understood as a geophysical location at which at which a popup social and/or commercial function is held.

### SUMMARY OF INVENTION

The present invention provides a system and method for enterprise integration providing a semiautomated or fully automated process of building a popup social commercial event, a popup commercial event, a popup retail storefront, a popup restaurant, a mobile popup shop, a food truck, an interactive modular storefront high-rise or midrise smart building, or a popup franchise. The definition of “social commerce” is to be understood as a subset of electronic commerce that involves social media. The definition of a “social commercial event” is to be understood as a geophysical location at which at which a popup social and/or commercial function is held according to data engineering technologies or statistics modules from which data extracts generate computer readable dataset objects such as but not limited to, conversation tracking data, consumer behavior data, user behavior data, spatial demographic data, spatial interaction data, spatiotemporal data, gravity based spatiotemporal data, memoryless topographic stochastic probability distribution data, cloud-based API real-time data engineering data, sentinel surveillance data, serosurveillance data, population density data, temporal data, social graph data, or user statistics data, which may be utilized to detect trends or seasonal demand, or further unitized in the calculation of target market vector nodes, or devices, as part of a graph learning model. Furthermore, the term “popup event” may be used interchangeably in the context of all other popup construction concepts. Furthermore, the term “marketplace environment,” “auction space environment” or “auction environment” may be contextually conflated or used interchangeably to represent a virtual trading space or trading environment. Furthermore, while the term “virtual development environment” may be used to refer to a virtual land development or virtual building experience, and while the term “virtual design environment” may be used to refer to a virtual interior design or staging experience, the two terms may be contextually conflated or used interchangeably. In the context of this current invention, the term “flat currency” is to be understood as a backed currency that has direct correspondence with a commodity's value, a commodity such as gold or silver, or fiat currency, or a legal tender recognized by a government, that serves as an independent variable in bid weighting models, dataset price valuation models, or as a basis for generating a cryptocurrency or game currency that is not backed.

In one exemplary embodiment, the system generally includes a machine learning, cloud computing network and a mobile device with a user interface for accessing a cloud server or host server, and linking, embedding, or inputting personal records keeping or registration information criteria, that allows for the integration or interoperation of web hosting platforms, social networking platforms, merchant to consumer websites, or dropping shipping service systems, to form a master account holder user profile, or as part of a data engineering method that may provide a multi-use, interactive geographic information system, that may be presented in the form of a map or an interactive geospatial data map or, an interactive data visualization device, that indicates relative areas of various population densities, using filterable heatmap overlays or data layers that create georeferenced visualizations of relative dataset objects such as but not limited to, behavioral tracking data, social graph data, cookie compliance system data, conversation tracking data, campaign management analytics data, serosurveillance data, sentinel surveillance data, demography data, stochastic modeling, spatiotemporal data, gravity based spatial interaction data, cloud based API real-time data engineering data, consumer behavior data, user behavior data, or user statics data, that may be further used in part to define a target market profile. The system may also include a memory coupled to the processor for storing digital data, an application program stored in the memory and accessible by the processor for directing processing data by the processor, and one or more internal databases or cloud databases for storing a target market profile, datasets relating to georeferenced areas, and user registration criteria relating to a target market or constituency.

The present invention provides a system and method for providing an optimizable graph learning social networking experience for retailers in the scouting for one or more prospective cosponsors or cocreators of one or more popup social commercial events, popup commercial events, popup retail storefronts, popup restaurants, mobile popup shops, food trucks, interactive modular storefront high-rise or midrise smart buildings, and popup franchises, using a social graph learning database comprised of the recording keeping or business registration data input criteria, of the master account user interface, including user associated dataset objects. The client-side criterial inputs of a business registration within the records keeping system of the master account holder user interface, may consist of things such as but not limited to one or more, linked, embedded, integrated, or interoperating merchant to consumer e-commerce uniform resource locators (URL), e-commerce webhosting platforms, affiliated social media pages, web hosting platforms, or drop shipping platforms; which may be used to engineer datasets that represent a target market or consumer user profile, according to data obtentions such as but not limited to, user statistics, or data from a social graph application programming interface (API), or conversation tracking, or consumer behavior, or behavioral tracking, or campaign management analytics. The processor may transmit a filterable comparative analysis of the target market profile data between two or more users which may or may not be displayed within an interactive geographic information data map, with interchangeable heatmap overlays or data layers that denote one or more areas of various population densities, that further denote a shared target market, relative to the combined target market profiles or dataset objects of a first user of a master account user interface and an indicated prospective cosponsor candidate or second user of a master account holder user interface of a candidate profile that is presented to the first user as a selectable option within an aggregated cosponsor prospect search or shopping environment and graph learning social networking system, wherein the system may further comprise a data visualization device displaying dataset objects that may be represented as contrasting heatmap data overlays or data layers. The acceptance of a co-sponsorship invitation by a second user of a master account user interface, may actuate a synchronous or joint-user experience within various embodiments including such but not limited to, a joint-user virtual design or virtual site development experience within an interactive virtual design or virtual development environment within the master account holder joint-user interface, which may include two or more users in the virtual development, design and event planning of a prospective popup event. The acceptance of a co-sponsorship invitation may further comprise of a smart contract detailing a temporary land use join-proprietorship, or join-tenancy, wherein a subtenancy is further defined by the procurement of a commercial space sector or subsector by a master account holder acting as a buyer or bidder within a commercial space marketplace environment.

The processor may transmit a plurality of interactive geospatial data maps or interactive geographic information systems, as part of interactive data visualization device selection options within the master account holder user interface, partly generated according to preferred temporary retail construction styles or types, geographic locations, or relative target market dataset objects, or a combination of the three. The processor may also transmit real property selection options from one or more multiple listing service (MLS) systems, systematically integrated, interoperating, or accessed via an internet protocol, or transmission control protocols (TCP/IP), or via an API, that may be actuated by the use of an interactive geographic information system (GIS), or a geospatial data map, which may or may not further comprise a heatmap data overlay or data layer filtering tool or input device of an interactive data visualization device, used for the visual display of various population densities that delineate datasets such as but not limited, to conversation tracking data, consumer behavior data, user behavior data, gravity based spatial interactions data, demography data, spatiotemporal density data, stochastic probability distribution data, cloud based API real-time data engineering data, or social graph data, that may be used in the client-side master account holder user interface to guide an aggregated real estate shopping experience, within a generalized or specified geographic location. The preferred properties that are selected and archived may denote a prospective venue location of a popup social commercial event, a popup commercial event, a popup retail storefront, a popup restaurant, a mobile popup shop, a food truck, or an interactive modular storefront high-rise or midrise smart building, and may include a physical address, a name of an establishment, a property identifier number, a crossing of two street names, a phone number, a name of an institution, a name of an entity, geocodes, contact information of one or more associated licensed or non-licensed sales persons, one or more satellite images, one or more uploaded images, and/or any number that is used to identify a destination or location. According to an embodiment selection of an embodiment that may also be accessed via the aforementioned interactive data visualization device selection options, further comprising embodiment shortcuts, the processor may also transmit selection options within the master account holder user interface, of a shelf space or commercial space marketplace system, wherein a shopping or online auctioning experience of a virtual marketplace environment may be used to facilitate the procurement of commercial space, or shelf space, as well as the actuation of a drop shipping service technology, whereby products of a product inventory repository are shipped and placed onto a real-world shelf or commercial space of a popup geophysical location, subsequent to the procurement of a shelf space or commercial space availability of a virtual marketplace environment publication.

The present invention also includes a method of virtual development, virtual design, virtual stocking or virtual staging of a prospective real property location, or of a modular construction, prefabricated construction, mobile construction, temporary construction, or other forms of popup construction, such as but not limited to, commercial tents, kiosks, or modular, mobile or prefabricated shipping containers, modular construction units, novelty construction, 3D print construction, modular midrise buildings, modular high-rises, brick and mortar buildings, truss, or commercial stands. The method may further include the computer rendition of an interactive virtual design or virtual development environment digital background or virtual setting, that is generated according to datastores or dataset objects of an image processor storage medium, a video image processor storge medium, a real-time video or image processor storage medium, or a geographic information database or storage medium, or data extractions of data engineering technology such as but not limited to, remote sensing, temporal resolution, satellite terrain mapping, or satellite imagery, the computer rendition of a virtual design or development background or virtual setting may comprise 3D dataset voxelizations or volumetric display. The processor may transmit a plurality of scaled popup construction style selection option virtualizations within a virtual development or virtual design environment, which may also actuate a TCP/IP, or an API, that may be used to generate an aggregated list of relative servicers, providers, vendors, manufactures, contractors, or other users of a processor that may be configured to receive data transmissions within a storage medium from the virtual development or virtual design environment, or configured to receive criterion that may be generated from the data entries of an order submission or service request forms, as part of an integrated step within the virtual popup project building experience of the client-side master account holder user interface. In one exemplary embodiment of the method of the present invention for providing a virtual interior staging or design experience, the method includes the step of shopping an aggregated list of interior design elements such as but not limited to, purchasable shelving items or fixtures, which can be cutout via integrated or interoperating background removal technology from online product images, scaled according to inputted dimensions that may be extracted via an API or TCP/IP with integrated sources, and placed onto a digital or virtual background setting of the virtual design environment as foreground items upon which cutout, scaled virtualizations of uploaded inventory product items of a business registration inventory product repository may be placed. Scaled product virtualizations may be generated using inventorial data extractions from an TCP/IP, or API, or from criterion entry items, or via the uploading of inventorial data, or via the linking, or embedding of a merchant to consumer e-commerce business website, at the business registration stage as part of a records keeping method within the master account holder user interface. If scaled dimensions of an interior staging or furnishing product item is not extractable, or is not available, the item may not be purchasable by the user via the use of this present invention, or may be otherwise incorporated via alternative methods, or may be purchased via the traditional use of this present invention with caution. A scaled staging or furnishing foreground item that has been placed onto a virtual background setting, may represent a fixture or furnishing item to be purchased, shipped, placed, or stalled at prospective real property or geophysical popup event location, as the placement of foreground items onto a digital setting or background may further generate an archive or itemized list of checkout online product items. In this embodiment, the user of a master account user interface, may also utilize a virtual fencing agent to indicate all or a portion of a virtualized shelving foreground object, as a shelf space availability, within a publication of an aggregated shelf space marketplace system. In one exemplary embodiment, the user may further utilize a virtual fencing agent to indicate a subsector or a sector of an interactive digital background or virtual background setting, as a commercial floorspace or commercial area subsector or sector availability, within a publication of a commercial space marketplace system, or may indicated virtualized construction foreground objects as a commercial space availability, within a publication of a commercial space marketplace system. During a single shelf space auction or a commercial space auction period, an API or TCP/IP with a social media or social networking platform website, may be actuated to conduct a public poll within a target public, wherein individual subjects of a target public may participate in an opinion poll to help generate polling data that may be further implemented as dataset bid factors in a bid factor weighting model of a bid factor weighting module that may be further implemented to help to determine an auction winner, at the conclusion of the live auction period. During a shelf space auction period or a commercial space auction period, the user may further actuate a selective content dissemination computer generated perceptual programming or an augmented reality polling infrastructure, to launch a polling campaign within a remote geotargeted location, according to the geographic positioning of the global positioning systems (GPS) enabled device or target market vector nodes for receiving content within a processor.

The present invention also includes a method of incorporating personnel administrations systems (PADS), which may include the actuation of an TCP/IP or API within one or more job listing or recruitment service platform systems or technologies, or with one or more freelancing platform systems, as part of the popup project building and event planning process. A method of actuating one or more job listing, recruitment service or freelancing platform systems or technologies, may or may not include the placement of a digital personnel icon foreground item onto a virtual background or a virtual setting of the interactive virtual development or virtual design environment, representing the paid participation of a hired personnel, at the prospective popup event location. The personnel icon foreground object further comprising a shortcut to a real-time feedback channel, or communication channel. The present invention may also include a payroll and personnel planning data system (PPDS), that may or may not further include a simplified payment verification (SPV) directed acyclic graph (DAG) spatiotemporal querying or temporal querying payments environment.

In one exemplary embodiment of the method of the present invention for providing an interactive GIS, or a geospatial data map displaying relative population densities, the method includes filterable, contrasting indicatory areal overlays that may delineate areas high in a target public population density, and may also indicate the general locations of one or more prospective popup retail stores with shelf or commercial space availabilities, that may appear within an aggregated shelf or commercial space marketplace system. This embodiment may include an interactive profile page with a scaled image or virtualization of a shelving product or fixture, upon which scaled digital models, virtualizations, or cutout static images, of product inventory items may be placed as a foreground overlay of a candidate product item or items, thereby actuating the display of data such as but not limited to, product pairing rates between two or more products that may share shelf space at a popup retail location, as well as estimated shipping costs or delivery date calculations, further generating product placement scoring such as but not limited to, shelf positioning scores, brand adjacency scores, shelving flow scores, or product availability scores.

In one exemplary embodiment of the method of the present invention for providing an interactive geospatial data map or GIS displaying relative population densities, the method includes filterable contrasting heatmap overlays or data layers that may indicate areas high in a relative target public population density, and may also indicate the general locations of one or more prospective popup retail stores, or popup event locations with one or more floorspace or area availabilities, that may appear within an aggregated commercial space marketplace shopping experience. This embodiment may include an interactive profile image or virtualization of a floorspace or areal sector or subsector, a shelving product, a construction unit, or a fixture, upon which scaled digital models, virtualizations, or translated cutout images, of product inventory items or branding items, or popup construction items may be placed, which may actuate the display of datasets such as but not limited to, product pairing rates between two or more products that may share floorspace or areal space at a prospective retail location, shipping costs calculations, servicing cost calculations, service completion timeframe estimates, and delivery timeframe estimates.

This present invention further provides a method of generating an immersive virtual environment for the virtual development or volumetric design of a popup shop or popup event, that may be rendered according to either temporal resolution data, static imagery data, video imagery data, or real-time video imagery data, generating a binary multi-dimensional attribute tree (BMAT) data indexing manager of a 3D symmetric traceless tensor field, or hybrid spatial data indexing structures that are optimized for the computable calculations of viewing angles according to topological relations and connectivity wherein the dynamic tensor mesh is comprised of nodes representing datasets for visual focal points that are points or vertices which may be geometrically encoded in terms of Euclidean distance calculations, eigenfunction hyperstreamline calculations, or in terms of Coordinates that are a translative function of a critical angle, point-of-view, or a line-of-sight calculation, wherein the root node represents a vector axiom schema according to viewer height criterion. Or, generating an octree-data structure, of a dynamic tetrahedral or polygonal mesh, wherein nodes or octants represent visual focal points, and wherein hyperedges represent line-of-sight, or point-of-view in the calculations of object rotation angles whereby pixel depths correspond to shadow depths wherein the viewer is represented by the root node that further represents infinite space. The either octree-data indexing structure, BMAT, or hybrid spatial data indexing structure may either be affixed to static imagery or temporal resolution imagery to create an immersive 3D interactive panorama, or the either octree-data structure, BMAT, or hybrid spatial data indexing structure may be used to generate an immersive 3D interactive panorama. The aforementioned data indexing structures, may be further extended into a spatiotemporal or temporal querying method of a Merkel tree data structure via the translation of data stores to either a remote image processing device, or to a remote mixed-reality image processing device, or to a remote hyper-reality image processing device, or to a remote neurotechnology image processing device, wherein the pattern recognition proximal alignment of real-world object parameters with real-world object virtualization parameters of a composite display, create a block of a Merkel tree data structure as part of a simplified payment verification system of a task completion real time feedback channel.

The present invention also includes a system and method for the virtual development or design of a mobile, prefabricated, modified, or modular construction unit, the method may include selectable unit construction style options provided via an interoperation or integration of a shipping container repurposing recommendation marketplace or system, or via a TCP/IP or API with providers, vendors, manufacturers or contractor product item listings. The method may further comprise of recruiting or selecting, and commissioning contractors, via the interoperation or integration of recruiting service technologies, or the submission of order placement forms to selectable options of respective construction unit providers. The method may further comprise of a digital or virtual interior floor planning tool via the integration or interoperation of modified computer-aided design (CAD) floorplan blocks, and virtual unit customization tools or virtual agents. The method further comprising a staging technique which may be used to add scaled virtualizations of product inventory items or branding materials, to a virtual setting or background.

An exemplary embodiment of this present invention provides a system and method of creating a vehicle route for the commercial use of mobile, prefabricated or modular construction units, or shipping containers, at various target market population dense locations according to entries of an interoperating or integrated geographic event planning network. The method may include the use of an interactive GIS, or geospatial data map that may display filterable areal overlays or data layers that delineate various datasets such as but not limited to serosurveillance data, contact tracing data, social graph data, user behavior data, consumer behavior data, conversation tracking data, ticketing system & event planning network data, population density data, spatiotemporal data, gravity based spatial interaction data, spatial demographic data, stochastic probability distribution data, or target public population density data. The method may further include the implementation of, recruitment service technologies, personnel administrations systems, or payroll and PPDS in the prescheduled geotargeted placement of security or management personnel at a commercial location of a mobile popup shop or food truck. The method may further include a spatiotemporal or temporal querying as part of a SPV DAG block-lattice or blockchain payments environment.

The present invention also includes a system and method of building an interactive high-rise modular smart building, steel module structure frame, within a virtual development environment. The method may comprise of an aggregated real estate shopping experience generated by data extracted from one or more interoperating MLS systems, which may or may not be initiated via the use of an interactive GIS or geospatial data map displaying the areal indications of various datasets in data overlays or data layers, such as but not limited to, sentinel surveillance data, general population density data, population density data of a targeted public, contact tracing data, serosurveillance data, social graph data, user statistics, conversating tracking data, gravity based spatial interaction data, spatial demographic data, stochastic probability distribution data, cloud-based API real-time data engineering technology data, or user behavior data. The method may further comprise a technique within a virtual development environment for the comprehensive architectural schematics of an abstract building design in the concretization of development project concepts, created using a user modified computer aided design system wherein the client-side customization or selection of architectural building features are simplified for the user to generate translative criterion that are compatible with construction management software or computer aided design technologies that are developed for professional use. The master account user interface further configured for the virtual planning of various floors levels within a scaled virtual model of a high-rise or midrise modular building floor layout of steel module structure frame units, as part of the aforementioned user modified CAD program. The method may further comprise of a virtual fencing agent whereby the user of a master account user interface, may indicated one or a plurality of virtualized modular steel frame cells as a single commercial floorspace availability product or lot of a commercial space marketplace environment or auction environment publication. The method may further include the implication of one or more employment networks or automated recruiting systems which may be used to commission personnel for a development project in a remote location, whereby an order or service request submission or computer readable job offer or project commissioning acceptance may further include a transmission of criterion generated within the use of the virtual development environment of the master account holder user interface, wherein communication protocols allow for a compatibility with computer-aided design and drafting (CADD) construction management software, receiving within a processor a translated submission of a three dimensional or two dimensional interactive architectural rendition.

An exemplary embodiment of this present invention provides a system and method of operating a robotic autonomous crane or an autonomous mounted crane, for the extraction or emplacement of a modular or prefabricated construction unit or a modified or modular shipping container unit into a steel module vacancy of a high-rise or midrise modular building, as part of an integrated or interoperating portion of a semiautomated deep learning modular commercial floorspace marketplace system. This method may include a commercial space marketplace or auction environment that may or may not include a technique of applying bid factor weighting, or a technique of applying a dataset valuation pricing model, to a modular commercial space steel module unit(s) vacancy, further comprising at least one input device for accepting auction entry criteria, or unit space purchase eligibility criteria, using a relative valuation pricing model with variables that represent candidate buyer or bidder master account holder user profile associated datasets or associated target market datasets of data extractions such as but not limited to, geospatial population density of a respective target market relative to a development site or modular building location, social graph data, user behavior data, product pairing rates relative to prospective occupants of adjacent module cell unit floorspace subsectors, conversation tracking data, records keeping data, product inventory repository data, user statistics, or criterion relative to a business category or subcategory. This method may further comprise of a repurposing recommendation machine learning system designed to generate and provide suggestions for pre-owned or used construction unit selection options from a master account unit archive storage medium or from a repurposing recommendation modular construction unit marketplace, matching in dimensions and construction style compatibility to a steel modular frame unit commercial space availability, presented as selectable options within a commercial space marketplace environment publishing. The use of container archives may also be made available for other popup shop construction types involving the use of shipping containers, modified shipping containers, or modular construction units.

An exemplary embodiment of this present invention provides a system and method of implementing communications with GPS enabled onboard technology vehicle tracking systems or devices, for the tracking of archived modular, modified or prefabricated construction units that may be scheduled for extraction or emplacement at a high-rise or midrise modular building's steel module structure frame, or for placement other geophysical locations, or for tracking within a dynamic pick-up and delivery route of a mobile popup shop or food truck path planning system. This method may also include integrative programming with shipping container port or storage yard databases, for the geophysical referencing and tracking of archived shipping container units. This method may further comprise a temporal or spatiotemporal querying blockchain or block-lattice architecture for the timestamped tracking of autonomous or non-autonomous vehicles.

This present invention also includes a system and method of searching target market relative social media influencer candidate profile pages as part of an influencer likeness virtual item or likeness virtual item content marketplace environment and talent recruitment search system. This method may include the interoperation of data extractions such as but not limited to, social graph data, geospatial data, conversation tracking data, user statistics, or target market profile data which may be used to find correlations in user activity or user behavior data that may help generate an aggregation of selectable talent or social influencer candidate profile pages within a social influencer likeness virtual item or content marketplace and talent recruitment search system. This method may also include a non-master account holder user interface that may enable social media influencers or talent users to act as sellers, the seller user interface further allowing for the uploading of video telephony content or static imagery content containing the seller's likeness, to be sold as virtual items to buyer users of a master account holder user interface, for the translational use in selective content dissemination marketing content, purchased at a value that is determined via a dataset valuation pricing model of a relative valuation pricing module, with variables that represent user behavior, user activity and conversation tracking, datasets of a sellers constituency represented by social media follower vector nodes or hyperedge labels of an applied hypergraph graph learning system.

In an exemplary embodiment of this present invention provides a system and method of purchasing content or virtual items containing a digital likeness of a target market relative social influencer or talent for the translational use within an augmented reality or mixed-reality advertisement content creation medium, for receiving within a target market vector node or GPS enabled device, that is located within a proximity of a geotargeted location or within or a mixed-reality image processing device pairable to a GPS enabled device, or within a real-time image processor, an interactive composite view of real-world images and geotargeted content or imagery containing a seller or social influencer's likeness. In the context of this present invention, a “GPS enabled device” may be understood to represent either a mobile computing device, a computing device, a neurotechnology device, a mixed-reality device, or a hyper-reality device, wherein a neurotechnology device is a device that includes a neuroreality interface of a real-time image processor.

This present invention provides a system and method of creating a rideshare technology ticketing or admissions proximal content dissemination system, as part of a consumer footfall generation technique. This method may include the transmission of geotargeted content to GPS enabled devices representing an individual subject of a target public within a relative proximity to a geophysical popup event location using the interoperation or integration of dataset data extractions such as but not limited to, memoryless stochastic probability distribution data that may be displayed as a data layer or data overlay within an interactive gravity based geospatial interaction data visualization heatmap indicating a market share or patronage probabilities within a certain proximity or within an areal range or radius of a geophysical popup event location; data extractions further including rideshare technology data that gives rideshare cost estimates according to ranging proximations within an areal indication relating to individual subjects belonging to a targeted public. This method may further include an ad campaign content creation system for the building and transmission of advertisement content to geotargeted GPS enabled devices or target market vector nodes, or real-time image processors or mixed reality real-time image processors, by which a rideshare technology service discount, coupon, or complementary ride may be provided to the recipient via content transmissions, in exchange for specified or unspecified consumer participation at the advertised and relatively proximal popup event. The method may further comprise a hypergraph learning model wherein an individual subject may be represented by a vector node, wherein a rideshare vehicle may be represented by a vector node, or wherein a popup event and relative master account holder user profile may be represented by a hypernode, and wherein a hyperedge may represent spatiotemporality, stochastic probability, or target market dataset correlativity connecting a target market vector node to a popup event hypernode, or a rideshare vehicle node.

An exemplary embodiment of this present invention provides a system and method of providing a selective content dissemination technique. The method may include a technique for engineering target market profile datasets, using data extractions such as but not limited to geospatial data, demography geospatial data, demography data, social graph identifiers, user statistics, campaign management analytics, conversation tracking, cooking compliance, contact tracing data, sentinel surveillance data, serosurveillance data, user behavior data, consumer behavior data, stochastic probability distribution data, or spatiotemporal gravity data. The method may further include a computer-generated perceptual programming content, or an augmented reality advertisement content creation technique for the distribution or transmission of content to a content or image processor of respectively geotargeted GPS enabled device, or GPS pairable device comprising a processor that may provide for an augmented reality or mix-reality interactive composite display of content.

An exemplary embodiment of this present invention provides a system and method of implementing a decentralized blockchain or block-lattice ARAS marketplace virtual gaming terminal and selective content dissemination mechanism for retail business owners, or authorized retail business owner representatives of a master account holder user profile, that is further represented as player within a single ARAS trading game, gaming session. The gaming terminal comprising a virtual environment in which one or more players are selected according to relative correlations in master account profile associated data by which a player's target market is defined, as well as player unique identifiers of the master account holder records keeping registry medium by which a player is further defined and thereby selected to engage in a competition within a single gaming session. The method may further comprise of a virtual ARAS marketplace game terminal environment or game setting creation technique for the cryptographic or tokenized trade of virtual game goods that are geotagged to a geophysical location for the geotargeting or selective content dissemination, of computer generated perceptual programming or augmented reality advertising content, subsequent to player procurement of first virtual game goods that are geotagged to geographic locations selected by players, or by an automated game setting customization module, whereby the game setting is created according to target market relative datasets such as but not limited to, demography geospatial data, geospatial gravity data, spatiotemporal gravity data, stochastic probability distribution data, cloud-based API real-time data engineering data, serosurveillance data, population density data, target market population density data, or shared target market population density data, as part of a geotargeting advertisement content dissemination technique. The method may also include a dataset relative valuation pricing model of virtual goods, virtual gameboard spaces, or virtual game setting items, that include pricing variables such as but not limited to, the respective geotagged location's shared target market population density according to social graph identifiers, general population density data, serosurveillance data, geospatial gravity, temporal social interaction data, spatiotemporal gravity data, or geospatial payment graph dialog data. This method may also comprise of a geotargeting selective content dissemination technique by which the relative size, relative price, or relative token value of a second virtual game good item may be implemented as variables to determine the areal reach or radial distance within the respective virtual game good's geotagged geographic location, in which advertisement content is to be received within an image or content processor of the GPS enabled devices or target market node, or devices that are pairable with the GPS enabled device of a target market node located within a radius or area of the geotagged location, according to a range or a circumferential coverage that is associated with attributes or variables of the respectively geotagged second virtual game good. Revenues or monies earned by a player via the use of an ARAS marketplace or of an ARAS virtual trading game may be applied in a distributional use across various embodiments of this present invention.

An exemplary embodiment of this present invention provides a system and method of registering a commercial real property location that may be used as an ARAS location. This method may include a real property ownership or tenancy claim verification process along with the criterial entry of a geophysical address that may be used in a geotargeting technique within a decentralized blockchain ARAS marketplace gaming platform, or for use as an ARAS trading marketplace environment. This method may also include a payments environment, a SPV block-lattice or blockchain architecture, which may allow for purchase or temporary use of a registered ARAS location.

This present invention provides a system and method of augmented reality gameplay spatiotemporal DAG block-lattice, or local blockchain crypto mining where patrons, shoppers or consumers, within a geographic proximity of a popup event, represent players in an augmented reality local blockchain game or local block-lattice game, wherein players may earn or trade tokens, game currency, or game goods of a monetary value, that may provide discounts, or coupons at relatively proximal popup retail locations, or relatively proximal popup restaurant locations, or that may be eligible for a flat currency exchange via integrations with a payment service or banking systems. This method may include a system that allows for the templated creation or freehand creation of an augmented reality game setting by remote popup shop retailers or remote popup restaurant owners, or may provide an opensource plugin system for remote game developers.

An exemplary embodiment of this present invention provides a system and method of admissions or ticketing for popup events that may include a biotechnology identification system, a sentinel surveillance device identification or enrollment system, a serosurveillance unique identification or enrollment system, a unique device identifier enrollment system, or an identification registration or enrollment system, that may be used within an integration or interoperation of a consumer identification system, ticketing system, or admissions systems of this present invention. This method may or may not be used to obtain or engineer data within a machine learning data communication systems, or may, or may not further comprise of a cryptocurrency architecture.

An exemplary embodiment of this present invention provides a system and method of creating selective content dissemination content or augmented reality ad content for use in heads up display or onboard heads-up display technology or devices. This method may include the use of a doppler effect data engineering mechanism using Wi-Fi-signals or other wave frequencies, GPS technology, or onboard GPS technology. The method may further include the remote geotargeting of various locations for heads up display augmented reality or composite display of disseminated advertisement content. The method may further include the calculation of a heads-up display device or onboard heads-up display technology vector node within a topographic memoryless stochastic probability distribution model, wherein the interconnectivity of highway or street topography of a state space helps to determine content dissemination radius, range or areal coverage.

### INCORPORATION BY REFERENCE

All publication and patent applications mentioned in this specification are herein incorporated by reference to the same extent as if each individual publication or patent application was specifically and individually indicated to be incorporated by reference.

### BRIEF DESCRIPTION OF THE DRAWINGS

FIG. 1) Welcome/Greeting

FIG. 2) Business Registration: An example of the client side personal records keeping and enterprise integration system by which a retail business owner or authorized retail business owner representative, registers as a user of a master account use interface, by entering criteria or by linking or embedding items, such as but not limited to, online merchant websites, drop shipping technology service, business associated social media accounts, product images, inventorial stock keeping unit information, product sizing & dimensions, consumer order dispatch datastores, categorized or subcategorized business or product descriptors, in the engineering of datasets such as but not limited to, target market or target audience profiles, a master account holder user profile, using data extractions such as but not limited to, social graph identifier data, demography data, conversation tracking data, user statistics data, consumer behavior data, user behavior data, serosurveillance data, sentinel surveillance data, campaign analytics data, geospatial data, spatiotemporal data, or geographic information data

FIG. 3) Enterprise Integration System Continuation Option: The user is given the option to continue adding more businesses, or the option to add other authorized users of a master account, or is given the option to continue to the homepage of a master account user interface

FIG. 4) Master Account User Interface Homepage: The user is presented with selection options of system embodiments on a homepage display, these embodiments may include various interactive GIS or geospatial data maps, various blockchain, block-lattice or decentralized marketplace systems which may include shelf space & commercial space marketplace environment systems, geotargeting selective content dissemination systems, campaign analytics data engineering systems, event management systems, virtual design or development environment systems, accounting systems, archiving systems, PPDS, and personal records keeping systems

FIG. 5) ARAS Blockchain Gaming Marketplace And Geotargeting Selective Content Dissemination System (crypto trade): The user assumes the position of an ARAS marketplace trading game, game player, by selecting an icon to represent their participation throughout a single gaming session wherein virtual real estate, gameboard spaces, or digital goods that represent geotagged, geophysical locations, to be traded with other players, as a method of geotargeting in the selective content dissemination of augmented reality advertisement content to player shared target market vector nodes or GPS enabled devices within a composite view of real world images, or within a content display of a content processing medium

FIG. 5A) A method for creating a marketplace game, game setting via the selection of geophysical locations for the geotagging of virtual gameboard spaces as virtual trade items or game goods, using filterable datasets that are displayed on an interactive GIS data visualization map (crypto trade): The game players proceed to utilize an interactive geographic data visualization device displaying filterable dataset overlays or data layers indicating a shared target market, by which the user may further indicate geographic areas for the geotagging of virtual board space game good items to the indicated geophysical locations as part of the subsequent creation of a blockchain game marketplace environment game setting

FIG. 5B) A swipe viewer of a satellite imagery or uploaded internet images of geophysical locations, within a generally indicated areal selection (crypto trade): The players further utilize freeform map indication tools of the geographic data visualization device, in a method of viewing satellite or internet uploaded images, of relative locations within the most densely populated areas that may be selected as a gameboard space virtual game good item geotagging option, that have been optimized as prospective ARAS location, via the use of filterable datasets that describe a target market, or a shared target market and the degree to which datasets describing a shared target market correlate according to a map legend or degree of data overlay or data layer shading

FIG. 5C) An example of a virtual game setting (crypto trade): The blockchain game or ARAS marketplace game setting is represented by a virtual gameboard wherein the game board spaces are game goods that are geotagged to a geophysical location, as part of an interactive display that further consists of gaming elements such as but not limited to, a method of player turn taking via the use of a virtual pair of dice, player icons that are synonymously displayed as player identifiers or that further denote the respective player's ownership of a virtual gameboard space game good or of a piece of virtual real estate, as well as a player's relative position on the virtual gameboard; also shown is the display of the crypto, token, or game currency value of a virtual gameboard space game good, along with the respectively geotagged location's satellite imagery or internet images, and relative information within a candidate purchasing option profile of a respectively indicated gameboard space game good

FIG. 5D) Augmented reality content selective content dissemination system (crypto trade): Upon the successful player purchase of a virtual gameboard space game good, the player continues to the creation of advertisement content, for transmitted geotargeted dissemination to a plurality of GPS enabled nodal devices located within a radius or range of the respective game good's geotagged location, with a reach that may be adjusted according to the size or price value of a virtual real estate property or gameboard space improvement item second game good, or OG:product

FIG. 6) Locate demand: This is an example of an interactive GIS data visualization map with filterable georeferencing data overlays or data layers that typify population densities of a relatively targeted market or further configured to indicate general or specified geophysical locations, denoted by datasets such as but not limited to, conversation tracking data, demography, social graph identifiers, cookie compliance data, user behavior, consumer behavior, campaign analytics data, gravity based spatial interaction, memoryless topographic stochastic probability distribution, demography data, spatial demography data, real-time spatiotemporal data, interactive cloud-based API real-time data engineering data, data mining database data, MLS data, sentinel surveillance data, or serosurveillance data, in relation to personal records keeping and business registration data, criterial input items, or query items of an input device

FIG. 7) Interactive geospatial data map drop down selection menu: an embodiment of the FIG. 6 image where the user is presented with various interactive GIS data map data visualization display options, using a dropdown list of selectable items which may act as shortcuts to various embodiments presented as icons on the homepage, as depicted in wireframe FIG. 4

FIG. 8) Project building system actuation/home page: the initial stages of beginning a project, according to different popup construction types represented by digital iconized popup shop construction type or style depictions, the selection of which may populate the interactive GIS data visualization map with selectable real estate shopping environment shortcut map icon items that further indicate locations and the number of MLS listings that may be suitable for the selected popup shop development type or construction style

FIG. 8A) Cosponsor information (build project): a variation of the FIG. 8 wireframe and an entry into the following stage of the popup event project virtual building experience, wherein the user is presented with a dismissible informational screen display detailing the use of an interactive GIS data visualization map toggle switch data display filtering tool, that may appear on the screen upon the dismissal of the information screen and may be utilized in the configuration of interactive dynamic data visualization displays

FIG. 8B) Location selection (build project): a variation of the FIG. 8A wireframe, presented with an enabled map data overlay or data layer display toggle switch tool, actuating an aggregated real estate search mechanism within a configuration of the interactive GIS data visualization map, in a method that offers the user a preview of the real estate market according to a preselection of a popup construction style or development type, within a generalized areal indication representing a prospective event location

FIG. 8C) Project duration information page (build project): A variation of the FIG. 8A wireframe, where the user indicates a desired start and end date of a popup event at one or more prospective event locations, or the duration of tenancy at real property location, which may be limited according to user terms or conditions, or according to land use laws that may be incorporated in the communication protocols limiting event duration, or according to computer readable regulatory rules, smart contracts, or contractual agreements pertaining to land use

FIG. 8D) General location selection land use sizing specifications (build project): A variation of the FIG. 8A image where the user applies desired areal dimensions and budgeting specifications, as an advanced search, or search optimization technique

FIG. 8E) Shipping container procurement information (build project): A dismissible information screen informing the user of ways with which to create a popup shop franchise via the accumulated archived procurement of modular or modified units such as but not limited to, shipping container modular construction units, which can be procured via an API or interoperating communication protocols with product unit providers, manufacturers, contractors, shipping container repurposing recommendation marketplace systems, or vendor e-commerce product publication or webhosting service technologies. If the user has created a joint user master account by registering authorized representative, archived units may be made available for use by one or more authorized users in a plurality of popup projects in various locations, as a method of franchising a popup shop business

FIG. 8F) Hospitality options (build project): After the input of budget, land use and areal dimension specification criteria of wireframe FIG. 8D, the system may detect relatively large areal dimension specifications for an event of a size that may allow for the inclusion of a modular hospitality construction building that may serve as an inn, hotel or suites at a prospective event. This option is provided with an additional toggle switch tool that allows for the incorporation of hospitality planning within the methods of virtual land development

FIG. 8G) Modular construction unit procurement option (Build Project): the user is presented with the option to rent or purchase the modular construction units to be incorporated in the construction of a prospective event. Modular construction unit procurement options may be generated from the archived units of other users that have modular or modified units listed as available for purchase or for rental use as part of a unit repurposing recommendation marketplace system, or from an API or integrative programming communication protocol that provides an aggregated search experience for modular, prefabricated or modified construction units that are listed as purchasable options by outside vendors, manufacturers, contractors, or suppliers

FIG. 8H) Event space planning and land use apportioning (build project): The user proceeds from the “rental or purchase” option screen depicted in wireframe FIG. 8G, to an interactive screen display comprising tools that allow for a method of virtual land sector apportionment and venue space planning, using algorithms with functions that create an interactive visual display of areal recursive division, where the “event” subsector is the independent variable determined by buttons labeled “small” “medium” “large” used to define the “event” sector's size, relative to the entire venue area consisting of other subdivisions labeled for other uses, with a limit or threshold setting the smallest amount of usable or plannable space at 1/16^{th} of the entire venue space, representing the venue's entry or admissions area

FIG. 8I) Hospitality modular construction & unit layout style selection (build project): A tool by which the user selects modular hospitality construction style, that may be include a modular unit “stack,” a unit “spread,” or a “freehand” option where the user manually positions an odd or even number of modular construction units onto an isometric display of a virtual development site, via the use of a modified CAD system

FIG. 8J) Stacked hospitality modular construction style (build project): User indicates an areal sector of virtual land using a land apportionment slide bar tool to further adjust the relative size or area of the spatial indication, onto which scaled virtual renditions of hospitality modified modular construction units are applied using a modular unit stack grid tool with cells that represent individual units, as method of quantifying the number of modular construction units, according to the volume, length, width or depth of the virtual modular unit stack or modular midrise building, and the selected unit size; the user also indicates unit colors via use of the grid tool with which to indicate one or a plurality of applicable units

FIG. 8K) “Spread” hospitality modular construction style (build project): User indicates an areal sector within a virtual setting using a land apportionment slide bar tool used to further adjust the occupation of areal space by hospitality modified modular construction units, via the use of a subsector planning grid tool, utilized in quantification of modular construction units according indicated cells representing the width and length of the unit spread, separated according to scaled conversions of a floor area ratio, and the unit size selection; the user also indicates unit colors, via use of the grid tool or by indicating applicable individual units

FIG. 8L) Hospitality modular construction unit floorplan style selection (build project): the extraction of location pin or location tag data, from a constituent profile or from a targeted market profile, defined as such in part by API social graph identifiers, wherein a relative dataset price valuation model is generated according to dataset object variables that include a “home,” location, represented by the most commonly posted geotagged location on a respective target market subject's social media page, further defining a variable that is represented by “remote” location tags of geotagged locations that are relatively distant from the “home” location, indicating a “travel” destination location, from which an integrative algorithm or communication protocol is used to obtain data detailing the average hotel stay rates within a respective “travel” destination location; this data is then used to produce a suggested rental rate from datasets detailing the estimated average hotel stay rates paid by the collective plurality of individuals of a target market or constituency, as well as the estimated rate of return or return on investment (R.O.I) relative to the suggested stay rate, and preselected event duration criteria, implemented in the optimization of modular construction hospitality unit interior floorplan selection options of furnishing product items and constructional elements, presented according to furnished unit pricing estimates, and based upon sales projections

FIG. 8M) Mass attribution of hospitality suite interior floorplans to modular construction units (build project): The use of a unit stack indication grid tool to quantify the number of modular construction units to which an indicated interior floorplan style selection is to be applied, which may or may not subsequently cause an adjustment to current overall cost estimations

FIG. 8N) Dining area planning (build project): The user is presented with the option of adding dinning accommodations to an event site, if the user wishes to apply dinning accommodations to individual hospitality units, a shortcut to readjust individual unit floorplans to include a kitchen or kitchenette may be utilized, or the user may choose to provide a modular hotel with one main kitchen along with room service staffing using an integrated recruitment service technology, or the user may utilize a FAR subsector grid virtual fencing tool for the scheduled placement of food trucks, or for the placement of popup food court modular construction units, as a means of incorporating other system users for participation at prospective event

FIG. 8O) Land subdivision appropriation and commercial space auction criteria (build project): The use of a venue space subsector planning FAR grid virtual fencing tool, by which cell size and quantity is adjusted according to the popup retail unit style, and land sector size, indication via the utilization of a sector apportionment slide bar tool; each cell indicates a categorized commercial space availability, to appear within a publication(s) of a commercial space marketplace system, where the procurement of space may also require the procurement of a popup retail construction unit

FIG. 8P) Floor area ratio apportionment grid auction building (build project): a variation of the FIG. 8O wireframe, where “commercial tent” is selected as the pop construction type for the occupation of spatial allocations indicated by the FAR subsector planning grid virtual fencing tool, and the input device where the user adds auction entry or space procurement eligibility criteria, or enters business subcategorization descriptors of a preferred spatial allocation occupant using a query string separation method

FIG. 8Q) Cosponsor land and budget apportionment (build project): The user that has indicated the intent to add co-sponsoring parties, and further indicates virtual land sector apportionments to dedicate to the joint proprietorship of a limited or specified number of prospective co-sponsor invitees, thereby granting cosponsors the right to sublet space in the option to auction or sell subsector spatial allocations for temporary use, via the commercial space marketplace

FIG. 8R) Cosponsor search initiation (build project): the user indicates prospective event locations within a single project and the intent to implement one or more co-sponsoring parties with whom to co-create and cosponsor one or more events within a single project

FIG. 8S) Cosponsor search system (build project): The cosponsor search experience within a retailer's social graph network technology, conducted by entering descriptive criteria, using a query string separation method, that describes business registration criteria that may correlate with some of the business registration data, records keeping data, or the target market profile datasets of a master account holder, according to the indicated preselected, prospective event location. The user may also choose to use default criteria from user registration criteria entries as a method of optimizing cosponsor candidate options

FIG. 8T) Cosponsor search system, event information (build project): the user creates a profile for each prospective event by including information such as but not limited to, a summary of the event's theme, a summary of the targeted public, key terms or words used to describe a brand or business

FIG. 8U) Cosponsor search and invitation system (build project): After inputting cosponsor search criteria and event information criteria, a scrolling list of candidates that match the search criteria and other relative, data appears in the tool panel; this interactive display consists of an interactive GIS data visualization map and data overlay or data layer filter options that provide a comparative analysis of the user's target market population datasets, and the respective cosponsor candidate datasets whose profile is accompanied with a link to a business website and associated social media websites. Also, part of the interactive display, is a scrolling list of archived preferred, prospective invitees, and a “send” button for the mass or burst invitation of preferred cosponsor candidates

FIG. 8V) Cosponsor invitation confirmation (build project): This wireframe features an invitation confirmation screen to which the user may refer to for the tracking of message receipt or response feedback that may be viewed via the “my projects” embodiment, wherein the response deadline of a cosponsor invitation may also be adjusted

FIG. 9) Project management screen (my projects): The user is able to manage multiple projects that are underway, track the activity of hired or authorized personnel, track any status updates or locations of archived modular units, view campaign analytics, receive cosponsor invitations, track project site development, track auctions, track shelf space or commercial space trades, view modular unit archives, view live events, and check the progress of cosponsor invitations that have been sent out

FIG. 9A) Cosponsor invitation (invitee): This wireframe portrays an example of an interactive screen that is presented when a user opens a cosponsor invitation, wherein an interactive isometric digital layout of a virtual event venue is displayed, showing virtual land sector that are available for joint proprietorship or joint tenancy with the project initiate and other prospective cosponsors, in addition to information or data concerning other prospective cosponsors that may include a comparative analysis such as but not limited to, a shared market percentage, or a brand adjacency zoning score

FIG. 9B) Cosponsor invitation event profile (invitee/my projects): A cosponsor invitee is presented with the response deadline countdown, various filterable interactive GIS data visualization map dataset overlay comparative analyses of various target market population densities, with that of the inviter or project initiate and other invitees, the event theme information, along with the average event subsector size per prospective cosponsor and the average budget or offer amount

FIG. 9C) Cosponsor budget & offer submission system (invitee/My projects): The invited cosponsor candidate indicates a budget for their respective portion of the event, and their desired event sector size as part of the criteria entry items of a cosponsor invitation offer submission, the screen further displays datasets and the display of other cosponsor candidate invitee offer submissions that may be provided as a reference

FIG. 9D) Cosponsor project co-creation initiation & aggregated real estate shopping experience (build project): The user or cosponsor prospects that have had their cosponsor invitation response offer submission accepted by the inviter, will then proceed to a group search or joint-user real estate shopping experience, for prospective real-property venue listings or locations zoned for temporary use, located within preselected areal indications that were denoted on an interactive geographic information dataset display map, as areas with high population densities of a relatively shared target market

FIG. 9E) Cosponsor preferred property voting/polling infrastructure (build project): After compiling an archived list of properties within a synchronous, group or joint-user aggregated real estate listing shopping experience, members of the sponsoring party will be given an allotted time in which to organize the archived list of preferred real property listings in descending or ascending order from most to least desired, which may be used as a method of casting a vote for prospective venues on which each respective member of the sponsoring party would agree to submit a temporary use permit application to the respective city's planning division or city council's Zoning Development Director's office, or to submit a temporary land use or joint-proprietorship offer to an associated sales agent or owner of the prospective venue space, subsequent to the submission of a vote

FIG. 10) Virtual site development experience (build project): This wireframe features a method of virtual site development using scaled renditions of modified shipping container construction units, that the user can rotate and position onto an interactive scaled satellite imagery and remote sensing data generated virtual rendition of a prospective real property development site, used as an interactive background of a virtual development environment that includes tools to add elements such as but not limited to, special effects, logos, texts, colors, or other features as a method of drafting custom order criteria to be implemented in an order submission to a modular shipping container construction unit contractor, supplier, manufacturer, or vendor that may be presented as selectable options on the integration or interoperation of an aggregated, scrolling search list of purchasable products or commissionable servicer selection items

FIG. 10A) Virtual site development experience (build project): This wireframe image depicts a remote sensing and satellite image of a prospective venue development site, presented with an interactive subsector patronage planning grid virtual fencing agent or tool, to be used in the categorized apportionment of a retail space, or of a commercial land sector, in which grid cells may hold a key term, word or digital icon for the apportionment or planning of a commercial space, or of a gross leasable area, generating a plurality of categorized publications of virtual space subsector auction temporary subtenancy space availabilities, within a commercial space marketplace. Users that are co-sponsors of an event, may be prohibited from planning or apportioning certain sects that are not under their assigned jurisdiction as a joint-tenant or coproprietor

FIG. 11) Virtual site development experience (build project): this wireframe features a variation of wireframe FIG. 10 wherein the prospective venue site is a body of water, whereby site development options may be configured to accommodate a water event with construction modifications that provide buoyancy or connectivity to construction units that may further configure an adjustment to servicer, provider or vendor options according to a deep learning algorithm

FIG. 11A) Virtual site development experience (build project): This wireframe features a variation of the FIG. 11 wireframe in which the user is presented with tools that further allow for the development of a water venue site by, implementing site appurtenances or improvement items such as but not limited to docking, lighting or signage

FIG. 12) Virtual site development experience (build project): This wireframe features a method of virtual site development by which further customizations and construction features may be applied to an indicated scaled virtual rendition of a modular shipping container construction unit, such as but not limited to windows, doors, paint color, or signage

FIG. 12A) Virtual site development experience (build project): This wireframe image depicts a variation of the FIG. 12 wireframe featuring servicer assignment tabs positioned directly above a respective modular shipping container construction units, that may act as a feedback channel shortcut for tracking request or order submission responses, a direct message communication channel shortcut for the facilitation of dialog between a user and a modular construction contractor, architect, manufacturer, vendor, or provider, and the respective member of a sponsoring party, or as a real-time task completion feedback channel for tracking a development project

FIG. 12B) Virtual site development experience (build project): A variation of the FIG. 12 wireframe, where a “hired personnel” icon is applied to a virtual setting via use of the sliding or scrolling control panel, that may be configured to actuate various integrated or interoperating recruitment service technologies that are presented as selection options and are activated or deactivated via individual toggle switch indicators, as part of a burst recruitment technique that causes a “hired personnel” icon foreground item to appear on a virtual setting, representing the prospective presence of one or more hired personnel at a prospective event. The hired personnel icon foreground item may also serve as a feedback channel, or as a communication channel shortcut for the facilitation of communication between the user and employees, job candidates or application respondents

FIG. 12C) Virtual site development experience (build project): a variation of the FIG. 12 wireframe where a toggle switch tool located at the top of the screen, that is used to display servicer assignment tags placed directly above each respective modular construction unit, has been switched over to show the relative profile pictures or icons representing participating cosponsors, which may also be used as a shortcut to direct message threads or communication channels that allow for dialog between sponsoring parties. The image cutout tool is also implicated, in the actuation of background subtractor or pattern recognition algorithms or integrations, for the translation onto the interactive background or virtual site of image cutouts uploaded from a user's device picture archives, or from raster graphic images, or from vector graphic images that may represent augmented reality event theming composite display content items, mix-reality event theming composite display content items, or real-world novelty items such as but not limited to, 3-dimensional foam sculptures, a cardboard cutouts, promotional balloons, props, 3d prints, floats, novelty construction buildings, or printed construction buildings, in a method that includes drafting custom order form criteria to be submitted to relative servicers selected from an aggregated scrolling list of vendor websites, supplier websites, contractor websites, manufacturer's websites, or recruitment services options. Method used herein, may also actuate the transmission of rendering data via integrative communication protocols with interoperating technologies or compatible technologies, such as but not limited to, computer aided-design (CAD) programs, computer aided-manufacturing (CAM) systems, computer numerically controlled (CNC) systems, 3D printing technology, 3D print construction technology, AutoCAD technology, computer integrated construction (CIC) systems, robot programming language, or finite element analysis (FEA) systems, in the semiautomated or fully automated fabrication of a novelty item. A servicer assignment tag may appear above the novelty item upon their selection from the aggregated list, which may serve as an access point or shortcut to a communication channel or direct messaging thread used for the dialog between a user and the respective servicer, and may also display a progress bar that indicates real time project progression feedback. The applied novelty item in this wireframe, is exemplified by the giant ice cream cone

FIG. 12D) A dismissible information screen (build project): This wireframe image depicts an informational screen display that instructs the user in the implementation of a novelty item or structure, in which the user is instructed to scale the translated cutout image to an appropriate size that may help to indicate its intended use, in method that would also help to generate a dropdown menu of novelty items types that could define the physical nature of the novelty item and further aid in the generation of an aggregated list of applicable servicers, manufacturers, or suppliers, according to the applied scaling that may or may not be limited by building setback requirements, FAR, or zoning regulation algorithms

FIG. 13) Virtual staging and interior design (build project): This wireframe illustrates tools with which to add interior elements within a modular construction unit such as but not limited to, clothing racks, shelving items, fixtures, furnishing items, clothing mannequins, security equipment, novelty items, as well as the addition of security personnel, cashiers, management staff, or other hired personnel according to an interior design style or construction type selection

FIG. 14) Virtual staging and interior design (build project): This wireframe depicts a method of modular construction unit interior design, where the interior style has been selected to accommodate a “service” provider, a service provider further defined by the “salon” subcategory selection option, the selection of which thereby rendering a list of purchasable or rentable furnishing elements and product items relative to services provided by a “salon,” such as a “salon chair;” the user may also select the augmented reality icon in the upper righthand corner to view the interior design within an interactive virtual or augmented reality setting, as with all interior design or exterior design or development environments provided within the use of this present invention

FIG. 15) Virtual staging and interior design (build project): This wireframe depicts a method of virtual interior design for the customization, editing or addition of wall design elements such as but not limited to, wall tiles, paint colors, or other textural or visual design elements. A scaled virtual rendition or image cutout of a mannequin is also shown, accompanied by a product tag with a dropdown list consisting of mannequin pricing information and the selected supplier, along with the option to purchase. The product tag may also serve as a shortcut to real time parcel tracking data, after a purchase or rental transaction is completed. This image also depicts a shelf space auction shortcut tag, tagged to an indicated shelf space area of a shelf space auction publication, with an adjustable allotted amount of time until the auction period is set to end.

FIG. 16) Virtual staging and interior design, personnel administrations system (build project): This wireframe image depicts the appearance of a personnel icon on a virtual scene as a result of using a “hire personnel” tool to configure the interactive control panel to feature an aggregation of recruitment service technologies, which are indicated via the use of toggle switches that activate an integrative communication protocol with the respectively indicated recruitment service websites or website platforms to which job criteria will be translated and hosted on a webpage upon submission; because this action is being performed during the interior design stage, an optimized list of relative jobs that describe a function or role for managing a store's interior, may be presented as a selectable option as part of a semiautomated job recruitment submission form criteria autofill technique

FIG. 17) Virtual staging and interior design, product shelving and shelf space marketplace interoperation (build project/My projects): This wireframe depicts a virtualization of a modular construction unit's interior, where the user has indicated a shelving item or sector of shelf space and is then presented with the option of adding uploaded products or a product repository from which to place scaled cutout foreground item virtualizations thereof onto a shelving item or fixture, in a method that actuates the itemized placement of a drop shipment order, via integrated communication protocols with respective drop shipping service technologies. The user may also select the option of publishing a shelf space availability within an interoperating shelf space marketplace, via the use of key words, or terms, that describe a desired product type as an input method of auction entry or space procurement eligibility criteria, or they may choose to use default criteria from records keeping or business registration criteria entry items, thereby further generating an optimized search return within a shelf space marketplace environment according to criterial correlations

FIG. 17A) Virtual inventory product placement (build project): This wireframe depicts an example of a method of scaled cutout product virtualization foreground item placement onto a virtual shelving item or fixture, from a selectable list of archived products from a product repository of product items uploaded at the business registration stage

FIG. 18) Virtual staging and exterior design, commercial floorspace marketplace availability publication (build project/my projects): This wireframe depicts a virtualization of a shipping container modular construction unit with an open floor display, on which the user has indicated an area of floorspace to be posted as a floorspace sector availability, within a commercial space marketplace, further illustrating the input of auction entry or space procurement criteria, which may include the use of key words or terms used to describe the desired product or service that may occupy the respective space at a prospective real-world event represented by the virtual rendition. The user may also choose to use default criteria from records keeping business registration criteria entry items, thereby further generating an optimized search return within the commercial space marketplace environment according to criterial correlations

FIG. 18A) Virtual staging and exterior design environment, commercial floorspace marketplace (build project/My projects): This wireframe depicts a virtualization of a shipping container modular construction unit, with an open floor display, upon which a live auction is taking place for an area of open floorspace indicated by an interactive 10×10-foot areal indication overlay. The image further depicts a scrolling list of prospective bidders with correlative user profile data, from which the user may choose a candidate to invite to the auction. The wireframe further illustrates a display of comparative analytical data that shows percentage-based dataset correlations between the target audience or consumer behaviors of the auctioneer and the indicated bidder candidate on the scrolling list, the data may also include product pairing rates between a candidate's products and the auctioneer's products according to detectable dataset correlations

FIG. 19) Live auction data (build project/My projects): This wireframe depicts an interactive live auction screen where the auctioneer is presented with a scrolling list of active commercial space bidders participating in the live auction, from which a bidder's profile with hyperlinked information may be viewed, and bid weight may be adjusted in accordance with a criterial input, the remaining time left within an auction period may also be adjusted, a comparative analysis may also be displayed according to criteria filter options

FIG. 19A) Social media polling, auction tiebreaker polling infrastructure and bid factor weighting model (Build project/My projects): This wireframe depicts a live auction screen and a method of bid factor weighting or auction tiebreaking, where the auctioneer selects from a list of active bidders to be the subject of a geotargeted social media opinion poll, via a method of selective content dissemination, from which the generation of polling data dataset objects may be further implemented to serve as bid factor variables within a bid factor weighting model

FIG. 19B) Social media polling (build project): This wireframe image depicts a method of applying a dataset valuation model or a bid factor weighting model to opinion polling dataset objects, as a method of certifying a winning bidder for a shelf space or commercial space availability auction lot publication

FIG. 20) Advertisement selective content dissemination tool (build project): This wireframe depicts a burst social media advertisement selective content dissemination technique by which social media accounts that are associated to the respective business are indicated via a toggle switch in the actuation of an API or of integrative communication protocols that allow for the posting of ad content onto the respectively indicated social platforms, further actuating a collective ad campaign analytics data engineering module

FIG. 21) Social media ad campaign analytics (My projects): This wireframe depicts customizable advertisement content along with campaign analytics datasets

FIG. 22) Influencer talent search and likeness virtual item marketplace environment (build project/my projects): This wireframe depicts a talent search and social influencer marketplace environment, in which the user may search and find a respectively talented or influential individual (according to target market profile data) to host or make a physical appearance at a prospective event, or in which the user may search for social media influencers from whom to purchase a virtual product containing their likeness for the transmitted display within a mixed-reality, augmented reality, or virtual advertisement content processor of a target market vector node represented by GPS enabled devices, or receiving content within devices pairable to GPS enabled devices that are within a proximal area of a geotargeted location. This image also depicts a comparative analysis of the user's targeted market and the relative social media influencer's or talent's core audience's, conversation tracking data, consumer behavior, social graph demographics, or user behavior data.

FIG. 22A) Influencer talent search and likeness virtual item marketplace environment (influencer/talent user interface): This Wireframe depicts a method by which a social media influencer or respectively talented individual, is able to upload static imagery, or video telephony content, as virtual product items to be sold in a likeness virtual item marketplace, via the use of background subtractors and pattern recognition algorithms. In this depiction, the model is instructed to record the video while standing in front of a white background or wall, wearing solid colored clothing to reduce noise and image distortions. If the user is uploading customized content, they may be required to implement clothing items, products, branding materials, or props, to be included in audiovisual content or static imagery. If the user is recording customized audiovisual advertisement content, they may also receive a written script and posing or body positioning instructions, as part of a customized order from a respective buyer

FIG. 22B) ARAS geotargeting system for proximal selective content dissemination (my projects): Depicted in this wireframe, is an interactive spatial interaction map of an event venue space that calculates gravity-based probabilities of consumer footfall or patronage at each event location within a spatiotemporal or geospatial market share dataset, as indicated within an interactive data visualization map with polygonal overlays or data layers, further comprising a geotargeting mechanism by which the user will indicate content reach within a geotargeted location, according to target public demographic data, memoryless stochastic probability distribution data, gravity based spatial interaction data, real-time proximal spatiotemporal density data, and areal market share data

FIG. 22C) Storefront/event venue geotargeted augmented reality advertisement translation and selective content dissemination system (my projects): depicted in this wireframe is an augmented reality likeness display of a talent or social media influencer, that has been translated onto a virtual setting depicting the outside of a modular shipping container construction unit storefront at a real property location, along with a tool panel that allows for the addition of text, and a tool to adjust the advertisement's runtime which may or may not incur additional costs

FIG. 22D) Augmented reality display (target public): This wireframe image depicts an individual subject of a targeted market's viewing experience of geotargeted augmented reality advertisement content, via the use of an augmented reality eyewear device

FIG. 22E) Admission systems selection (build project/my project): This wireframe depicts an example of a method for selecting various forms of ticketing and admissions types, which may include the integration or interoperation of technology systems such as but not limited to, online ticketing or preregistration services, sentinel surveillance technologies, serosurveillance technologies, rapid diagnostic testing technologies, or rideshare technology service ticketing methods, the selection of which may further present selectable options of corresponding event admissions requirements

FIG. 22F) Rideshare technology consumer footfall generation and geotargeting ticketing system (build project/my projects): Depicted in this wireframe, is a geospatial market share and spatial interaction model of an event's venue space areal location displayed in an interactive data display heatmap that calculates gravity-based probabilities of consumer patronage at a sect of a venue space represented as a geospatial dataset, along with a content creation and storage medium comprising a geotargeting or selective content dissemination mechanism, whereby the user indicates advertisement content reach or areal coverage within a geotargeted market share location, guided by areal market share data layers or data overlays, as well as average estimated rideshare costs from within various points representing target market nodes within the geotargeted area that are of a relative spatiotemporal proximation to the respective venue location and a rideshare ride node. The target market's areal population density calculated estimations, helping to generate sales projection data, an estimated return on investment, and a budget for the provision of complementary rideshare technology services or for rideshare technology service discounts, in exchange for specified or unspecified consumer participation at the respective event. The content received in a geotargeted GPS enabled target market node content processor, or a mixed-reality image content processor, interactive content comprising a module for accepting a geographic location for an integrated or interoperating rideshare technology service

FIG. 23) Build project screen (build Project): This wireframe image depicts the “build project” homepage where the user has selected a “mobile popup shop” as the desired popup construction style

FIG. 23A) Mobile popup shop virtual construction (build project): This wireframe image depicts the virtual construction of a mobile, prefabricated, or modified shipping container construction unit, or modular construction unit, where the user is presented with “interior type” criteria and design options, utilizing some of the aforementioned virtual interior and exterior design techniques, as well an aggregated list from which the user selects a unit contractor or provider, as well as a trucking transportation service. This image also depicts a button that actuates an integrated, or interoperating recruitment technology service in the geotargeted hiring of personnel for the management or security of the mobile shop during route stops, by inputting required prerequisite and job description criteria in a method of generating a staffing list that may be posted on selected recruitment service platforms or websites, during the appointment of each route stop destination during the proceeding vehicle routing stage

FIG. 23B) Mobile retail store route stop aggregated event shopping experience (build project): This image depicts a variation of the FIG. 23 wireframe wherein the swipe viewer of candidate events is hidden to reveal the event planning system entries as interactive map icons located along a prospective mobile popup shop dynamic tour route

FIG. 23C) Mobile retail store route stop creation (build project): This wireframe depicts an interactive GIS data visualization map that displays filterable areal indicators, that represent various population densities and relative target audience datasets. As a tour route is drawn by the user onto the interactive map, the map is populated with map icons indicating geographic locations of events that have been created via the use of this present invention or via the use of other event management and ticketing system technologies, that are displayed using an API or other forms of integrative communication protocols. The map icons further denote locations at which the user may schedule a route stop where commerce may be conducted, the indication of which generating an aggregation of prospective event profiles in swipe viewer, that are scheduled to be located along the tour route, with preferred venues appearing as scheduled events appearing within an archive list display in the control panel. The illustration further depicts the use of filterable contrasting dataset display overlays or data layers that may be configured to display a comparative analysis between the datasets relating to the user's target public, and dataset objects of respective events locations and descriptive criterion entries, that are generated according to the respectively indicated map icons representing upcoming or current, events which may help to guide the user in the selection of route stops, further denoted by map icons, according to favorable dataset objects

FIG. 24) Build project screen (build Project): This wireframe depicts the “build project” homepage where the user has selected a modular popup shop store front “tower mall” or interactive smart building as the preferred popup construction style

FIG. 24A) Selective content dissemination polling infrastructure campaign analytics (build project): This wireframe depicts the results of a geotargeting polling infrastructure and method by which the user geotargets a population near a prospective construction site in order to poll the opinions of a local public about the prospect of the relative development project, in this case, regarding a modular popup shop storefront interactive high-rise smart building

FIG. 24B) Burst job recruitment technique (build project): This wireframe depicts a method by which the user may select various hiring or recruitment platforms, contractors or architect firms for which to submit an order or service request, as well as live transmissions of CAD data and for the further endorsement of a development project permit submission

FIG. 24C) Cloud-based postage, email, and fax, burst permit submissions technique (build project/my projects): This wireframe depicts a method of burst building permit submission, to one or more city council's Zoning Development Director offices, via the interoperation of query search algorithms used to find URLs with key words such as but not limited to, “.gov,” “city council,” “zoning,” “development,” or “permit” in relation to preselected prospective development site locations, or via the use of various API cloud-based fax, email, letter and postage automation services

FIG. 24D) Virtual development environment (build project/my projects): This wireframe depicts an interactive isometric display of a virtual modular construction high-rise building development site, where a graph is used to indicate the number of modules at the modular-high-rise building's base in depth and width, and the number of modules comprising the modular high-rise tower's height, according to FAR calculations, international building code, and set back requirements

FIG. 24E) Virtual design environment, floorplan (build project/my projects): This wireframe depicts a method of patronage floor planning of each building floor level, using an interactive patronage subsector categorization grid from which categorized grid sections can be dragged and placed to a content input device featuring a query string item separation method, where the query string items are translated from the subcategorized grid cells, to a query string item input field representing the retail store types to be found within the respectively indicated building levels. Also displayed is a capacity percentage indicator, showing the number of module spaces within an indicated building section, left to be assigned to a retail store type according to the maximum allowable module space that may be allotted to a single business category. The query string items may further be used as module commercial space auction entry or procurement eligibility criteria

FIG. 24F) Module space bid entry criteria (build project/my projects): This wireframe depicts a method of calculating ROI according to the starting bid per steel frame module cell, per floor, as well as a method of distributing a percentage consumer admissions fees, amongst tenants of an auction cycle, that may be procured from participating patrons or consumers in an admissions fee

FIG. 24G) Categorized bid factor weighting technique (build project/build project): This wireframe depicts a method of applying bid weight to a business subcategory according to patronage grid sector category sections from which a cell subcategory criteria item is dragged from the category field, to a dataset bid factor weighting criteria field, in which a desired or defaulted amount of weight may be applied. Also depicted in the image, is a data visualization device showing data that corresponds to dataset objects of bid factor weighting criteria fields, configured to display data that is relative to an indicated or selected subcategory criteria item

FIG. 24H) Virtual development, architectural display (build project/my projects): This wireframe depicts an isometric display of an eco-friendly, interactive modular high-rise smart building to which the user may apply unit feature requirements to a percentage of module spaces, such as but not limited to, solar panels, terraces, green roof terraces, aquariums, or swimming pools

FIG. 24I) Virtual development, manual floor planning (build project/my projects): This wireframe depicts an optional method of floorspace appropriation, by which the user further defines auction entry eligibility by applying modular unit floor plan type requirements for multiple or singular, module cell occupancies. This image further depicts a method of indicating scaled virtual module spaces of a modular high-rise building floor, subsequently generating a list of eligible modular construction unit type CAD blocks, representing a unit type that the respective bidder may be required to procure, or possess within their modular unit archive, in order to submit a bid for the relative module space availability. Upon the indication of virtual module spaces and a modular construction type, the user may then drag and paste patronage grid subcategory query string/criteria items to a field that defines the preferred store type relative to the CAD and module cell selections, which may be further implemented in the search optimizations or eligibility requirements presented in a commercial space publication viewed by a prospective bidder

FIG. 24J) Cosponsor invitation (build project/my projects): This wireframe depicts a method of inviting co-owners to buy-in on a “tower” popup mall, interactive high-rise smart building development project to take on partial ownership of a tower's percentage, as part of a joint-proprietorship, via graph learning master account social graph networking system. The wireframe image further depicts the display of estimated construction cost of indicated building floor levels or sections as well as the associated patronage, that is indicated as a portion of desired proprietorship of floor levels or building sections that available for purchase by a perspective co-owner invitee

FIG. 24K) Cosponsor invitation (my projects): this wireframe depicts a variation of the FIG. 24J wireframe, illustrating a high-rise co-ownership invitation, further displaying information detailing the mandatory payment of an escrow fee set at a percentage of the desired building section's construction cost that may be required subsequent to the acceptance of an invitation offer submission. The wireframe further illustrates a spatiotemporal geostatistics data visualization display, showing proximal target market datasets that are relative to criteria item selections of patronage floorplan business subcategories of the respectively indicated section

FIG. 25) Popup Commercial Tent (build project): This wireframe depicts a method of automating tent customization services via an API, where in the user applies features to a scaled virtualized tent foreground item placed onto a satellite rendition of the prospective venue as the interactive digital background of a virtual development environment

FIG. 25A) Computer-aided design to computer aided-manufacturing (CAD/CAM) communication protocol (build project): This image depicts a method of CAD to CAM integrative communication protocol for the manufacturing of modular construction using 3D printing construction technology or computer aided building fabrication technology, wherein a modified use of CAD is implemented in the virtual rendition of a 3D print construction building or a prefabricated building for receiving within a CAM processor, generated building schematics. The illustration further depicting an aggregated list of servicers or providers

FIG. 25B) Novelty CAD/CAM) communication protocol (build project): This image depicts a method of CAD to CAM integrative communication protocol using 3D printing construction technology to design and fabricate a novelty construction building, wherein a modified use of CAD is implemented in the virtual rendition of a 3D print novelty construction building for receiving within a CAM processor, generated building schematics. The illustration further depicting an aggregated list of servicers or providers

FIG. 26) Build project, locate demand screen (build Project/auctions): This image depicts the “build project” “locate demand” embodiment wherein the interactive GIS data visualization map selection dropdown menu is displayed, and the “auctions” option has been indicated

FIG. 26A) Commercial space marketplace interactive GIS data visualization map homepage (auctions): This wireframe depicts an interactive GIS data map for actuating an aggregated commercial space shopping experience within a commercial space marketplace environment, with map icons that delineate the locations of various popup shop types, and the number of the respective popup shop types, that have commercial space availabilities, along with a filterable map data overlay or data layer display tool, that may be used to indicate relative target public datasets and various population densities. The illustration also comprising area sizing, dimensions, budget and square footage criteria entry fields

FIG. 26B) Commercial space marketplace (auctions): This wireframe depicts a variation of the FIG. 25 wireframe where the popup type display map icon filter selected is “popup tower” mall, the selection of which generating an aggregated “like” “dislike” swiper viewer of high-rise modular building module space shopping experience, wherein the interactive profile page of a tower located within an indicated geographical area is displayed, showing floors with relatively available module spaces and respective auction data

FIG. 26C) Tower module floorspace auction unit mockup (auctions): This wireframe depicts a method of module space and module unit procurement, wherein the user has selected “tower mall” as the preferred popup type within a commercial space marketplace and has proceeded to indicate a module space availability within an interactive commercial space publication profile. The user is further presented with the option of purchasing or renting modular units the selection of which thereby actuating a method of shopping modularly modified shipping container units of a repurposing recommendation marketplace system, or a method of selecting eligible archived modularly modified shipping container units of the shopper's unit archives, or a method of providing shipping container product units of a provider's product repository that may be eligible for the retrofitted placement within the respective module space availability indication. Using this technique, the user may be allowed to place a module space bid that includes a mockup virtualization of a prospective module unit that may be viewable by the module space auctioneer or auction host, or that is submitted to the processor of a deep learning automated auctioning system. Elements applied to the unit mockup may include detailing such as but not limited to, interior design elements, exterior color selections or branding themes, that may be aesthetically or schematically compared to that of other prospective units to occupy floorspace during the respective floor's auction cycle, in a review by the auction host, along with the shopper's master account criterion and relative datasets, or may be processed a variables in the deep learning algorithms implemented in the automation of floorspace auctions, or further implemented as bid factors of a bid factor waiting model that may be applied in the determination of a module space auction winner

FIG. 26D) Commercial floorspace marketplace (auctions): This wireframe depicts a variation of the FIG. 25 wireframe wherein the preferred auction type selected is a modified, prefabricated, or modular shipping container unit space, actuating an aggregated “like” “dislike” swipe viewer shopping experience, wherein a container space availability publication's profile showing the amount of available space and an isometric floorplan is displayed, along with live auction data, and the amount of time remaining in the auction period. In this instance, the bidder is not required to provide or procure a modified shipping container unit

FIG. 26E) Commercial floorspace marketplace (auctions): This wireframe depicts a variation of the FIG. 25 wireframe, where “brick and mortar” is selected as the preferred popup shop type, thereby actuating an aggregated “like” “dislike” swipe viewer shopping experience, wherein the amount of available space and a floorplan is displayed, along with the remaining amount of time within the auction period

FIG. 26F) Shelf space marketplace (auctions/test my products): This wireframe depicts a variation of the FIG. 25 wireframe, wherein the preferred popup shop type selected is a commercial tent where the largest possible space availability is shelf space which may include an entire shelving item in a commercial tent, whereas the “test my products” embodiment is actuated for the procurement of a subsector of shelf space on a shelving item or fixture or shelving product item that may not be in a commercial tent

FIG. 27) Shelf space marketplace (auctions/test my products): This wireframe depicts a variation of the FIG. 26F wireframe, wherein the interactive display features a shelf space availability publication's profile within an aggregated “like” “dislike” swipe viewer shopping experience, wherein the user is able to view a comparative analysis of datasets such as but not limited to, product paring rates with prospective shelf mate products that are to occupy space on the respective shelving unit, along with shipping cost and delivery time estimates, according to an eligible archived product selection of the shopper's uploaded product inventory repository

FIG. 28) Patronage rating system (test my products): This wireframe depicts a page within a shelf space availability publication's profile, displaying a floorplan patronage map along with brand awareness ratings, according to the floorspace location of the respective shelving item with the respective shelf space availability according to the perception of the consumer, including brand agency scores, isle lead scores, shelving flow scores, product availability scores, shelf positioning scores,

FIG. 29) Modular high-rise module frame: This image depicts a modular tower frame mounted with a robotic autonomous crane that interoperates with an autonomous vehicle tracking and dispatch scheduling system, and with a module marketplace system, for the extraction or emplacement of modular construction units into vacant module spaces, equip with sensors that may provide data for the scheduling of unit extractions and installations

FIG. 29A) Sample zoning pattern for satellite image matching to be used in an MLS real property search: This image depicts an example of zoning dimensions and street patterns that may be implemented as functions within a pattern recognition algorithm, that may be used as a search mechanism for prospective real property development sites according to a virtual development environment using an isometric display or a computer generated interactive background that is not rendered according to real-world imagery datasets, in this case used for a modular high-rise mall development project, within the interoperations of satellite imagery databases and one or more MLS systems

FIG. 29B) Digital scaling: This image depicts an illustrative example of some of the algorithmic formulas, that may be used in the scaling of modular high-rise tower digital renditions, such as FAR, zoning patterns, or setback requirements, that may also be implemented in the search mechanisms for eligible development sites

FIG. 29C) Metric Scaling Conversions: This image depicts an example of a metric conversion method that may be used to scale a digital rendition of a modular high-rise building floor in an interactive display that may be used for the manual management of floorspace module auction cycles

FIG. 30) Ultraviolet light decontamination shipping container: This image depicts a prefabricated or modular shipping container construction unit that has been modified for the decontamination of products or items

FIG. 31) Social distancing/sentinel surveillance/serosurveillance admissions bracelet: This image depicts an example of a method of a serosurveillance technology, biometric surveillance technology, sentinel surveillance technology, contact tracing technology, or rapid diagnostic testing technology, admissions or ticketing system, that implements a waterproof bracelet with an identification code registered within a serosurveillance system, a sentinel surveillance system, or contact racing technology system, that may also be used for ticketing and admissions purposes to indicate a vaccinated individual, a noncontagious individual, or an antibody carrier, indicated by bracelet color or code; this particular design example is also equip with a vibrating sensor to alert the wearer of a breach in social distancing measures when another bracelet wearer is too close in proximity

FIG. 32) Augmented reality inventory stocking and product display instructions: This image depicts the resulting inventory management guidance technique, that is produced by the use of a virtual inventory stocking method such as that depicted in FIG. 17A, where a retailer has implemented an inventory archive system in the virtual interior staging of a prospective popup shop, in a method that subsequently drafts inventory stocking and product display instructions that may be used by relatively hired personnel within an augmented reality or virtual reality experience, in the inventorial management of a popup shop's floorspace

FIG. 33) Heads up display geotargeted advertisements: This image depicts a heads-up display of augmented reality advertisements that are experienced by a subject within a geotargeted audience, represented as a node within a topographic stochastic model

FIG. 34) Decentralized blockchain example: This image depicts an example of a virtual item dataset valuation pricing model mechanism, that may be used in the algorithmic creation of an ARAS blockchain game marketplace setting

FIG. 34A) Opensource gaming platform: This image shows an example of the possible data structures of an opensource ARAS marketplace blockchain gaming platform

FIG. 35) Decentralized Blockchain ARAS Marketplace: This image illustrates a diagram of data syntax structures that may be used to create a decentralized ARAS marketplace

FIG. 36) Decentralized Blockchain Retail Popup Shop Franchising & Enterprise Integration System: This image shows a diagram of how various decentralized marketplace systems, datasets, and enterprise integration systems may interoperate to create an enterprise integration system for the development of popup shop retail locations

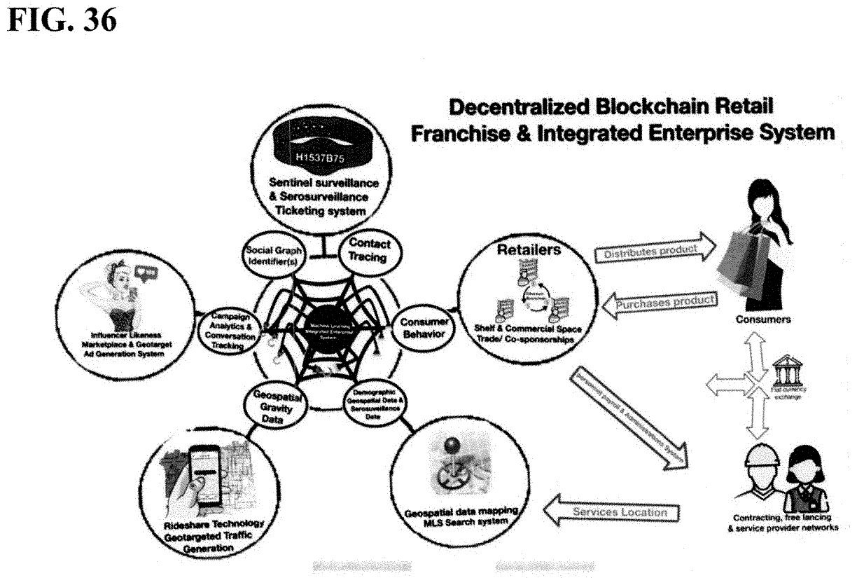

FIG. 37) Popup shop construction types: This image illustrates an example of the various types of popup shop selection options provided to a user as options within a shelf space marketplace environment, a commercial space marketplace environment, or within a popup shop project development system, or as virtual property improvements within a blockchain ARAS marketplace gaming terminal in the case that the concepts of this present invention are taught to the user via a gamification method, wherein the type of virtual property improvement game good correlates to the radial or areal coverage of selective content dissemination transmissions

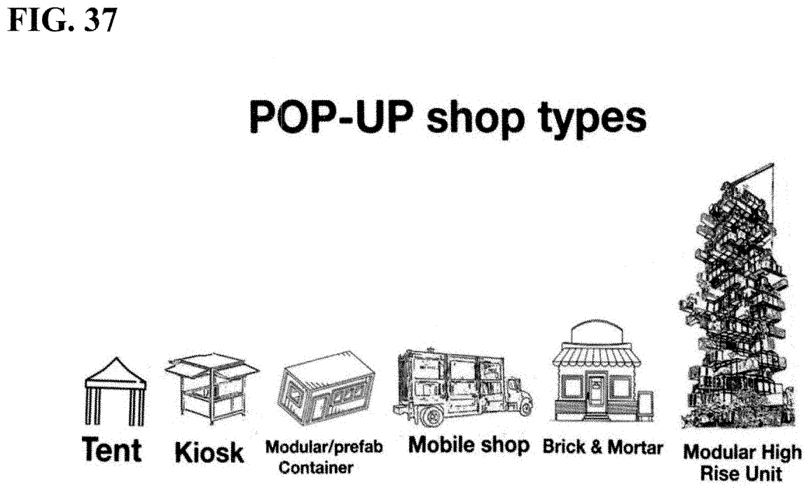

FIG. 38) Influencer/Talent likeness marketplace dataset valuation pricing mechanism: This image depicts an example of how a dataset valuation pricing model may be applied to the sale of virtual items within a social influencer or talent likeness virtual item marketplace

FIG. 39) (CAD/CAM) communication protocols: This image depicts an example of machinery or technology wherein communication protocol data transmission may be revived within a processor and applied in a semiautomated or fully automated, fabrication, construction or manufacturing process

FIG. 40) Target Audience Augment Reality Polling experience: This image illustrates the experience of a geotargeted individual in a proximity to a prospective development site, who has been invited to participate in an augmented reality opinion poll concerning a prospective modular high-rise development project, displaying within a composite display of a real-world view, a scaled augmented reality building construction concept and relative information including a call to action or instructions for participating in the respective poll

FIG. 40A) Augmented reality consumer event participation experience: This image depicts an example of a consumer's experience at an event which may include elements such as but not limited to, an augmented reality local blockchain or block-lattice gaming platform, an augmented reality order-pickup-up alert system, and an augmented reality popup shop shopping experience

FIG. 41) Consumer/Employee user interface: This image depicts a records keeping criteria entry page of a user interface for the participation of a consumer or an employee at a prospective event

FIG. 42) 3D holographic augmented reality experience: This image illustrates an example of an algorithmic function for critical angle thresholding or density slicing using pixel depths that may allow for the 3D rendition of objects within an augmented reality or mixed-reality content display

FIG. 43) Proprietorship classification and consumer identification system: This image illustrates an example of how popup shop proprietors may be classified via a business registration method that may be identified by consumers participating at a relative event, using, computer generated perceptual programming, quick response codes, or temporal resolution pattern recognition

FIG. 44) A temporal graph and directed acyclic graph (DAG) model: This image illustrates an example of a system by which a hybrid delivery model for mobile popup shop trucks and food trucks is conducted according to temporal queries, real time IP location data, or timestamp consensus protocols

FIG. 44A) Hybrid consortium blockchain: This image illustrates an example of a blockchain system that may be used in an ARAS trading gaming terminal wherein permissioned access is required

FIG. 44B) Private blockchain: This image illustrates an example of a private blockchain system that may be implemented within a shelf or commercial space marketplace environment wherein access is permissioned and only the auctioneer may receive payments

FIG. 44C) Spatiotemporal block-lattice: This image illustrates an example of a spatiotemporal block-lattice wherein a directed acyclic graph model is used as part of a simplified payment verification (SPV) system wherein permissioned access or consensus protocols are defined by temporal queries, real time IP location data, or timestamps

FIG. 44D) Social hypergraph block-lattice: This image illustrates an example of a decentralized social influencer likeness virtual item marketplace environment system of a graph learning method wherein edges may represent social relationships or cryptographic transactions between nodes

FIG. 44E) Geotargeting of ads & rideshare ads: This image illustrates an example of graph learning mechanisms and stochastic modeling that may be implemented in a geotargeting selective ad content dissemination system, wherein real time IP location data or other data mining datasets are used as variables in the calculation of vector node representation

### DETAILED DESCRIPTION OF INVENTION

While preferable embodiments of the invention are shown and described herein, it will be obvious to those skilled in the art that such embodiments are provided by way of example only. Numerous variations, changes, and substitutions will be apparent to those skilled in the art without departing from the spirit and scope of the invention. It should be understood that various alternatives to the embodiments of the invention described herein may be employed in practicing the invention. It is intended that the following describe exemplary methods and apparatus falling within the scope of the invention.

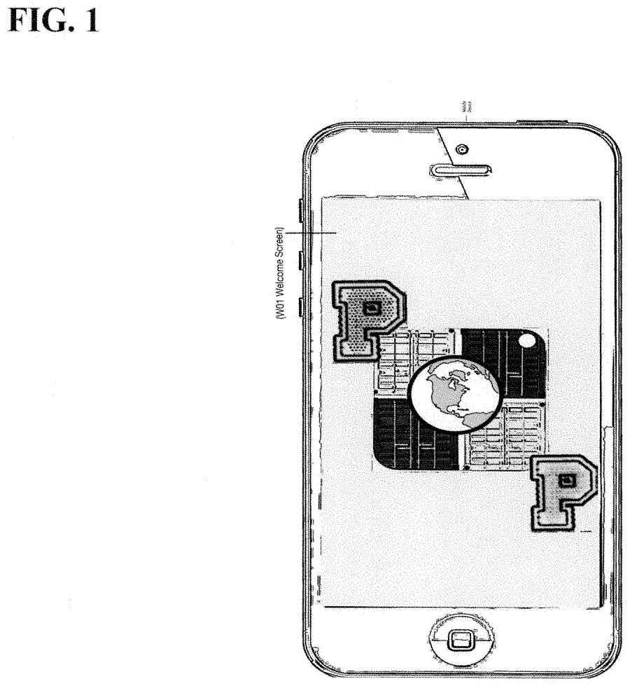

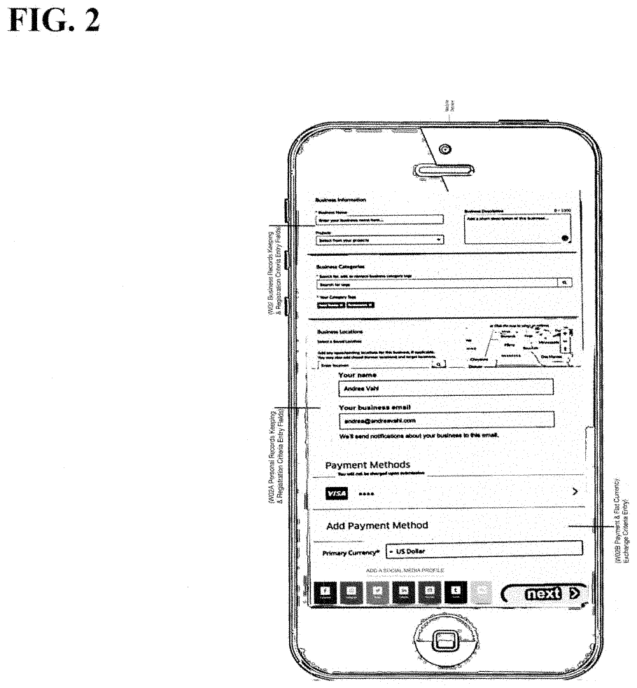

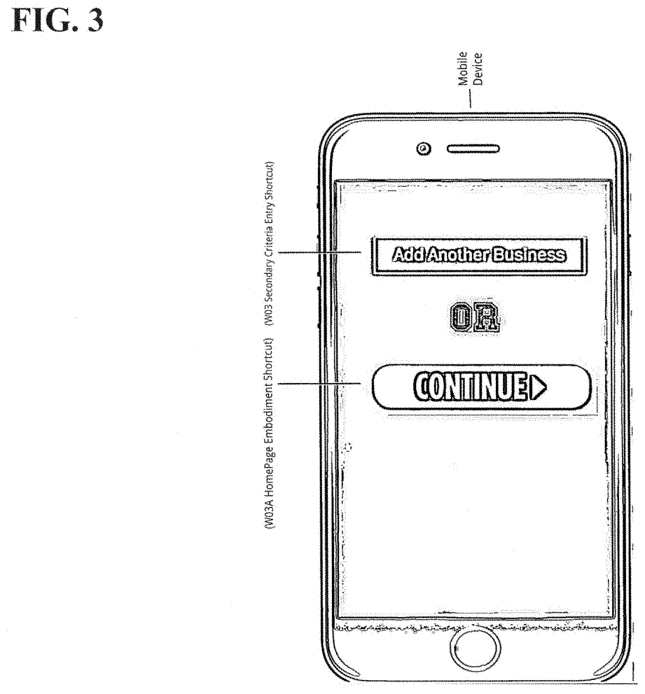

Wireframe FIG. 1 depicts a greeting or introduction screen which is to be displayed upon the launch of the application. After the greeting screen is presented, the user is then presented with the first page of the personal records keeping system and user profile registrar depicted in wireframe FIG. 2 where the user proceeds to fill out criteria entry fields to create a master profile which may consist of data entries such as but not limited to, contact information and a method of payment. This step may also include a method of enterprise integration where the user proceeds to register a business under the user profile which may consist of data such as but not limited to a physical address of a commercial business location, and/or a business URL(s), social media platform URL(s), or a merchant to consumer website or platform website URL(s). However, a geophysical business address is not required. These data criterion entries may actuate a method of data engineering or data extractions from statistics modules, data engineering storage mediums, or cloud-based API real-time data engineering storage mediums which may further aid in the creation of a target market profile that may be implemented in the technique of generating various interactive GIS data maps and geographic information systems that indicate areas of various population densities, or other target market datasets, or in the generation of other interactive or non-interactive data visualization displays. The user may be given the option to register more than one business as shown in wireframe FIG. 3. The user may be further presented with the option of adding authorized users with permissioned access to some or all of the system embodiments of a joint-master profile user interface. After the user completes the registration and records keeping process, a homepage is then presented to the user that includes a “settings” embodiment where the user may be presented with options such as but not limited to, the option of activating the geophysical location(s) of a registered business(s) as an available ARAS, which may also serve the purpose of engineering more data in relation to the surrounding demographics.

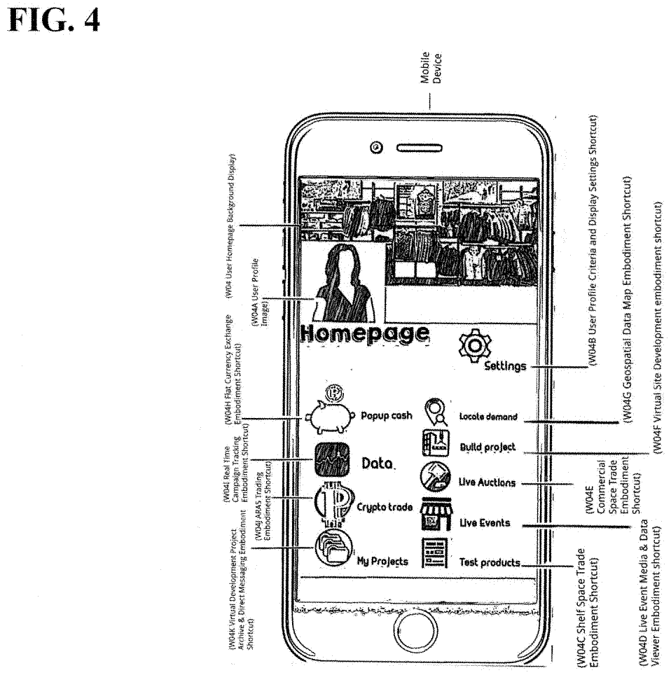

Wireframe FIG. 4 depicts a homepage where the user is given access to various embodiments, including multiple selections of block-lattice or blockchain marketplace systems such as the, shelf space trading system, commercial space trading system, and ARAS marketplace systems, as well as blockchain or block-lattice gaming terminals, the “build project” virtual development and virtual design environments. The home screen also presents an embodiment for a crypto wallet characterized by the “popup cash” piggy bank icon, an embodiment from which the user may locate demand or a target public using interactive GIS data maps denoted by the “locate demand” icon, an embodiment represented by a “build project” icon in which the user engages a virtual site development and interior design experience, an embodiment by which the user manages projects or by which the building of projects is continued, characterized by the “my projects” icon, as well as an embodiment under which live events and consumer statistics can be viewed, accessed via the “live events” icon.

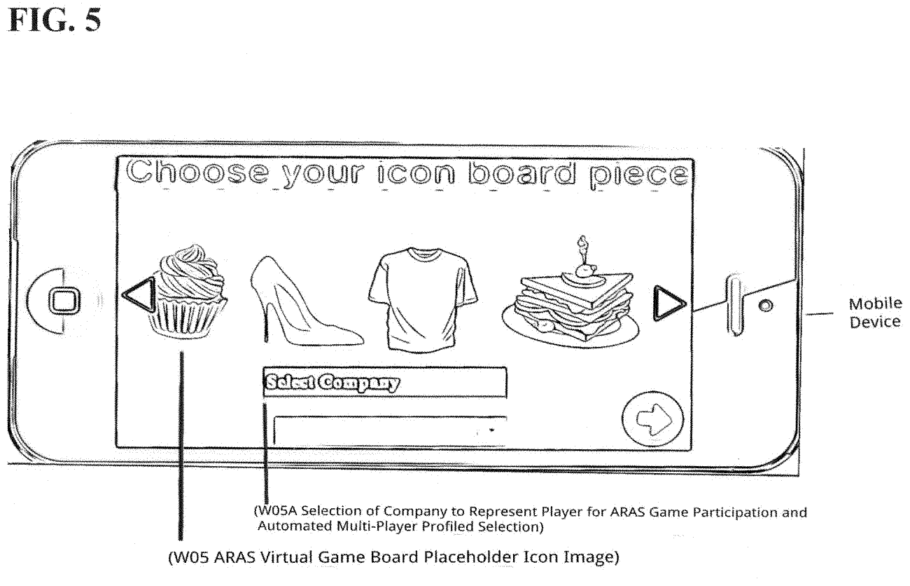

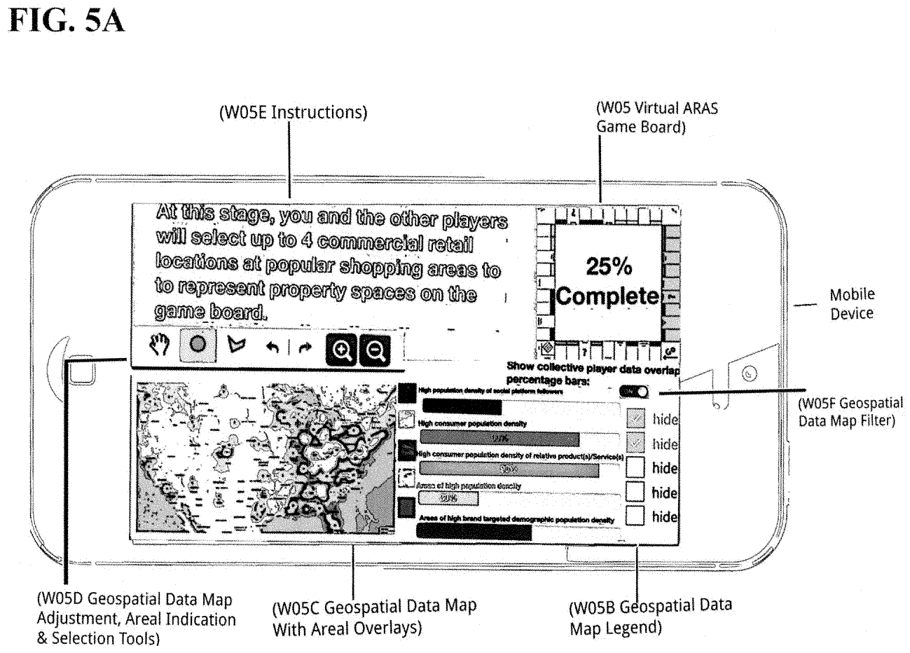

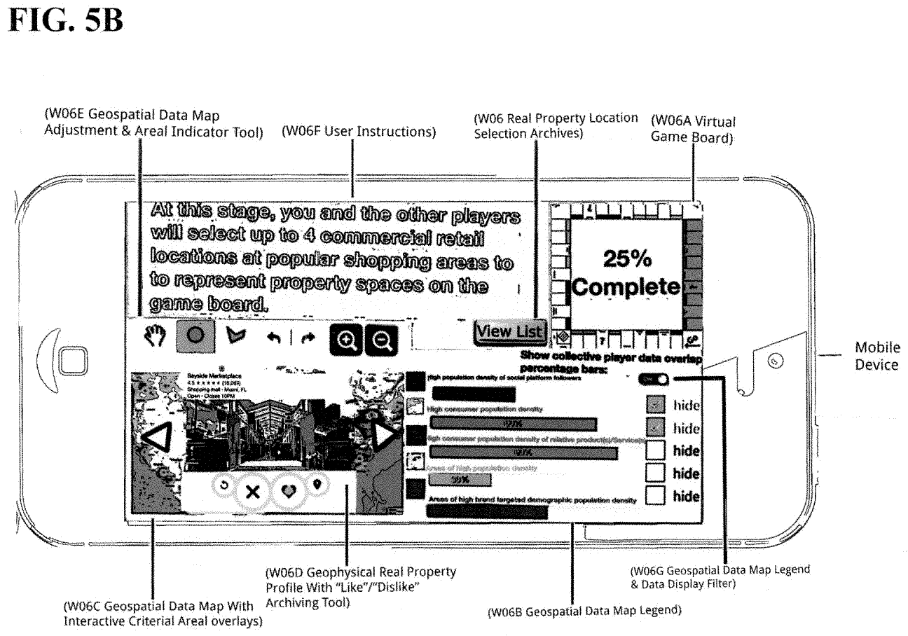

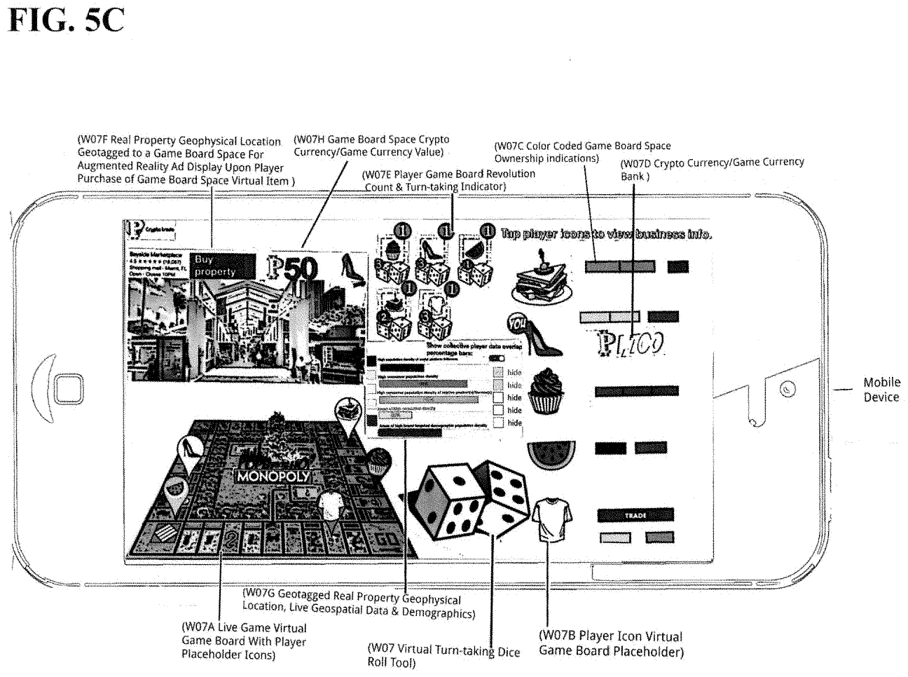

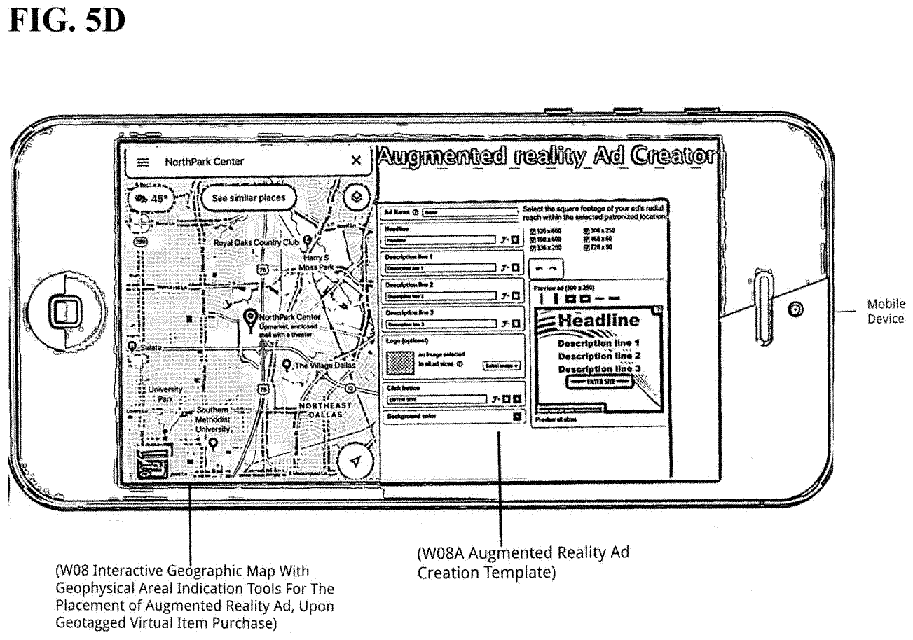

Wireframe FIG. 5 illustrates the result of launching the ARAS marketplace embodiment via the home screen icon labeled “Crypto Trade,” and selecting an ARAS game option which may actuate algorithmic functions to convert the data of a user profile into a player profile, thereby selecting and grouping registered users as players within a single ARAS trading blockchain game. Wireframe FIG. 5 depicts an example of an ARAS marketplace game, that may or may not be provided via a game plugin system or via an API communication protocol, where each player is prompted to select an icon that will represent their gaming participation throughout a single gaming competition. An example illustration of a virtual environment in which one or more players are selected according to correlations in user behavior data, geospatial data, or other data trends of a real time data mining storage medium or statistics module used to define a target market, as well as master account holder unique identifiers of records keeping registry medium criterion by which a player is further defined and thereby further selected to engage in a competition of a virtual blockchain gaming terminal and ARAS marketplace environment.

Wireframe FIG. 5A depicts the next stage within this particular ARAS game selection, where the players are prompted to create a virtual marketplace blockchain game setting by geotagging a geophysical location to a gameboard space, which represents a virtual item or game good to be traded amongst the players. In the FIG. 5A depiction, this process is shown to be aided by the interactive data overlay or data layers of geographic information, and geospatial data, denoting various population densities of an unshared target market or shared target market demographic that is relatively shared to a certain degree amongst the players of a single game, which may aid in the player's selection of a respective location to be geotagged and represented by single gameboard space game good. The geotagging process is repeated until the game board is complete, any remainder of spaces left to be filled, may be geotagged to an auto-selected location. Wireframe FIG. 5B depicts the continuation of the gameboard space game good geotagging process with a swipe viewer displaying geotag selection options, relative to an indicated geophysical location. Location selections do not have to include a real property improvement, for example a national park or a public walking trail maybe selected as a geotag. Location selections may be optimized according to relative population density datasets. These geotagged geophysical locations represent the remote locations to which augmented reality content may be geotargeted to target market nodes in a selective content dissemination technique utilized by a game player as the result of a trade or purchase of the associated virtual gameboard space game good during the respective decentralized ARAS marketplace game session.

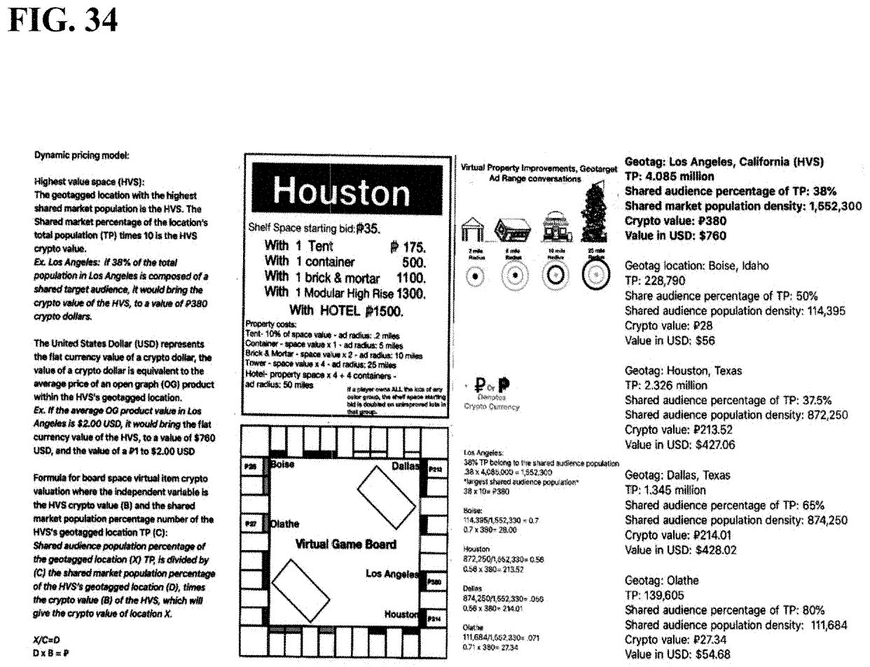

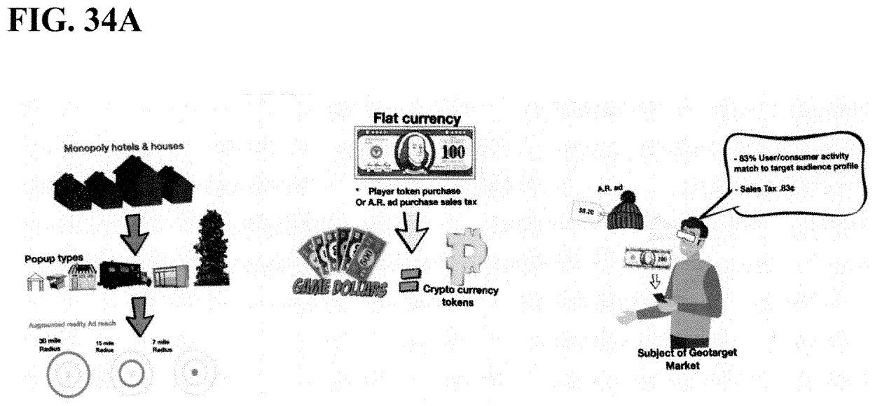

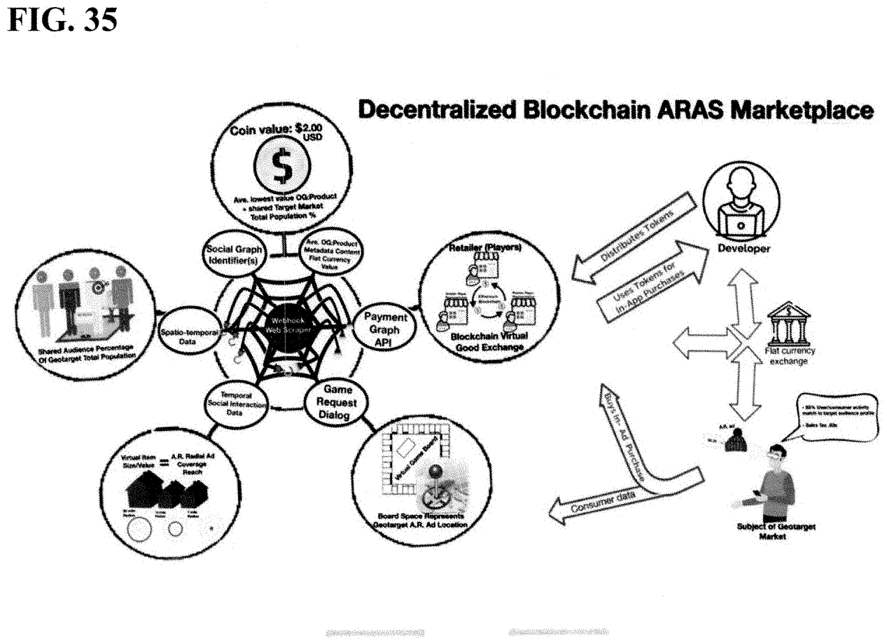

Image FIG. 34 illustrates an example of how an ARAS marketplace gaming platform system uses a machine learning algorithm to extract data from the geotagged locations, to form a dataset valuation pricing model within the blockchain game. In this example, the algorithm is shown to extract spatiotemporal data, temporal social interaction data which may be used to help determine ad content or augmented reality advertisement content's range, reach, radial, or areal coverage, according to geospatial data defined by the rate at which information is passed between servers, which could further define a location's population density. Social graph identifiers may be used to demographically assign subjects of a geotarget population to a target market or target audience profile, as part of a method of identifying the percentage of subjects within the respective location, belonging to a target audience that are relatively shared by the players of a single ARAS game. In this example, a web scrapping data mining technique may be used to obtain datasets from game requests dialogs detected on servers within a location, that may be linked to a payment graph database which may help determine the average flat currency value of an OG:product within a respective location, which could be implemented as part of a relative valuation method in the delineation of a cryptocurrency's or game token's single monetary unit identifier within a decentralized virtual game good dataset valuation pricing model. For example, if the average cost of a virtual game product within a respective location representing the highest valued gameboard space is $2.00 USD, the flat currency value of a single crypto dollar or game token could be set at $2.00 USD. Image FIG. 35 depicts a decentralized blockchain trading system data structure syntax, wherein developers can provide tokens in exchange for a percentage of a token's flat currency value. Image FIG. 34A additionally illustrates the optional use of a product dataset valuation pricing model in the event of an augmented reality advertisement content target audience interaction or consumer purchase of a content relative product, wherein an advertised product or service is purchased at a flat currency value that is determined by the consumer's demographic proportional percentage of the total geotargeted location's general population of which the respective consumer may belong according to the calculation of the vector node representing the consumer and individual subject of a target audience profile. For example, if the respective consumer's demographic represents 83% of the relatively proximal, general population, the originally listed flat currency value of the product item may be reduced to 83 [symbol] per 1 dollar of the product's original flat currency value, meaning an item listed at $5.00 USD, by the ARAS game player, may be purchased at $4.15 by the geotargeted consumer; or the consumer's demographic population percentage may represent an increase in cost or sales tax according to a criterial threshold that may be set by the respective seller or ARAS game player.

Image FIG. 34 depicts a dataset valuation system used to apply value to virtual items, in which the ARAS game marketplace setting is represented by the game “Monopoly” and the virtual items to be traded or purchased are represented by virtual gameboard spaces denoting pieces of real estate as a first game good, and virtual property improvement items a second game good. The gaming experience may be algorithmically modified to represent concepts that may be seen within other embodiments, as a method of teaching operational concepts of this present invention, via a gamification technique. In the example depicted in the FIG. 34A and FIG. 34 image, the virtual product items are represented by various types of virtual property improvements that take the form of the various types of popup shop construction styles that may also be presented as selectable options for use within other embodiments of this present invention. The aforementioned geophysical location gameboard space geotagging stage may represent an MLS shopping experience that may be provided within in the embodiment denoted by the “build project” or “locate demand” icon on the homepage, for example. In this example of an ARAS marketplace game, the relative size or value of a virtual property improvement item, may also correspond to the variations in range, areal or radial coverage of a selective ad content dissemination or augmented reality selective ad content dissemination within the general area of a geotargeted location. The user experience may also include an advertisement creation method that at least in part mimics the process of virtual development, design and staging of a popup shop, experienced in the embodiment denoted by the “build project” icon, but may include a translative algorithmic function or communication protocol resulting in the rendition of advertisement content of a content creation and selective content dissemination module.

Image FIG. 34 further depicts a method of data valuation pricing or relative valuation pricing of generated framework variables by which an algorithm creates datasets from the geotagged selections made using methods depicted in wireframes FIG. 5A and FIG. 5B, and determines the highest value virtual gameboard space which is represented by the geotagged location consisting of the highest population density of individual subjects belonging to a shared target market amongst a single group of ARAS game players. In this example, the shared target market's general population proportional percentage number is multiplied times ten, giving the game token value of the respective virtual gameboard space. Although not shown in this example where the percentage number is multiplied by ten giving the highest valued space's price value hundredth's place, place value, the place value of the highest valued gameboard space's price may be determined according to the place value of the average revenue or profits earned by the player's registered retail businesses, generated within a given period of time during a fiscal year. In the FIG. 34 example, the geotagged location with the largest population of a shared target market represented by a calculation of vector nodes, is the highest valued space (HVS) on the virtual gameboard. As previously stated, the shared target public's proportional percentage number of the HVS's geotagged location's general population density is multiplied times ten, giving the game token value or price value of the HVS, which may serve as the independent variable in a formula to determine the relative price value or token value of the remaining virtual gameboard spaces. The estimated or calculated number of individuals belonging to a shared target market population, within each of the remaining gameboard space's respectively geotag locations, is the shown to be divided by that of the HVS's geotagged location. The quotient is then multiplied by the HVS's cryptocurrency value or price number, to get the relative game token value or price number, of a respective gameboard space, according to its shared market population density relative to that of the HVS's geotagged location. These methods are used to determine a game token value, however, the average open graph (OG): product cost within the highest valued virtual gameboard space's geotag location, or the average OG: product cost across all geotagged locations, may be used to determine the flat currency value of single game token or single monetary unit identifier. For example, if the average cost of a single OG: product value in the respective HVS location, is determined to be $2.00 USD, the flat currency value of a virtual gameboard space may be twice its game token value. The flat currency value of the highest priced virtual gameboard space valued at 380 game tokens, would have a flat currency value of $760 USD, for example.

Wireframe FIG. 5C depicts an example of an ARAS game virtual gameboard screen on which the icon of each player is displayed next to the color stripe corresponding to the virtual gameboard spaces or virtual properties owned by the respective player. The player at turn, rolls a virtual pair of dice to advance to the next virtual gameboard space, if unowned, the player is presented with the option to purchase the space, along with the display of information about the space's geotagged location's population, social activities, and tourist attractions within the area as well as other datasets relative to the player's target market profile. If the space is owned by another player, the visiting player must pay a fee which may represent the renting shelf space or commercial space at real-world popup shop and may or may not result in a featured spot within an augmented reality advertisement of a geotargeted content dissemination for augmented reality display or content display within the nodal devices of the respectively geotagged location. Players may also be allowed to trade properties amongst themselves.

Wireframe FIG. 5D depicts an example of a stage within an augmented reality advertisement content creation and geotargeting mechanism, illustrating what could happen should a player decide to purchase a virtual gameboard space and a virtual real estate improvement item game good for the geotargeted transmission of advertisement content, to a processor of the GPS enabled devices where in a GPS enabled device may be either a mixed-reality device, a neurotechnology device, a hyper-reality device, or a device that is pairable to a GPS enabled mobile device, wherein the said GPS enabled device represents a vector node or an individual subject of a target market that is within a geotargeted area of the respective virtual gameboard space's geotagged location, within a range represented by the size or value of the virtual property improvement item game good.

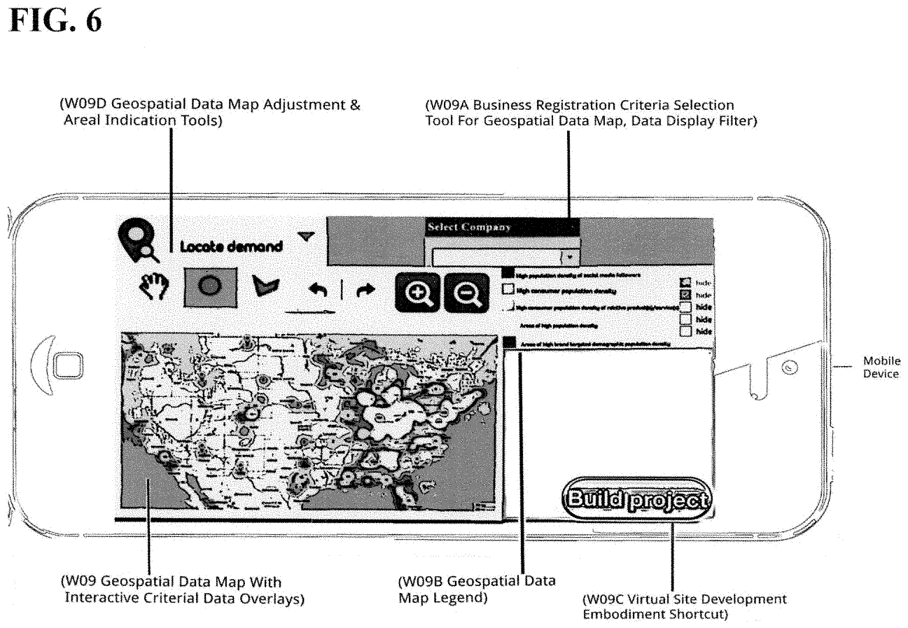

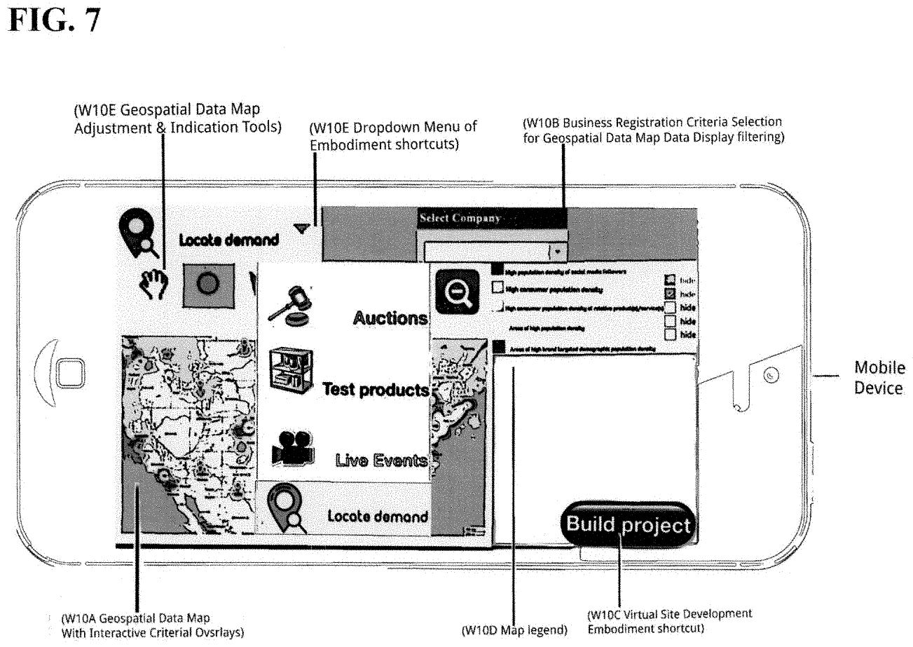

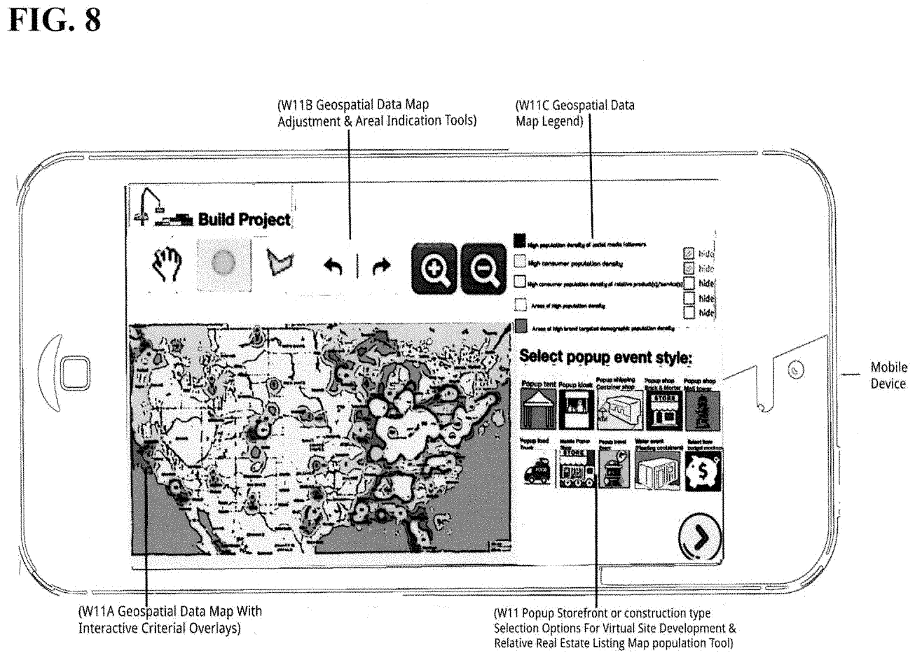

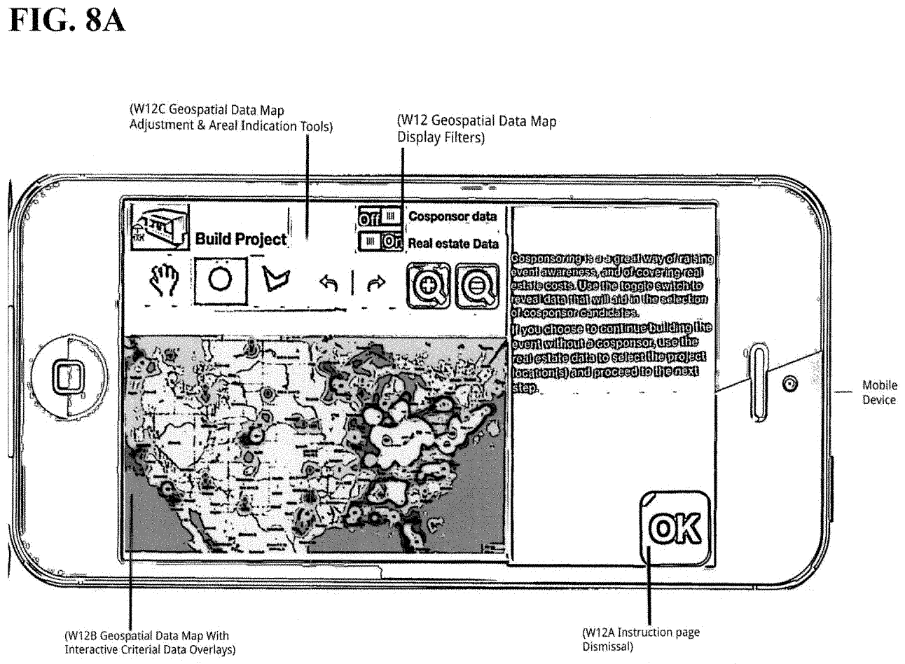

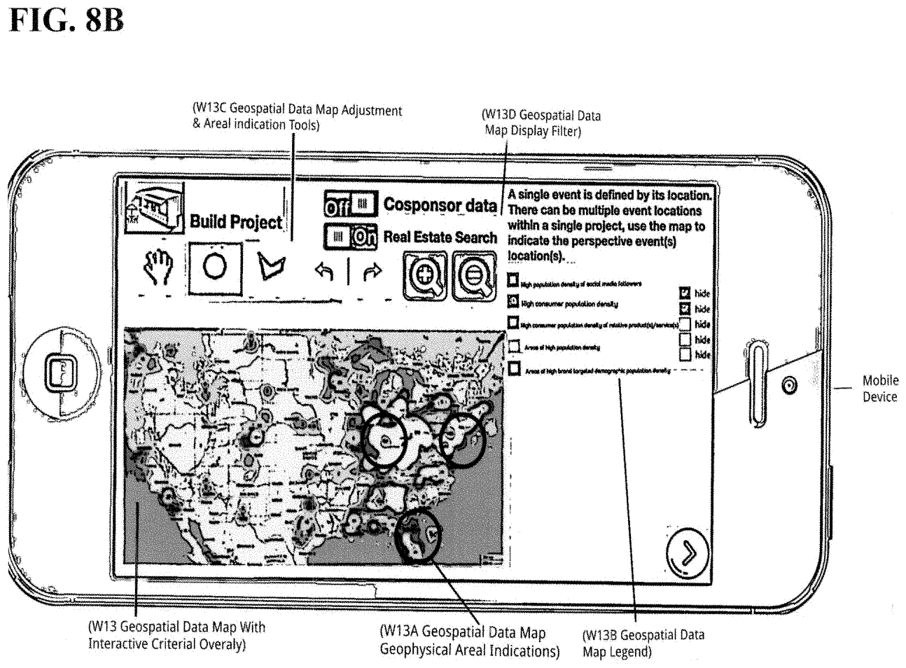

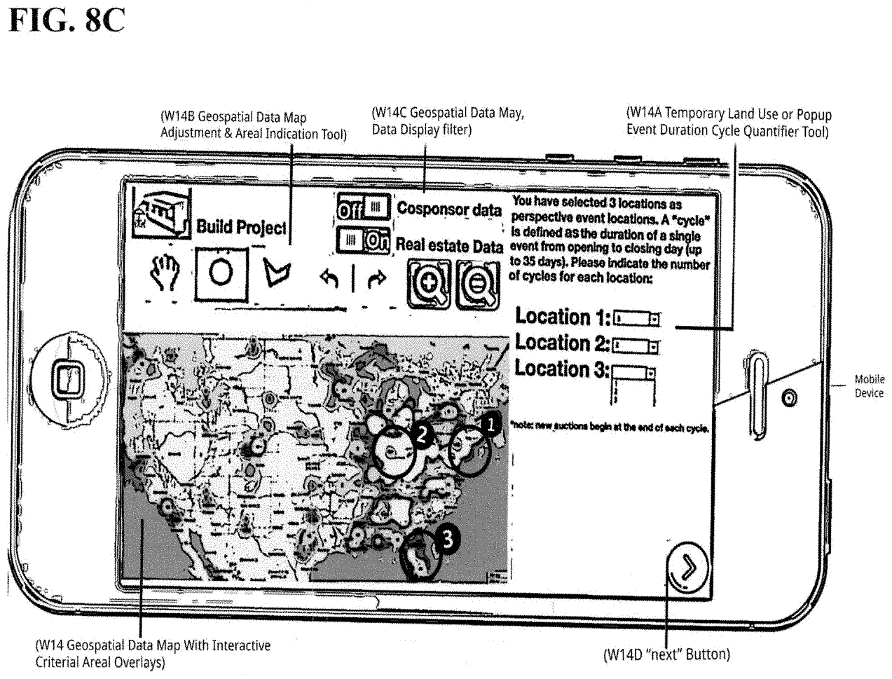

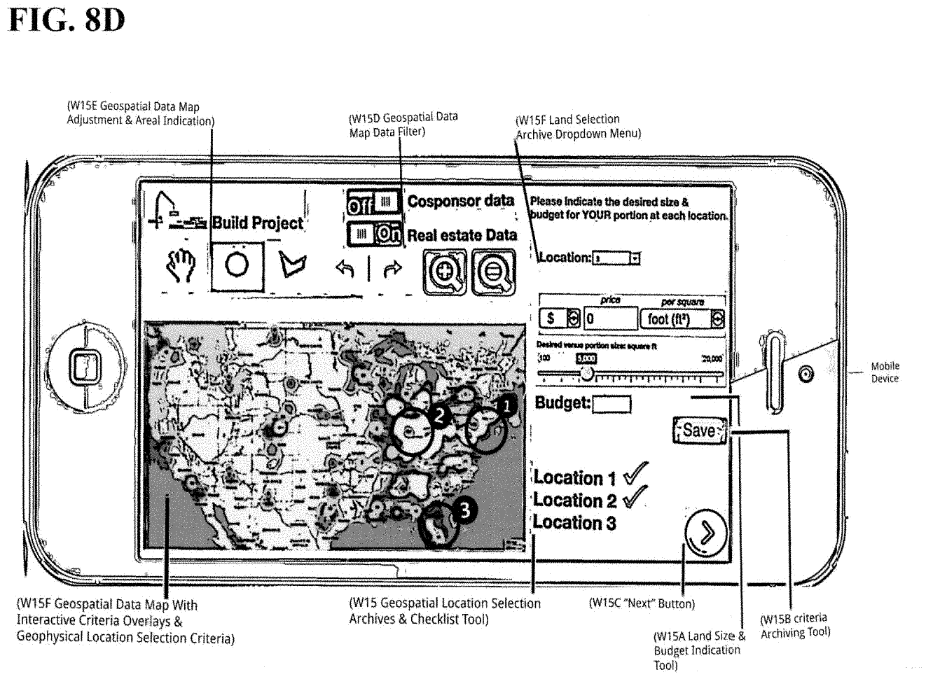

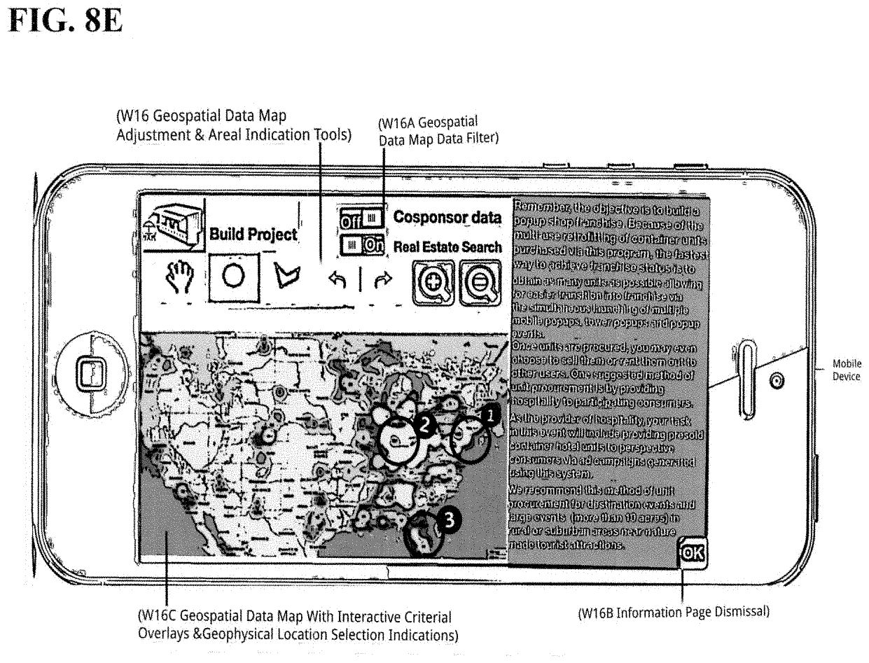

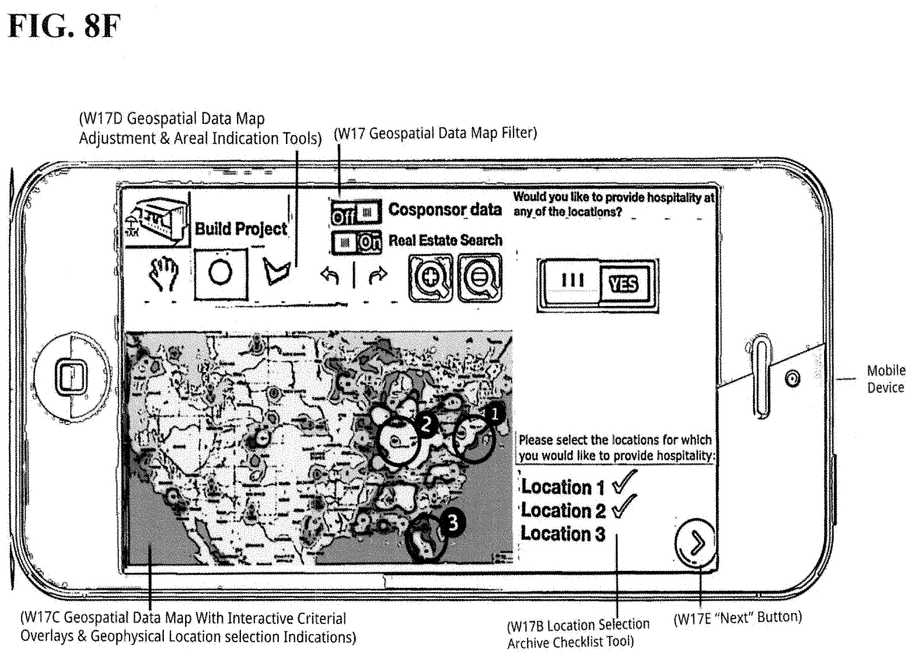

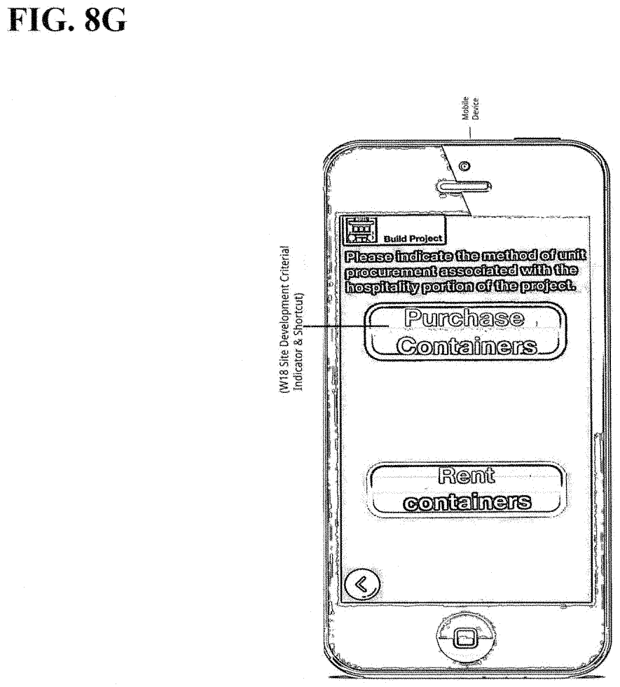

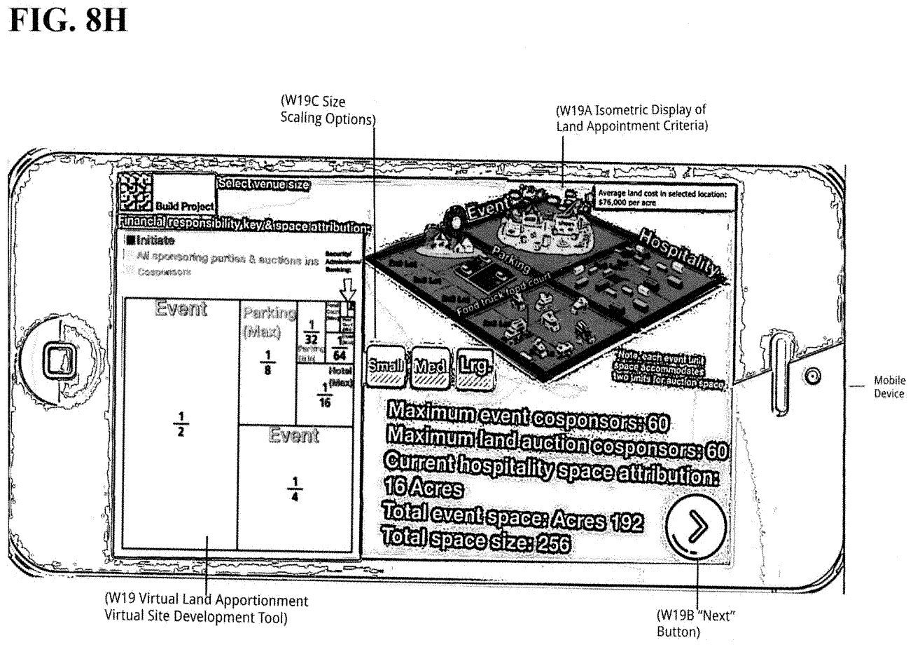

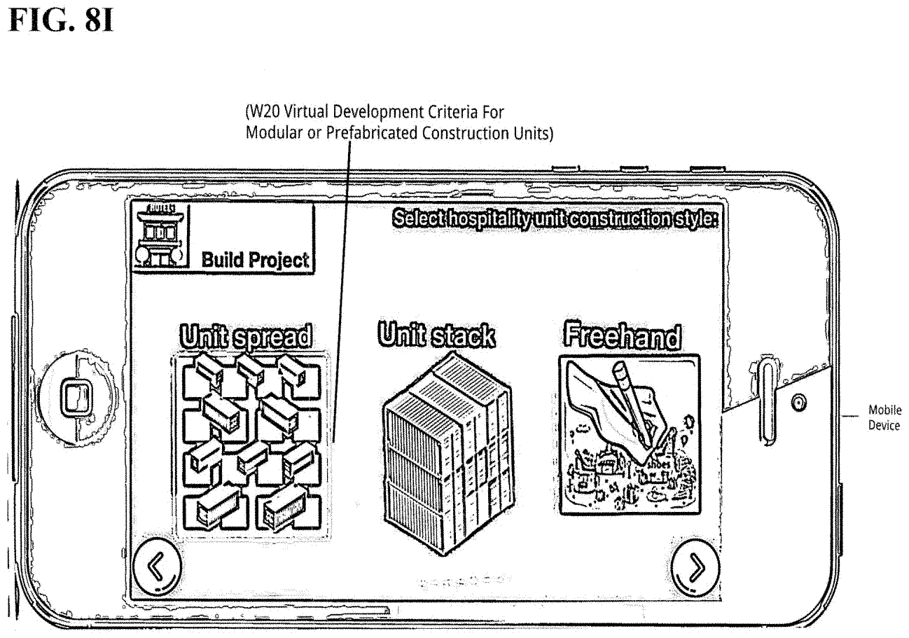

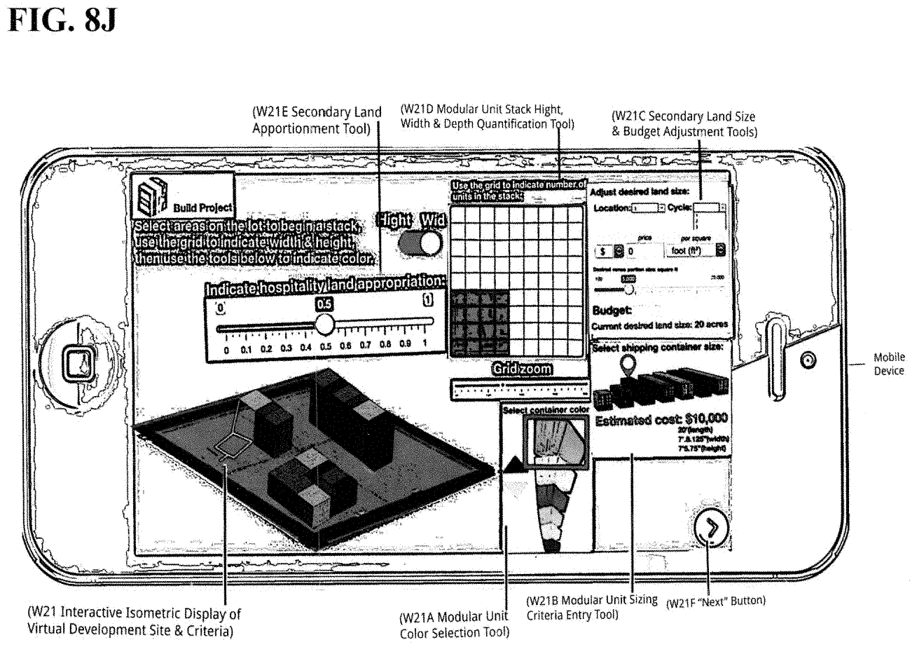

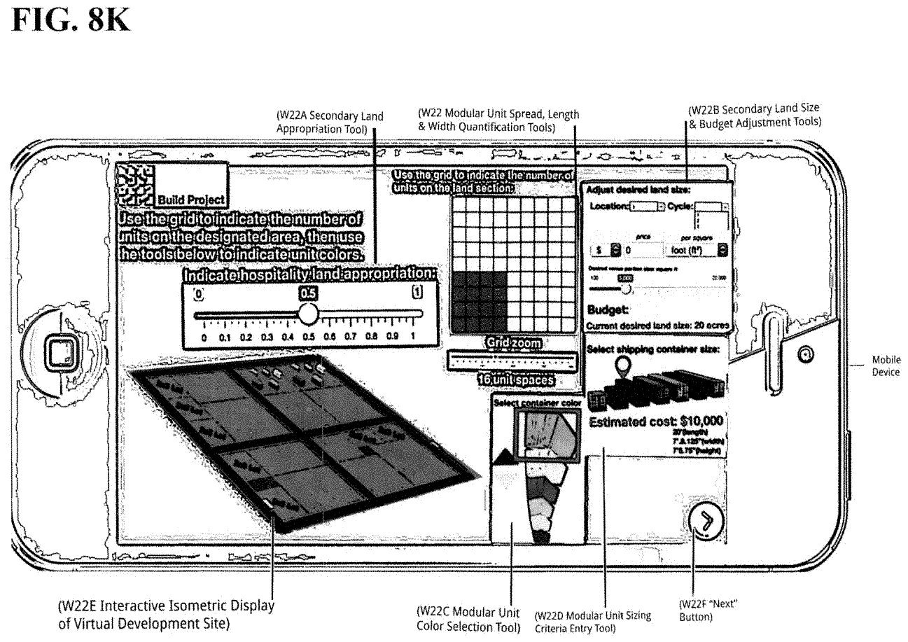

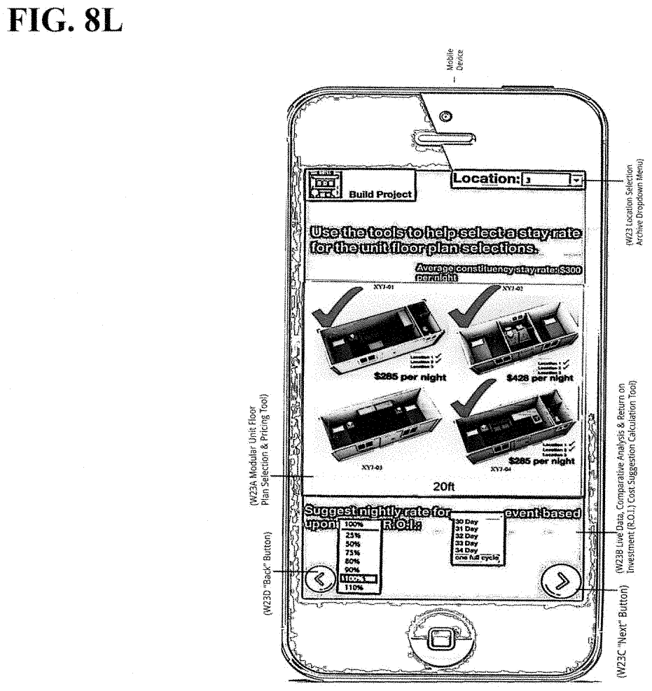

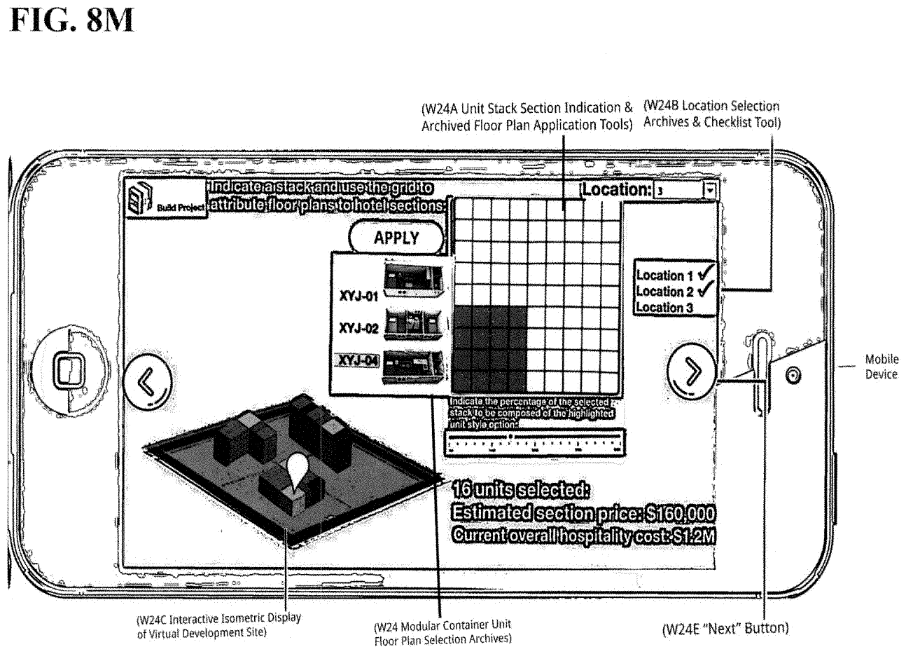

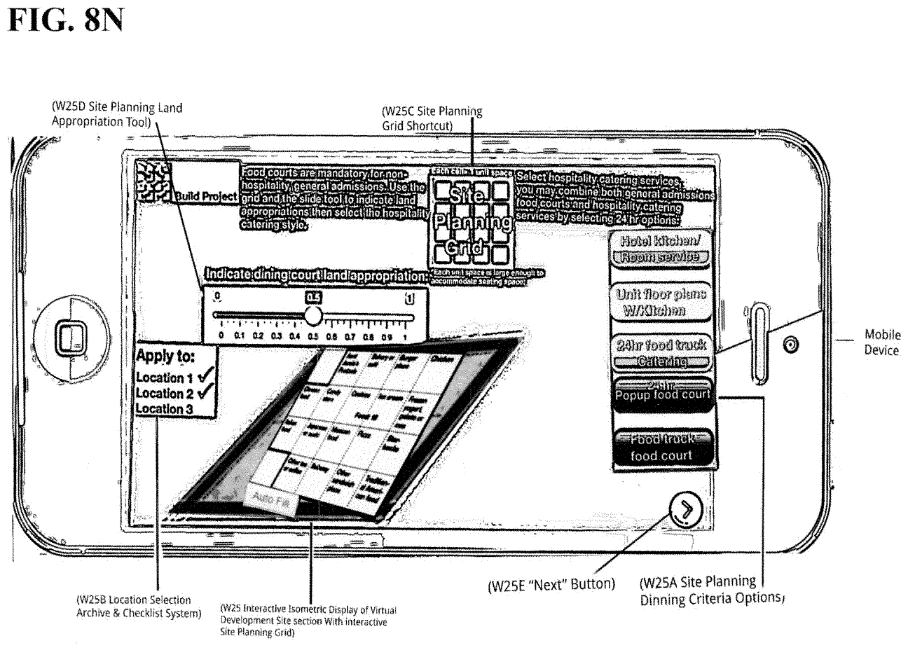

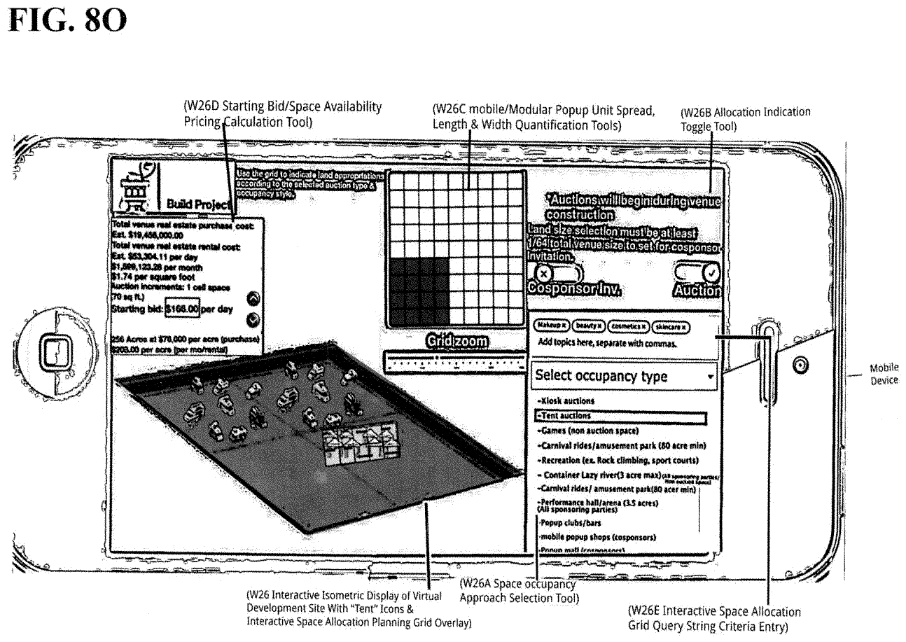

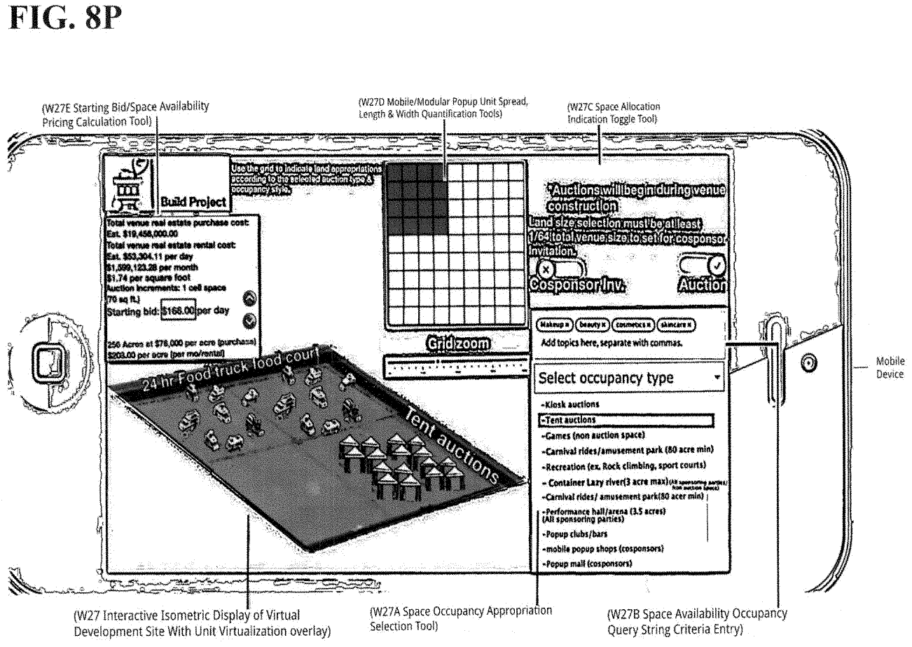

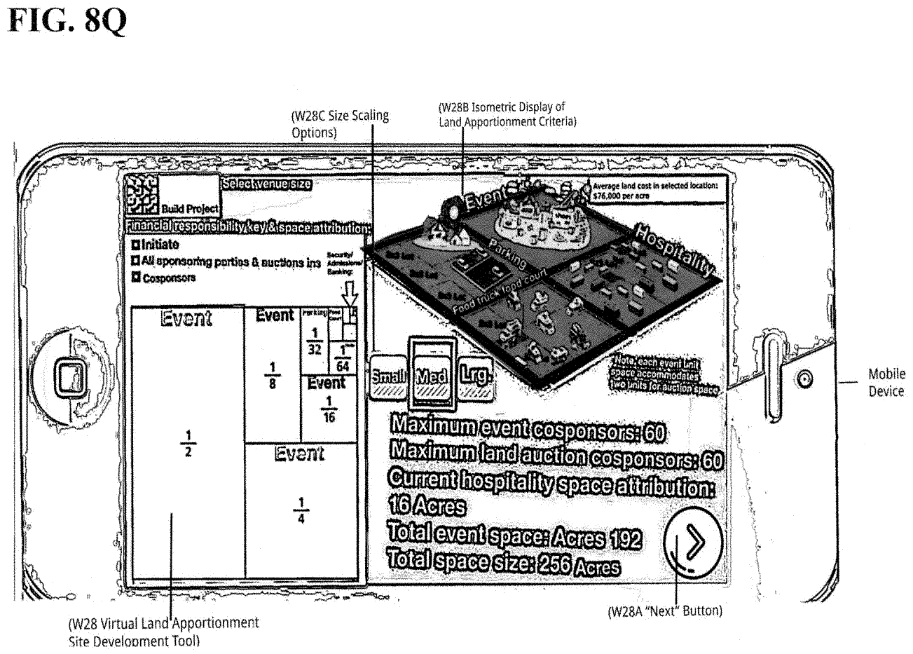

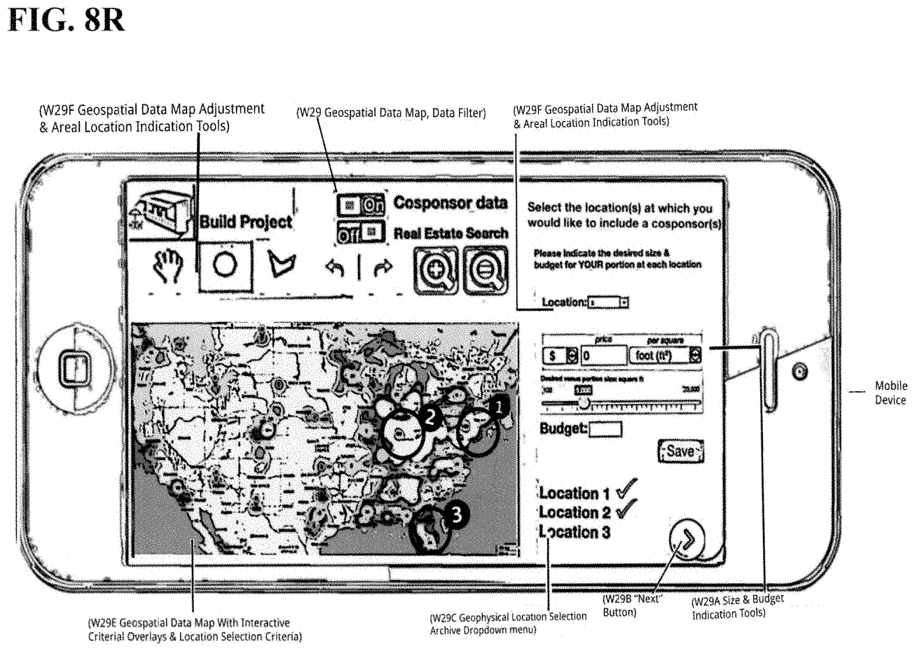

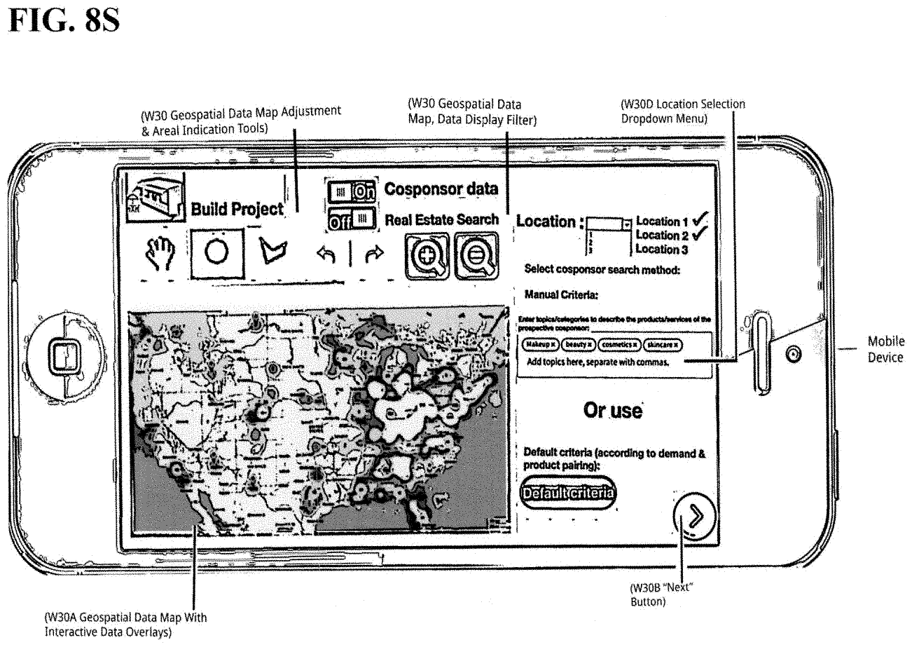

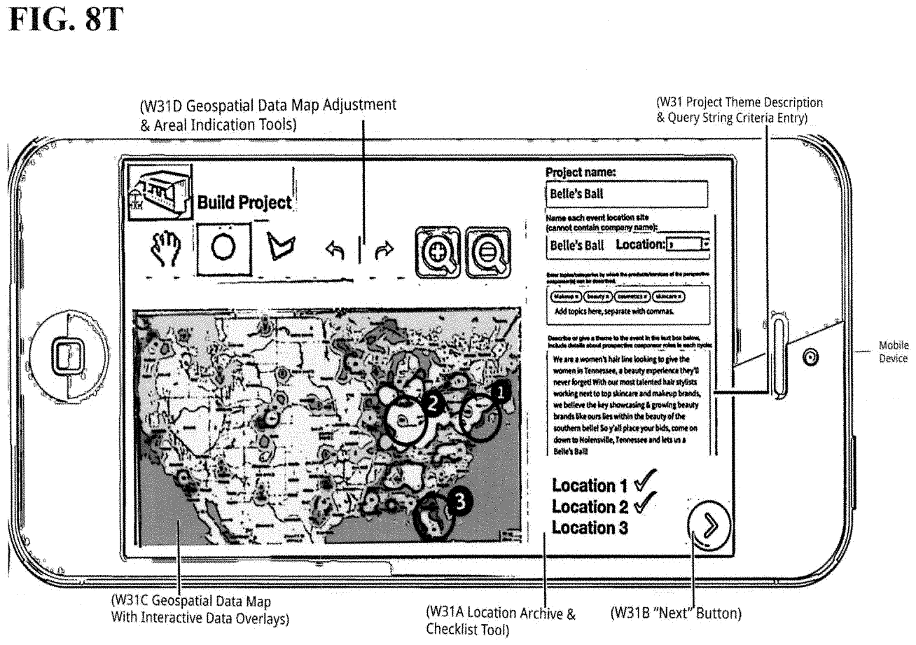

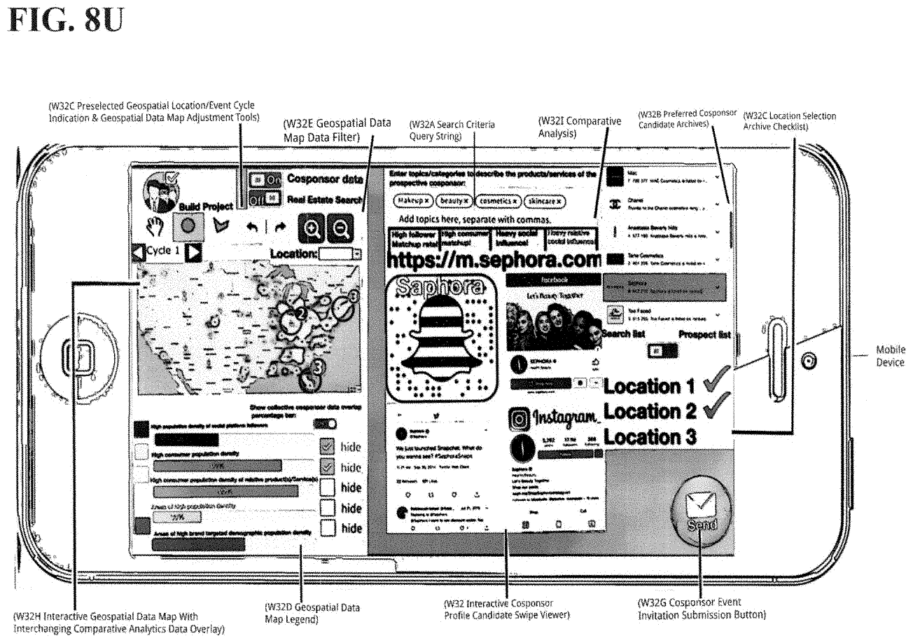

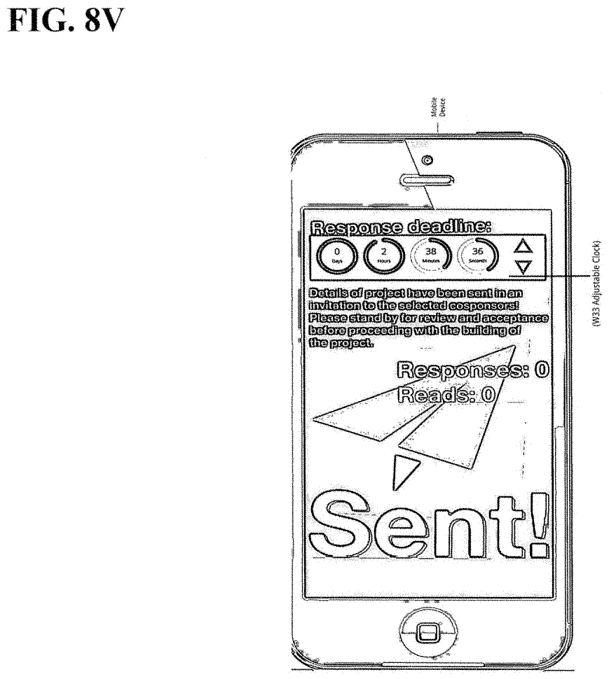

Wireframe FIG. 6 illustrates an embodiment accessed under the “locate demand” icon, depicted on the home screen wireframe, wherein the user is able to locate demand and target market relative population densities on a global scale, in relation to each registered company, prior to engaging in the launching of a project. The wireframe further illustrates an interactive data visualization or the graphic representation of datasets or variables of a real time data mining storage medium, or of a statistics module database, that involves producing images that communicate relationships among the represented data to viewers of an interactive GIS data visualization map in data layers or data overlays. In this context, a statistics module is defined as computerized method of providing functions to mathematical statistics of numeric data that may represent variables such as but not limited to, user behavior, consumer behavior, gravity based spatial interaction, spatiotemporal density, cloud-based API real-time data engineering, geospatial demographics, the stochastic modeling of variables representing a target market, relative population densities, conversation tracking data, cookie compliance data, etc. This communication is achieved through the use of a systematic mapping between graphic marks and data values in the creation of the visualization. The wireframe further depicts the interactive GIS data map with visual display and data overlay filter options, for the display of various datasets, along with a shortcut dropdown menu to various types of interactive GIS data maps as depicted in wireframe FIG. 7. Both FIG. 6 and FIG. 7 depict an embodiment that is accessed via the “locate demand” icon depicted in wireframe FIG. 4. Wireframe FIG. 8 depicts the “Build project” embodiment which can be accessed via a shortcut on the dropdown menu depicted in wireframe FIG. 7, or via the homepage icon labeled “build project” illustrated in the FIG. 4 wireframe. The FIG. 8 wireframe depicts a variation of the “locate demand” embodiment, subsequent to the selecting the “build project” option, thereby generating the screen display on which the user selects the preferred popup shop construction type for the prospective project, which may actuate a data extraction from various multiple listing service (MLS) websites, worldwide or within a user specified location, in accordance with the popup shop construction style selection and relative real property listings that are located within the indicated general location of interest.

Wireframe FIG. 8A, further depicts the “build project” screen, wherein the user is notified of the option to include a cosponsor with relatively correlative target market profile data, to join in the hosting, creation or launch of a popup shop or event project in a joint-user interface, requiring no further action other than the dismissal of the notification screen upon review. Wireframe FIG. 8B further illustrates an information page that guides the user in selecting one or more general preselected prospective locations for the launch of a popshop shop or popup event development project, the user then proceeds to select the general locations, and further defines the desired amount of space and a budget for each project at each general location using the criteria entry fields depicted FIG. 8D. Wireframe FIG. 8C depicts a stage at which the user selects a desired launch date and indicates the desired duration time per each event at each of the prospective locations, a maximum duration limit may be set according to zoning or temporary use laws within the respective location.

Wireframe FIG. 8E illustrates an information page that introduces the user to the option of including a “hospitality” option at one or more of the selected prospective event locations, which is dismissed to display the screen depicted in wireframe FIG. 8F where the user can choose from the general location selections to indicate those at which they wish to include hospitality services, if any. Also displayed is a toggle switch option with which the user may choose location selection options at which they may wish to include cosponsoring parties to aid in the conceptualizing, building, and funding of the project within the respective location, as part of a joint user interface, subsequent to the utilization of the toggle tool as depicted in wireframe FIG. 8R. At this stage both the “real estate” toggle switch and the “cosponsor” toggle switch, are used to show the relative quantity of potential options that could be available within a selected area during the real estate or cosponsor search stage. Wireframe FIG. 8G illustrates an option to purchase or rent modified or prefabricated shipping containers or to be used at a shipping container popup construction style event.

Wireframe FIG. 8H depicts the “build project” embodiment as virtual land development experience within a virtual environment, wherein the user has opted out of adding a cosponsoring party of a temporary use join-proprietorship, but has not excluded commercial space auction bidders or subtenancies, and is given the option to plan the prospective event space using an interactive isometric display by adjusting land apportionments relative to the event space allocation size which may be given in various sizing options. Additional land space may be required according to factors such as but not limited to parking lot space zoning requirements. After the initial virtual land development process is complete, an algorithmic function may apply the scaled dimensions as part of a query entry or criteria input method in the search for MLS listings matching the desired dimensions, that are within the respective preselected general location. The virtual land development experience may also be utilized to conduct the auctioning or selling of subsectors before a real property purchase is made within the prospective location, however an earnest period may apply which may limit the duration of an auction period. Wireframe FIG. 8H further depicts an optional use color-coded key to indicate the party of financial responsibility according to a selected subsector or measurement of space, should the user choose to include cosponsoring parties or a temporary use joint-proprietorship and bidders of a temporary use subtenancy.

Wireframe FIG. 8I depicts the introduction to the virtual land development and volumetric design stage of the “build project” embodiment wherein the user has opted to include hospitality at a shipping container construction style popup event. The user is the given a display of modular or prefabricated construction layout types from which to choose, as the construction style of modified, prefabricated or modular hospitality units. The options presented are as follows, “unit spread,” which depicts individual modular or prefabricated shipping container units that are spread out according to floor area ratios (FAR), a “unit stack” which illustrates the use of a steel module frame in the stacking of modular or prefabricated shipping container units, and “Free hand” which actuates modified CAD and FAR algorithms to aid in process of virtual architectural design.

Wireframe FIG. 8J illustrates a method of virtual land development and land subsector apportionment using an interactive grid tool or virtual fencing agent with cells that represent the number of shipping container units within a given stack of a steel module frame, according to the indication of cells in the grid representing the length, width or height of the stack. The user would further indicate the desired size and color of the shipping container units within a single stack which may cause an adjustment to the previously entered budget and apportionment criteria and may also aid in the generation of shipping container vendors, modified, prefabricated or modular shipping container vendors, manufacturers, contractors, provider or servicer, search criteria. As the user manipulates the tools, the changes made are exemplified on an interactive isometric display model of the prospective midrise modular construction building, which may also be used generate criteria in the search for a modular steel frame vendor, contractor, provider or servicer later in the building process. Wireframe FIG. 8K illustrates the methods used when the “unit spread” option is selected and the grid cells represent a single shipping container's land apportionment according to FAR, which is used to determine the spacing between individual, modular, modified or prefabricated shipping container units.

Wireframe FIG. 8L illustrates a method of selecting hospitality floorplans that are to be offered at a shipping container construction style popup event. The user is guided by tools that use data extractions from the user's target market profile, to help determine pricing and the potential return on investment according to the projected number of event admission ticket sales. For example, social graph data could be used to determine how many subjects of a target market would be likely to an attend an event based upon correlations in user behavior or conversation tracking data, wherein the target market is represented by vector node. Wireframe FIG. 8L also depicts a data extraction that describes the use of social graph data to determine average hotel costs or travel expenditures within a target market, according to various location tags on applied to a plurality of individual target market subject's social media profile pages, that have been applied to posted images or videos at a rate or frequency that would indicate a respectively tagged location as a travel destination. For example, if 0.03% of a subject's posts includes a “Honolulu, Hi.” location tag, and 80% of the subject's posts include a “Wakefield, Mo.” location tag, the algorithm may determine that the subject's place of residence is Wakefield, Mo., and Honolulu, Hi. as a travel destination. Based upon interoperating geographic information data extractions of a data engineering database that details the average hotel costs within a proximal location of Honolulu, Hi., as well as that of other locations frequently traveled by other individual constituents of a target public, the algorithm may generate a suggested stay rate and the projected return on investment according to data correlations and the construction and furnishing cost of the selected hospitality floorplan. The system may further generate average stay rates according to the identification of an actual hotel or hospitality service's name or location based upon such information that may be included in a location tag as well. Wireframe FIG. 8M depicts a method of applying the selected floor plans to a grid indicated section of a virtual unit stack within the interactive isometric display, which may cause an adjustment to the originally entered budgeting criteria. Any funds raised using an ARAS advertisement campaign, may be applied to development or purchasing costs.

Wireframe FIG. 8N illustrates another FAR grid tool or virtual fencing agent that is used in the planning of space wherein the planning for a popup food court is applied to a virtual isometric land subsector, by which individual spatial allocations are categorized by various types of cuisines; the selection of which may be further guided by the use of target market dataset visualizations that depict data correlations with cuisine categorizations. The site planning subsector grid tool or virtual fencing agent may offer multiple selectable options of subcategorized planning or patronage categories which may be applied to a virtual space, such as but not limited to “women's apparel” for example, in which each cell represents a spatial allocation for various subcategories such as “women's lingerie.” This tool may be used as a method of generating entry or eligibility criteria in the interoperation of embodiments comprising a commercial space marketplace, wherein the renting, or purchasing of spatial subsectors or sectors may be experienced by a plurality of retailers, representing master account holders, for the commercialized participation at a prospective event as temporary land use subtenants. Wireframe FIG. 8O illustrates the site planning subsector grid tool or virtual fencing agent as a method of allocating and specifying land use for various commercial space subsector auctioning categories where the popup style is an outdoor commercial tent, and the starting bid is determined according to the estimated price per square foot, based upon the average land cost in the selected general location. Subcategories are applied manually to each cell using a query string separation method of a criterial input device, which is used to allocate prospective land subsectors towards a specified use, for the rent or purchase by a user of a master account user profile that has relative criterial correlations found within the categorizing criterial descriptors of a registered business, that may also be used to optimize commercial space availability publication search options within the commercial space marketplace environment. FIG. 8O also illustrates the option of selecting a category for land allocation and subsector procurement eligibility criteria to be applied to the indicated area. The user is presented, again, with an option to invite cosponsors via the use of a toggle switch in which a cosponsor candidate may assume initial appropriations of financial responsibility for the respective grid virtual fencing tool indicated sector allocation, or may choose to submit a temporary land use joint-proprietorship or joint-proprietorship counter offer for the procurement of irregular areal sectors from which the prospective cosponsor may choose to auction, rent or sell subsectors via a commercial space marketplace environment; or the user may choose forego the option of including cosponsors to retain sole proprietorship of the indicated land sector from which they may proceed to auction, rent or sell, cell subsectors within in a commercial space marketplace environment. The user may also choose to go “back” and indicate the initial cosponsor inclusion option, allowing for a larger quantitative distribution of land sectorizations to a prospective sponsoring party, in the generation of a cosponsor invitation that includes virtual development criteria, as seen in wireframe FIG. 8Q. FIG. 8P shows the resulting isometric display of scaled outdoor commercial tent icons in the virtual spatial allocation that was previously indicated by the subsector planning grid or virtual fencing agent that was used in the categorization of cells, further depicting the foreground placement of scaled popup unit virtualizations, when the selected popup construction style is a commercial tent.

Wireframe FIG. 8S depicts a stage within the “build project” embodiment, where the user indicates the option of implementing cosponsors in the launch of the of a project, and has further indicated a budget for desired their portion of the prospective project. Through the use of a query string separation method, the user further indicates the desired business categories that may be used to define the prospective cosponsor(s) candidate options as illustrated in wireframe FIG. 8S. The optimization of cosponsor candidate options may also be automated according to business descriptor items, or according to target market relative dataset objects, or consumer behavior data relative to product paring rates relating to business product inventory repository criteria. The user may be guided by data extractions that indicate correlations between a business category and the data that defines a target audience or by default options that automates search criteria entries according to relative criterial data extractions from the personal records keeping and business registrations systems. For example, the conversation tracking data of a target audience or a consumer population, may reveal a high product pairing rate in the consumer purchases of products or services that may be categorized or described in ways that are similar to the descriptive criteria that two or more registered users have input to categorize or describe a business during the business registration process, which may aid the algorithmic functions actuated in detecting suitable cosponsor matchups within a graph learning retailer social graph networking system. Wireframe FIG. 8T depicts a method of entering criteria in summarizing the idealization of a prospective event's theme and branding message, at each of the locations within a single project.

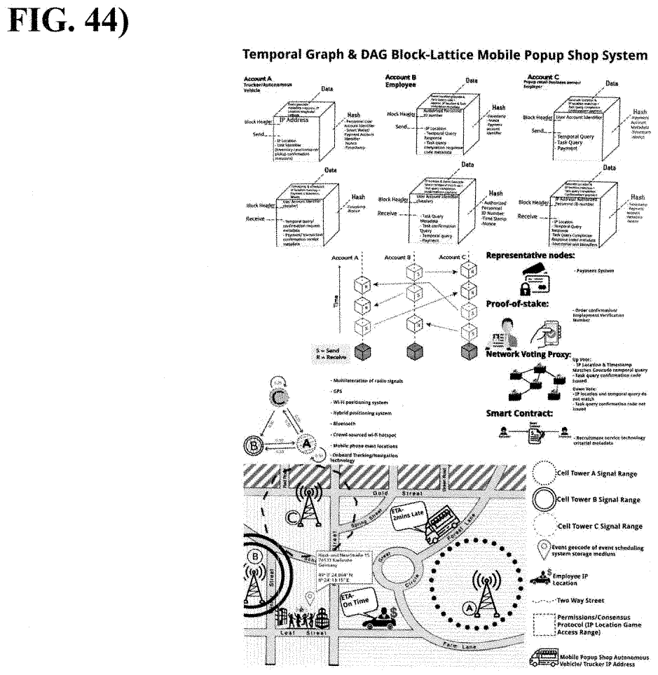

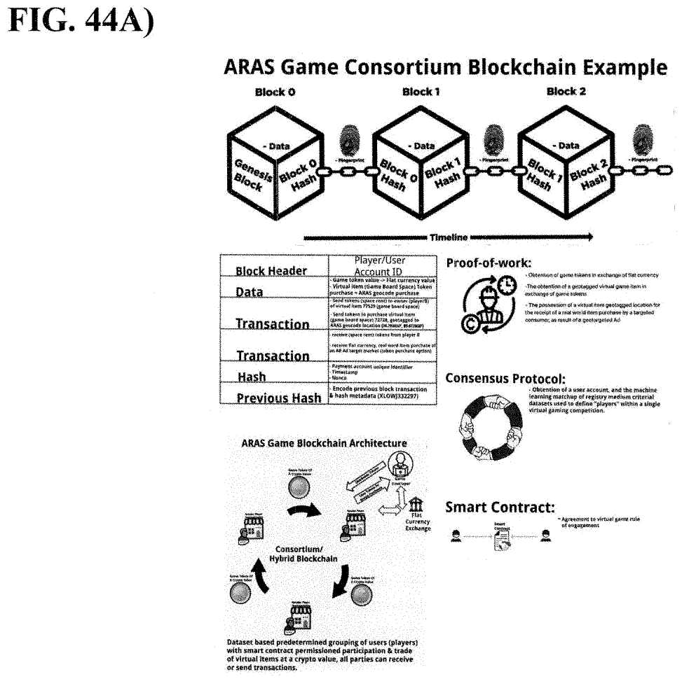

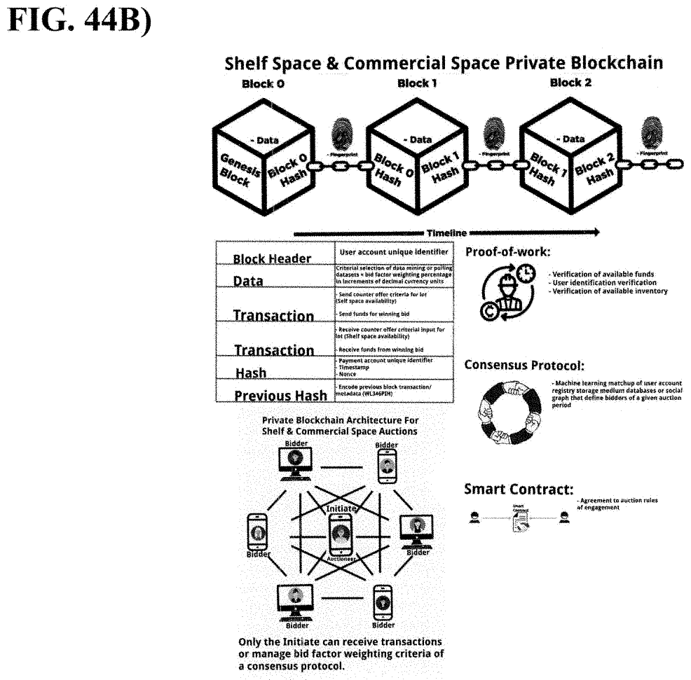

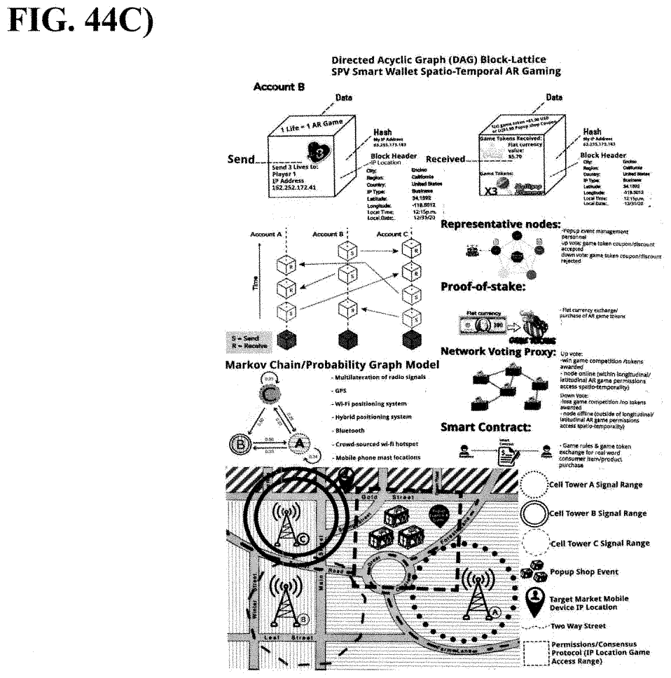

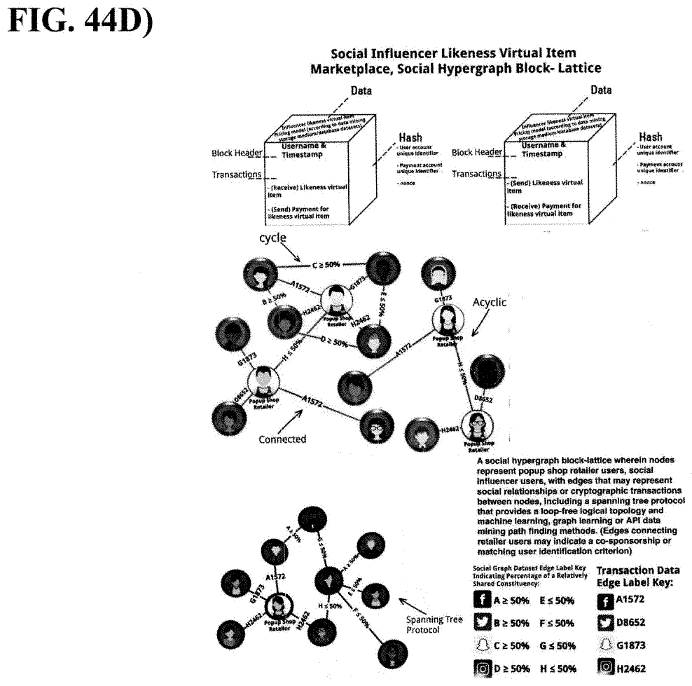

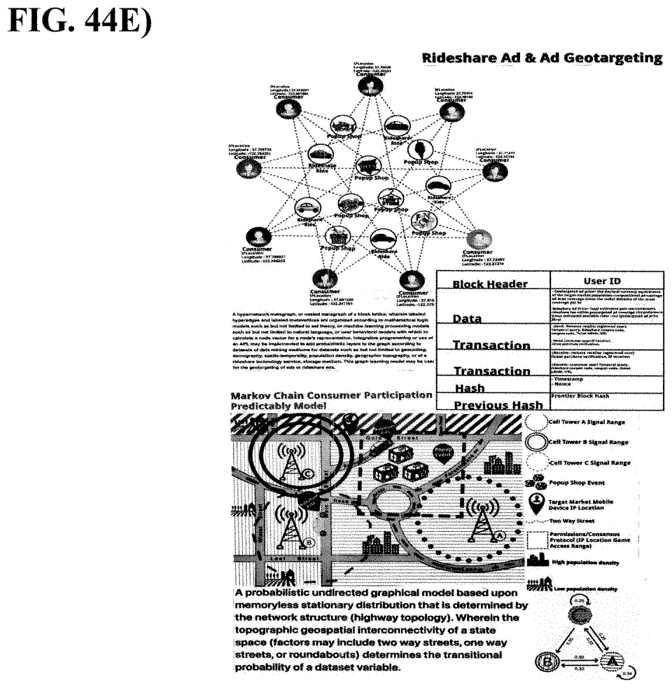

Wireframe FIG. 8U depicts method of shopping registered users representing cosponsor candidates, within a retailer's social networking environment, that may be selected to participate as a co-creator or cosponsor in the launching of a project by the inviting user. The social network environment implemented via the use of a graph learning sociogram, social graph computing, or via an API, wherein a master account profile may represent a graph node in a plurality of nodes that represent the digital identity of a respective user, including connective edges that represent correlative criterion or dataset concepts associated with the characteristics of one or more, other user identity nodes that are thereby grouped together to generate a virtual social environment of communication pathways and joint interactions, similar to the example illustration of FIG. 44. Wireframe FIG. 8U further illustrates a swipe viewer of interactive cosponsor candidate profile pages that provide hyperlinks to various websites such as but not limited to, social media pages and merchant websites, accompanied with correlative data information and an interactive GIS data visualization map with overlapping, contrasting indicatory areal data overlays or data layers providing a visual display of data correlations that indicate a shared target market within the respective location, between a cosponsor candidate and the user. Candidate options may be optimized according to the degree of data correlations indicating a shared target market. The wireframe further illustrates a list of prospective cosponsor invitees and preferred candidate options. Wireframe FIG. 8V illustrates a confirmation message that indicates that cosponsor invitations have been sent to the list of preferred candidates, along with an adjustable clock that notifies the recipient of a response deadline. If the inviting user has made an offer on a real property listing, the response deadline may be determined according to an earnest period, in which case the allotted time of the response deadline may not be adjustable.

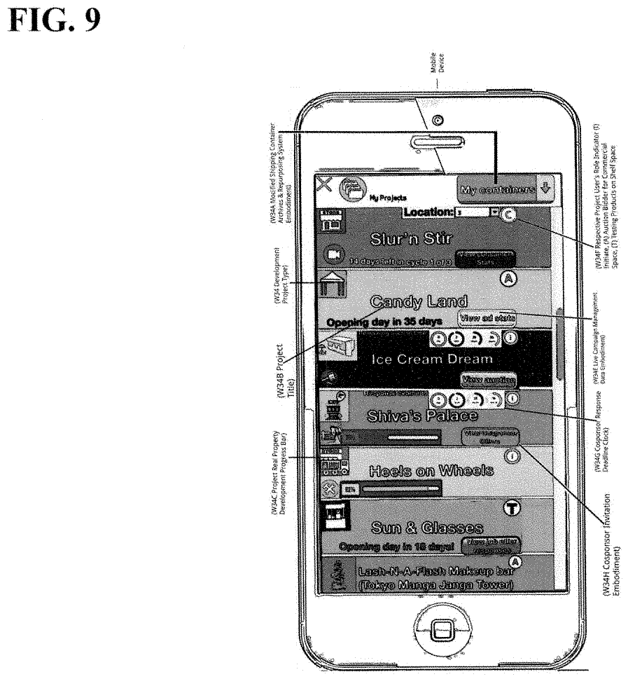

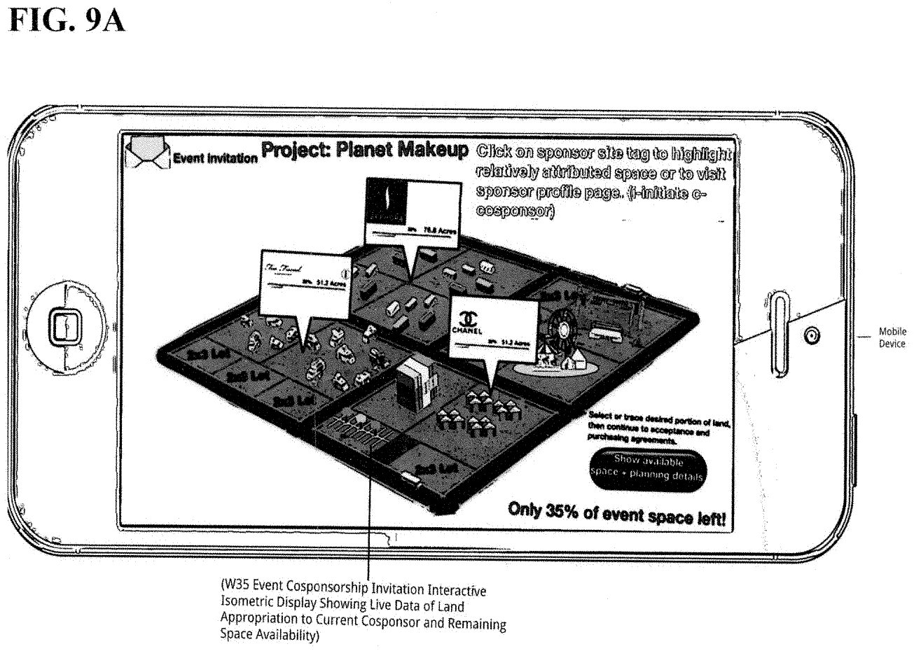

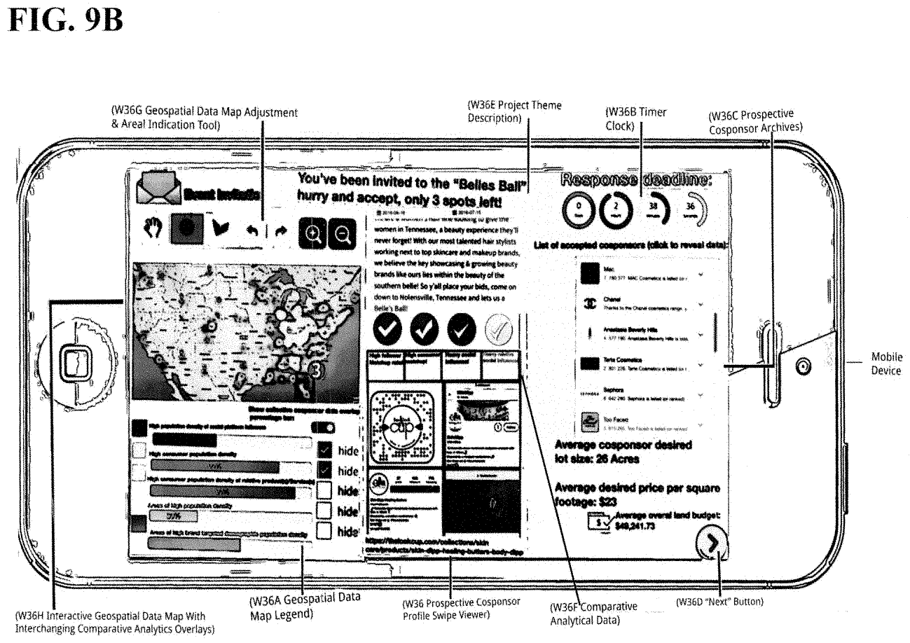

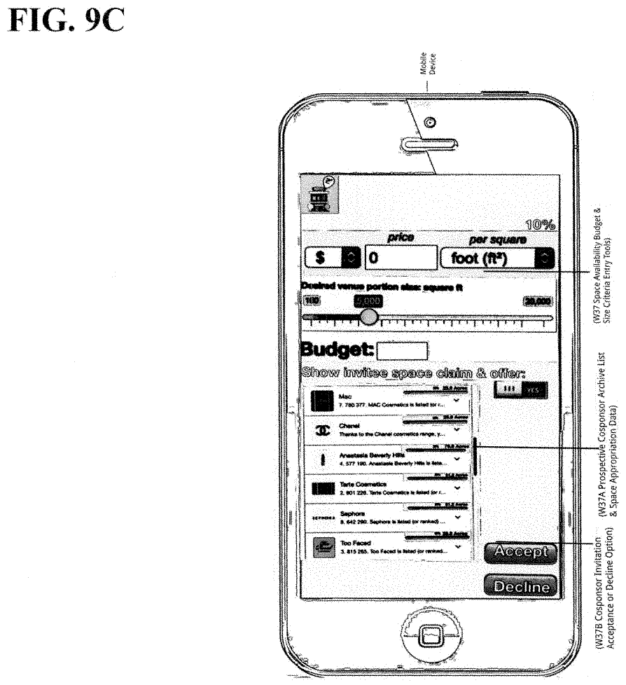

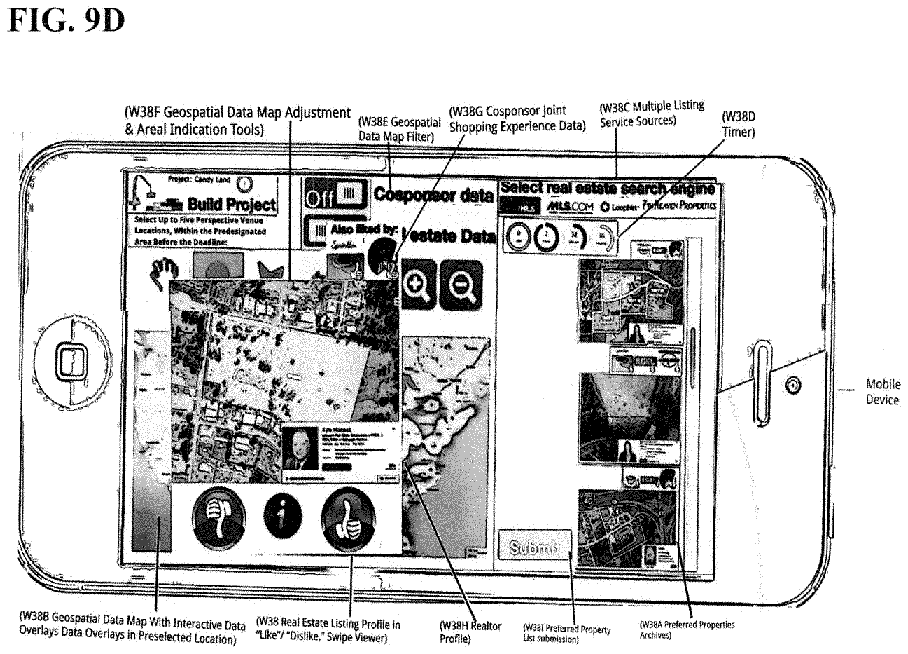

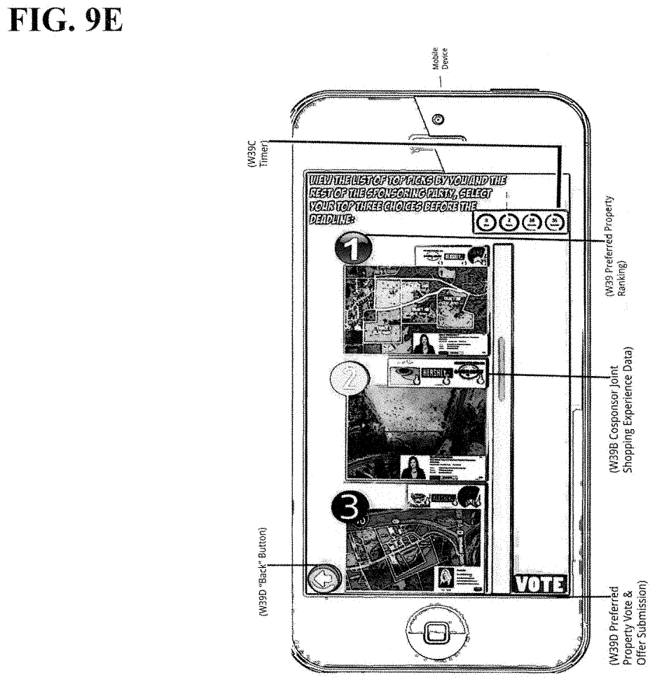

Wireframe FIG. 9 depicts the “my projects” embodiment where the user has access to embodiment shortcut tabs such as but not limited to, archived shipping container units from which the user can sell or rent out modified or prefabricated construction units via a repurposing recommendation system or marketplace environment, various project embodiment shortcut tabs from which the user can access and manage one or more ongoing projects or view the archived data and statics of past projects, the user can also manage live shelf or commercial space auctions, manage payroll systems, as well as open and view cosponsor invitations.

Wireframe FIG. 9A illustrates an opened cosponsor invitation in which the user is presented with an interactive isometric display of a prospective event venue space with virtual land improvements that may further represent allocated land usage. The further illustrates virtual land sectors labeled by interactive tabs that indicate a subsector of land allocated for the proprietary use by a prospective member or cosponsor of a sponsoring party that has accepted the invitation to participate in the prospective event as a cosponsor, as well as the display of data that notifies the invitee of how much space is still available. FIG. 9B illustrates the next interactive screen display within the cosponsor invitation embodiment, in which the invitee may select from a list of other invitees that have accepted the invitation, to display the prospective cosponsoring party's profile page with links to various websites such as but not limited to, social media websites, and merchant websites, along with a visual display of data correlations between the target audience profiles of two or more users indicated on the list. List items may be indicated as the user scrolls through profiles of the swipe viewer, or the user may indicate list items as a method of organizing the order of, or quantifying the number of, profile pages to appear in the profile swipe viewer and, thereby in part filtering the display of correlating dataset overlays or data layers that indicate a shared target market. Wireframe FIG. 9C illustrates a screen within the cosponsor invitation embodiment where the respective invitee is presented with a scrolling list of invitation accepters that is displayed along with their respective subsector allotment sizes, also displayed is a budget indication tool with which the invitee may manually indicate an apportionment offer amount guided by the percentage of the prospective venue space projected to be allotted to the invitee, according to the estimated cost per square foot within the selected general geographic location, or the estimated spatial area sizing according to entered budget criterial inputs. If no specified location has been preselected by the initiate, these criterial inputs may aid in the optimization of MLS listings within a cosponsor group or joint-user real estate search or shopping experience.

Wireframe FIG. 9D depicts a multi-user group real estate shopping environment and procurement experience wherein the sponsoring parties of a prospective event, shop aggregated real estate listings that may be provided via an interoperating MLS or via an API with various interoperating MLS platform websites, websites or databases. This system may generate a memory of geographic locations that have been previously procured by one or more master account holders, for the location of a popup event venue, in the optimization of MLS listings. The figure illustrates an interactive GIS data visualization map that may show data such as but not limited to relative population densities, or gravity based geospatial data, to indicate areal factors such as but not limited to, urban locations or locations with a relatively high population density, or in spatiotemporal activities, which may further aid members of sponsoring parties in prospective venue selection. Along with a listing's profile and the listing agent's contact information, the user is also able to see which of the cosponsoring members have “liked” or have indicated interests in a real property listing. As the user “likes” property listings, the preferred properties are archived in a “liked properties” list of preferred listings. FIG. 9E depicts a polling infrastructure for conducting a group vote on selected properties by arranging a list of preferred properties in ranking order, within an allotted time. Once the allotted time has expired, the most favorable property listing is elected to be the prospective venue. The members of the cosponsoring party may then be presented with an agreement, or a joint-proprietorship smart contract, or a temporary use joint-proprietorship for example, one which would require an electronic signature, stating that the receiving party will agree to pay the ensuing cost of a joint tenancy for an agreed upon period of time in regard to the preferred real property listing location, or until the cosponsor can be replaced, before which any member of the party that wishes to withdraw from further participation will incur a withdrawal fee in the amount of earnest moneys or tenancy fees proportional to their initially agreed upon financial contribution. Once all parties have agreed to proceed, the system may open an automated communications channel between the sponsoring party's representatives and the respective listing agent or listing agent representative, through which the facilitation of a system verifiable real estate transaction is completed, after which the project building processes may proceed.

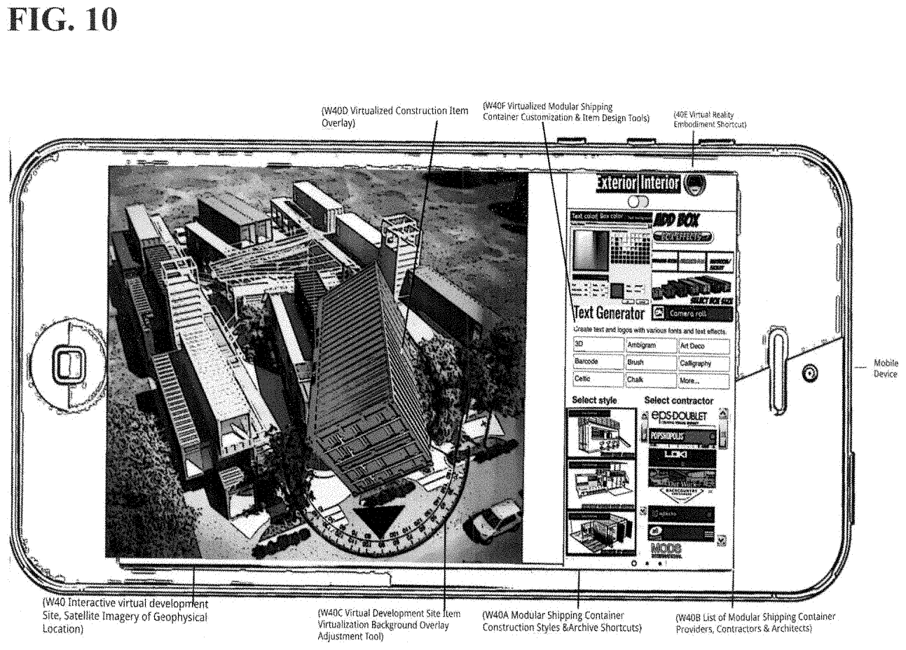

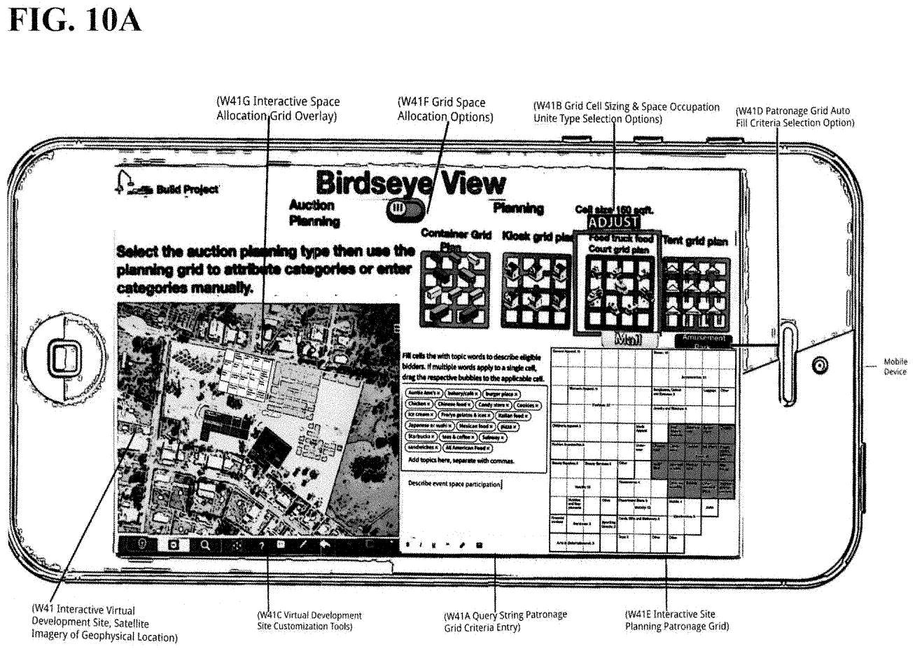

Wireframe FIG. 10 depicts a method of virtual land development design of a virtual design environment or of an immersive virtual design environment, accessed via the “My projects” or “build project” embodiments, wherein user modified CAD software technology is implemented to apply scaled volumetric design models of shipping container construction units as foreground objects that are placed to an interactive digital background generated from the satellite imagery and satellite terrain mapping of a prospective event venue's geographic location. The use of technologies such as but not limited to, remote sensing, pattern recognition, and terrain mapping for the identification of geometric parameters of real-world objects are implemented, aiding in the panoramic, interactive virtual rendition of a geographic location as the background or virtual land development environment or setting, onto which scaled virtualized objects such as appurtenances, fixtures, construction units, property improvement items, novelty items, etc. arc placed as foreground items. The panoramic interactive screen display, features a scrollable control panel that provides design recommendations from which the user may select virtualized improvement items or apply constructional design elements to an improvement of the virtual development site, further providing option selection items that include various shipping container sizes, the selection of which generating selection items of a scrolling list of prefabricated or modular construction styles which may serve as criterial inputs for searching relative vendors, manufactures, providers, contractors, architects, servicers or suppliers that are provided as selectable options within a scrolling list of the control panel. The selection of a modified or modular shipping container construction style may further generate selection options from the user's unit archives as part of a unit repurposing recommendation system. The interactive virtual land development environment further comprises a virtual agent defined as such by a linguistic placement constraint algorithmic programming language, whereby placement preferences determining candidate placement surfaces of a virtualized improvement item foreground object selection of an online product repository of a provider or vendor, that is cutout and scaled according to dimensional criterion or metadata, and is placed onto the virtual background or setting thereby populates an itemized archive list of real-world purchasing items upon the foreground object's placement. The virtual development methods used may also be experienced by the user in a virtual reality experience that may be customized according to the user's height criterion generating either line-of-sight hyperedges of an octree-data spatial indexing structure whereby shadow depth and object rotation calculations are translate to pixel depths or thresholding, or generating Euclidean distance calculations, or eigenfunction hyperstreamline calculations, or Coordinates calculations representing line-of-sight or point-of-view within a binary multidimensional attribute (BMAT) of a 3D symmetric traceless tensor field. Once the user has completed key elements of exterior or interior virtual development, an automated communication channel is established between the user and the relatively selected contractors, manufacturers, vendors, architects, contractors, servicers, or suppliers, that are commissioned in the real-world development of the project. The recipients or hired personnel will receive an interactive translation of the virtual design, that can be also be viewed within an augmented reality or virtual reality experience, for example, because the virtual background used during the virtual development process, is a rendition from satellite imagery and satellite terrain mapping, a hired contractor may use augmented reality eyewear to visualize the finished construction project before its build due to image matching, pattern recognition and scaling algorithms that can align the parameters of applied virtual elements with parameters of real property appurtenances and geographical feature, according to datastores received within a processor. Virtual or augmented reality experiences may be customizable according to the height of the respective hired personnel system user. The alignment of composite image parameters and real-world object parameters may further generate a real-time feedback channel denoting task completion as part of a temporal querying method. The user-friendly CAD system used to develop the virtual site with comprehensive architectural schematics of an abstract construction design in the concretization of development project concept that are applied with modified tools programmed for the user to generate translative criterion that are compatible with construction management software or CAD technologies developed for professional use, may allow for a smoother translation of information or criterion to the professional CAD software that may be used by hired personnel that are relatively assigned to a portion or all of the respective development project.

Wireframe FIG. 10A depicts a method of virtual land development, accessed via the “build project” or “my projects” embodiments. The figure illustrates an interactive screen wherein a scaled satellite image rendition of real property land sects are used as a digital background onto which the user may apply a FAR subsector grid virtual fencing agent by which the user may indicate an area of virtual space for the allocation of categorized auction space, according to a selected popup construction type. The control panel features patronage FAR & popup retail construction unit virtual fencing agent grid cell criteria item options in an interactive grid with retail business categories, and cell subcategories that can be subtracted or added to grid cells using a query string separation method of a criteria entry field that may be used to categorized business types for auction entry or subsector space purchasing eligibility within an interoperating commercial space marketplace system. The user may or may not provide archived popup construction units to space renters, purchasers, or bidders, for a fee that may or may not be included within a starting bid or auction entry cost, or as part of event space procurement costs.

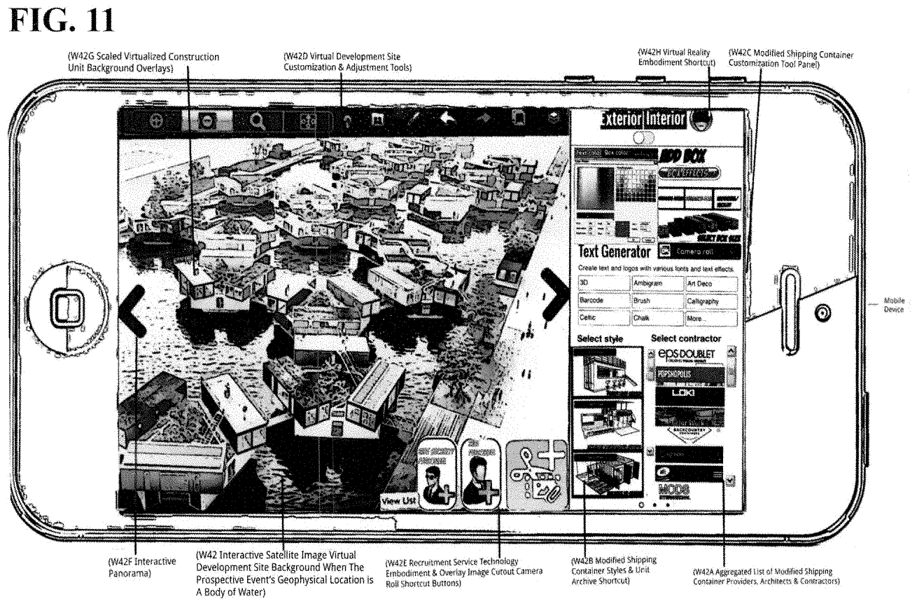

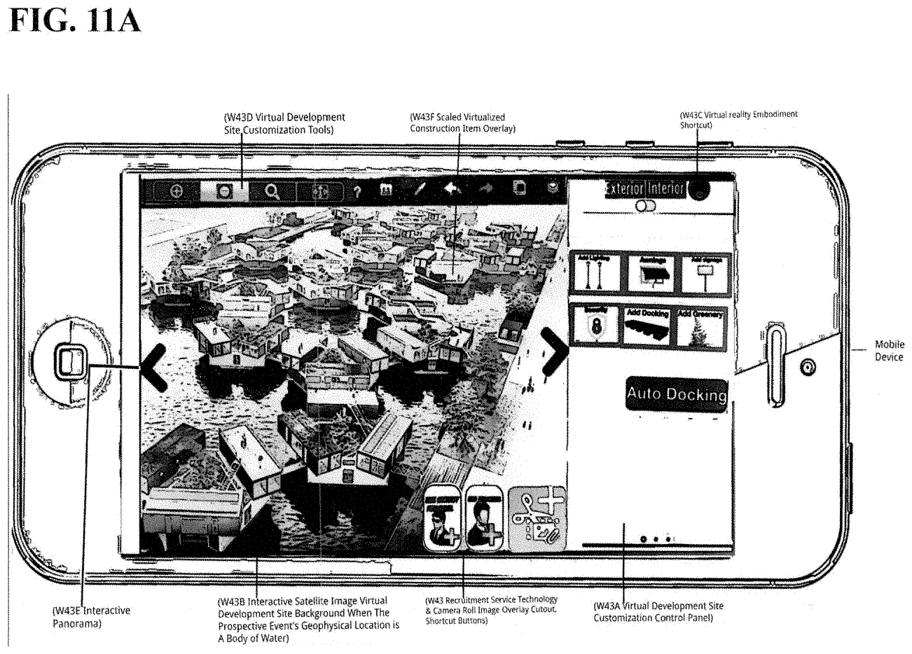

Wireframe FIG. 11 and FIG. 11A depict a method of virtual site development, accessed via the “build project” or “my projects” embodiments, when the development site is a body of water and the selected popup style is “shipping containers.” The control panel is used to apply scaled, virtual modular or prefabricated construction units to the surface of the water, using modified CAD technology that an includes an “auto docking” feature which aids in applying the correct amount of connectivity and buoyancy elements to the development site, according to international or local building codes and algorithmic mathematical formulas.

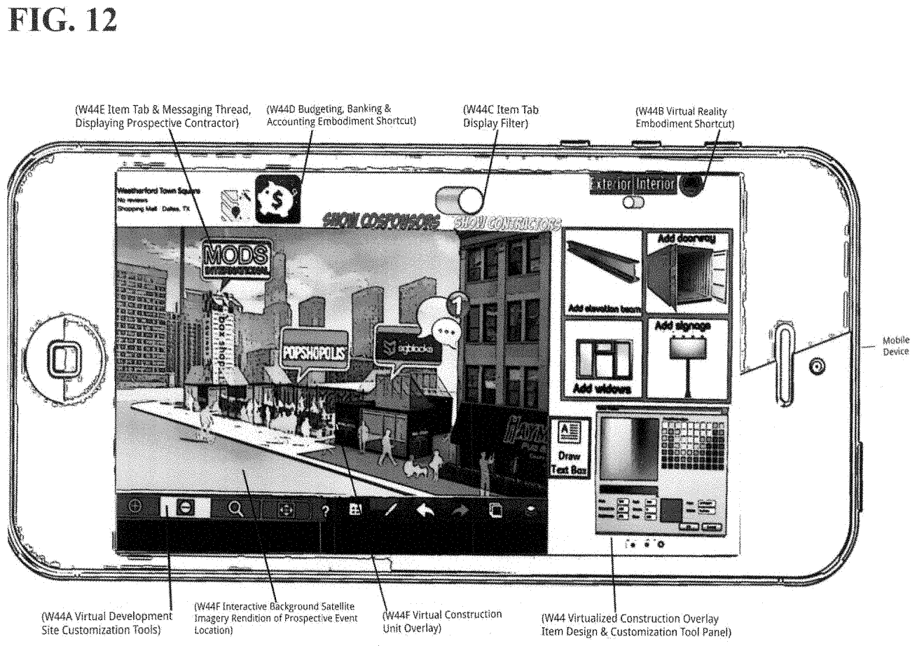

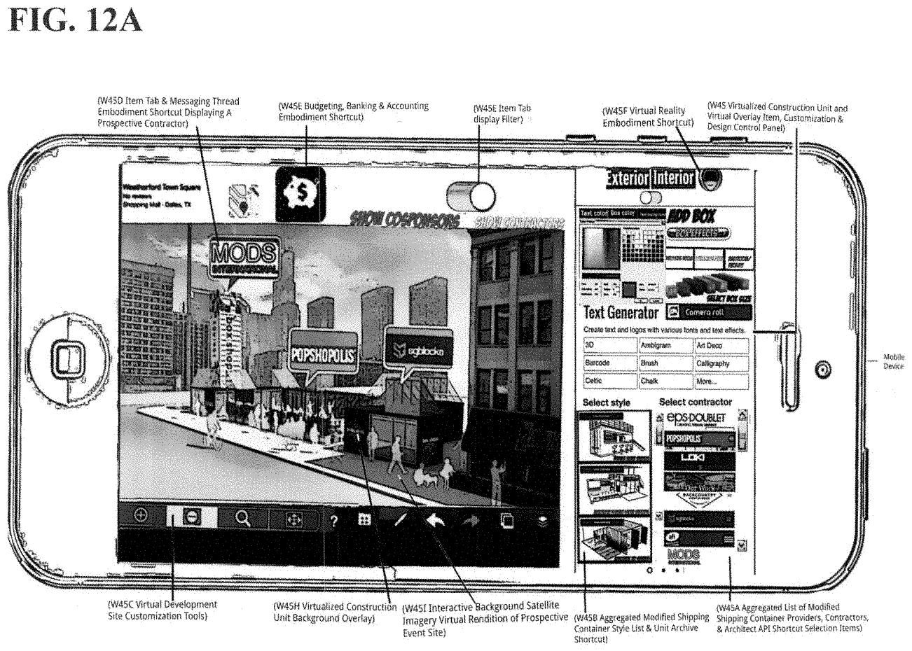

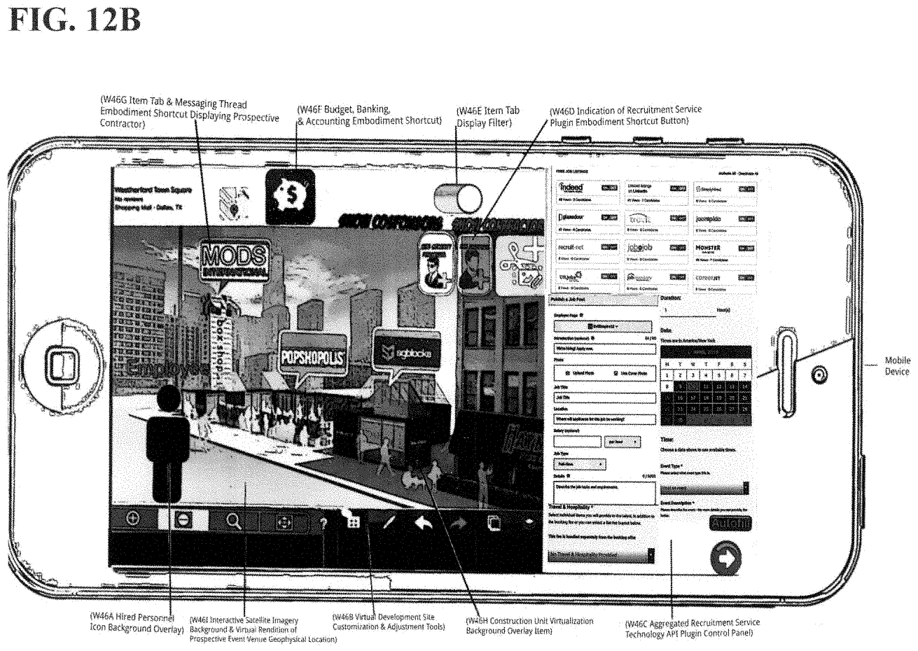

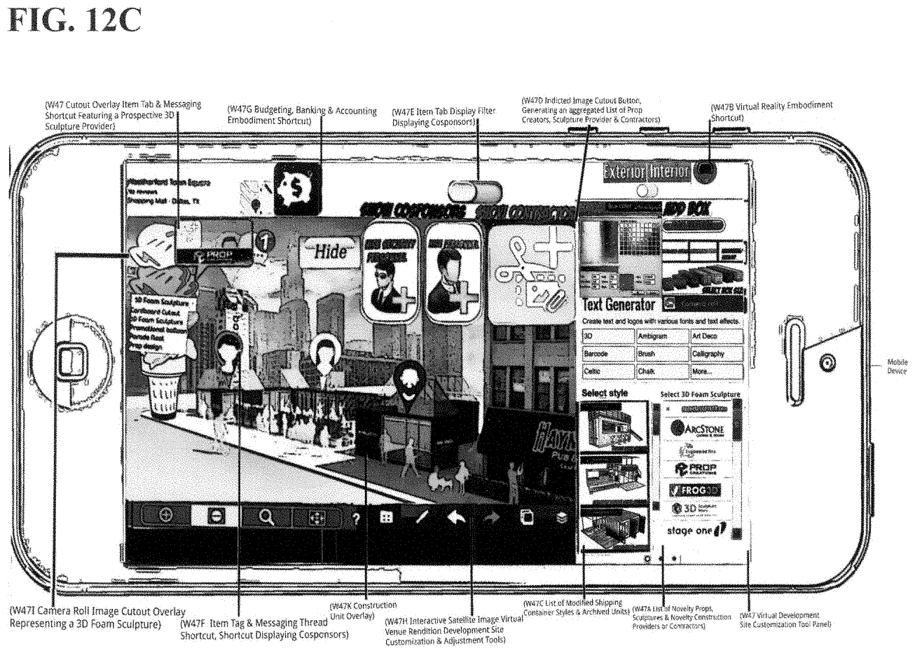

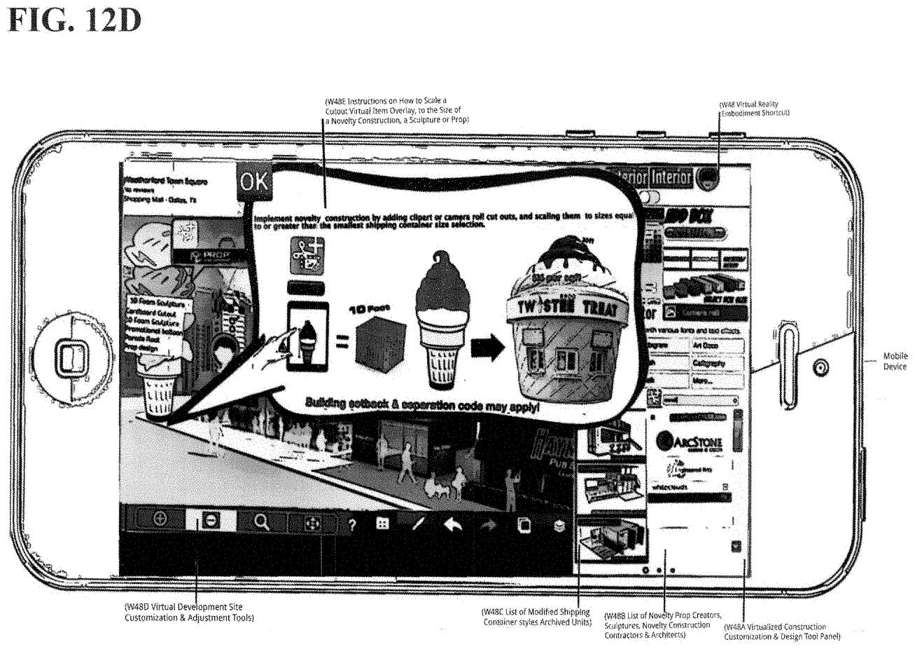

Wireframes FIG. 12 and FIG. 12A illustrate a method of virtual land development that may be accessed via the “my projects” or “build project” embodiment, when shipping containers are the selected popup shop construction style. The user may apply exterior elements like signage, as well as aesthetic elements such as but not limited to, awnings, support beams, or lighting. The virtual development screen display features the scaled prefabricated or modular virtual construction units or site improvements with respective “assignment tabs” that display the company name of the contractor, manufacturer, architect, vendor, or servicer that has been commissioned to provide the respective real property development site with the relative construction units or real property improvements. The assignment tab may also be used as a shortcut to a communication channel, or to an instant messaging thread, between the service provider and the user, the tab may also display a progress bar that indicates the relative portion of the development project's real time progression. The screen also displays a shortcut icon to the user's crypto wallet, or payments environment, and financial analytics embodiment where the user may be allowed to track budgeting and payroll management systems. For example, integrative programming or APIs may provide a communications protocol between various payroll management systems, accounting software systems or banking systems, from which the user could choose to manage budgeting and from which the user could view data from various sources. The user may choose to supplement cost with ARAS profits that may be held in a crypto wallet.

Wireframe FIG. 12B depicts a variation of figures FIG. 12 and FIG. 12A where the user has scrolled to the recruitment service platform API control panel from which to hire event management or security personnel. The control panel features a series of employment marketplace platforms and recruitment service sites, that are indicated via individualized toggle switches with which to indicate websites or website platforms on which the user wishes post a recruitment ad, as a method of generating required criteria entry fields from various sites by which an autofill burst recruitment technique that allows the user to recruit from various websites in a single submission of one or more job ads, maybe actuated. A “hired personnel” persons icon may appear onto the interactive virtual development site, to denote the presence of a prospective hired personnel. After a posting has been reviewed and a resume or application has been returned, a tab with one or more folders, indicating one or more applications, may appear over the hired personnel icon which may be used as a shortcut to a communication channel with the applicant, employee, or to a payroll planning data system.

FIG. 12C is a variation of the figures FIG. 12, FIG. 12A and FIG. 12B, where the user has indicated the image cutout button icon, by which the user applies a virtual site improvement using image cutouts as foreground items from images saved in the device's “camera roll” or archived images, or from vector graphics, or raster graphics such as “clip art” image repositories. Any non-product virtual site improvement shall represent branding or theming novelty items such as but not limited to, props, sculptures, or novelty branding items, 3-D printed items, or prints, for example, 3D-foam sculptures, poster cutouts, novelty construction, novelty item sculptures, or event augmented reality content composite images that are geotagged to a longitudinal or latitudinal location proximal to a relative popup shop location. FIG. 12D illustrates an informational display of instructions for applying an image cutout foreground item according to scaling thresholds provided via the use of programming language describing pixel values of two or more regions outlining segments of a foreground object, by which the object is given relative dimensions which may be resized according to real world item sizing criterion or according to the relative number of pixels of other objects that are present in the image frame. Once the foreground object is applied and scaled to size by the user, as shown in FIG. 12D, a scrollable dropdown list of categorized item description selection options appears over the image cutout foreground item which then renders a list of applicable services, manufacturers, artists, architects, vendors or suppliers, relative to the highlighted or indicated dropdown list selection option. In the example, the user has labeled the cutout image of a large ice cream cone, as a “3D foam sculpture,” and has selected “Prop creations” as the preferred provider after viewing the servicer's website via a hyperlink from the generated list of providers. After the user has filled out of an order submission form, which may or may not be autofilled via API communication protocols, a tab will appear over the virtual image cutout foreground item, acting as a shortcut to a communication channel between the user and service provider and may also show a task progression bar indicating real time progress.

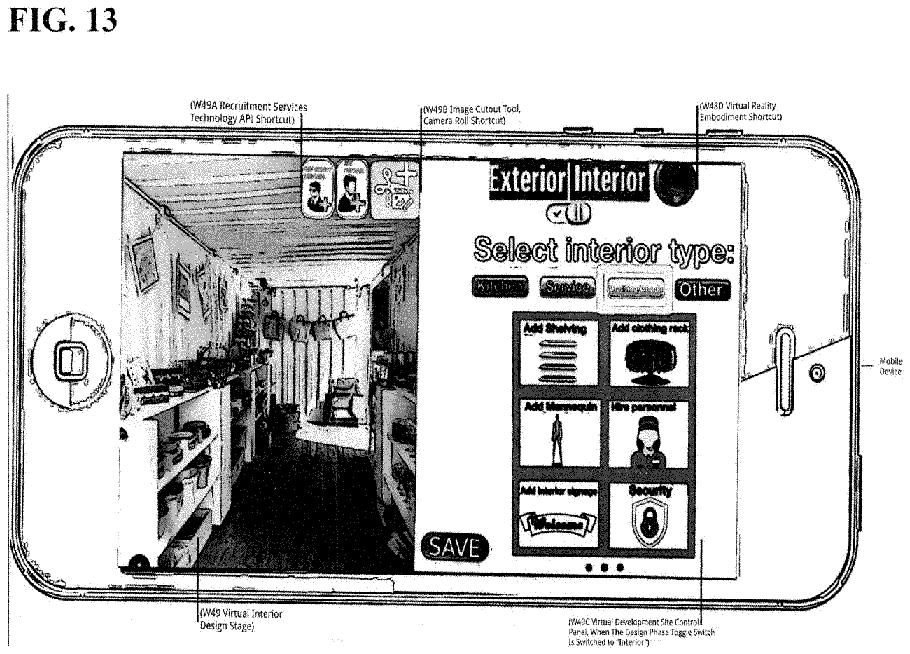

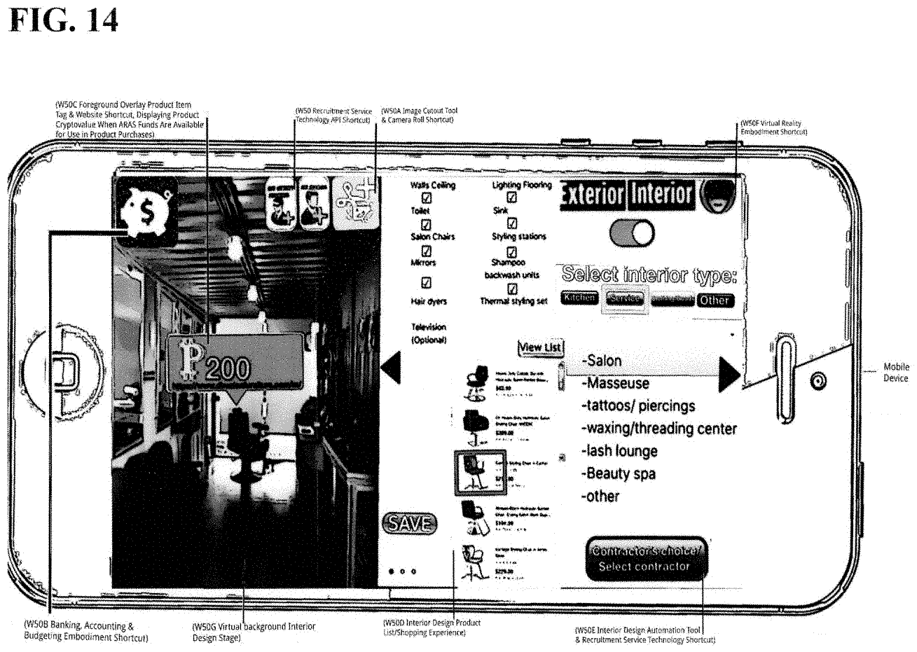

Wireframe FIG. 13 illustrates a portion of the “build project” embodiment, wherein the user has selected “shipping containers” as the popup shop style and has entered the virtual interior design stage of a virtual design environment. The user is presented with various interior design categories and subcategories, such as “kitchen,” “clothing/retail store,” “service shop” or “other,” the selection of which helping to generate an optimized list of furnishing items of an online product repository or interior design elements. FIG. 13 illustrates a control panel page from which the user has selected “clothing/retail store” and is presented with the option of adding hired personnel such as but not limited to, cashiers, customer service representatives, promotional models, or retail management personnel, as well as the option of applying items such as but not limited to mannequins, security equipment, print media, clothing racks, shelving items, furnishing items, or fixtures. As previously mentioned, the interior design categories selected by the user, may aid in the generation of a scrollable list of selectable interior design product items, fixtures, or furniture. For example, in FIG. 14 the user has selected the “service shop” interior design category, and has selected “salon” as the subcategory, allowing for the generation of relative furnishing product items such as “salon chairs.” Once an item is selected, a cutout image of the product item will appear on the virtual staging site, scaled according to the selected product item's dimensions. The user may choose to purchase items using profits of an ARAS campaign or using a percentage of profits or revenues of other popup events. The user is also given the option to engage the virtual design stage as a virtual reality experience which may be customized and scaled according to the user's height.

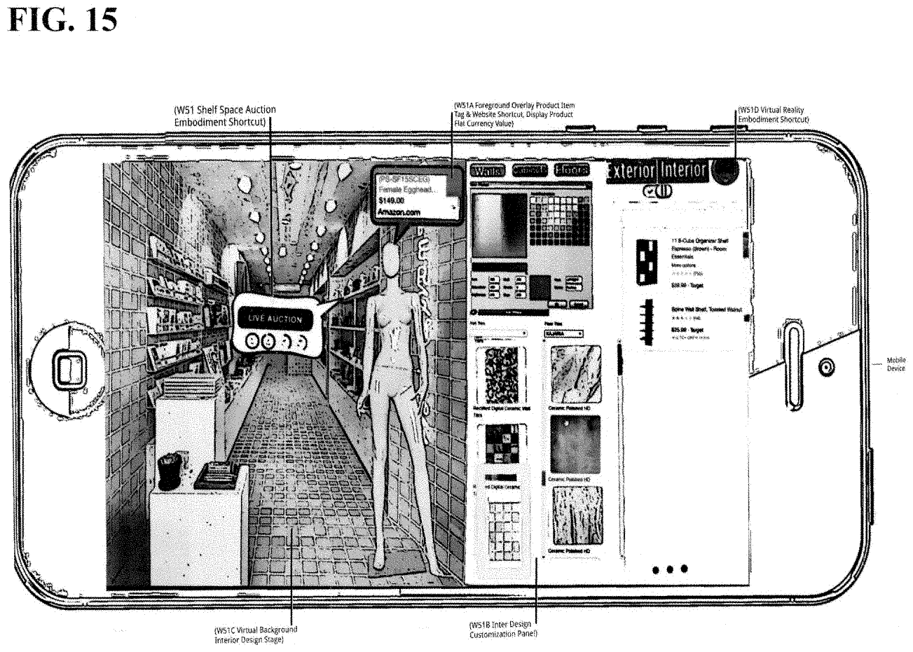

FIG. 15 further depicts an interior design recommendation system, including a control panel wherein the selection of a scaled, virtualized object may actuate a virtual agent of a linguistic placement constraint algorithm that determines one or more candidate placement surfaces of placement of the target object. FIG. 15 further depicts the interior design stage of the “build project” embodiment, wherein the user has selected a “tiled wall” design element which may or may not result in the generation of a selectable search list of servicers such as but not limited to, interior designers, contractors, or providers, that may service the development site's location. FIG. 15 further illustrates a shelving item with a live shelf space marketplace environment shortcut tab, showing the time left in the respective auction bidding period for the shelf space availability's lot publication. FIG. 15 further depicts a mannequin online product item, with a hyperlink tab featuring the product's pricing and the website from which the product may be procured.

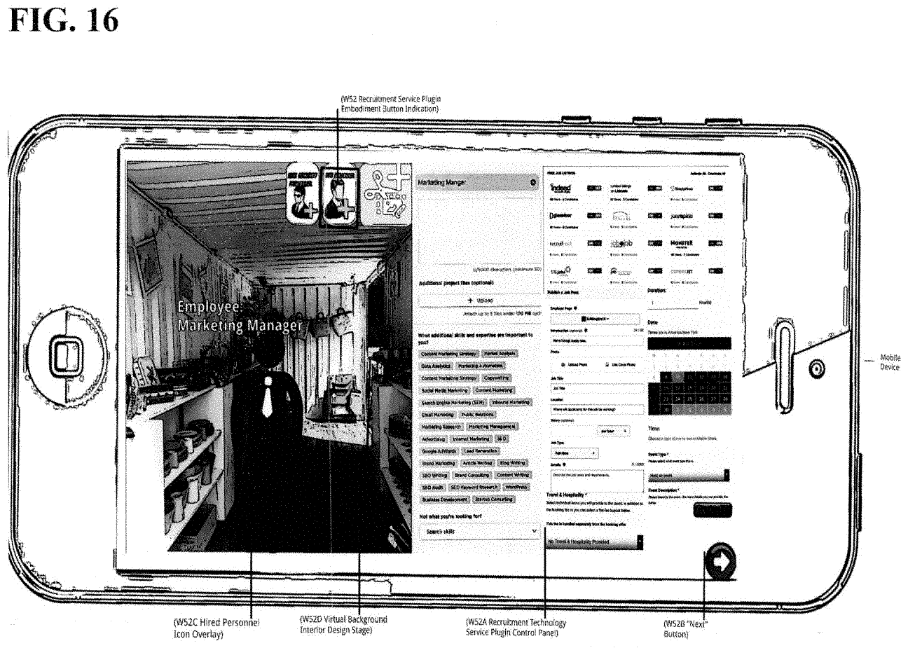

Wireframe FIG. 16 depicts the interior design stage of the “build project” embodiment, wherein the user, utilizes the control panel to actuate the aforementioned burst recruitment technique with extended criterial entry specifications, that may be applied using a query string separation method of a criteria input device. The personnel recruited via use of the burst recruitment system, may experience an unconventional employment process or experience that is atypical for the general job description. For example, if the employer has selected a “commercial tent” as the popup construction style, an employee hired to work as a manager or salesperson at the prospective event, may be required to enter an address to which the tent may be delivered for transportation and later construction, by the hiree, at the prospective event site. Or if the popup construction type is a “shipping container” the employee may be required to enter an address at which a padlock and key may be delivered, for the security of the unit. Another example may be an unconventional way of clocking work hours via the activation of a locations tracking device that may notify the employer of when the authorized personnel arrives at, and departs from, the event site as part of a temporal or spatiotemporal querying method. A prospective employee may also be required to scan enter a biotech device or a serosurveillance or sentinel surveillance identification code, which may or may not be coupled with a SPV system, a crypto wallet or payment environment.

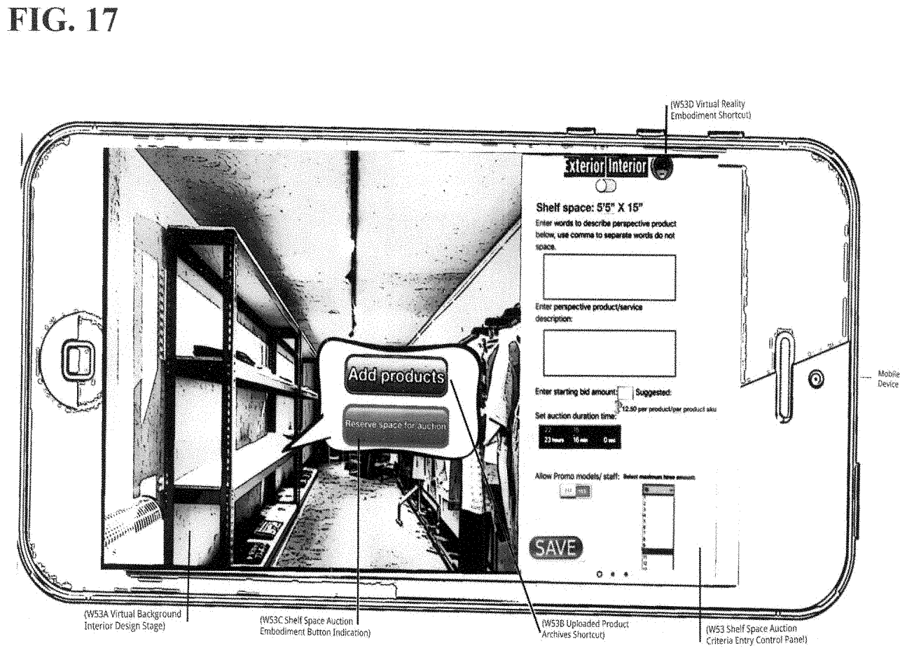

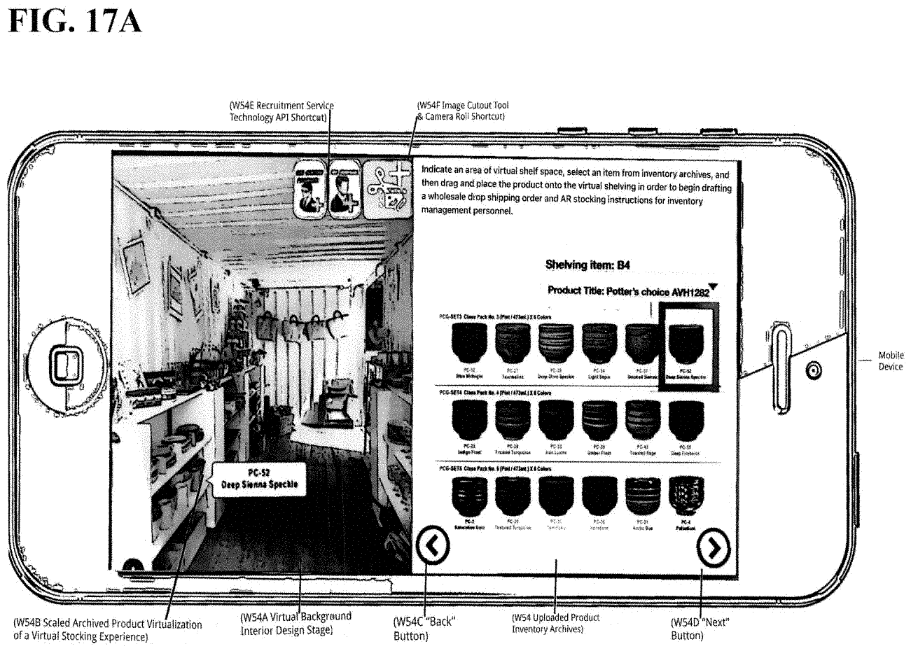

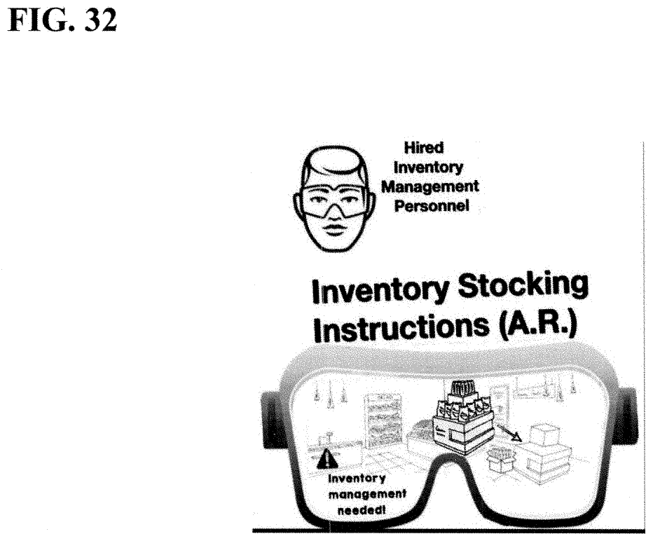

Wireframe FIG. 17A illustrates an example of virtual shelf stocking using digital renditions or image cutouts from uploaded product archives of a product inventory repository associated with a respective business registration. The figure depicts the virtual placement of a scaled product item image cutout foreground item onto a virtual shelving item or fixture, as a method of generating a wholesale product order or drop shipment to be delivered to the event site for the subsequent stocking or inventorial staging. The placement of product foreground objects may further comprise a method of generating spatial indexing structure datastores for receiving within a processor a composite view of augmented reality or virtual reality instructions or guidance for product placement or stocking by hired retail or inventory management personnel, illustrated in FIG. 32, wherein the alignment of virtual object parameters with real world object parameters denote task completion within a real-time feedback channel.

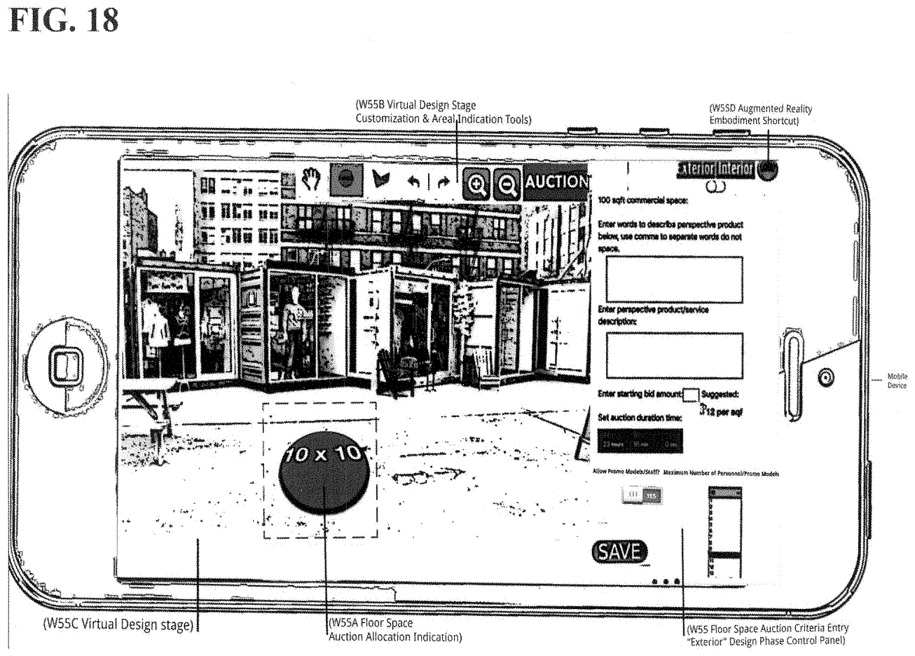

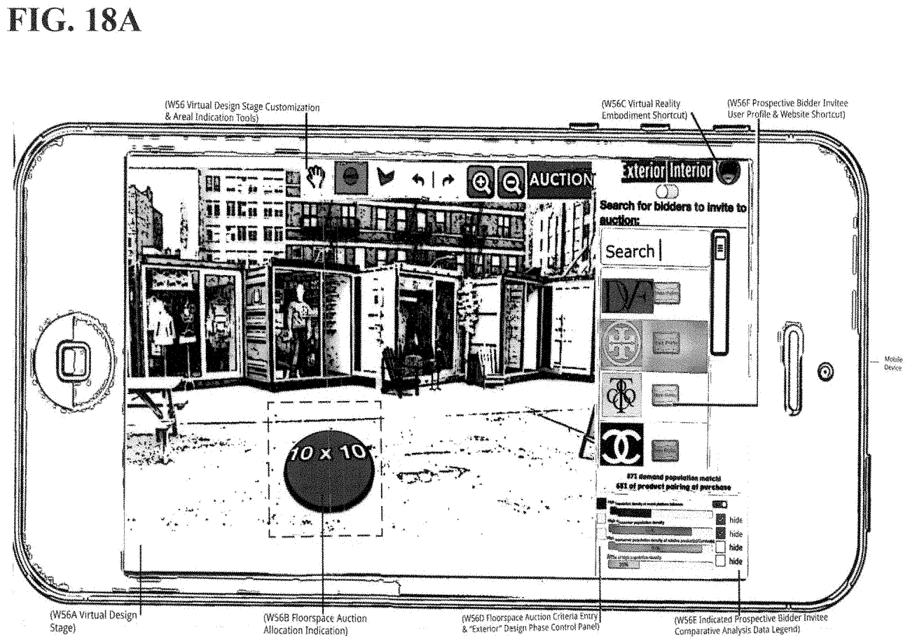

Wireframes frames FIG. 17 and FIG. 18 illustrate an example of how a shelf space and commercial space trade publications are initiated. FIG. 17 depicts a scaled virtual rendition of a shelving product or fixture, of which the user has allotted as shelving space for procurement by retailers, representing master account holders, engaged in a shelf space marketplace environment, for the commercialized participation at the prospective event. The user may categorize the products to be placed on the shelf space allocation, via the input of shelf space procurement requirements or auction entry criteria, which may be guided by data extractions such as but not limited to, consumer behaviors and purchasing patterns, which may help to indicate a high, moderate, or low, purchase paring rates, between prospective shelf mate products, according to the criteria items used to detail and categorize shelf space product candidates via a query string separation method of an input device used in the subcategorization of the apportioned shelf space publication, for the prospective shelving of relative products by a procurer of the shelf space availability. Wireframe FIG. 18 depicts an interactive virtual development site, on which the user as utilized a virtual fencing agent to indicate a 10×10 square foot areal indication, that is thereby made available for purchase via the subsequent publication of a commercial space availability within a commercial space marketplace environment, using similar criteria data entry methods that are used in the posting of space availability publications within the aforementioned shelf space marketplace environment. FIG. 18A depicts a method of searching and inviting businesses represented by a master account user profile to a commercial space auction, aided by a data visualization of a comparative analysis or data correlations between the user's and the candidate invitee's target market profile data, indicating a shared target market.

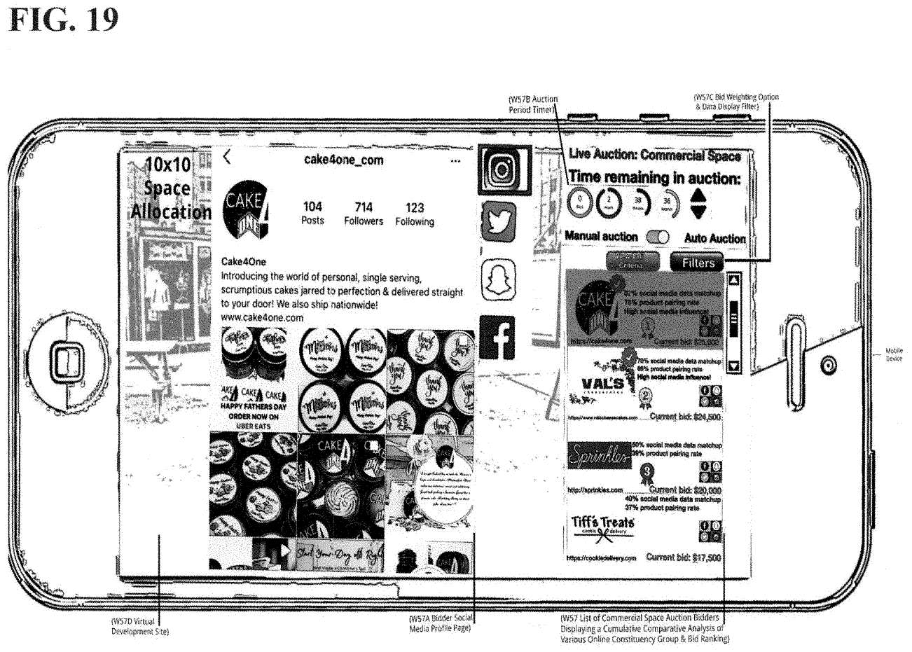

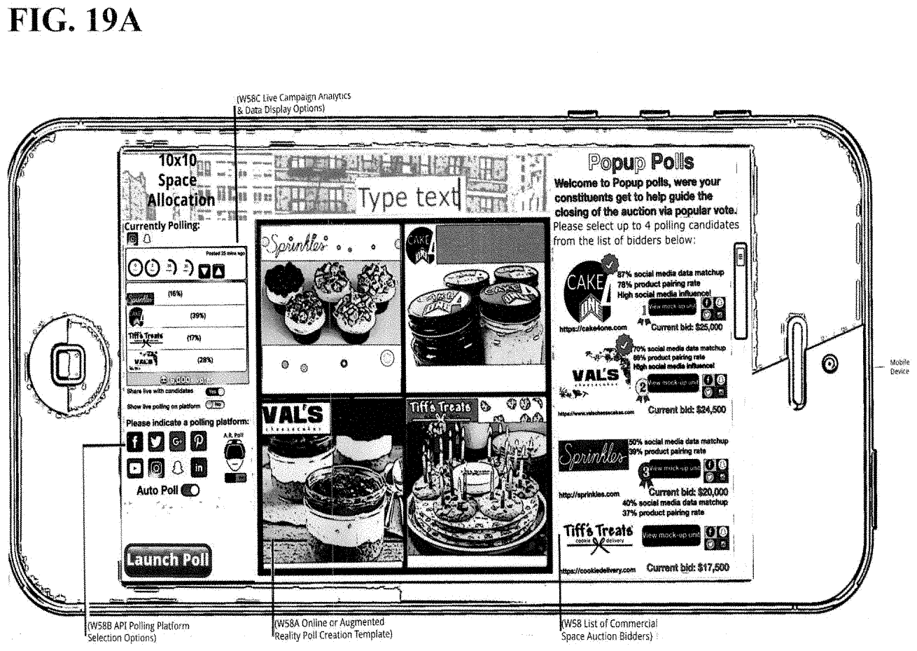

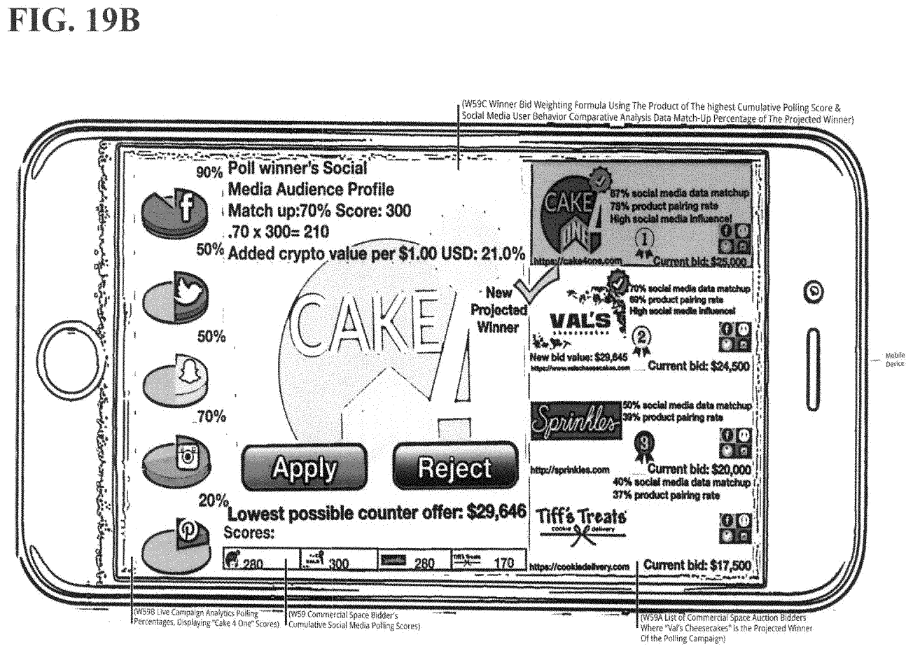

Wireframe FIG. 19, depicts an example of a what a live auction would look like to the commercial space seller or auction host user, wherein the interactive screen features an adjustable auction period clock, and a selectable list of bidders ranked in order from the highest to lowest bidder. The screen also features individualized, correlative target market datasets relative to each bidder, and displays an interactive bidder profile page with live hyperlinks to the bidder's social media and business webpages. The user (auctioneer) is also given the option to allow the winner of an auction to be decided according to default criteria which may define a winner according to the bidder with the highest flat currency bid value, options may further include a bid factor weighting technique that may involve an artificial inflation of a bid offer amount's flat currency value, in decimal currency increments that are equivalent to a percentage value representing dataset objects. For example, the user may choose dataset categories such as but not limited to, “social media followers,” “consumer profile,” or “target audience profile” dataset objects as variables to be applied within a bid factor weighting model or as algorithmic functions of a bid factor weighting model. Dataset variables of a bid weighting model may be determined according to data engineering methods such as but not limited to, social media polling where the bid amount offered by the bidder with the highest number of poll votes may be increased or weighted by the product of the poll winning bidder's shared target audience percentage number, and the poll winning bidder's polling score total, when the whole number product is divided by 10 and the quotient is expressed as a percentage representing the percentage of a single monetary unit by which a bid is weighted in increments of decimal currency, as shown in FIG. 19B. In the example illustrated in FIG. 19B, the user is given the option to accept the possible outcome after applying bid weight to the poll winning bidder's bid amount wherein $1.00 is valued at $1.21 bringing the poll winner's weighted bid offer amount to a value of $29,645, which may require the bidder with the prepoll highest flat currency bid to submit a counteroffer to the weighted bid amount by at least one dollar before the conclusion of the auction period, if they wish to remain the projected auction winner. The user (auctioneer) may also choose to reject the polling results and accept the prepoll highest flat currency bid offer. FIG. 19A depicts a content creator of a polling infrastructure wherein the top bidders are selected as opinion polling subject matter in poll that may be distributed for the participation of a target market via a social media platform API or, via a selective content dissemination or geotargeting method wherein a target market proximal to a prospective popup shop storefront location may participate in a poll, helping to decide the winner of the commercial space auction. Polling content may be experienced by a geotargeted subject, as an interactive composite display of real-world images via the user of a GPS enabled device or a device pairable device comprising a processor for receiving content or computer-generated perceptual programming.

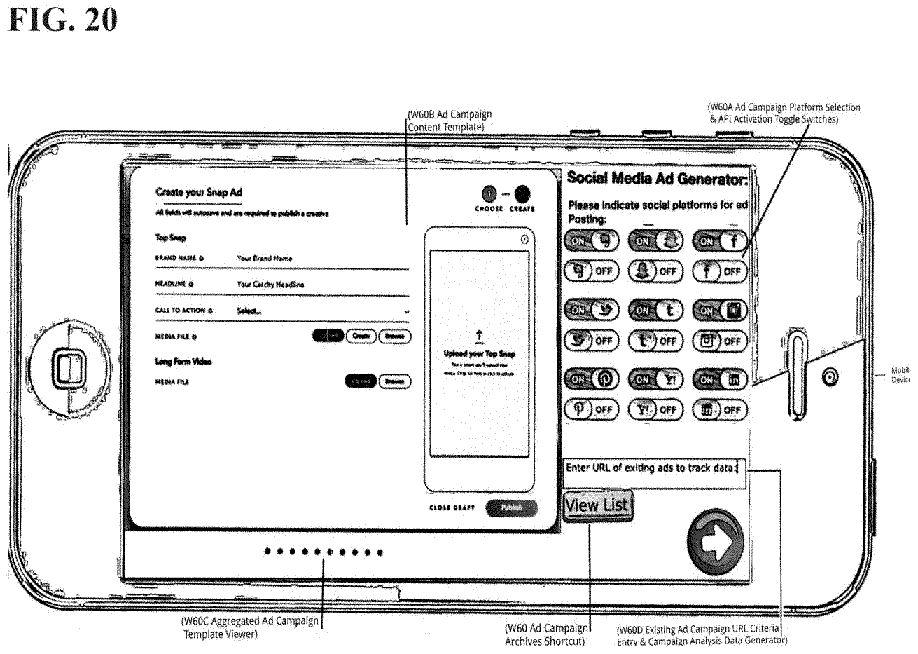

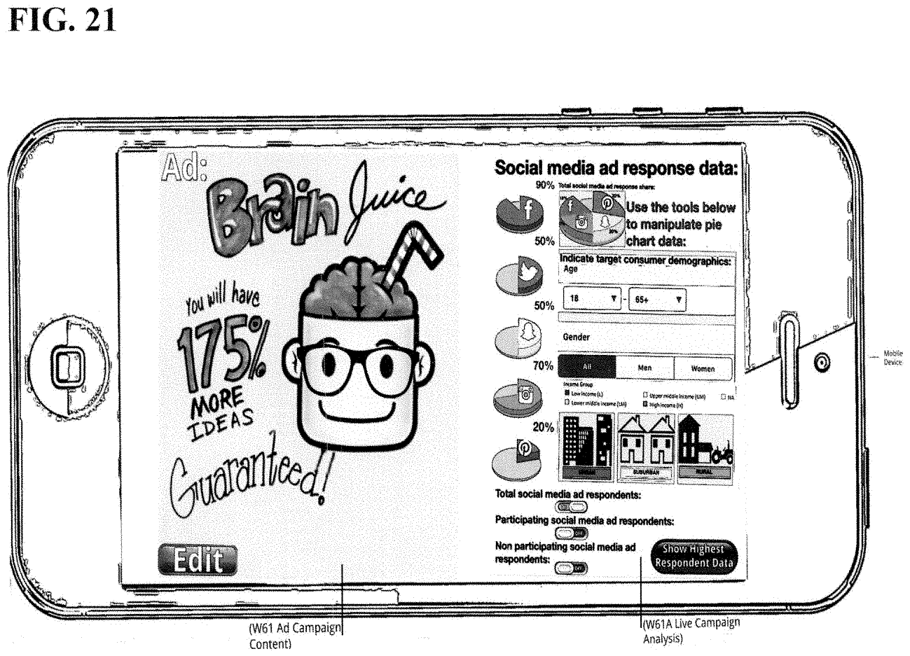

FIG. 20 illustrates a method of advertisement content building and API communication protocol for an advertisement post burst technique wherein the respective website platforms on which the user wishes to run an advertisement campaign, are indicated by individualized toggle switches, thereby generating a content creation template. The example also depicts a method of extracting campaign analytics by entering or pasting an existing ad campaign's URL into a criteria field which may allow for the algorithmic identification and extraction of relative datasets such as but not limited to user statistics, conversation tracking, consumer behavior or user demographics. Wireframe FIG. 21 depicts an example of an interactive ad campaign burst cumulative campaign analytics display, with the ability to edit ad content, along with a scrollable side panel featuring the data analytics.

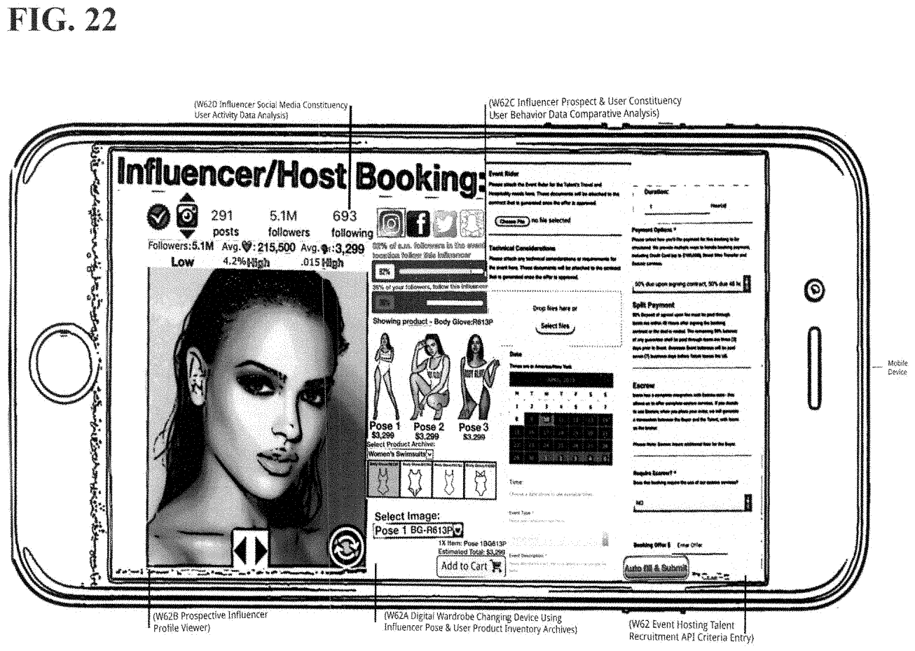

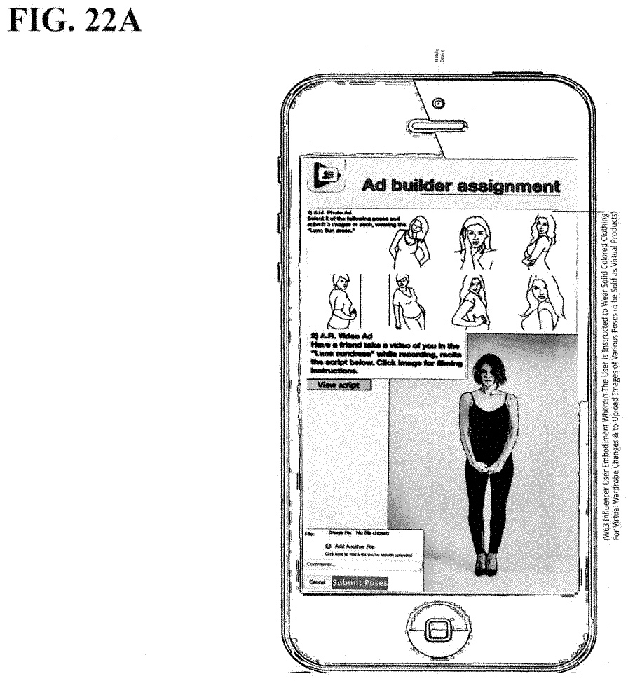

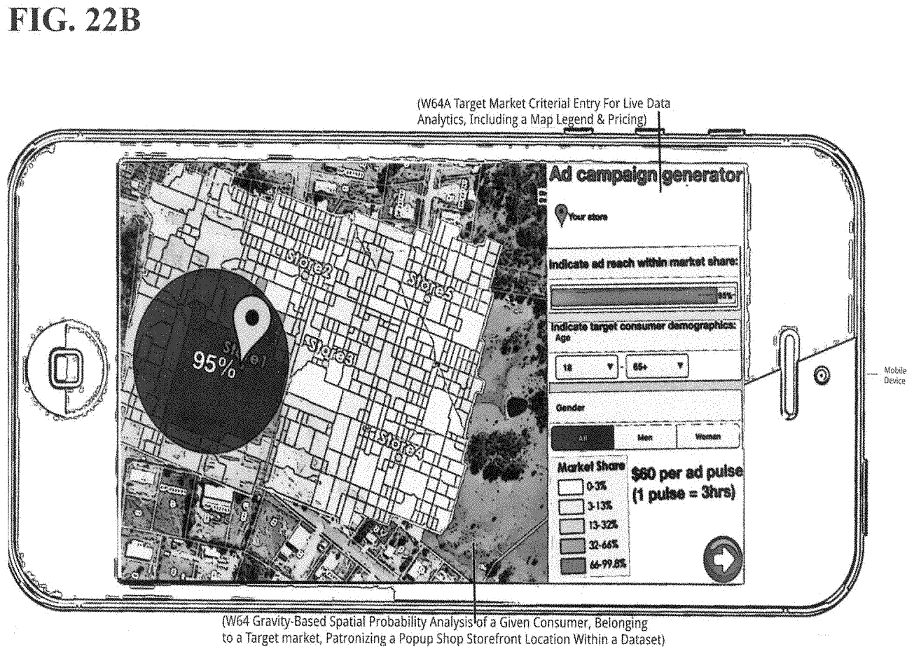

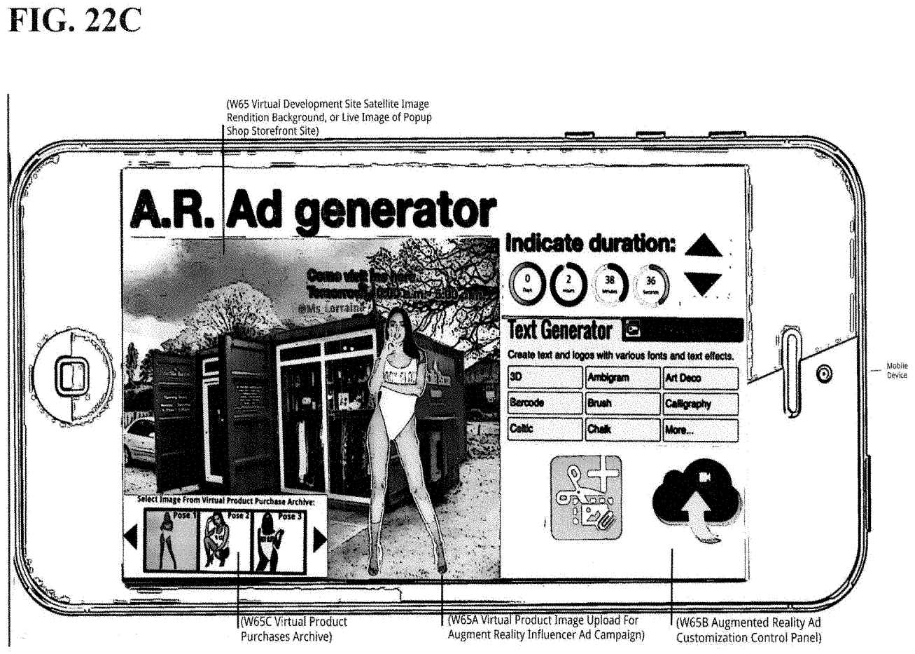

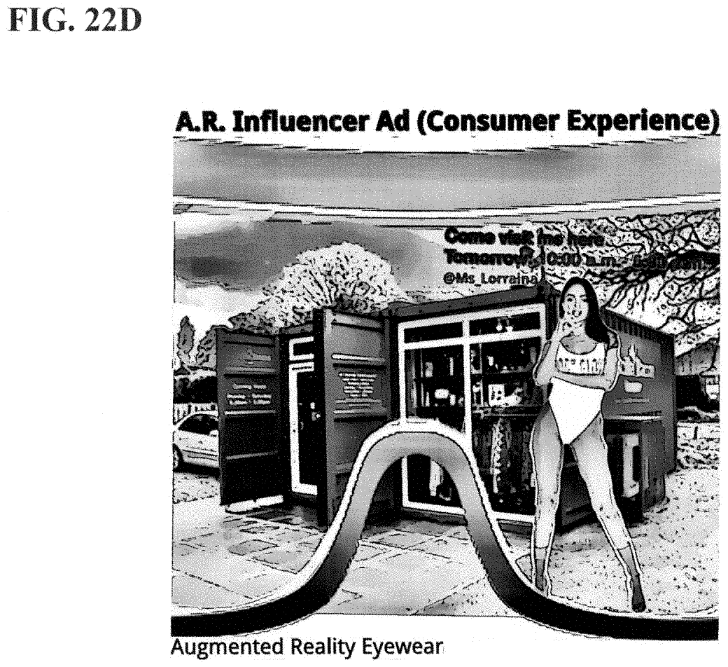

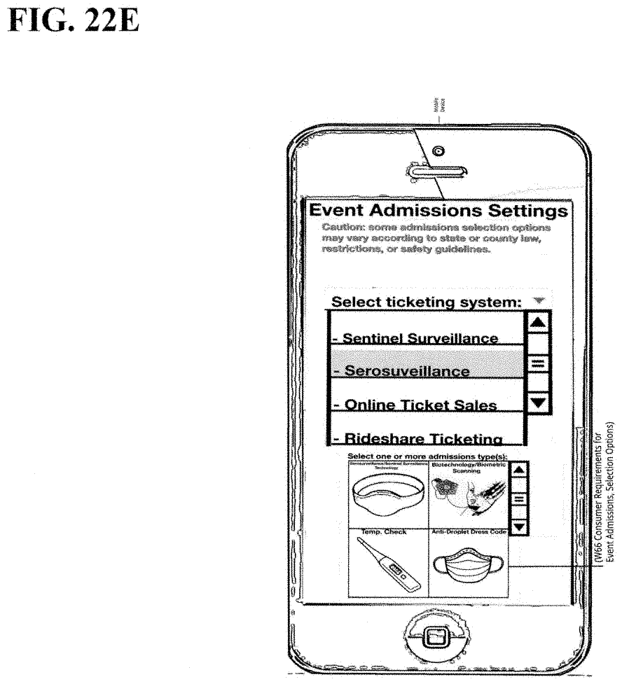

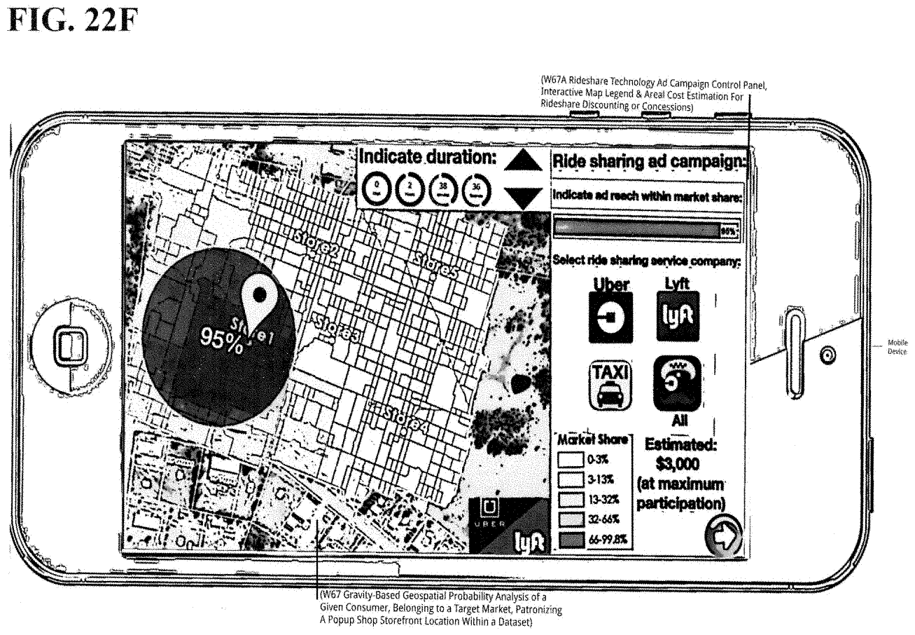

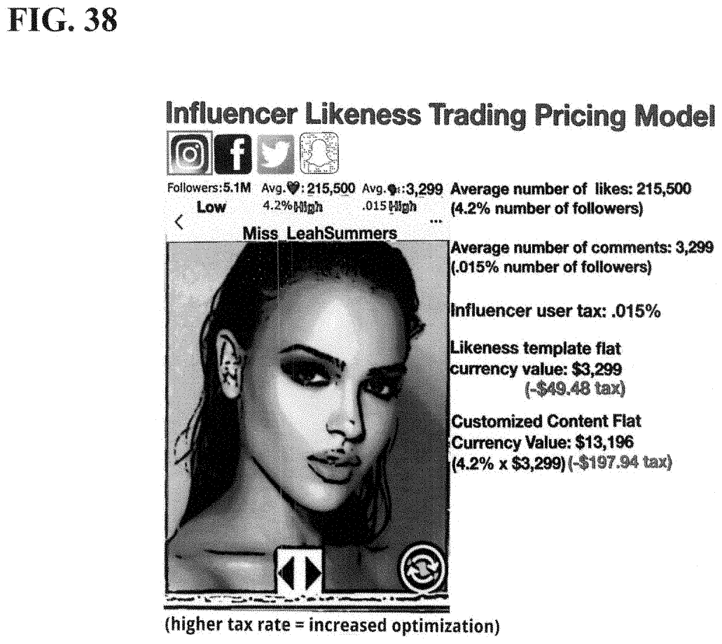

FIG. 38 depicts a dataset valuation method that may be used in the relative valuation of virtual items traded within a, social media influencer or talent likeness virtual item marketplace, wherein social influencer's or relatively talented or influential individuals may sell their likeness as virtual items, for the translational use within the selective content dissemination of augmented reality ad content, mixed-reality ad content, or digital ad content, by purchasers represented by a Master account user profile. Wireframe FIG. 22A illustrates an interoperating, social influencer user interface that may allow a social media account holder to link or add a payment account or a crypto wallet and depicts the instructions for uploading categorized ad content images or videography to be sold as part of a template for the creation of advertisement content, to master account profile holders. For example, a method of uploading ad content may include the instructional use of clothing styles or props such as but not limited to, solid colored clothing that fall within a clothing style category, and that bare no visible branding or labels, the instructed use of a white background or wall in front of which to take photos or film video content, so that clothing style and background can be virtually interchanged or subtracted while customizing or sampling ad content templates. FIG. 22 further depicts the ad content associated with a profile of a candidate social media influencer, in a profile swipe viewer of an influencer likeness marketplace environment, wherein the candidate influencer or talent has uploaded various static images under a specific clothing category from which a clothing style, whereby a clothing style and body positioning or pose may be selected by the prospective purchaser for the translational use within an advertisement template. To sample the content, user selects an uploaded clothing product from their inventorial product repository, to give the influencer a virtual wardrobe change, in a pre-purchase sampling experience that generates a preview of what the influencer would look like in an augmented reality ad that showcases the selected clothing product. The purchaser may or may not be allowed to view sampling in a virtual reality or augmented reality experience, prior to virtual item's purchase. Wireframe FIG. 22 also depicts a dataset display that shows correlations between a user's (master account holder) target audience and the respective social media influencer's follower's or constituency's user behavior or target market, as it pertains to a general geographic location or a predesignated ARAS, which may help guide or influence the purchasing selections made by the user during their shopping experience. Wireframe FIG. 22 further depicts how an augmented reality likeness virtual item marketplace, a talent search system or host recruitment service technologies can be integrated for simultaneous use, when the user wishes to both purchase a talent's likeness for augmented reality display, or selective content dissemination, as well as hire them to host and physically participate at an upcoming or at a current event, using an API with talent search platforms or service websites, or by other means of programmable incorporation providing the same algorithmic function. The image may also depict an interoperation of a talent search or host recruitment platform, not implemented via integrative programming, functioning as a combined system with the likeness virtual item marketplace environment.

Wireframe FIG. 22A may also depict an example of what a customized ad content builder could look like when the user of a master account profile has opted out of purchasing static image content or generic ad content that is used in a template, but wishes for the talent or influencer to create customized ad content, instead, as part of a selectable option that may allow for the opening of a communication channel or of a permissioned instant messaging channel between the respective influencer or talent and the purchaser. The example depicted in FIG. 22A, illustrates selection options of various poses or body positioning and clothing styles, and also includes a script text box for receiving script directives or prompts from the social influencer or talent seeker, that instructs the recipient in the building of customized advertisement content by implementing verbal prompts or scripting within a video recording. This method may include the use of a processor or medium for such but not limited to, videotelephony communication channels, videography, photoshopping tools, real-time video editing, image filtering, or image editing technologies, which may or may not be provided via API or other means of integrative communication protocols with relative technologies. FIG. 22B depicts a selective content dissemination method of marketing content containing a seller's likeness, that uses spatiotemporal stochastic graph learning models, location data, gravity based spatiotemporal data, or data of a statistics module database with which to geotarget advertising and promotional content, reaching consumers in particular localities with appropriate messaging via methods such as but not limited to, SMS messaging, email messaging, social media ads, or computer generated perceptual programming technologies and other such technologies that superimpose a computer-generated image onto a user's view of the real world, thus providing a composite view of geotargeted marketing content. FIG. 22B further depicts an interactive geospatial density map data visualization tool which may aid the user in determining the range or radial distance of an ad proximal to the prospective event's location, allowing adjustments that may incur additional costs in order to run the ad campaign, increased in decimal currency increments. For example, if the user selects an option to further include an outside media viewer platform as part of a geotargeted ad campaign that charges one dollar a day to run an ad, and the respective user's target audience makes up 38% of a proximal population density, the user may be charged one dollar and an additional 38 cents or $1.38 USD per square mile, within the ad reach radius, per day for the duration of a single ad campaign. Or, if the user opts out of selecting an additional outside media viewer platform and instead chooses to run an augmented reality ad campaign, alone, with 38% of the populational market share, the user may be charged 38 cents per square mile, per day to do so. FIG. 22C depicts a virtual item purchased from the talent & influencer likeness marketplace, that has been translated or uploaded onto a shipping container style popup shop project virtual development site. FIG. 22D depicts the experience a patron or shopper within a proximity of an event location, viewing transmitted content as an augmented reality ad, via an augmented reality eyewear device or via a heads-up display device.

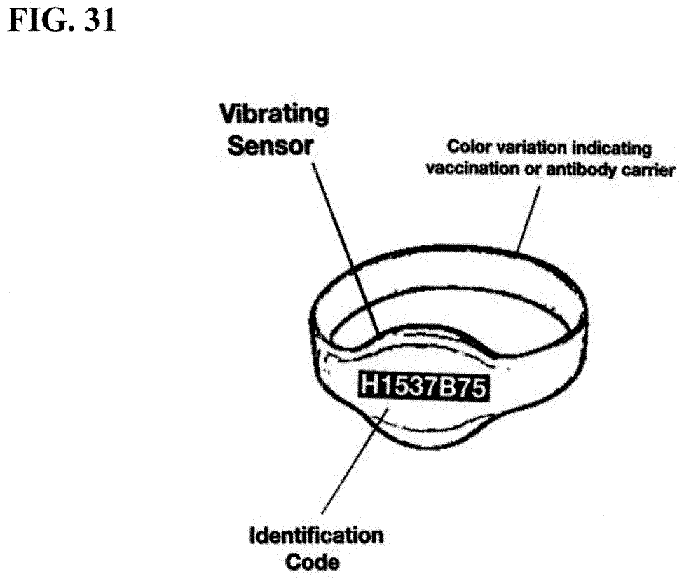

FIG. 22E depicts a ticketing system by which the user may select requirements for event admissions or consumer participation. These options may involve the actuation of interoperating technology service platforms such as but not limited to, serosurveillance systems, sentinel surveillance systems, biotechnology admissions systems, biometric enrollment systems, ticketing service technologies, temporal query consensus protocols, unique device identifiers, identification systems, or rideshare technology services, which may be used as a method of consumer identification, admissions, or ticketing methods within a separate consumer user interface that allows for a spatiotemporal block-lattice permissioned access, or consumer user identification and event participation. The user may also add safety requirements such as but not limited to face masks, temperature checks, or rapid diagnostic testing at event entry points, via integrative admissions or ticketing service technologies communication protocols. FIG. 31 illustrates an example of a sentinel surveillance or serosurveillance device by which individuals of a participating consumer public may be identified and given access to an event, as part of an integrated or interoperating admission system for unique device identification technology. For example, a bracelet with a vibrating sensor to aid the wearer in the practicing of social distancing, when standing too close in proximity to other individuals with bracelet identification codes that may not be recognized as that of a family member or of someone whose identification code indicates the receipt of a vaccination or a positive antibody test. Such systems may be included as part of the hiring process of those such as but not limited to, event management personnel, promotional personnel, or security personnel for the employed participation at a respective event's location, wherein in the alphanumeric code or numeric code corresponds with government issued identification.

Wireframe FIG. 22F depicts a method for generating consumer footfall at a real property event location, via the interoperation of a rideshare technology service and the use of a gravity based, geospatial data map within a geotargeting advertisement content building, ticketing or admissions system. The interactive data visualization map, may also include datasets of a stochastic model, a Marklov Random Field (MRF) model, or a Marklov chain as a probabilistic undirected graph learning model based upon memoryless stationary distribution that is determined by the network structure of highway or roadway topology, wherein the topographic geospatial interconnectivity of state space which may include factors such as but not limited to, two way streets, roundabouts, highway exits, or sidewalks determines the transitional probability of a dataset variable that may be characterized by relatively proximal target consumer patronage or foot traffic likelihood. The user is presented with a data visualization display of a polygonal overlay heat map of datasets data layers or data overlays such as but not limited to, population density, market share, gravity based spatiotemporality, cloud-based API real-time data engineering data, the ratio of rideshare rides to individual subjects of a market share of a stochastic model, the percentage of a relatively proximal population that consists of a target public, as well as the population density of individuals that may be identified or categorized by an interoperating sentinel or serosurveillance system. These datasets may help determine factors, such as but not limited to, the probability of event participation by individuals of a relative demographic, the probability of participation by individuals that are within a relative proximity of the prospective event location, or the average cost of a rideshare technology service that may be charged to an individual within varying proximal ranges of an indicated location or market share for a ride to the event location. The method further comprised a medium for content creation and for accepting geographic locations in a method of selective content dissemination. The creation of geotargeted content may include purchasing options or an allocation of payments for a quantifiable prepayment of rideshare service rides or for a plurality of rideshare ride discounts or couponing codes, via a dynamic integrative communication protocol may allow the user to provide geotargeted individual subjects of a proximal target market with free or discounted rideshare service rides to the event location, using methods that may also serve a dual purpose as an event admissions or ticketing method.

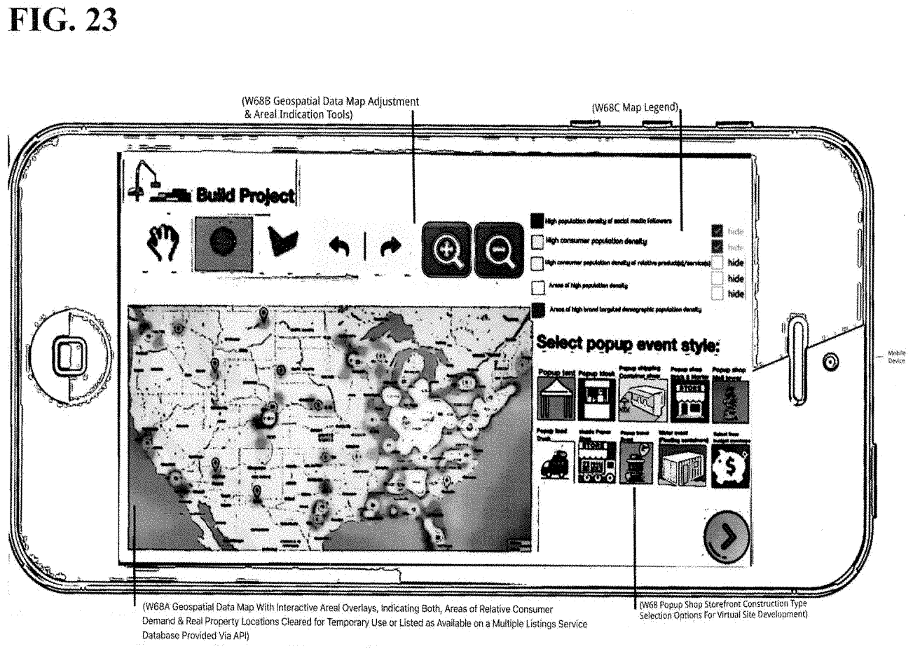

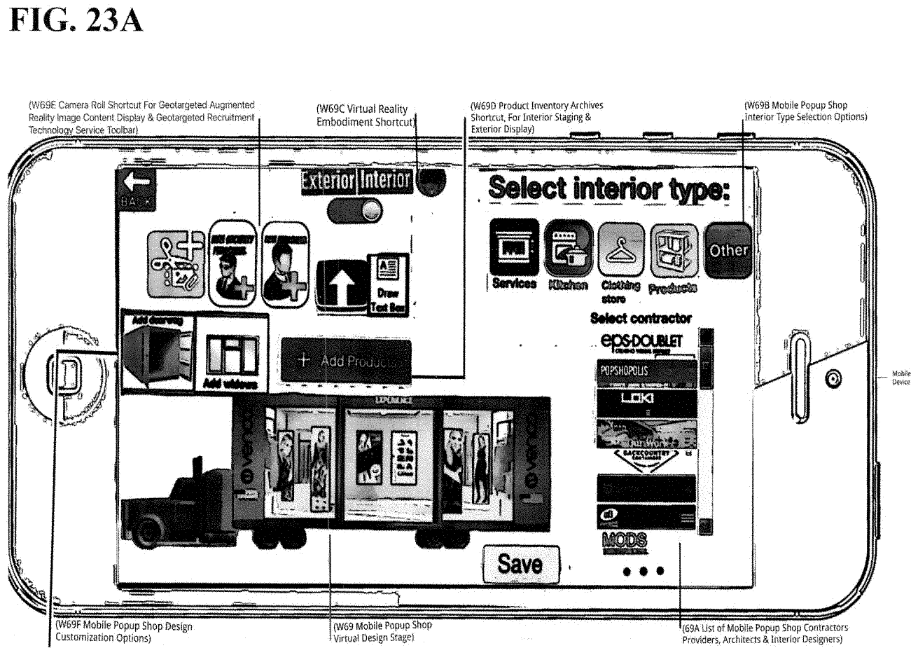

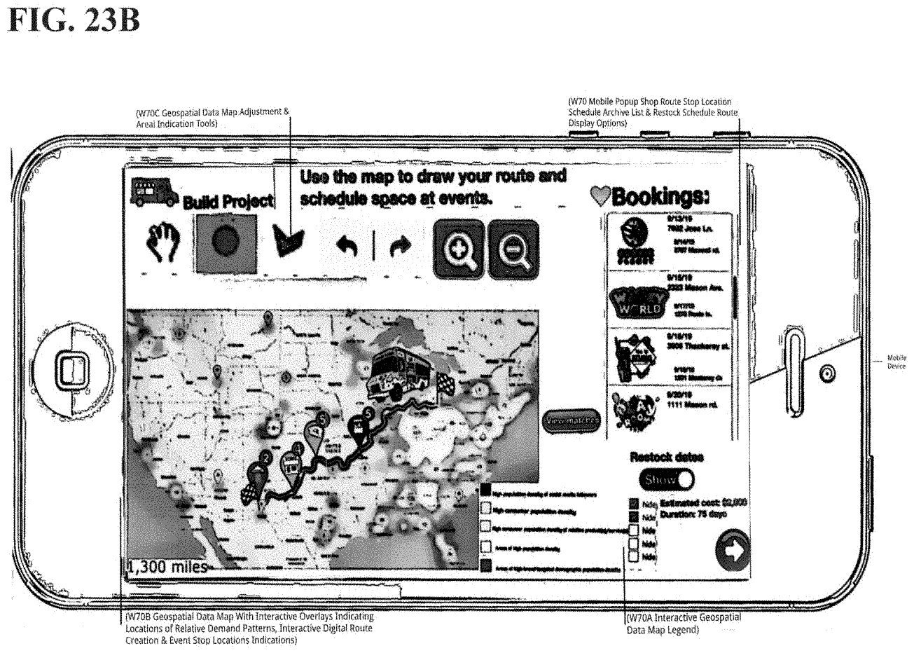

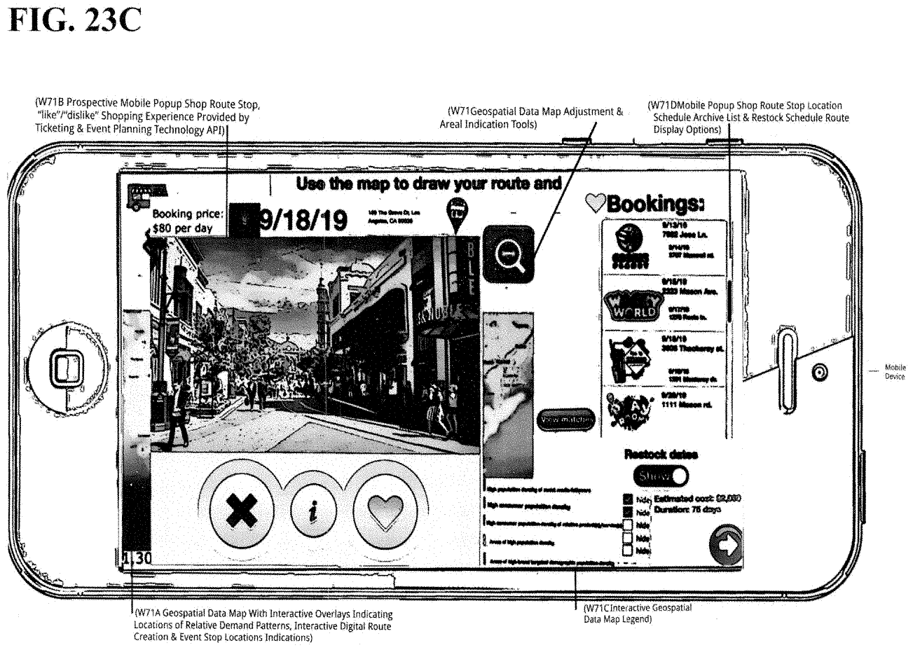

Wireframe FIG. 23 illustrates the “build project” embodiment's homepage, where the user has selected “mobile shop” or “food truck” as the popup shop style. FIG. 23A depicts an example of a the “build project” method used within the virtual design environment that has been modified for the virtual construction of a mobile popup shop. This modified version of the “build project” embodiment may include an interior and exterior virtual design method that may or may not be experienced as a virtual reality. The user may be provided with various interior design styles, such as but not limited to, service shops, a clothing store, a restaurant, or other retail construction types. The image further depicts a scrollable control panel featuring a selectable search list of relative servicers, manufacturers, contractor, architects, vendors or providers that may change or update as the user moves along various stages of the virtual building process. FIG. 23B depicts a modified real property shopping experience for mobile popup shops, where an interactive GIS data map, showing various target public and consumer population densities, is used to create a tour route which actuates a communication protocol within an API, or other methods of integrative programming, with event planning websites or platform websites, that may be used to generate a list of current and upcoming events, which may also include events scheduled via the use of this present invention. The drawing of a tour route may also be used as a method of generating a list of trucking services from which to hire a driver or schedule an automated vehicle service, or non-automated trucking service, from service providers that may be geographically located near the starting point of the tour route. The starting point of a tour route may or may not also represent the pickup location of a modified container. This method of creating a dynamic tour route may also include a geotargeting recruiting technique wherein job seekers in relative geographic proximation of tour route stops, may be hired to work a management, security, or sales job shift at prospective mobile shop's route stop location. This method of creating a dynamic tour route may further be used to include designated drop shipping stations, that are geographically located along the route, at which the user may schedule the shipment and pickup of a new product inventory case prior to arriving at the next event destination. The system may use a communication protocol with GPS enabled onboard technology or GPS enabled mobile devices to track the location of a container or the arrival and departure of hired personnel at each stop location. The hybrid vehicle route alignment system optimizes the routes of autonomous popup shop trucks and food trucks or the routes of truck drivers on the road, by improving the order of the visits according to a schedule database of an event entry network. This hybrid routing and delivery optimization allows for the integration of geotargeted recruiting service technology in the scheduling of hired personnel to arrive at a route stop during prescheduled shifts according to smart contracts and temporal queries of a simplified payment verification (SPV) graph learning spatiotemporal block-lattice system, the interoperation of event entry network technologies and statics modules used in the identification of events that may be indicated as prospective route stop locations of a dynamic delivery model as part of a data visualization display, as well as the integration of geocode databases and drop shipment order placement technology to indicate inventory case batch pickup locations as part of the hybrid routing system as exemplified in FIG. 44. FIG. 44 further depicts an example of a temporal graph and directed acyclic graph (DAG) block-lattice for mobile popup shops, by which a dynamic simplified payment verification system operates according to a series of temporal queries and time stamp hash values as part of a cryptographic, transactional exchange between users and autonomous vehicle dispatch or onboard technology systems, or employee users, according to a smart contract of a recruitment service technology or of an order placement technology. FIG. 23C is an example of the event venue shopping experience, wherein the user is able to view event entry profiles in a swipe viewer that contain information about the location of upcoming events scheduled on interoperating event planning and ticketing websites and are aggregated according to their proximity to a drawn route. Preferred events are archived on a scrolling list of prospective “bookings” within a margin of the control panel.

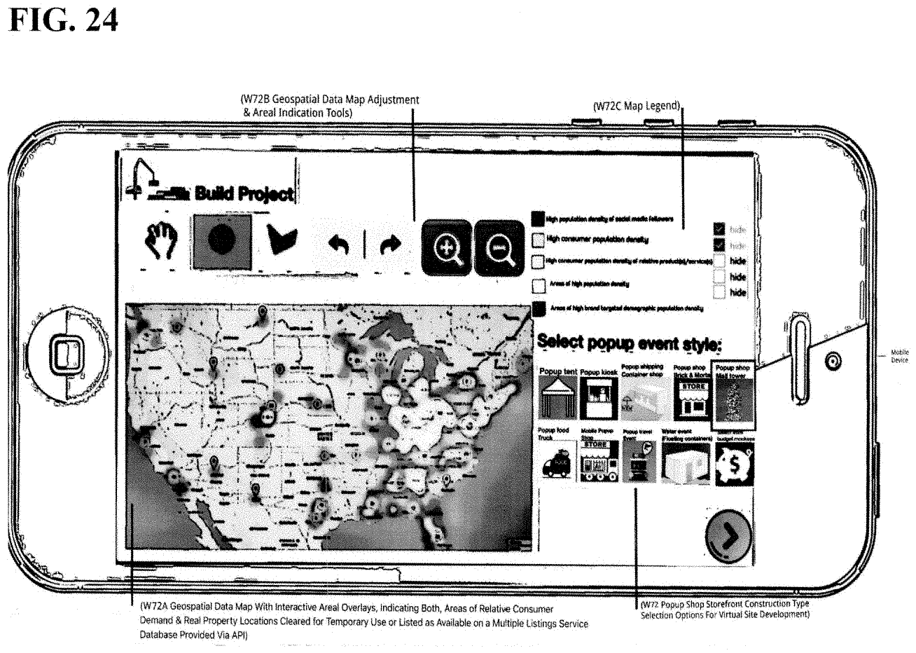

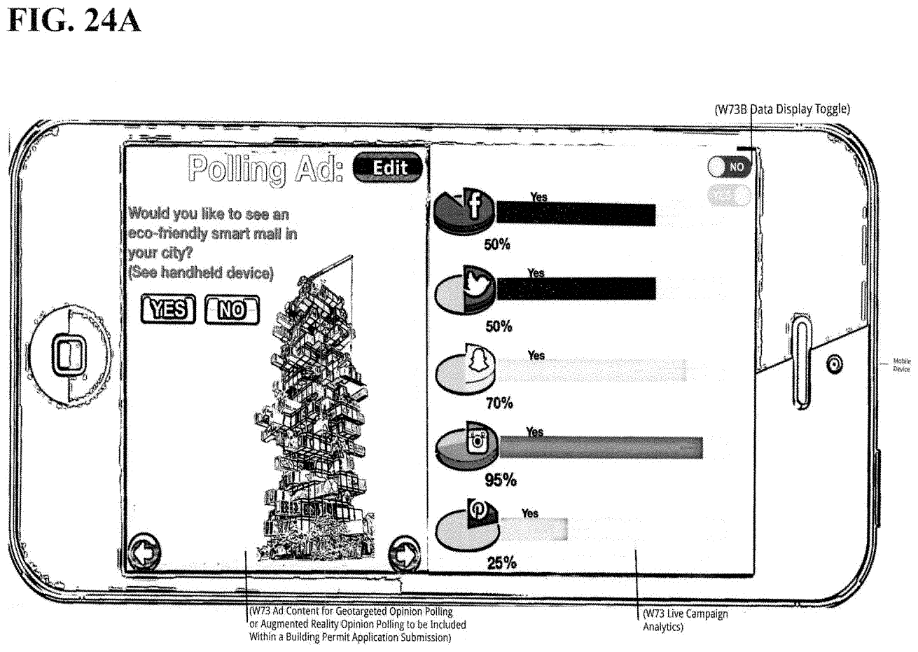

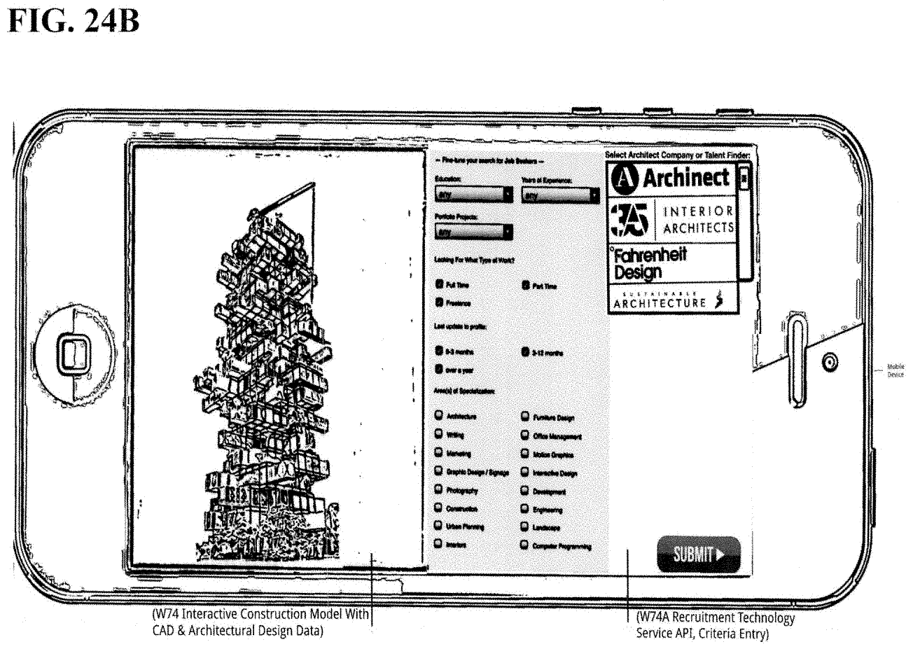

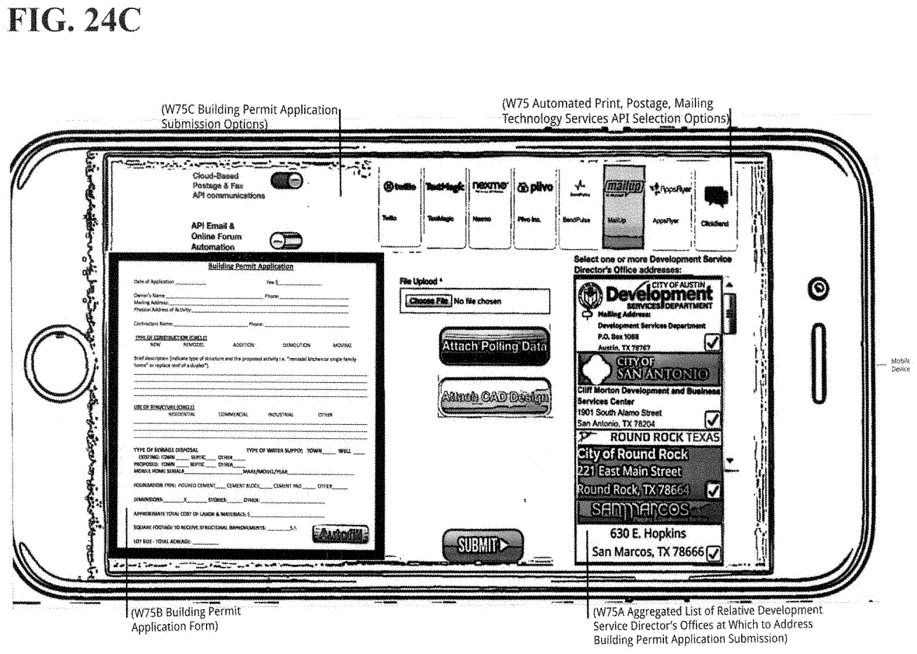

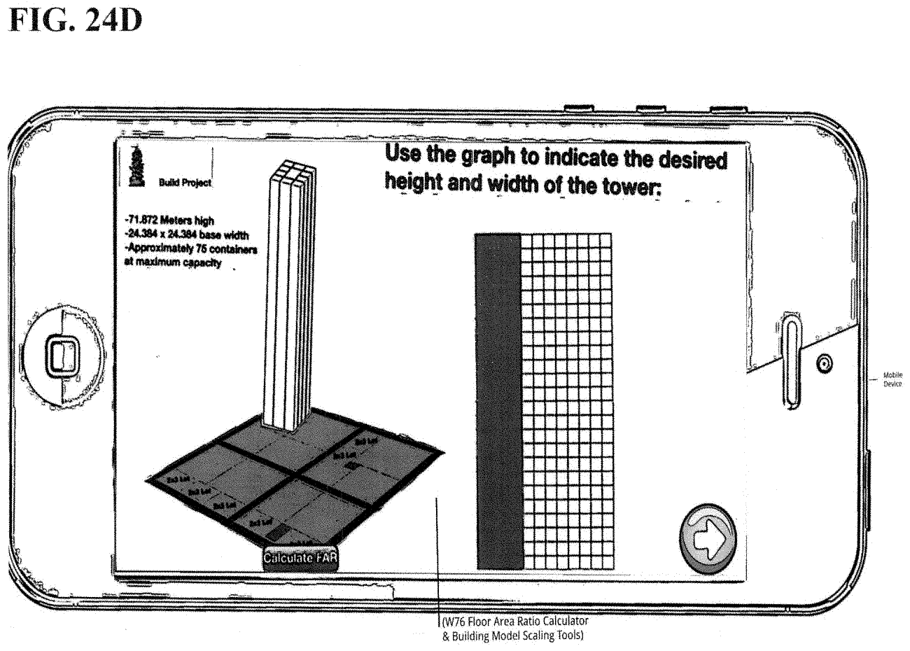

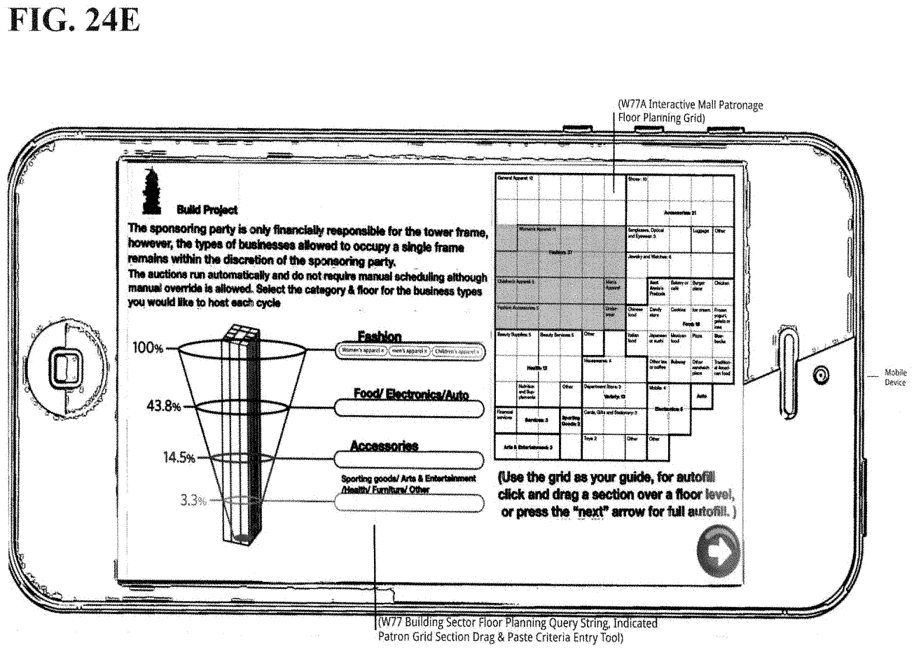

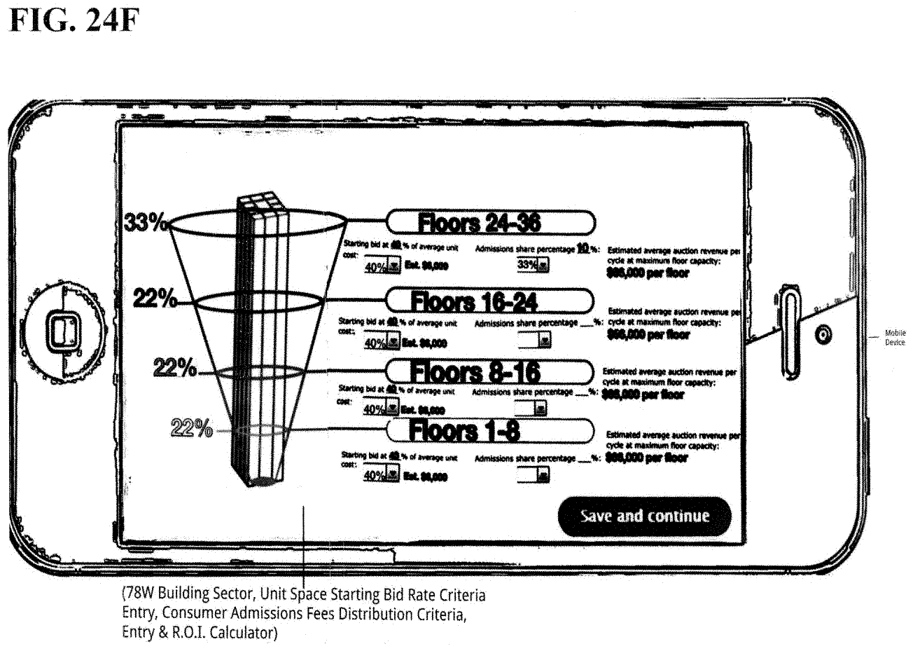

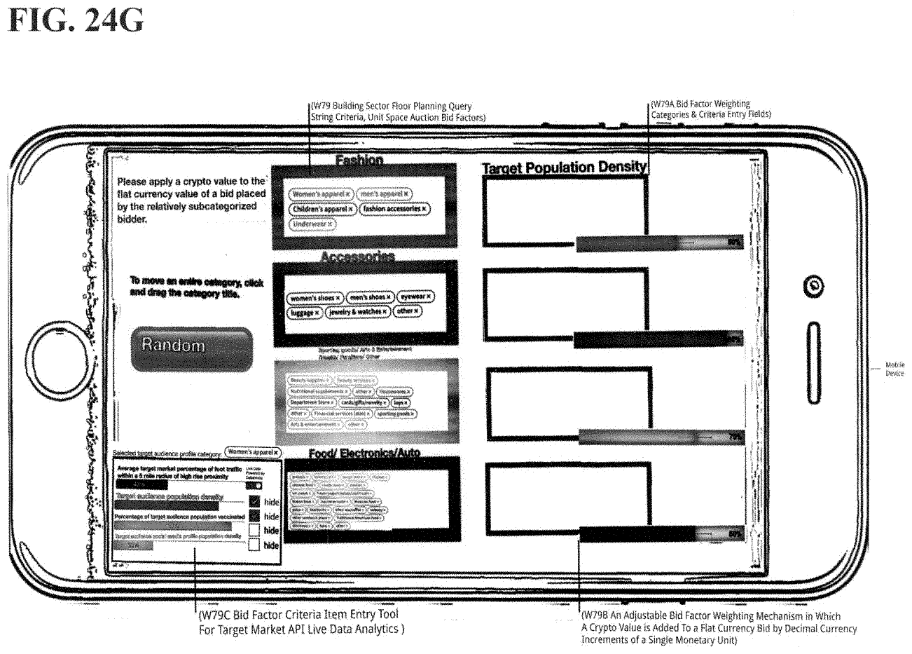

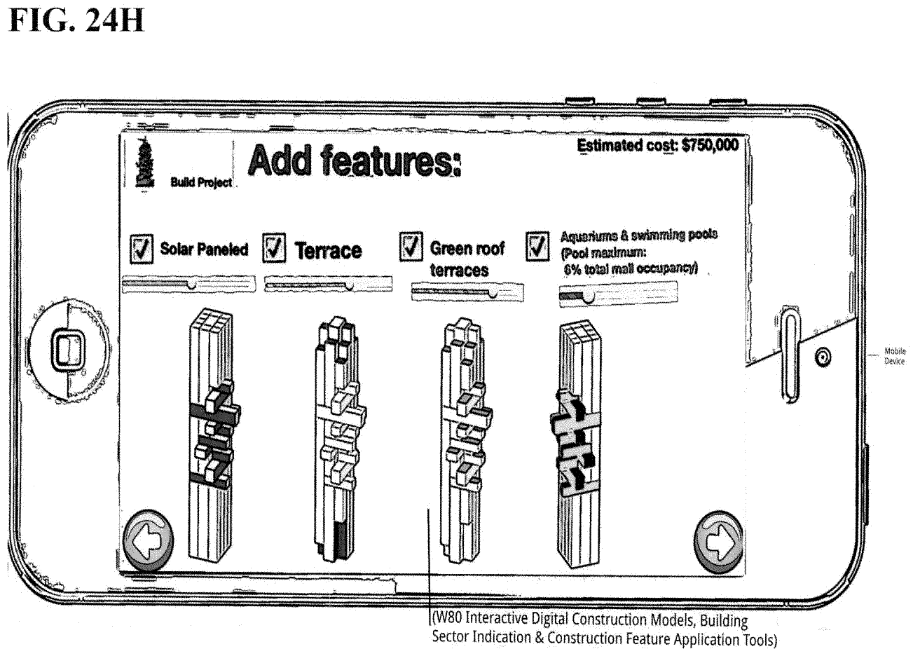

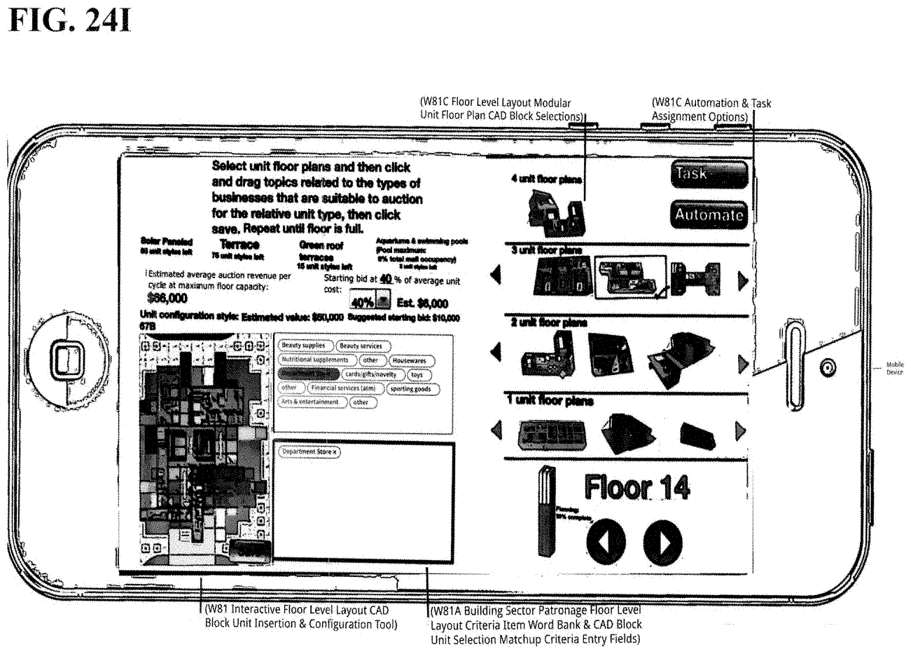

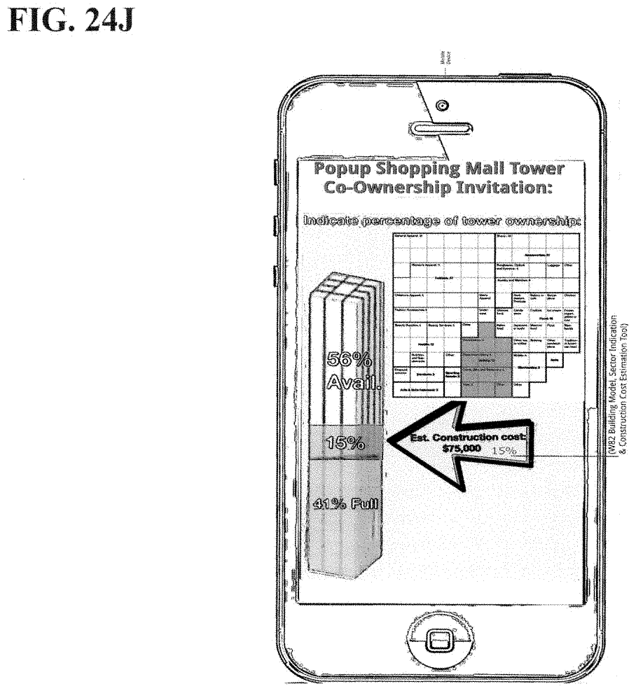

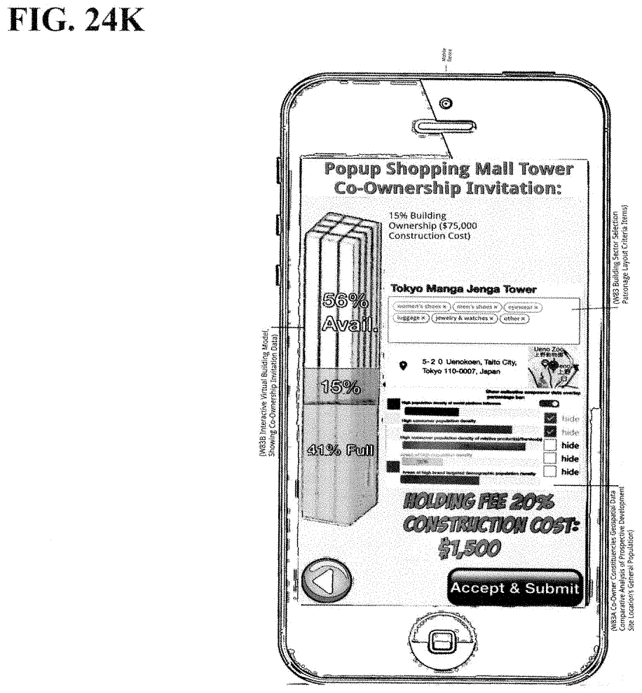

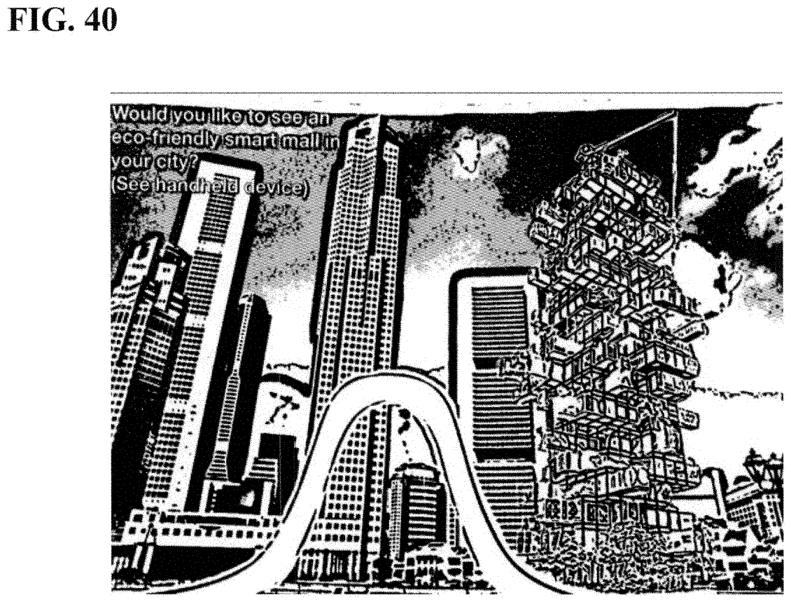

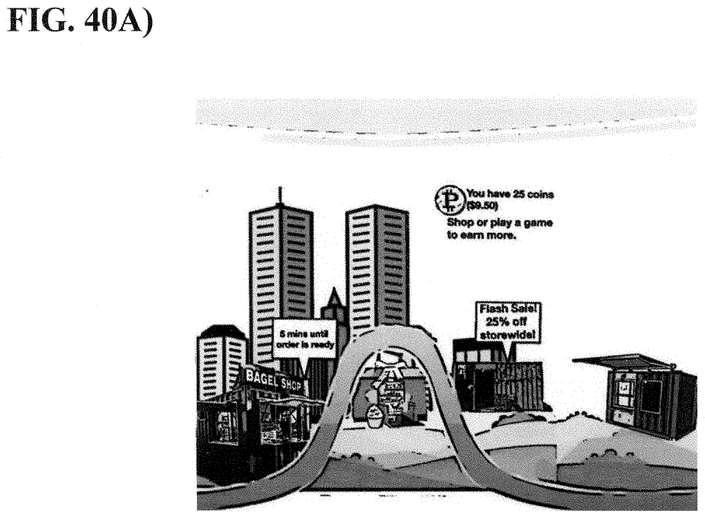

Wireframe FIG. 24 depicts the “build project” home screen where the user has selected “tower” as the popup construction style. Upon indicating this selection, the user may be notified of a possible delay in the project development time, pending the approval of a building permit by the respective city council or city development services director. The user may be prompted to aid the approval process by running geotargeted or social media platform polling ad campaigns via a content creation device shown in FIG. 24A, as method of opinion polling data engineering. FIG. 40 depicts the augmented reality experience of a geotargeted individual subject of a target population, that is within a proximity of a location that is zoned for a high-rise modular construction development project, at which augmented reality eyewear connected to a GPS enabled device allows the geotargeted subject to observe a scaled version of a modular high-rise popup shop mall in composite display of real-world images. Because the selective content dissemination technique may involve locating the GPS enabled nodal devices of social media users, the subject may be prompted by a social media notification to participate in a social media opinion poll regarding the prospective development project, via a social media polling ad campaign that may contain supplemental information about the prospective development project.

FIG. 24B illustrates an example of a burst recruitment ad posting and submission technique in which the user may submit autofilled or manually entered criteria for the hire of contractors and/or architects in the commissioning of a modular popup shop storefront high-rise smart mall development project, onto various recruitment service platforms or websites presented as aggregated options. This system also includes an interactive draft comprising comprehensive architectural schematics of an abstract building design and the concretization of development project concepts, created using a modified computer aided design system wherein the client side customization or selection of architectural building features are simplified for the user to generate translative criterion that are compatible with construction management software or computer aided design technologies that are developed for professional use. The recruitment ad may also be submitted prior to user generated abstract building design, implementing a default general mockup abstract building design content.

Wireframe FIG. 24C outlines an example of a method used within the “popup tower” variation of the “build project” embodiment, in which the user is prompted to utilize a burst automated mailing technique, using cloud-based mail, postage, fax, email and letter automation API services, by which the user may send an auto-filled building permit to a respective city development services director's offices located in one or more general locations preselected on an interactive GIS data real property search map. The search technique for a respective city council division for which to address a building permit, may include auto generated search criteria used to render relative government websites or document submission sites that include “.gov” or “city” as part of the uniform resource locator. The autofilled criteria may include the information of a commissioned contractor or architectural development team, as the representative of the master account holder, or as the direct or indirect correspondents to the permit submission. The autofill options may also include the ability to attach local polling data regarding the relative location's local population's opinion concerning the prospective development project, which may include datasets such as but not limited to, polling demographics, campaign analytics, or conversation tracking. The methods outlined in figures FIG. 24A through FIG. 24C may be presented before or after stages outlined in FIG. 24I.

FIG. 24D depicts a method of virtual site development, within the “build project” embodiment, where the user has selected “popup shop tower” as the popup construction style. The user is guided by FAR formulas and a grid with cells that may represent container modules, to determine the height and width of the prospective modular high-rise construction. FIG. 24E depicts a method of commercial space marketplace activity modulation, wherein the method includes an interactive patronage floor planning grid that is sectioned by categories that include subcategorized cells containing metadata criteria items which can be dragged and pasted into a criteria field, as part of a query string separation method, representing the prospective popup shop types that are to occupy various building floor modules of a building section as a result of a commercial space auction cycle. Once a building floor section is filled to maximum capacity, the user continues to fill the remaining building selections with the available categories and subcategories, the usage of a subcategory, more than once, may or may not be allowed.

FIG. 24F illustrates an example of a method that could be implemented in the specification of starting bid, bid entry criteria for each of the subcategorized module space availabilities, as well as method of distributing admissions fees amongst prospective popup tower tenants, according to their business category's proportional percentage of tower occupancy. For example, an “admissions fee” charged to participating consumers that wish to engage in the mall's augmented reality shopper's experience, which may include interactive experiential elements such as but not limited to, augmented reality local blockchain couponing games, augmented reality or virtual reality sales discounts display, or cardless checkout. The sum of such fees that are accumulated during an event cycle, may then be distributed to the respective tenants according their business category's proportional percentage of the tower. For example, if 33% of the tower mall consist of tenants that fall under the “accessories” business category, 33% of the total admissions fees collected during an auction cycle would then be evenly distributed amongst the subcategorized businesses that are categorized as an “accessories” shop.

Wireframe FIG. 24G depicts an example, of the “build project” embodiment when the popup selection type is a “popup tower.” This wireframe depicts a method by which the user may utilize a dataset valuation pricing model wherein the user may “drag and paste” criteria items into a bid factor weighting input device, as part of a bid factor weighting or dataset valuation pricing technique. The user is aided in this method, by proximal target market population density per centum data visualizations that are displayed in relation to each of the subcategorized business criteria items that are selected or indicated to be dragged from the business subcategory criteria field, into a bid factor or valuation category criteria field where weight or dataset price value can be applied. A randomization option may be implemented, by which the system scores the criteria item's associated datasets, and places the respective criteria item into the bid factor criteria field that corresponds to the highest scoring dataset object, as part of an automated dataset valuation or bid factor weighting technique. The user may apply a value to a bid factor weighting category using a slide bar tool. For example, if a “women's apparel” subcategorized business's highest scoring dataset object is the proportional percentage of a proximally targeted constituency or target audience that is 80% comprised of individuals that are women who buy watches with relatively updated vaccination records or immunizations during a pandemic that has caused an increased demand for vaccinations, the user may be compelled to set the “vaccination” bid factor at a 95% value increase representing the highest valued module space availability of a commercial space auction cycle due to an estimated larger market share. For example, a bid from a bidder whose business is subcategorized as a “women's apparel” business that sells watches, may have an increased flat currency value of 95%. Therefore, $1.00 USD placed in a bid by the “women's apparel” watch business master account holder, may hold the increased flat currency value of $1.95 USD. If a “men's apparel's” highest scoring dataset is the total general population density of the proximal location at 20%, placing them under the “total population density” bid factor weighting factor, that is valued at an 80% flat currency value by the user, the value per $1.00 could be set at $1.80 for a bidder representing respectively subcategorized business. Because both “women's apparel” and “men's apparel” are both categorized under “fashion,” the bidder subcategorized as “men's apparel” could be required to bid against the “women's apparel” for a “fashion” module space availability, with a flat currency dollar value that is 8% less than a women's apparel bidder's bid per dollar, due to an artificial inflation applied via the bid factor weighting technique.

Wireframe FIG. 24H depicts a method of adding features such as but not limited to, green roof terracing, terracing, solar panels and swimming pools. Because “swimming pools” may not match any particular business category, any business bidding for a designated swimming pool module unit space, which may contain a prefabricated shipping container unit or modular unit with brand related images or logos, may be allowed to enter a “swimming pool” auction. The swimming pool module subtenancy spaces may also be retained by a high-rise owner. The swimming pool module tenant may be allowed to retain a percentage of admissions fees in an amount that reflects the total composition of the tower modules that have been designated as swimming pool spaces.

Wireframe FIG. 24I illustrates an optional method of virtual floor planning and path planning by which the user selects a floor level on which to allocate a number of module space for occupancy by a business subcategory during a prospective auction cycle. A single auction cycle may or may not delineate the maximum or minimum time for a module space tenancy. In this example, the user moves a subcategorized criteria item from the business category criteria field, to the module unit CAD block allocation criteria entry field, upon indicating one or more module spaces on the interactive, scaled virtual floor model, and then further indicates a roofing feature such as but not limited to, “green roofing” or “solar paneled” thereby rendering matching containerized floorplan CAD block selections, which may further represent auction entry in regards to module unit's emplacement. For example, if the smallest amount of space allotted to a selected business subcategory is 320 square feet, or one shipping container unit per store, the user may create a “department store” by allocating three container units or 960 square feet of module floorspace, to a single bidder of a business subcategory, as the maximum space allotted for a single store, while limiting the size of other store types to 640 square feet, or two shipping container units. This process may be foregone, randomized, or automated according to a deep learning algorithm, should the user decide to “skip” this step, or the user may choose to “task” this step to an authorized user or representative with permissioned access to the user's account. The respective bidder may be required to acquire, rent or produce a matching or eligible module unit or set of units to further satisfy auction entry eligibility requirements. A bidder may use eligible prefabricated shipping containers from their personal archives or from the archives other users that are offering units for rent or purchase via a unit repurposing recommendation system, or they may choose to shop vendors, suppliers, manufacturers, or contractors. The repurposing recommendation system, and unit marketplace environment, is a machine learning software tool designed to generate and provide suggestions of pre-owed or used popup shop construction units as selection options from a unit database for units that have been archived for resale or reuse by users, presented to other users based on the user's unit style and size preferences as well as other relative criterion or auction entry eligibility requirements. The selections from the unit database may include metadata items such as but not limited to, numeric or alphanumeric unit identifiers, unit sizing and dimensions, unit color, number of uses, and other visual or quality descriptors, as well as geocodes of shipping container ports, shipping container depots or, shipping container yards, and estimated shipping cost or relative arrival dates.

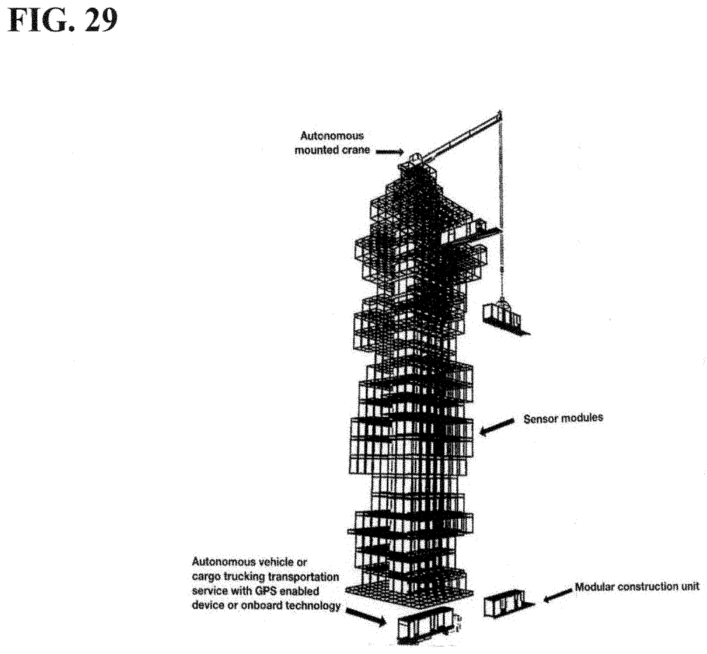

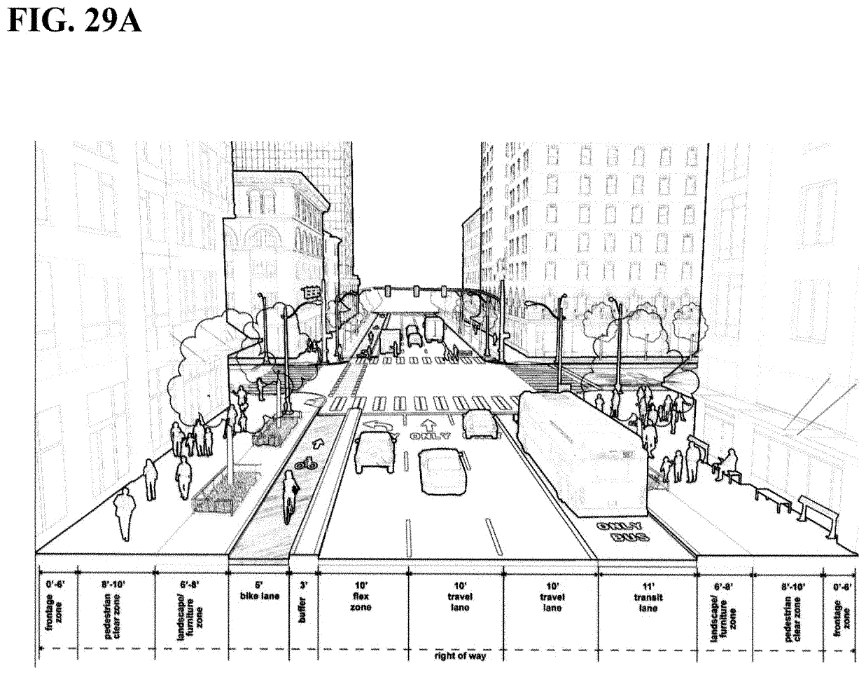

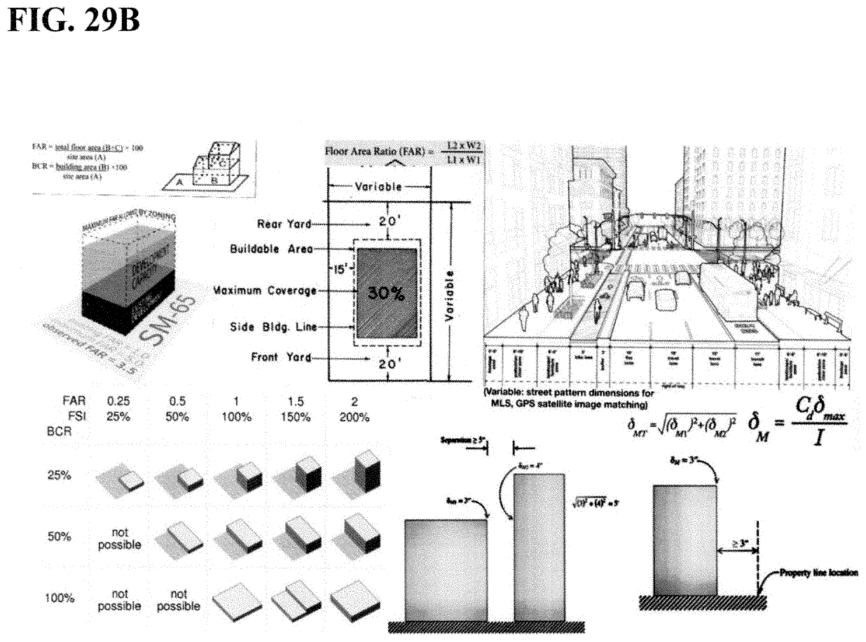

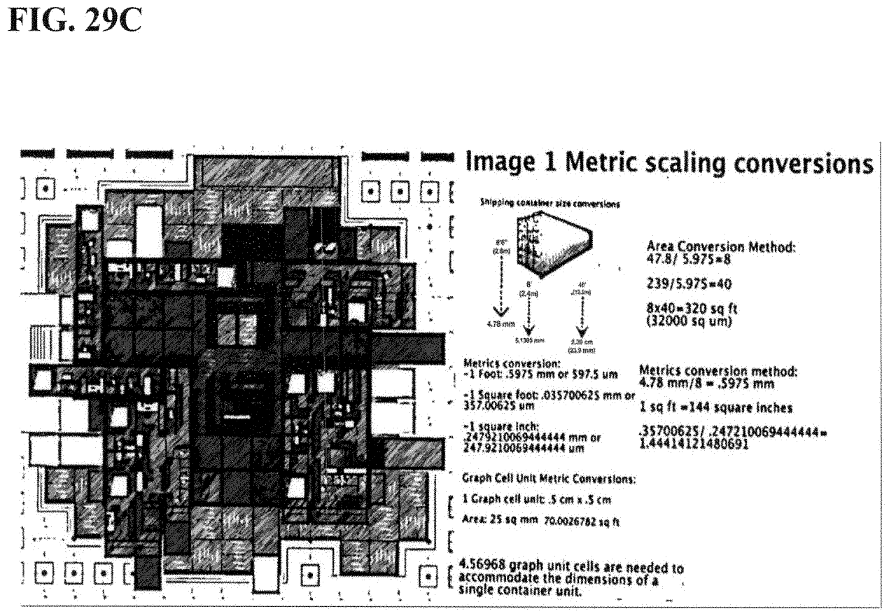

Wireframe FIG. 24J illustrates an example of a method that may be used to invite “popup tower” co-owners to joint-proprietorship of the prospective high-rise building, via a retailer's social graph networking graph learning system, by indicating floor levels or sections of a virtual high-rise building that may be purchased by an invitee. FIG. 29 illustrates an example of what a “popup tower” modular high-rise mall construction may resemble before being occupied by any interchangeable module units. The image shows a high-rise modular building, module frame for the interchanging of retrofitted modular or prefabricated shipping container units. Because unit extractions and installations are scheduled according to auction cycles as part of a path planning method, and are thereby partially automated, the high-rise modular frame may or may not be mounted with an autonomous robotic crane that is interoperated within a combined system comprising integrated programing communication protocols with an auction scheduling system, an autonomous truck dispatch and tracking system, a non-autonomous truck dispatch and load tracking system, and a container tracking system which may further include an onboard technology tracking system of an autonomous trucking service or, the tracking of a GPS activated device of a hired trucker of a spatiotemporal querying method. The steel module frames may also be weighted or may include sensor network technology to help track tenancy start dates, end dates, module vacancies, and module occupancies that may aid in the remote control, automation, or semi automation of floorspace auction cycles. FIG. 29C depicts an example of formula by which virtual floor models, modules and module units could be scaled. FIG. 29A and FIG. 29B illustrates a zoning pattern example and FAR formulas that may be implemented as functions within a machine learning algorithm used within a technique to search various MLS databases and detect real property listings that would be eligible for a modular popup shop high-rise mall development project, which may further be implemented pattern recognition or image matching deep learning algorithms. FIG. 24K depicts an example of what a co-ownership invitation accessed via the “my projects” embodiment, may look like, wherein the recipient is presented with an interactive virtual tower that shows available floor levels, the predesignated retail businesses of a business category or subcategory set to occupy the floors, and associated datasets relative to a population within a proximal or general location of the prospective tower's development site. Owners may or may not be allowed to trade business subcategories amongst themselves, as well as manually operate respective floorspace auction cycles.

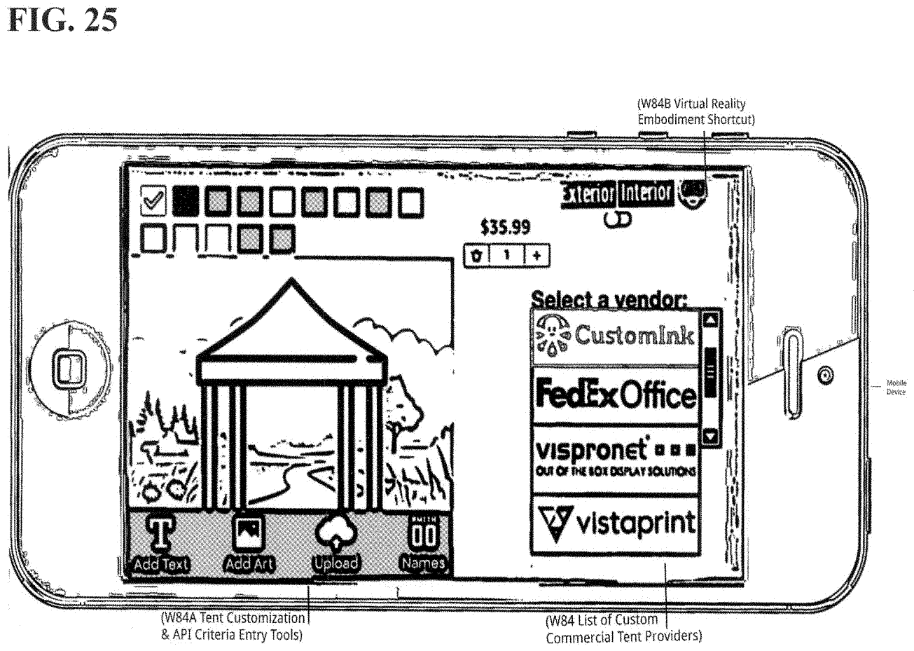

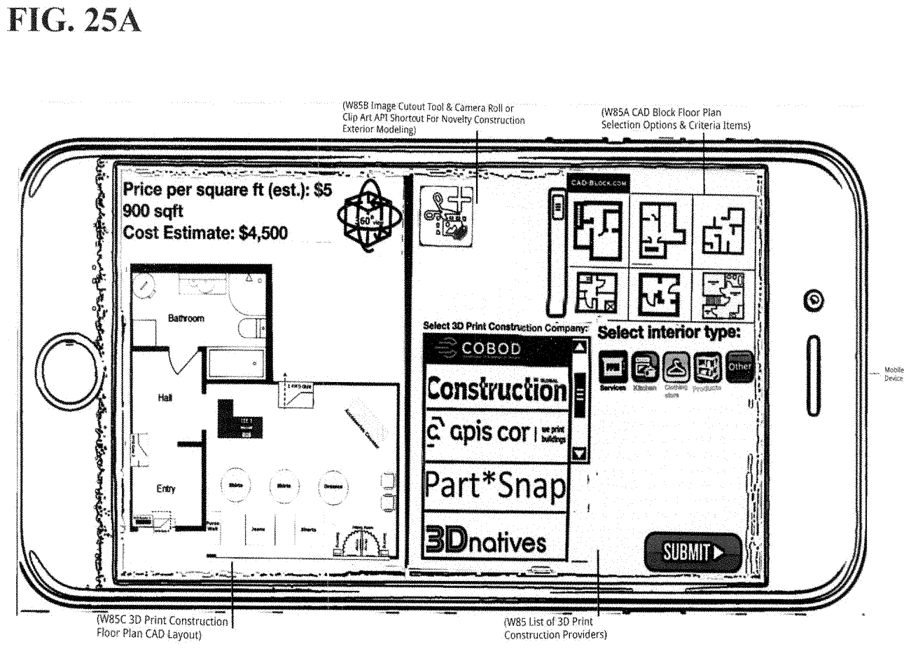

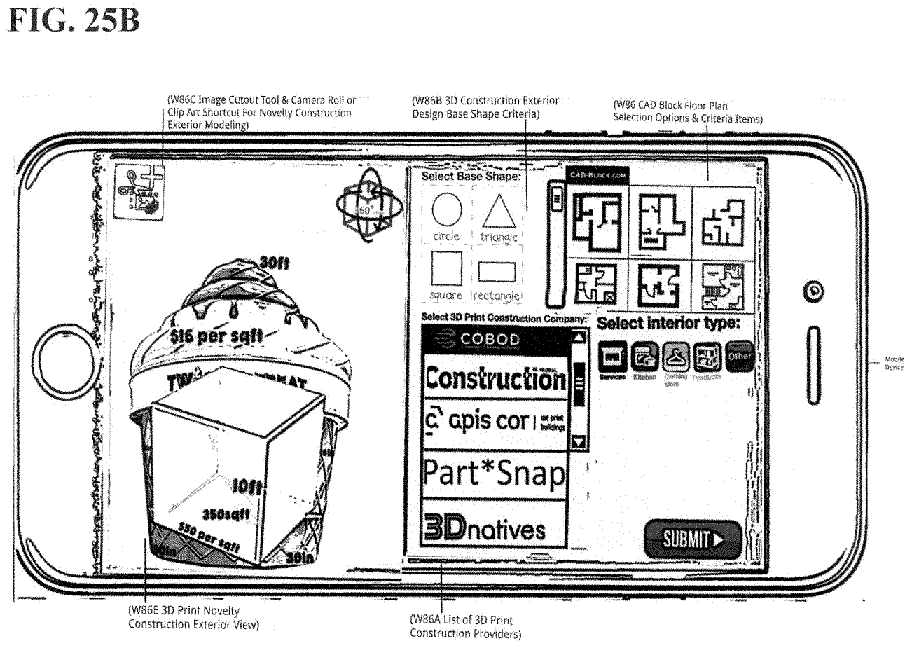

Wireframe FIG. 25 illustrates a variation of the “build project” embodiment wherein the user has selected “commercial tent” as the popup construction type. In the illustration, the user is shown to have selected a tent style and color. The user would then proceed to add images and logos and would then select a vendor for the purchase of the tent item and for the custom design of the virtual rendition, via an API order form autofill and submission technique. Prior to entering this phase, the user may be allowed to utilize an interactive GIS data visualization map, geospatial data maps or interactive geospatial gravity maps that interoperate with event planning or ticketing platforms, as well as the event planning aspects of this present invention, to search for and purchase floorspace subsectors that are suitable for a commercial tent, for the commercial participation at a prospective event.

FIG. 25A depicts an example of a stage within the “build project” embodiment, wherein the user has selected the “freehand” option presented to users as depicted in FIG. 8I. The term “freehand” may be used to describe a modified CAD to CAM communication protocol by which the user assembles a floorplan by selecting an interior style category and choosing from search relative CAD blocks, that may be provided via integrative programming or via an API with one or more CAD program technologies, from which a CAD block may be selected for the design of a modular or prefabricated construction which may then be developed using 3D print construction technology. The user is presented with a scrollable list of 3D print construction companies that may service a general area, or a specified remote location representing a prospective event venue. The illustration further depicts a method by which the material cost per square foot is estimated, as well as a method of viewing a virtual rendition of the structure's exterior which may be experienced in a virtual reality setting. An interior design shopping experience wherein items such as but not limited to, shelving or furnishing product item suggestions are presented, may be actuated by indicating individually labeled generic furnishing items or respectively labeled spatial allocations within a selected CAD floorplan design display. The user may also indicate subsectors of floorspace, or shelving products, or shelving fixtures, as space availability publications in a commercial floorspace subsector marketplace or shelf space marketplace system.

Wireframe FIG. 25B illustrates an example of a stage within the “build project” embodiment, wherein the user has applied an improvement to a virtual development site, using the image cutout tool depicted in figures FIG. 12C and FIG. 12D. In this example, an image cutout tool that may be provided via the integration or interoperation of pattern recognition or background removal technology, is used to cut out an image that is then scaled to fit the classification of a “novelty construction,” whereby a machine learning algorithm is used to generate a list of architect companies, architect freelancing and recruitment service platforms or websites, or 3D printing contractors, that service the respective location, and that may be commissioned for the project's development. The figure further illustrates a method of using CAD blocks to plan the interior of the novelty item shaped construction according the selection of an interior design category. The user may then proceed with adding interior furnishing items via a shopping experience that is actuated via the selection of individual labeled generic furnishing items or spatial allocations of the CAD floorplan design. Depending on the size of the novelty construction item, the user may also be given the ability to sell commercial floorspace or shelf space within a commercial floorspace marketplace or commercial shelf space marketplace, using aforementioned methods.

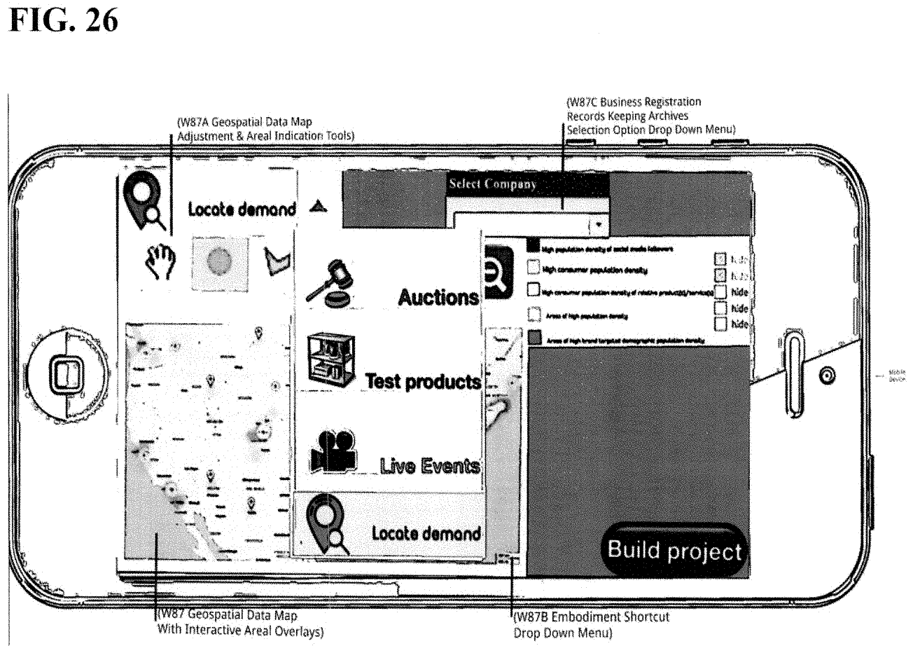

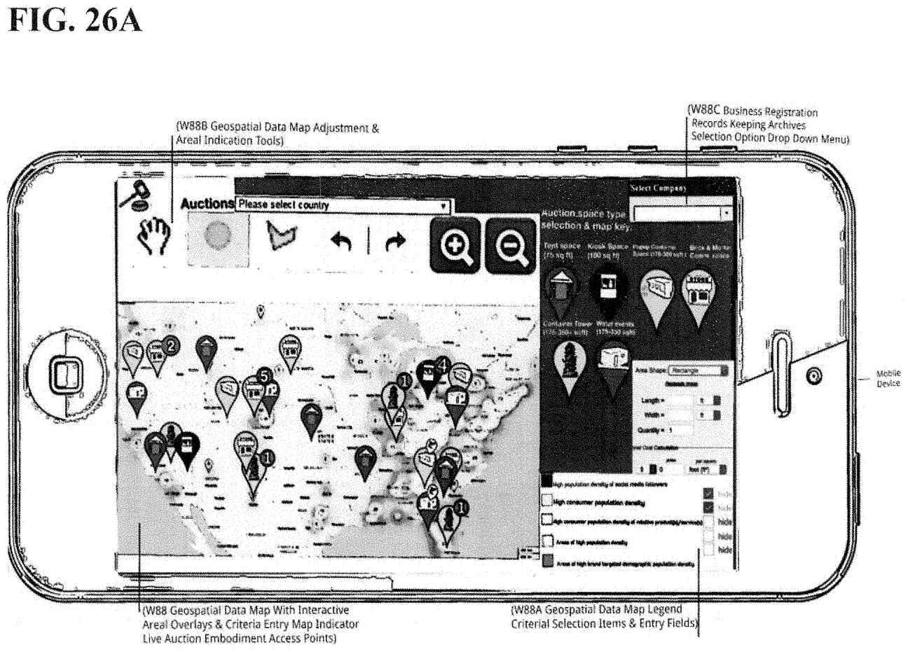

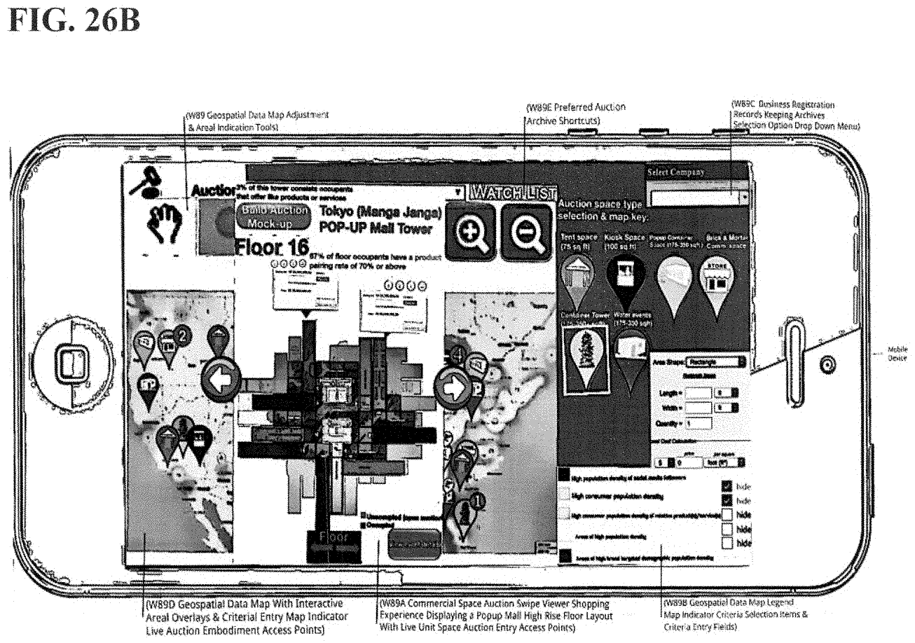

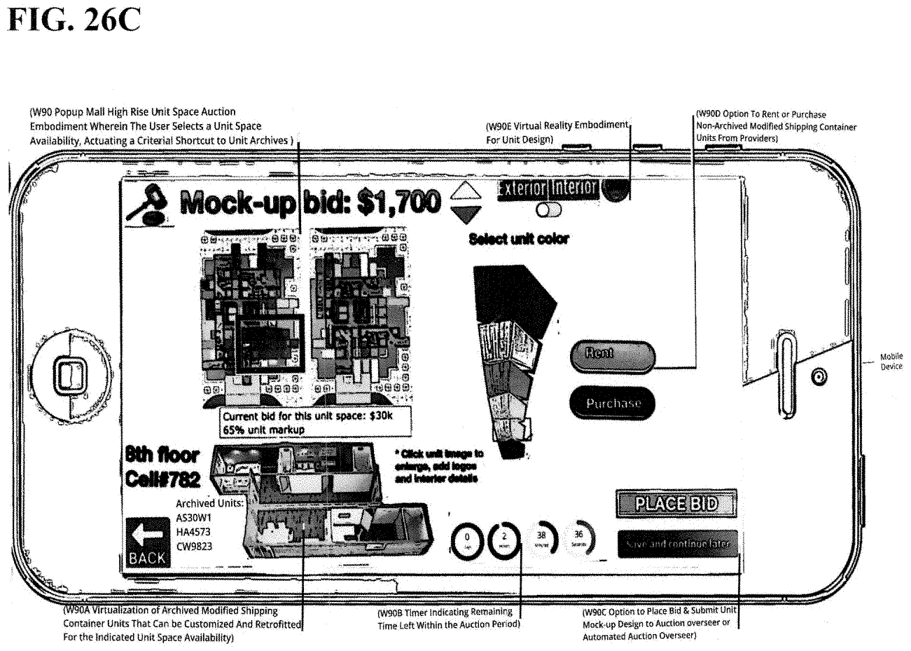

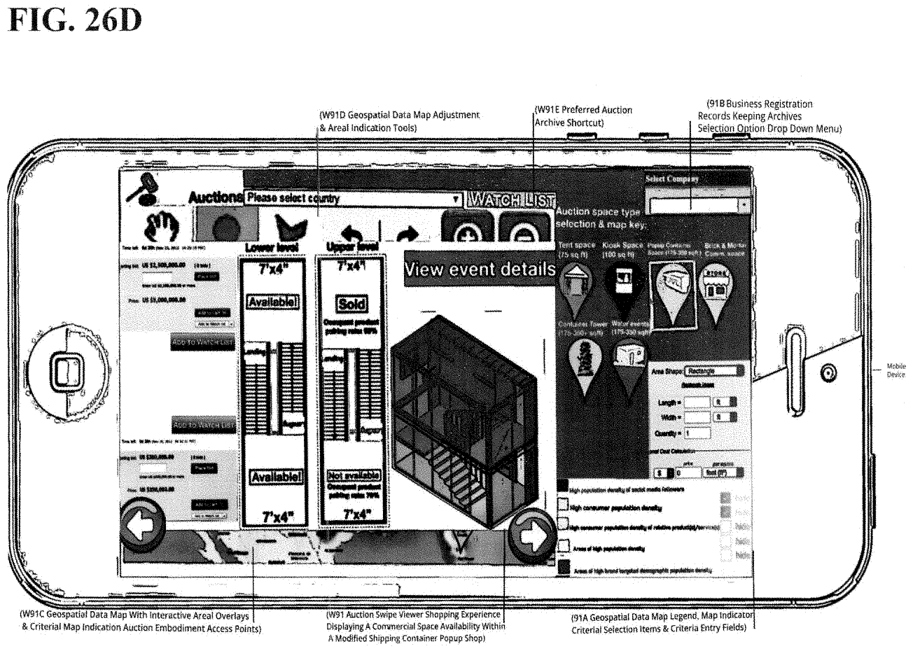

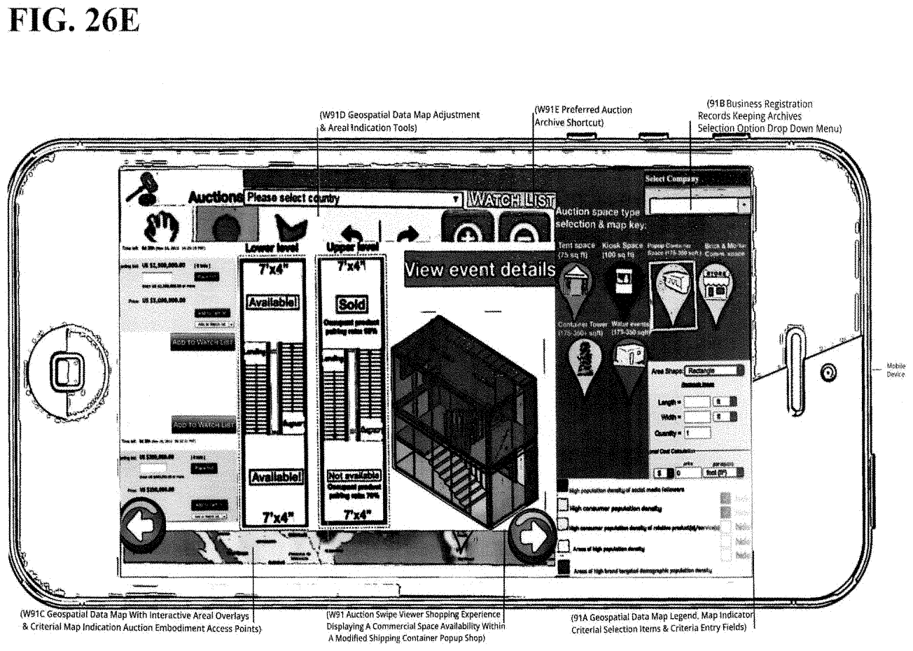

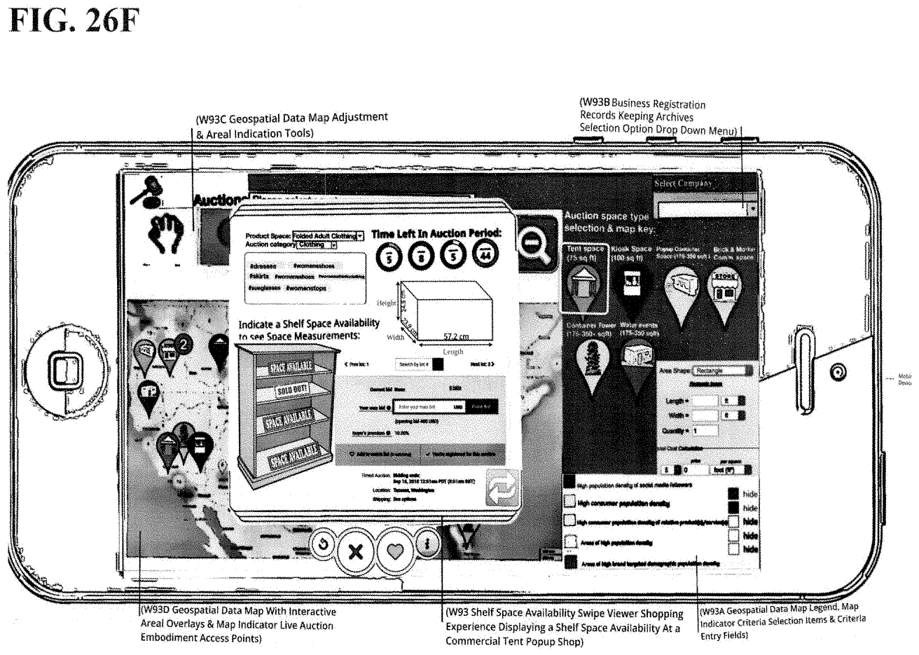

FIG. 26 illustrates the “locate demand” embodiment, where the user as selected the shortcut to the “Live auctions” embodiment, using the dropdown menu shortcut tool. FIG. 26A depicts an example of the “live Auction” embodiment GIS data visualization map, populated with map icons that represent locations of one or more popup types. To narrow the search, the user has indicated a desired amount of commercial space and has selected the “popup tower” as the desired type commercial space being sought after within the commercial space marketplace environment as shown in FIG. 26B. FIG. 26B further illustrates the populating of an interactive GIS, geospatial demographic population density map, with interactive “popup tower” map icons, indicating locations or prospective locations of a modular popup shop high-rise mall. To shop auctions or commercial space available for procurement, the user utilizes a freeform areal indication tool to select a general location on the map where one or more “popup tower” icons have appeared. FIG. 26B further illustrates the “popup tower” commercial space, shopping experience, after the user has indicated a map icon, generating a swipe viewer, wherein the user may swipe or scroll through various tower profiles, that may be opened to display an embodiment of a building profile wherein an interactive virtual floorplan of the respective building's floor levels having module space availabilities can be viewed along with other data such as but not limited to, current bids, and module spaces that are soon to be available to the shopper's registered business category, that may be added to a “watch” or “waiting” list.

FIG. 26C outlines an example of an embodiment of a “popup tower's” commercial floorspace auction profile page, wherein the user has furthered the bidding process by indicating available module spaces of interest. The user thereby, actuates a shipping container procurement method which may adjust the overall bid amount according to the procurement selection option. For example, the prospective bidder may choose to select from their archived prefabricated units that are suitable for retrofitted placement into an available tower module space, which may cut the additional cost that could be incurred by renting or procuring a modular or prefabricated shipping container unit via other methods, lowing the overall module space procurement cost. Shipping container archives or repurposing recommendation system unit archives may include data such as but not limited to, container port location, alphanumeric container tracking identification codes and automated trucking onboard technology GPS tracking, or the tracking of a GPS enabled device, by which a bidder can schedule and track the movement of containers set to be installed or removed from a respective “popup tower” modular high-rise popup shop mall, or other “shipping container” popup event venue sites. Upon winning a bid for module space and the subsequent modular storefront unit placement in the module space of a “popup tower” or modular popup shop high-rise mall, the prospective occupant may be given an allotted amount of time to add interior design furnishing elements, using aforementioned methods, if the bidder has not completed a mockup virtual interior design method prior to placing a bid. A mockup design, can be created using product items listed for sale, as outlined in the aforementioned interior design methods, however, product purchasing may be deferred until the bidder or purchaser has successfully procured the respective module space availability. Criteria and metadata generated via a mockup design, may be applied to a deep learning comparative analysis algorithm whereby the automated auction system establishes a compatibility between candidates according to datasets such as but not limited to, brand adjacency, product pairing, patronage flow, theming elements, etc. Mockups may also be viewed by a module space auctioneer.

Wireframe FIG. 26D depicts an example of the shopping experience within the commercial space marketplace embodiment wherein the commercial space shopper has selected “shipping container” as the commercial space type and has engaged the shopping experience using the interactive GIS data visualization map. The figure illustrates an example of a commercial space availability publication within a prospective shipping container popup shop, in a swipe viewer display of a commercial space auction profile. FIG. 26E depicts an example of the shopping experience within the commercial space marketplace embodiment, where the popup shop commercial space availability selection type is “brick & mortar” or 3D printed structures. No modular construction units are required to be procured by a bidder or purchaser of a brick & mortar or shipping container commercial floorspace subsector. However, the procurement of furnishing, shelving, or display items may or may not be required for the stocking of the bidder's or purchaser's, product items at the respective popup shop.

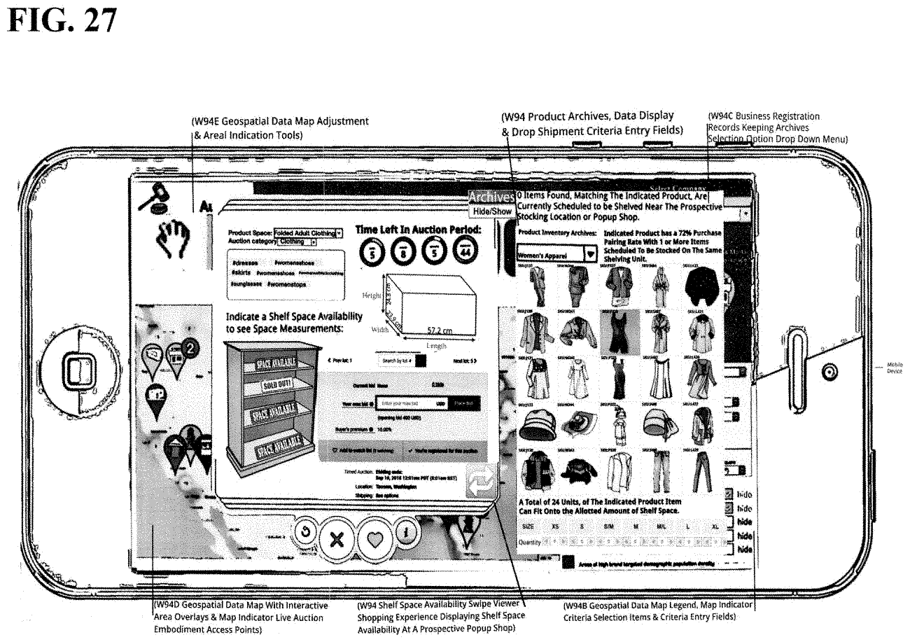

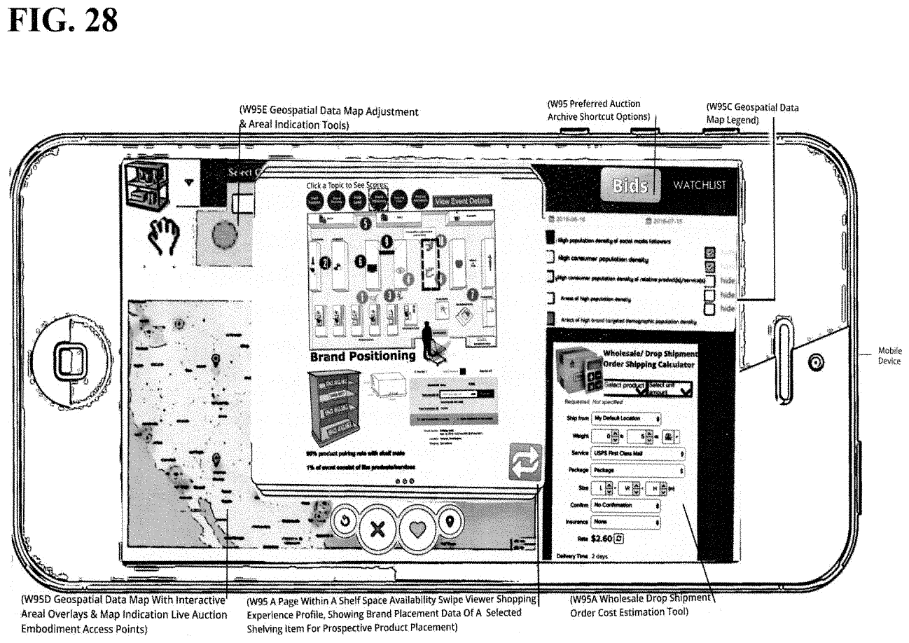

Wireframe FIG. 26F illustrates an example of the shelf space shopping experience within the “Test My Products,” embodiment, or the commercial space marketplace embodiment when the popup selection is a “tent.” Shelf space availabilities may be search optimized with an algorithm used to find data correlations within business registration criterial descriptors and product repository criterial descriptors, using data extractions that identify a target market such as but not limited to, conversation tracking data, user behavior data, or consumer behavior, to identify data correlations such as but not limited to, products that are frequently bought together, products with a relatively high brand adjacency with one or more products of the shopper's product repository, related products, or related businesses. Such data extractions may aid the shopper in the selection of prospective shelf space product placement locations. FIG. 26F further illustrates the use of a query string separation method, by which the user may edit business or product categorization criteria in order to search relative shelf space publications according to prospective shelf mate products to be placed near a shelf space availability at a respective popup shop, or to search for shelf space availabilities that are similarly categorized. The user is also given the ability to filter the search according to a desired amount of shelf space. Wireframe FIG. 27 illustrates a variation of FIG. 26F, where the shopper is allowed to select from their uploaded product archives as a method of filtering correlative datasets, relative to prospective shelf mate products, or as a method of calculating overall costs of product placement, including shipping cost estimations that are calculated according to product order item quantifications. FIG. 28 illustrates an embodiment of a shelf space availability publication's profile, of a shelf space marketplace environment, wherein an interactive display of a popup shop's floor planning layout includes fixture and aisle placement schematics, wherein a shelving items position is scored according to a topographic stochastic model of a shopping experience that generates a brand adjacency model according to product paring rates and consumer behavior data, to produce a shelf positioning and brand awareness scores, that indicates a shelving item or shelving fixture's brand awareness rating according to a consumer's perspective during the shopping experience, at a prospective popup shop.

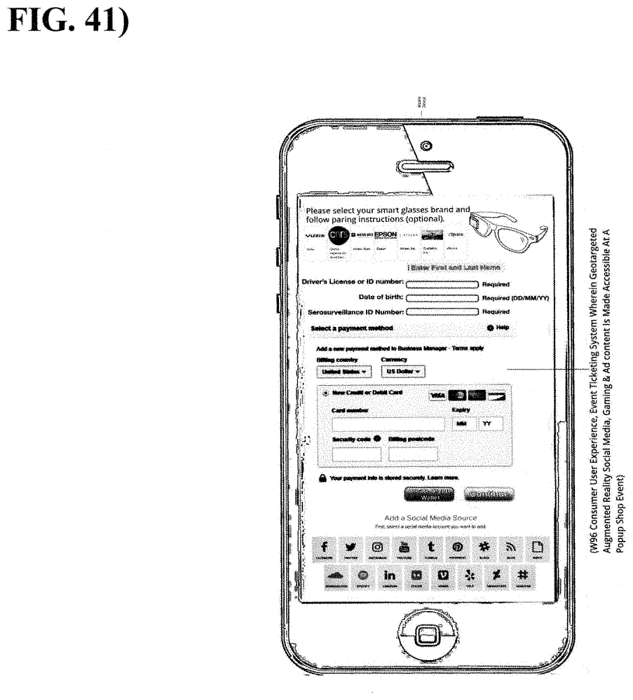

FIG. 41 illustrates an example of a payments environment, criterial input device in the user interface, of a consumer or hired personnel that would allow for participation at one or more events, or that would allow spatiotemporal block-lattice permissioned access in proximity to one or more events. This method may or may not include the interoperation with a biotechnology, serosurveillance or sentinel surveillance identification system, and a user associated crypto wallet that may allow for the participation in blockchain gaming or couponing for consumer users. This method may further include a medium for the coupling or pairing of a device with either an augmented reality device, or with a mixed-reality device, or a with hyper-reality device, or with a neurotechnology device.

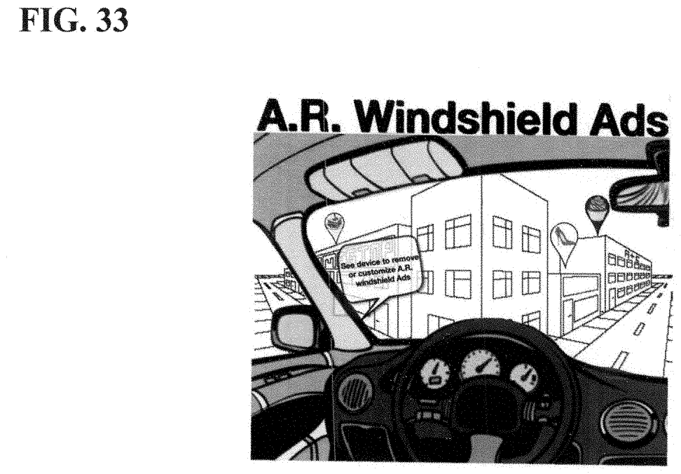

FIG. 33 illustrates an example of onboard heads-up display technology for receiving within a content storage medium or image processor, content transmissions of a content creator and selective content dissemination medium, for the geotargeting of advertisement content by a remote user.

FIG. 32 depicts the client-side experience generated via the use of tree nodes of an octree spatial data indexing structure, by which metadata of computer-generated perceptual programming is generated during the virtual design stage within a virtual design environment. The three-dimensional graphical computer model comprises active tree nodes of an octree spatial data structure that are optimized for the computable calculations of viewing angles according to topological relations and connectivity wherein a dynamic tetrahedral mesh comprised of octants or nodes representing datasets for visual focal points, that are points or vertices which may be geometrically encoded in terms of Coordinates that is a translative function of a critical angle calculation. A root node represents infinite space as well as a point of view calculation that is an independent variable and a translative function of computer readable user's height criterion. The dynamic tetrahedral mesh further comprises edges representing line of sight in critical angle calculations whereby reflectance or refraction attributes of lighting, or virtualized object shadow depths according to real-world object characteristics, or virtual object characteristics of the virtual design environment storage medium, are processed as viewing angel attributes of a focal point object. The processor translates calculations of wavelength nanometers to pixel depths and programmable color quantification thresholding of the focal point object, and further calculates the defocusing or blurred focus of co-boundaries or adjacent nodes. Focal point objects may be represented by plurality of vertices or nodes according to scaling thresholds, thereby simulating virtual object rotation and depth perception data processing transmitted to a mix-reality device rendering a composite view or copy of the interactive virtual design environment, within a real-world environment. The spatial data indexing structure may be further extended into a spatiotemporal querying mechanism by creating one or more copies of at least a portion of the spatial data indexing structure, within a storage medium for providing a composite display within an employee user interface as seen in FIG. 32. The spatiotemporal data indexing structure is created using a composite display of real-world item virtual renditions, and pattern recognition technology, whereby the user is instructed to align real-world items with the virtual items in the composite view, thereby creating a real-time task completion feedback channel with hashed or timestamped datastores.

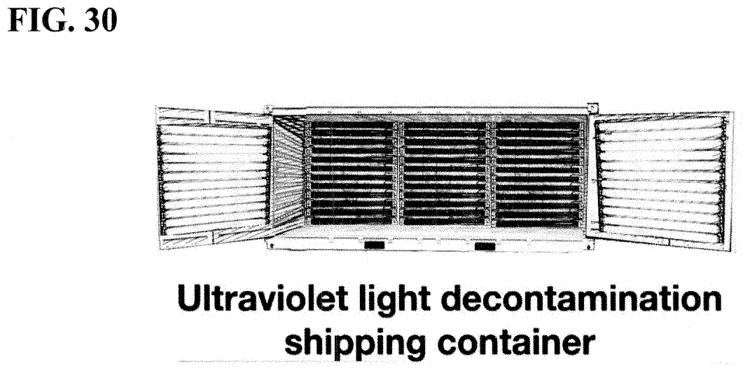

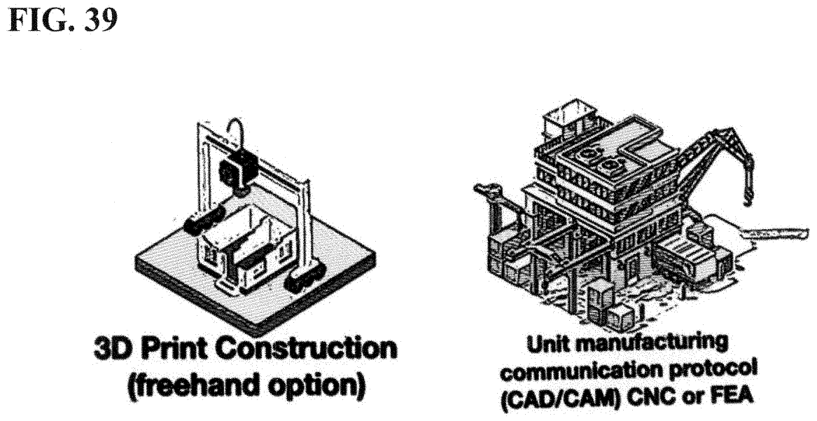

FIG. 30 illustrates an example of various “special effects” that can be added to a modified or modular unit, in the form of a mobile sanitation or medical storage unit that can be added to an event site, featuring UV lights for the decontamination of supplies or products. FIG. 39 depicts examples of manufacturing automation where the manufacturing of modified shipping container units, modular units, mobile units, or the manufacturing of 3D print construction, is partially or fully automated via communication protocols actuated via the integration of technologies such as but not limited of computer aided-manufacturing (CAD), computer aided-manufacturing (CAM) systems, computer numerically controlled (CNC) systems, or finite element analysis (FEA) systems, computer integrated construction (CIC), AutoCAD, or robot programming language. Not shown in the illustrations, are the user's options of adding other mobile or prefabricated elements, such as but not limited to outdoor or indoor flooring, stages, truss, bleachers, amusement park elements, or swimming pools. Other details not illustrated in the wireframes or images, is the implemented use of opensource distributed computing frameworks, cloud-based geostatistics technology, cloud-based data analytics platform, cloud-based API data engineering technology and machine learning algorithms, used to relatively provide real time, or predictive models, in regard to target market data, to the user.

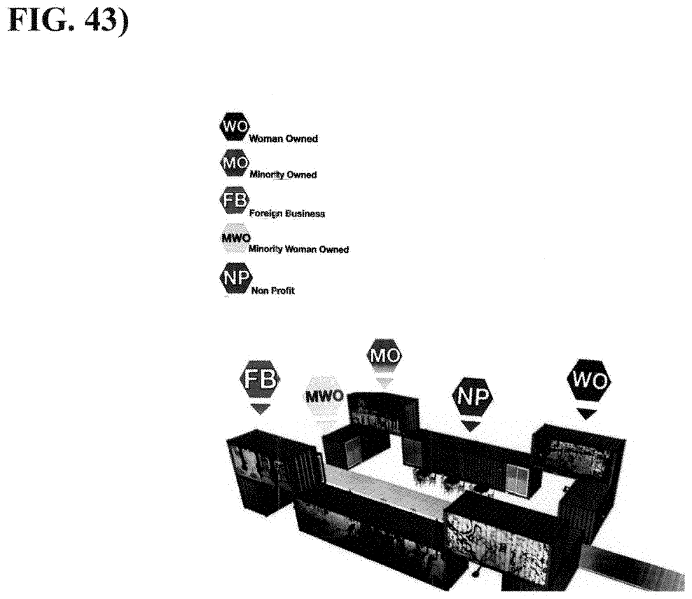

FIG. 43 illustrates a method by which a popup shop proprietorship may be classified in a real-world setting, via a business registration system, and identified by participating consumers via pattern recognition using temporal resolution, pattern recognition, or quick response code scanning, as a composite display according to a method of computer generated perceptual programming by which icons may be presented as an indication of relative proprietorship category identification or information about the respective business.

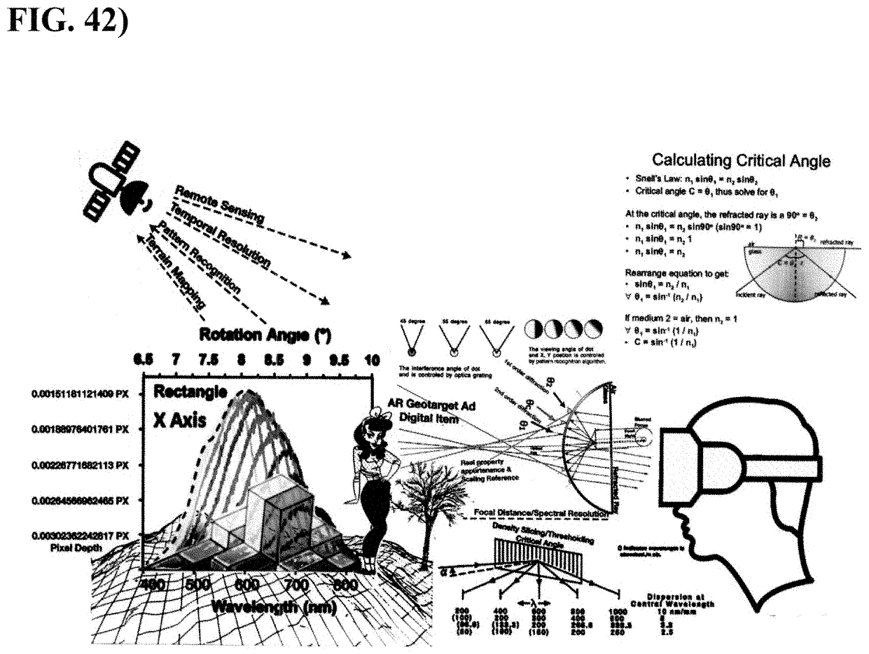

FIG. 42 illustrates an algorithmic function that may allow for a 3D augmented reality experience using augmented reality eyewear technology. The image shows the calculation of the viewer's critical angle, according to the user's height or georeferenced positioning, in relation to real property appurtenances that are identified by pattern recognition algorithms that may include data extracted from methods such as but not limited to, satellite remote sensing, temporal resolution, pattern recognition, or terrain mapping. A geotargeted, 3D spectral resolution of an augmented reality image may appear according to the viewer's georeferenced critical angle according to a real-world object reference point, which may be used as a dataset within a method of density slicing or thresholding, where the wavelength of a color corresponds to pixel depths, mimicking the depth perception and shadow effect of 3-dimensional objects. The distance between the viewer and the real-world object may be used to determine image scaling.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies such as but not limited to a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device (“PLD”) such as a Field-Programmable Gate Array (“FPGA”), Programmable Logic Array (“PLA”), or Programmable Array Logic (“PAL”), or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 8 operating system, Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform, the AutoCAD™ operating system, the AutoLISP™ operating system, the AutoDesk™ operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Client-side and server-side programming languages may include or interface with such but not limited to, Lower-Level, Lisp (LLL), Vyper, Simplicity, Varna, Obsidian, Solidity, WebAssembly (WASM), Rholang, Michelson, Plutus, Julia, R, LISP, Sophia, JSON, Swift, Kotlin, Lua, Laravel, Containers, Golang, Spatio-temporal query language (STQL), Artificial Intelligence Markup Language (AIML), Smalltalk, Prolog, Bash, STRIPS, Planner, POP-11, Haskell, Wolfram, MATLAB, Shell, Object-Oriented Programming (OOP), Interactive Data Language (IDL), Groovy, Delphi, Ada, Lua, ALGOL, Clojure, Visual Basics, COBOL, Objective-C, NIM, OCAML, Reason, RUST, Pony, ELM, Elixir, Syntax, Scheme, NODEJS, PV-Wave, Dart, GDL, Programming Language of Solid Modeling (PLaSM), Python, Cassandra, HTML, TypeScript, JavaScript, Java, MySQL, SQL, CSS, PHP, Ruby, Pascal, Query, XHP, Hack, SAS, Octave, Erlang, HBase, MariaDB, Bigtable, PostgreSQL, HBase, MongoDB, Peri, SQL Server, Django, Cosmos DB, Voldemort, Redis, Scala, Go, C#, C, C++, and XHP. Machine languages may include or interface with such but not limited to MATLAB, Automatically Programmed Tool (APT), G&M Code, Ada, Scratch, Basic, LISP, Prolog, Pascal, Fortran, Ruby, .NET, Hardware description Languages (HDL), Assembly (ASM), Swift, Java, Python, C, C++, C#, Configuration Space (C-space) programming language, Configuration space obstacles (C-Obstacles) programming language. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claim.

1) A computer readable, non-transitory, machine learning, cloud-based, decentralized graph learning economic architectures, graph learning social networks, and mixed-reality environments, of a combined system computer product for developing real-world popup events including popup retail storefronts, popup social commercial events, popup retail malls, mobile popup shop storefronts, or popup franchises, of a dynamic geographic event registry module or storage medium, using any combination or variation of the following methods wherein the improvement comprises;
A) the programmable implementation and/or integration of a non-transitory, machine learning, cloud computable, master account user profile registrar computer product and storage medium for business registration and personal records keeping that include the interoperation of social platform websites, merchant to consumer websites including inventory criterion entries or uploads of product information and images, wherein a registered user is always a primary user of a master account, or a secondary user of a joint-holder master account with permissioned access according to computer readable instructions whereby a master account defines the degree of user privilege that may include access to one or all embodiments featuring virtual development or virtual land development environments, virtual interior design environment access, virtual marketplace environment access, augmented reality advertisement space (ARAS) trading game terminal access, accounting environment access, recruiting service technology API access, payroll and personnel planning data systems (PPDS) access, or marketing content creation environment access, and whereby computer readable instructions for account limitations or permissioned embodiment access, or full account access, defines a primary master account holder or a secondary master account holder of a joint-holder master account
B) the programmable implementation and/or integration of a non-transitory, machine learning, cloud computable statistics module database or content storage medium whereby a target market of a said user profile may be defined according to computer readable instructions or programing language providing functions to mathematical statistics of numeric data that may represent one or a combination of variables such as but not limited to, user behavior datasets, consumer behavior datasets, geospatial demographics datasets, target market datasets, population density datasets, or stochastic modeling datasets, a statistics module database for receiving content of a content storage medium and a content manager for accepting one or more geographic location inputs, where said inputs define boundaries of one or more geographic regions, where statistics module datasets and content of the said storage medium is associated with said geographic regions
C) the programmable implementation and/or integration of a non-transitory, machine learning, cloud computable, social network environment wherein graph learning computer readable instructions may generate a content manager of said statics module datasets, a content manager for social graph hyperedge labels that define connections between a plurality of nodes, nodes representing primary or secondary master account holders
D) the programmable implementation and/or integration of a non-transitory, machine learning, cloud computable data visualization computer product for the computerizable generation of an interactive geospatial data map, or an interactive geographic information system (GIS), or an interactive geospatial data map, or an interactive geographic intelligence system, or an interactive GIS data visualization map
E) the programmable implementation and/or integration of a non-transitory, machine learning, cloud computable aggregated commercial real estate shopping mechanism computer product of a said data visualization computer product, the said data visualization computer product displaying interactive dataset visualizations of a said statistics module database for receiving content of a content storage medium and a content manager for accepting one or more geographic location inputs, where said inputs define boundaries of one or more geographic regions, where statistics module datasets and content of the said storage medium is associated with said geographic regions, wherein computer readable instructions enable access to a real estate listing item shopping environment that may include an aggregation of item selections via the programmable integration or interoperation of one or more multiple listing service (MLS) technologies
F) the programmable implementation and/or integration of a non-transitory, machine learning, cloud computable aggregated commercial real estate shopping environment and preferred property archives polling infrastructure computer product of a joint-user interface, wherein computer readable instructions may enable a plurality of users of a said master account to vote for one or more real property listing items of a preferred property archive list, the said real property listing item with the most votes representing the prospective real property location of one or more popup retail storefronts, or of one or more popup social commercial events or one of a combination thereof
G) the programmable implementation and/or integration of a non-transitory, machine learning, cloud computable image analysis computer product for generating a virtual environment, wherein the datasets of data extracted via the programmable integration or interoperation of one or a combination of following technologies such as but not limited to a MLS technology, geocode databases or storage mediums, a physical geography geographic information module, or remote sensing technology, whereby the said dataset objects are configured to generate a computer rendition of an interactive virtual land development environment, or interactive virtual development environment, the said virtual environment representing a real-world prospective location for a said popup event as an interactive panoramic virtual background, whereby the configurations of computer readable instructions of a virtual agent enable the volumetric design, customization, or addition, of relatively scaled virtualized representations of real property improvement items or popup event concepts as foreground items within a said virtual environment, foreground objects may also denote geotargeted conceptual items of a virtual display within a proximal relativity computer generated perceptual programming mixed-reality environment according to a configuration of computer readable instructions, foreground objects applied via the programmable implementation or integration of a pattern recognition background removal computer product, the virtual environment further comprising of a three-dimensional immersive virtual reality environment embodiment
H) the programmable implementation and/or integration of a non-transitory, machine learning, cloud computable, virtual volumetric architectural design environment for the transmission of schematic rendition data to a physical fabrication medium database in the semi-automated or fully automated fabrication of novelty construction real property improvement items
I) the programmable implementation and/or integration of a non-transitory, machine learning, cloud computable, input device or virtual agent for receiving modified computer aided design data for fabricating product items, according to computer readable customizations applied to a said static imagery cutout foreground object representing a real-world product according to computer readable criterion entry items
J) the programmable implementation and/or integration or a non-transitory, machine learning, cloud computable, bid factor weighting or pricing module for trading either real-world products, or digital goods, or virtual items, or game goods, or a combination thereof within one of a blockchain marketplace environment, or of a block-lattice marketplace environment, or of a virtual game environment, or of a marketplace environment
K) the programmable implementation and/or integration of a non-transitory, machine learning, cloud computable, virtual interior design or virtual land development environment wherein design recommendations are received within a storage medium further comprising either an octree-based data processor, or a binary multidimensional attribute tree (BMAT) data processor, or a spatial indexing data processor, or a geospatial indexing data processor, in the rendition of interactive three-dimensional or volumetric imagery for an improved immersive virtual reality experience
L) the programmable implementation and/or integration of a non-transitory, machine learning, cloud computable, virtual design environment further comprised of a virtual fencing agent for indicating a sector or subsector of virtual space, virtual space of a said interactive virtual design environment, whereby either a virtual sector or subsector indication or allocation may be defined as either a real-world sub-sectoral or a sectoral floor area commercial space product or auction lot item publication within a said commercial space virtual marketplace environment, the computer readable sectoral or sub-sectoral indication or allocation of a commercial space virtualization via the said virtual fencing agent actuating at least one programmable input device whereby either a said sectoral or a said sub-sectoral spatial allocation is further defined for the prospective placement of real-world objects or construction one or a combination of items such as but not limited to, commercial tents, or kiosks, or prefabricated construction units, or modified shipping container units, or modular construction units, or mobile popup shops, or mobile food trucks, or a truss, or a concession stand, or fixtures, or appurtenances, or novelty items, or novelty construction items, or products of a product repository or storage medium, to be placed at a prospective popup event at a relatively proximal or remote geophysical location by a master account holder enabled to perform computable functions defining a bidder or procurer of real-world sectors or subsector commercial space items a within a said commercial space virtual marketplace environment according to a configuration of computer readable instructions
M) the programmable implementation and/or integration of a non-transitory, machine learning, cloud computable, virtual shelf space marketplace environment wherein a virtual fencing agent overlaying a shelving item, or at least one input device defines a shelf space product publication of a real-world shelving item, the computer readable procurement of a shelf space product of a virtual shelf space marketplace environment product publication, representing the placement of inventorial product for commercial use at a said popup event remote geophysical location
N) the programmable implementation and/or integration of a non-transitory, machine learning, cloud computable, mixed-reality interior design and land development virtual environment and path planning computer product, wherein the configuration of computer readable non-transitory instructions of a said interactive virtual design environment computer product enables the drafting of object placement and orientational path planning instruction metadata, metadata describing the orientation or positioning of a real-world object corresponding to the representational real-world object virtualization's positional orientation metadata of the said virtual design environment storage medium, receiving within a storage module one or a combination of real-world interior design instructions, or land development instructions, or landscaping instructions, and real-world object placement instructions of pattern recognition computer generated perceptual programming
O) the programmable implementation and/or integration of non-transitory, machine learning, cloud computable, accounting service technology, personnel administrations technology, PPDS technology integrations of a combined system computer product wherein the automation of electronic disbursing of one or more employee payments of a simplified payments verification system are facilitated via stochastic tracking, temporal querying, or spatiotemporal querying mechanisms, one or a combination thereof configuring a location based worklog
P) the programmable implementation and/or integration of a non-transitory, machine learning, cloud computable, event planning mechanism and autonomous or non-autonomous vehicle route alignment system computer product wherein the configuration of computer readable instructions enable vehicle routing of a volumetric design of a mobile popup shop or a mobile food truck, a volumetric design representing a real-world object within an interactive virtual design environment further comprising a task schedule database having a plurality of entries
Q) the programmable implementation and/or integration of a non-transitory, machine learning, cloud computable popup event payments environment or opensource spatiotemporal graph learning computer generated perceptual programming gaming terminal of a mix-reality interactive content module a wherein a user's identity is associated with a block header relative to a local block-lattice of a proximal popup event, a popup event of an interoperating or integrated event planning module wherein event entries are associated with a geographic location
R) the programmable implementation and/or integration of a non-transitory, machine learning, cloud computable, popup retail storefront or popup event proximity based selective content dissemination, or stochastic selective marketing content dissemination and ticketing system computer product for directing an autonomous or non-autonomous vehicle for hire, wherein computer readable instructions, may enable the configuration of a content creator and manager for accepting geographic locations, a content creator further accepting criterial inputs for the facilitation, or the solicitation, of consumer participation at a relatively proximal popup event, or at a relatively proximal popup storefront geographic location, a consumer represented by a dataset of a statics module database, from which to target consumer nodes representing mobile devices, or mixed-reality devices, or hyper-reality devices, or neurotechnology, or a combination thereof in particular localities with appropriate advertisement or promotional digital content, or with content of a computer generated perceptual programming module, receiving within an image or content processing medium of a consumer node, superimposed computer-generated images in a real-time composite display of real-world images
S) the programmable implementation and/or integration of a non-transitory, machine learning, cloud computable, geotargeting computer product for selective content dissemination
T) the programmable implementation and/or integration of a non-transitory, machine learning, cloud computable, geotargeting computer product for selective content dissemination wherein a configuration of computer readable instructions may enable a said user of a master account holder, to act as a buyer within an interoperating virtual goods marketplace environment wherein the virtual good is a non-physical object containing the digital likeness of a seller, the seller represented by a second user of a non-master account user interface, a seller with relative influence in respect to a said target market, influence represented by computer generated or computer readable dataset object data correlations of a statistics module, or data engineering module
U) the programmable implementation and/or integration of a non-transitory, machine learning cloud computable, modified shipping container unit archiving and repurposing recommendation system for providing archived unit reuse recommendations or for facilitating intersystem trade of shipping container construction units between master account holders as a virtual marketplace environment, according to a configuration of computer readable instructions
V) the programmable implementation and/or integration of a non-transitory, machine learning, the programmable implementation or integration of a computer-generated perceptual programming content creation medium computer product, wherein computer readable instructions enable the generation of interactive augmented reality theming elements for a popup retail storefront, or for a popup event geophysical location
W) the programmable implementation and/or integration of a non-transitory, machine learning, cloud computable, decentralized blockchain augmented reality advertisement space (ARAS) marketplace and gaming terminal wherein computer readable instructions are configured to enable the cryptographic trade of virtual goods amongst players, players represented by a said master account holder, a virtual goods package including supplemental content of a content creator and manager for accepting geographic locations wherein a virtual good is a non-physical item geotagged to a geophysical area whereby said content is geotargeted or selectively transmitted to one or more mobile devices or mixed-reality devices, or hyper-reality devices, or neurotechnology device, or a combination thereof, of relatively proximal target audience
X) the programmable implementation and/or integration of a non-transitory, machine learning, cloud computable virtual environment computer product for creating architectural schematics of an interactive modular storefront high-rise or midrise smart building wherein computer readable instructions of an interactive virtual design environment are configured to design a real-world interactive modular storefront high-rise or midrise smart building wherein steel frame modules of a floor level floorspace are interchangeably occupied by modular popup retail storefront units or vacated according to the computer readable instructions of a steel module unit space auction scheduling medium or a commercial space virtual marketplace environment storage medium of a deep learning blockchain auctioning system
Y) the programmable implementation and/or integration of a non-transitory, machine learning, cloud based, biotechnology or biometric enrollment system, sentinel surveillance enrollment system, serosurveillance enrollment system, ticketing system technology, or temporal querying consensus protocol enrollment system, or a spatiotemporal querying consensus protocol of a combined system computer product, one or a combination thereof configured for use within one or a combination of technological architectures such as but not limited to a decentralized smart wallet cloud payment or a simple payment verification (SPV) environment, or spatiotemporal local block-lattice peer-to-peer query processing cloud-based storage medium for accepting geographic location inputs and opensource gaming platform content for geotargeted or spatiotemporal block-lattice gaming of a popup event, whereby the gaming status of a consumer user node updates the spatiotemporal local blockchain, the said gaming status associated with a hash value data of the said spatiotemporal block-lattice, or directed acyclic graph (DAG), the said hash value associated with a product discounting mechanism whereby game status, or game currency, or game tokens, or a cryptocurrency, or a combination thereof may provide discounted product purchase, or an admissions ticketing discount, or an event registrations discount, or a complementary purchase, one or a combination thereof relating to a respective popup event, or a popup retail location, or a plurality of popup events, or a plurality of popup retail locations
Z) the programmable implementation and/or integration of a machine learning, cloud computable decentralized blockchain or block-lattice ARAS marketplace environment computer product

2) A method of claim 1A wherein the method comprises:
the programmable implementation and/or integration of a machine learning, cloud computing, master account registrar computer product, comprised of enterprise integration technologies, business registration technologies, and personal records keeping technologies, functioning as a combined system or computer product that may form a cloud-based content storage medium, wherein a master account profile may be defined by username criterion and correlative dataset extractions from a statistics module or via other criterion entry items that may actuate one or more communication protocols, or one or more application programming interfaces (API), or other integrative programming languages, one or a combination of criterion entry items such as but not limited to one or more uniform resource locators (URL) embedment(s) or URL links, one or more query items, one or more hyperlinked icon selection options, or the programmable interoperation or integration of one or more, social platform websites, one or more merchant to consumer e-commerce websites, or of one or more merchant to consumer e-commerce platform websites, along with relative criterial inputs, metadata, or uploads of product inventory data that may include details such as but not limited to, product images, product stock keeping unit (SKU) information, product sizing and dimensions, product color, pricing, product type, product category or product weight, whereby a product inventory repository, or archive, image storage medium, or storage medium associated with a registered business of a master account may be generated according to computer readable instructions.

3) A method of claim 1B wherein the method comprises:
the programmable implementation and/or integration of a machine learning, cloud computable, storage media statistics module database whereby data extractions define variables of a generated framework including datasets representing a target audience profile, or a consumer profile, or a constituency profile, or a target market profile, or a target population profile, one or the combination thereof generated according to relatively correlative datasets of a said master profile's criterion, datasets via data extractions further acquired via the programmed interoperation or integration of one or a combination of technologies such as but not limited to, statistics mining technologies, statistics engineering technologies, cloud-based geostatistics technology, cloud-based data analytics technology, real-time cloud-based API data engineering technology, campaign management analytics, social graph technology, graph learning technology, users statistics engineering technology, user behavior tracking technology, webhook technology, demography data engineering technology, web scrapping technology, ecommerce order placement technology, consumer behavior tracking technology, cookie compliance systems, campaign management analytics technology, social demography data engineering technology, geospatial data engineering technology, geospatial demographic data engineering technology, spatiotemporal data engineering technology, serosurveillance technology, biometric surveillance technology, sentinel surveillance technology, stochastic model data engineering technology, predictive data engineering technology, or conversation tracking technology.

4) A method of claim 1C wherein the method comprises:
the programmable implementation and/or integration of a machine learning, cloud computable, social network environment, content manager and storage media computer product, wherein access to a data store of information corresponding to one or more of a plurality of users represented by a master account, users of a said social network environment and one or more of a plurality of relative dataset concepts such as but not limited to, master account criterion, or said target market datasets relative to a master account, that may further comprise of a plurality of nodes that each correspond to a respective user, and a set of said dataset concept nodes that each correspond to a respective said dataset concept, each node of the sets of nodes being associated with a corresponding structured criteria, and a plurality of edges that each define a connection between a corresponding pair of nodes from the plurality of nodes; for each of one or more users of a master account identifiable via a surveying process by one or more of the computing systems according to one or more candidate items of said dataset content stored or identified by one or more of the computing systems, content managers, or databases of a said social network environment, wherein computer readable instructions, stored on a non-transitory computer readable storage medium, may enable a master account holder to engage in a collaborative join-user interface of two or more master accounts, within one or more embodiments of a said decentralized economic system, social network and virtual environment for developing real-world popup retail storefronts, popup social commercial events, or popup franchises, wherein computer readable instructions may be configured to generate a content storage medium joint-user profile to receive input data including at least a portion of one or more source works, and store said input data into a joint-user profile associated with the portion of the one or more source works.

5) A method of claim 1D wherein the method comprises:
the programmable implementation and/or integration of a machine learning, cloud computable, data visualization computer product, for computerizable generation of an interactive geospatial data map, or an interactive GIS, or an interactive geographic intelligence system, or an interactive GIS data visualization map, for allocating various population densities according to mathematical statistics of numeric data that may represent variables such as but not limited to, relative consumer demand datasets, consumer behavior dataset, or target user behavior datasets, wherein computer readable instructions stored on a non-transitory computer readable storage medium, further comprising communication protocols or computer readable instructions that may enable the generation, or the configuration of an interactive data display, of a georeferenced data display, or of a georeferenced display of one or more areal indications, via the configuration of a dataset display filtering mechanism, dataset extractions acquired via the programmable integration or interoperation of one or a combination of data engineering technologies or data mining technologies such as but not limited to, opensource distributed computing frameworks, cloud-based geostatistics technology, geospatial demographics engineering technology, cloud-based data analytics technology, cloud-based API data engineering technology, cookie compliance technology, campaign management analytics technology, social graph technology, users statistics, conversation tracking technology, demography data engineering technology, serosurveillance technology, biometric surveillance technology, sentinel surveillance technology, relative predictive modeling technology, spatiotemporal data engineering technology, footfall data engineering technology, consumer behavior tracking technology, stochastic modeling technology, graph learning technology, or web scrapping technology.

6) A method of claim 1E wherein the method comprises:
the programmable implementation and/or integration of a cloud computable, machine learning, aggregated commercial real estate shopping mechanism computer product, comprised of the integration or interoperation of one or more multiple listing service (MLS) systems or technologies that may further comprise one or a combination of an interactive dataset object map, or an interactive GIS technology, or an interactive GIS data visualization map technology, or an interactive geospatial data map technology, or an interactive location intelligence technology, wherein computer readable instructions stored on a non-transitory computer readable storage medium, may enable the generation or configuration of an interactive data display of georeferenced datasets, or of a georeferenced display of one or more areal indications, by a filtering mechanism for the visualization of datasets, datasets acquired via the integration or interoperation of statistics modules, or of data mining technologies or one or a combination of data engineering technologies such as but not limited to, opensource distributed computing frameworks, cloud-based geostatistics technology, geospatial demographics engineering technology, cloud-based data analytics technology, cloud-based API data engineering technology, cookie compliance technology, campaign management analytics technology, social graph technology, users statistics technology, conversation tracking technology, demography data engineering technology, serosurveillance technology, biometric surveillance technology, sentinel surveillance technology, relative predictive modeling technology, spatiotemporal data engineering technology, footfall data engineering technology, consumer behavior tracking technology, web scrapping technology, or joint probability distribution data engineering technology, joint probability distribution data configured in the graphical display of areal indications according to the programmable implementation or integration of graph learning models, such as but not limited to, a Marklov Random Field (MRF) model wherein each node in the lattice corresponds to a geographic area such that neighboring nodes correspond to neighboring geographic areas, and each state variable representing an estimate of a number of mobile devices being used in a corresponding geographic area based on said dataset objects describing mobile devices being used in the geographic area, applying, by a computer processor, an observation of a number of mobile devices currently within the geographic area to the MRF model to produce an estimate of a number of mobile devices currently being used within the geographic area, and storing the estimated number of mobile devices currently being used within the geographic area in a computer-readable storage medium, or in the graphical display for areal indications of a gravity based spatial interaction model or Huff model wherein the cells define regions on the map and are overlapping or non-overlapping, and wherein each cell of the plurality of cells has the same predefined dimensions, for each cell of the plurality of cells, wherein cells are foreground objects generated according to a relative pixel value outlining cell regions that may be resized according to the number of pixels defined by a computer readable data display zoom factor of an image frame, calculate an aggregate attribute value for the cell, based at least in part upon the selected attribute and zero or more data objects associated with the selected attribute and locations within the region defined by the cell to determine shading for each of the plurality of cells based at least in part on the aggregate attribute values of the cells to generate data for rendering a grid-based heatmap on the interactive data visualization map, wherein each of the plurality of cells is associated with a corresponding aggregate attribute value and a corresponding shading based on the corresponding aggregate attribute value and transmit the generated data for rendering the heatmap to the client computing device to be overlaid on the said interactive dataset object map, transmit the georeferenced display of one or more geocode indicators, corresponding to geocodes of a said MLS system property listing publication geocode database or storage medium, or transmit dataset values which may denote the allocation of various population densities of individuals that may be represented by a said target market profile criterion that may exhibit relative demand according to relative criterion correlations of a said master account or joint-holder master account in relation to computer readable target user behavioral datasets, or computer readable consumer behavioral datasets, whereby the generation of overlapping or non-overlapping heatmap areal indication overlays, or the computer rendition of a georeferenced display of geocodes is enhanced, and may further denote prospective real property location indications of a programmable interactive visual display, candidate real property listings that may be respectively suitable or eligible selection options for the real-world development, rent or procurement of one or more prospective popup shops, popup event venues, or popup social commercial event venues according to entered criterion or entries of one or more MLS systems, further comprising computer readable instructions that may allow for the interaction of, the indication of, or the selection of, predefined dimensions of the plurality of cells by a user.

7) A method of claim 1F wherein the method comprises:
the programmable implementation and/or integration of a cloud computable, machine learning, primary account joint-user aggregated commercial real estate shopping and preferred property selection polling infrastructure and computer product, comprised of the integration or interoperation of one or more MLS systems or technologies, that may further comprise of one or a combination of an interactive dataset object map, an interactive GIS technology, an interactive GIS data visualization map technology, an interactive geospatial data map technology, or an interactive location intelligence technology, wherein computer readable instructions stored on a non-transitory computer readable storage medium, may enable the generation or configuration of a data display, of a georeferenced datasets, or of a georeferenced display of one or more areal indications, by a filtering mechanism for the visualization of datasets, datasets acquired via the integration or interoperation one or a combination of data mining technologies or data engineering technologies such as but not limited to, opensource distributed computing frameworks, cloud-based geostatistics technology, geospatial demographics engineering technology, cloud-based data analytics technology, cloud-based API data engineering technology, cookie compliance technology, campaign management analytics technology, social graph technology, user statistics technology, conversation tracking technology, demography data engineering technology, serosurveillance technology, biometric surveillance technology, sentinel surveillance technology, relative predictive modeling technology, spatiotemporal data engineering technology, footfall data engineering technology, consumer behavior tracking technology, web scrapping technology, or joint probability distribution data engineering technology, joint probability distribution data configured in the graphical display of areal indications of a Marklov Random Field (MRF) model wherein each node in the lattice corresponding to a geographic area such that neighboring nodes correspond to neighboring geographic areas, and each state variable representing an estimate of a number of mobile devices being used in a corresponding geographic area based on said dataset objects describing mobile devices being used in the geographic area, applying, by a computer processor, an observation of a number of mobile devices currently within the geographic area to the MRF model to produce an estimate of a number of mobile devices currently being used within the geographic area, and storing the estimated number of mobile devices currently being used within the geographic area in a computer-readable storage medium, or in the graphical display for areal indications of a gravity based spatial interaction model wherein the cells define regions on the map and are overlapping or non-overlapping, and wherein each cell of the plurality of cells has the same predefined dimensions, for each cell of the plurality of cells, calculate an aggregate attribute value for the cell, based at least in part upon the selected attribute and zero or more data objects associated with the selected attribute and locations within the region defined by the cell to determine shading for each of the plurality of cells based at least in part on the aggregate attribute values of the cells to generate data for rendering a grid-based heatmap on the map, wherein each of the plurality of cells is associated with a corresponding aggregate attribute value and a corresponding shading based on the corresponding aggregate attribute value and transmit the generated data for rendering the grid-based heatmap to the client computing device to be overlaid on the said interactive dataset object map, wherein the predefined dimensions of the plurality of cells are indicated by a user, or in the computer executable georeferenced display of one or more geocodes, geocodes relating to a said MLS system property listing publication which may denote the allocation of various population densities of individuals that may belong to a said target market that may exhibit relative demand according to matching criterion of a two or more said user profiles or the matching criterion of two or more said second user primary account joint-user profiles, in relation to user behavior, or consumer behaviors, whereby the generation of areal indications, or the computer rendition of a georeferenced display of geocodes is in enhanced, and may further denote prospective real property location indications of a programmable visual display, prospective real properties that may be respectively suitable or eligible selection options in the real-world development, rent or procurement for one or more popup shops, popup event venues, or popup social commercial event venues according to entered criterion, whereby preferred property listing selections are archived in a memory medium wherein non-transitory computer readable instructions of a polling infrastructure facilitate user input of a plurality of users in regards to archived preferred property selections, allowing for dynamic changes to that input while concurrently ranking preferred property selections according to real-time response data.

8) A method of claim 1G wherein the method comprises:
the programmable implementation and/or integration of a machine learning, cloud computing, image analysis computer product for generating a virtual environment wherein land development recommendations are received within a storage medium at least in part according to real-world environment geophysical datasets, the said virtual environment further comprising computer readable instructions that enable three-dimensional modeling for an improved virtual reality experience, real-world geophysical datasets acquired via the programmable interoperation or integration of one or more MLS databases, or via the programmable interoperation or integration of physical geography geographic information modules, or via the programmable interoperation or integration of a geocode database or storage medium, or of data mining technologies, or of data engineering technologies, one or a combination of such but not limited to, satellite terrain mapping technology, or satellite surveying technology, or remote-sensing, or satellite topology data engineering, or pattern recognition technology, or satellite imagery incorporated in the building of a three-dimensional graphical computer model dataset directory, datasets defining one or more natural characteristics of the said landscape area to be implemented in the virtual rendition of a said virtual environment representing the landscape of the said real-world environment, wherein the directory comprises information regarding various locations within the landscape of the said real-world environment, the information based on natural characteristics of each of the various locations within the landscape of said real-world environment wherein the three-dimensional graphical computer model comprises of a spatial indexing data structure, or active tree nodes of an octree data structure that are optimized for viewing angles according to critical angle calculations of reflectance or refraction attributes of lighting according to viewer high criterion, or virtualized object shadow depths according to said real-world landscape's geophysical characteristics, shadow depths and critical angle viewing angel attributes translating to pixel depths or virtual object rotation transmitted to a mix-reality device, the said storage medium further receiving via non-transitory computer readable instructions information about a said popup event concept items or products of criterion entries which may include one or more appurtenances, or one or more amusement appurtenances, or one or more amusement fixtures, or one or more fixtures, or one or more real property improvements, or one or more real property construction items, further configured to receive criterion or query inputs, or configured to receive rendering data transmissions facilitating remote interactions between a plurality of client systems and a server system over a communication network within an API, opensource, or an integrative programming communication protocol with one or more, merchant websites, e-commerce platforms, or product storage mediums of a marketplace environment, said popup event concept items incorporated into the said virtual environment as a scaled virtualized foreground static image cutout objects representing real-world objects to be subsequently incorporated into the respective the real-world landscape area, the said real-world area represented by the said panoramic rendition and interactive background of the virtual environment, said scaled virtualizations of real property construction items of a popup concept such as but not limited to, a truss, or a customizable commercial tent, or a commercial stand, or a modified shipping container construction unit, or a modular shipping container construction unit, or a prefabricated construction unit, or a novelty construction item, a novelty construction item represented by a static image cutout virtual object, or a modified construction unit, or a mobile construction, or a commercial kiosk, or an amusement appurtenance, recommended at least in part on the matching criterial inputs, or at least in part by information about the natural characteristics of one of the various locations of the said real-world landscape represented by the said virtual environment, further comprising of a said control panel, or at least one input device, a device wherein computer readable instructions stored on a non-transitory computer readable storage medium may enable the use of at least one input device adapted to receive at least one space, gesture, text, a said static imagery cutout of a background removal computer product, and touchscreen inputs, wherein a computer processor adapted to execute a program stored in a computer memory, the program being operable to provide instructions to the computer processor including receiving user input via the at least one input device, wherein the user input underspecifies a command for a virtual agent within the said virtual environment to use in moving at least one target virtualized foreground object in the said virtual environment; interfacing with the said virtual environment via a virtual agent, sensing by the virtual agent, the at least one said virtualized foreground object representing a said real-world object or product item in the said virtual environment, and finding at least one valid location for the virtual agent to place the at least one said virtualized foreground object in the said virtual environment wherein determining at least on one valid location includes retrieving a computational linguistic placement constraint, identifying the virtual agent's intent for a target object, identifying a placement preference for the virtual agent, determining one or more said virtualized foreground object properties of the target virtualized foreground object and determining candidate placement surfaces for placement of the target foreground object, the placement of which may thereby be further configured to receive criterion or query inputs, or configured to receive rendering data transmissions facilitating remote interactions between a plurality of client systems and a server system over a communication network within an API, opensource, or an integrative programming communication protocol with one or more, merchant websites, e-commerce platforms, recruitment service technologies, or order placement technologies, or order fulfillment technologies, that may appear as selectable options within a list of one or more search return items such as but not limited to target foreground object relative products, manufactures, vendors, contractors, suppliers, architects, freelancers, or three-dimensional print construction companies, or a modified shipping container archiving and repurposing recommendation marketplace system.

9) A method of claim 1H wherein the method comprises:
the programmable implementation and/or integration of a cloud computable, machine learning, virtual volumetric architectural design environment for facilitating remote interactions between a plurality of client systems and server systems over a communication network, wherein a control panel or computer readable instruction stored on a non-transitory computer readable storage medium of a said virtual environment, further comprising computer readable instructions that enable three-dimensional modeling for an improved virtual reality experience generating rendering data within an integrated or interoperating architectural design module that visually describes one or more virtual architectural elements in relation to pattern recognition data of a said static imagery cutout virtual foreground object representing a novelty construction real property improvement item, a virtual environment representing a real-world location, identifying real-world physical dimensions of a portion of the said virtual environment wherein the virtual architectural element is renderable within the portion of the said virtual environment within a scaling threshold based in part on the said geophysical datasets of a said real-world environment, transmitting rendering data to a mixed-reality device, computer readable instructions that may further enable the actuation of integrative communication protocols with order form submission technology, order fulfillment drop shipping technology, shipment tracking technology, or communication protocols wherein computer readable instructions may enable a configuration of the said control panel device, or configurations of computer readable instructions that may enable the transmission of schematics and mathematical or programmable rendering data to a database of a physical fabrication medium to provide functions of a generated building schematic breakdown, or of a geometry breakdown, of generated framework variables in a programmable integration of one or a combination of technologies such as but not limited to, a computer aided-design (CAD) system, an AutoCAD technology, a computer integrated construction (CIC) system, a computer aided-manufacturing (CAM) system, a computer numerically controlled (CNC) system, 3D printing technology, a robot programming language, or a finite element analysis (FEA) system, in the partial or total automation of the design, manufacturing, modification, or fabrication of a physical real property improvement item as part of the subsequent development of a said popup event at a said real-world environment located at a remote location.

10) A method of claim 1I wherein the method comprises:
the programmable implementation and/or integration of a machine learning, cloud computable, non-transitory computer aided design system for creating customized products wherein a said static imagery cutout virtual foreground object represents a real property improvement item within a virtual environment, a virtual environment representing a real-world location, comprising a virtual control panel wherein computer readable instructions stored on a non-transitory computer readable storage medium may enable the implementation of a pattern recognition mechanism, or a background subtractor mechanism, further actuating the scaling thresholds of a virtual environment by which the sizing of the said static image cutout virtual object is categorized as one of such but not limited to, a print, a cardboard cutout, a signage item, a sculpture, a novelty sculpture, a 3-dimensional foam sculpture, a 3-dimensional print object, a promotional float, a novelty construction, or a promotional balloon, the selection or indication of which may thereby generate a selectable list of one or more relative servicers, vendors, manufactures or suppliers, via one or a combination of integrated merchant websites, merchant website platforms, recruitment service technologies, or may further actuate an integrative communication protocol with one or a combination of technology systems such as but not limited to, an order form submission technology, an order fulfillment drop shipping technology, a shipment tracking technology, or may further actuate communication protocols of an integrated or interoperating information processing device machining computer product using modeling logic executing on a processor circuit, transmitting schematics and rendering data to a database of a physical fabrication medium to provide functions of a generated building schematic breakdown, or of a geometry breakdown, or of generated framework variables, or of a three-dimensional model of product, the three-dimensional model associated with model data stored in a non-transitory storage medium, an integrated or interoperating information processing device machine computer product database such as but not limited to, computer aided-design (CAD) programs, or computer aided-manufacturing (CAM) systems, or computer numerically controlled (CNC) systems, or 3D printing technology, AutoCAD technology, or computer integrated construction (CIC) systems, or robot programming language, or finite element analysis (FEA) systems, or a combination thereof in the partial or total automation of the physical design, manufacturing, modification or fabrication of a said scaled translated digital image cutout virtual real property improvement item, of a said virtual environment.

11) A method of claim 1J wherein the method comprises:
the programmable implementation and/or integration of a machine learning, cloud computable, bid factor weighting or pricing module computer product wherein either weighting, or a dataset price valuation, or a relative price valuation is assigned to either a virtual item, or to a virtual good, or to an item of a product repository or storage medium, or to a bid factor, according to dataset variables of data extractions, for trading virtualized representations of real-world objects as item publications, or for trading virtual items, or trading virtual goods, or for trading digital goods, or for trading game goods, or real-world items, one or a combination thereof within a virtual item trading system of a virtual marketplace environment, or of a decentralized graph learning cryptographic marketplace environment, or of a virtual game environment whereby the said dataset data is extracted via the programmed interoperation or integration of one or more statistics modules for either the weighting of bid factors, or for the pricing of said virtual items, or said virtual goods, or of said virtual game goods, or said real-world items, or said products of one or more repository modules or storage mediums, for the trade of said virtual items, or said virtual goods, or said digital goods, or said game goods, or said product items of a product repository, one or the combination thereof within one or more said virtual marketplace environments, or of one or more said virtual game environments, or of one or more said decentralized graph learning cryptographic virtual marketplace environments including those of such but not limited to one of a distributed blockchain ledger architecture, or of a block-lattice architecture, or of a spatiotemporal directed acyclic graph (DAG) architecture, or of a local blockchain architecture, or of a temporal graph architecture, or of a DAG block architecture, or of a undirected block graph architecture, or of a public blockchain architecture, or of a private blockchain architecture, or of a consortium blockchain architecture, or of a hybrid blockchain architecture, of a platform comprising a plurality of activity engines determining that one of payment information, or of transaction information, or of query information, or a combination thereof received by the network node device satisfies, or does not satisfy, a threshold associated with the activity engine and tagging via each activity engine of the plurality of activity engines, the payment information, or the transaction information, or the query information, one or all supplemented by an identifier associated with a block or a chain of blocks of the activity engine, wherein the identifier indicates that the payment information, or the transaction information, or the query information, one or the combination thereof satisfied or did not satisfy the threshold associated with the activity engine, a shared data layer of a blockchain network, or a shared data layer of a block-lattice network wherein the shared data layer is configured to store validated transactions, or validated payments, or validated query information, one or a combination thereof in a blockchain or in a block-lattice, wherein the validated transactions comprise a plurality of block entries including computer executable instructions and associated validation data, and a shared protocol layer of the blockchain network, or of the block-lattice network connected to the shared data layer configured to receive a transactional request, or to receive a payment request, or to receive a query, or to receive information request, one or a combination thereof for an executable instruction stored in one of a plurality of block entries in a blockchain, or in a block-lattice, or in a computer readable relative valuation pricing module, or in a dataset valuation pricing module, or in a bid factor weighting module, or in a combination thereof whereby computer readable instructions stored on a non-transitory computer readable storage medium may cause a computer to perform a method for receiving a plurality of bids, or payments, or queries, or information, or other transactions, one or a combination thereof from one or more users represented by a master account, or from a non-master account holder user, receiving within a said virtual marketplace environment for the trade of one or a combination of virtual items such as but not limited to, a said virtualized representation of a real-world object, or of a said real-world object, or of a said virtual product item or a product repository, or of a said game good, or of a said virtual item, or of a said digital good such as but not limited to, an ARAS virtual item that is geotagged to a real-world location representing an area geotargeted for the selective content dissemination of either or a combination of digital or augmented reality advertisement content, or of a real-world shelf space availability item publication or auction lot item publication of a decentralized blockchain virtual marketplace environment, or of a real-world shelf space availability item publication of a block-lattice virtual marketplace environment, or of a real-world shelf space availability item publication of a virtual marketplace, or of a real-world commercial space availability item publication of a decentralized blockchain virtual marketplace environment, or of a real-world commercial space availability item publication of a block-lattice virtual marketplace environment, or of a real-world commercial space availability item publication of a virtual marketplace, or of a virtual game item of a decentralized blockchain or block-lattice virtual game terminal, or of a virtual game item of a virtual game environment, or of a static imagery virtual item containing a relatively marketable individual's likeness of a blockchain or block-lattice likeness virtual item marketplace environment, or of a static imagery virtual item containing a relatively marketable individual's likeness of a likeness virtual item marketplace, or of a videography content virtual item containing a relatively marketable individual's likeness of a decentralized blockchain or block-lattice likeness virtual item marketplace environment, or of a videography content virtual item containing a relatively marketable individual's likeness of a likeness virtual item marketplace, or of a virtual real estate product or item of a decentralized blockchain or block-lattice virtual marketplace or virtual game environment, or of a virtual gaming product of a decentralized blockchain or block-lattice virtual marketplace environment, or of a virtual real estate product or item of a virtual marketplace or virtual game environment, or of an open graph (OG) product of a decentralized blockchain or block-lattice virtual marketplace or virtual game environment, or of an open graph (OG) product of a virtual marketplace or virtual game environment, or of a product repository or storage module item of a virtual marketplace environment, or of a product repository or storage module item of a decentralized blockchain or block-lattice virtual marketplace environment, wherein block headers, nodes, or hypernodes of one or all of the said blockchain or block-lattice virtual marketplace architectures are associated with user or master account holder user identifiers, or non-master account holder user identifiers, wherein hash value identifiers, graph edges, or hyperedges of one or all of the said blockchain or block-lattice virtual marketplace architectures are associated with said datasets of said data extractions, said data extractions acquired via the programmable interoperation or integration of statistics modules, or of one or a combination of data mining or computer readable data engineering methods or technologies, such as but not limited to, machine learning algorithms, cloud-based geostatistics data engineering technologies, graph learning technology, stochastic modeling data engineering technologies, consumer behavior data engineering technologies, cloud-based data analytics technologies, cloud-based API data engineering technologies, cloud-based API real-time data engineering technologies, cookie compliance data engineering technologies, campaign management analytics data engineering technologies, social graph technologies, users statistics tracking technologies, conversation tracking technologies, geospatial data engineering technologies, geospatial demographic data engineering technologies, spatial demographic data engineering technologies, serosurveillance technologies, biometric surveillance technologies, sentinel surveillance technologies, spatiotemporal data engineering technologies, predictive modeling data engineering technologies, or web scrapping data engineering technologies, data extractions whereby the collectable data structure can be configured to define a virtual item's, or a game good's, or a virtualized real-world object's attributes, or to define either a valuation related to the price value data of a dataset valuation pricing module, or may be configured to represent a variable within a bid factor weighting model of bid factor weighting module, or may be configured to represent a variable within a relative valuation model of a relative price valuation pricing module, or may be configured to represent a variable of a relative pricing module, or a combination thereof configured via non-transitory computer readable instructions.

12) A method of claim 1K wherein the method comprises:
the programmable implementation and/or integration of a machine learning, cloud computable interactive virtual design and land development environment computer product wherein interior design recommendations are received within a storage medium at least in part according to at least one input device or virtual agent configured to receiving an image-based query the image data including virtualized representations of real-world furnishing products, or of real-world furnishing items, or of real-world furnishing items, or of real-world fixtures, or of real-world appurtenances, of an integrated or interoperating real-world product or object repository or storage medium, or of an integrated or interoperating virtual product or item repository or storage medium, one or a combination thereof received within the said interactive virtual environment, the said virtual environment representing a prospective real-world environment rendered according to datasets of data set extractions acquired via the programmable integration or interoperation of one or a combination of data mining or data engineering data storage modules or data storage mediums, one or a combination of dataset data extractions such as but not limited to static imagery image analysis data, real-time image and video processing data, remote sensing image processing data, pattern recognition image processing data, or satellite terrain mapping data, wherein the three-dimensional graphical computer model comprises active tree nodes of either an octree spatial data structure, or of a spatial data indexing structure, or a binary multidimensional attribute tree (BMAT) of a 3D symmetric traceless tensor field multidimensional data indexing structure, or hybrid spatial data structures that are optimized for the computable calculations of viewing angles according to topological relations and connectivity wherein either a dynamic tetrahedral mesh, or a dynamic polygonal mesh, or a dynamic tensor mesh, is comprised of octants or nodes representing datasets for visual focal points, that are points or vertices which may be geometrically encoded in terms of one or a combination of Euclidean distance calculations, eigenfunction hyperstreamline calculations, or in terms of Coordinates that is a translative function of a critical angle calculation wherein the root node represents infinite space as well as a point of view representing either a vector axiom schema or as a translative function according to computer readable user height criterion entries, the dynamic mesh further comprising edges representing line-of-sight in critical angle calculations whereby reflectance or refraction attributes of lighting, or virtualized object shadow depths according to real-world object characteristics, or virtual object characteristics, are processed as viewing angel attributes of a focal point object, translating calculations of wavelength nanometers to pixel depths and programmable color quantification thresholding of the said focal point object, and the defocusing or blurred focus of co-boundaries or adjacent nodes according to scaling thresholds, focal point objects that may be represented by either a plurality of vertices or nodes, or further represented by degeneracies or non-degeneracies in tensors of a multidimensional tensor block or data cube, thereby simulating virtual object rotation and depth perception data processing transmitted either to a GPS enabled mobile device, or either to a mobile device pairable or GPS enabled mix-reality device, or to a mobile device pairable or GPS enabled hyper-reality device, or to a mobile device pairable or GPS enabled neurotechnology, or a combination thereof, rendering the said interactive virtual design environment via a said dynamic mesh, the said interactive virtual design environment wherein computer readable instructions stored on a non-transitory storage medium may enable the use of at least one input device or said virtual agent adapted to receive at least one of space, gesture, text, a said static imagery cutout of an interoperating or integrated background removal computer product, or touchscreen inputs, wherein a computer processor adapted to execute a program stored in a computer memory, the program being operable to provide instructions to the computer processor including receiving user input via the at least one input device, or the said virtual agent, wherein the user input underspecifies a command for a said virtual agent within the said interactive virtual design environment to use in moving at least one target virtualized object in the said virtual environment; interfacing with the said interactive virtual design environment via a virtual agent, sensing by the virtual agent, the at least one virtual object or said virtualized object representing a real-world object or product item in the said interactive virtual design environment, and finding at least one valid location for the virtual agent to place the at least one said virtual object, real-world object representative in the said virtual environment, wherein determining at least on one valid location includes retrieving a computational linguistic placement constraint, identifying the virtual agent's intent for a target object, identifying a placement preference for the virtual agent, determining one or more said virtualized object properties of the target virtualized object and determining candidate placement surfaces for placement of the target object, the placement of which may thereby be further configured to receive criterion or query inputs, or configured to receive rendering data transmissions facilitating remote interactions between a plurality of client systems and a server system over a communication network within an communication protocols of computer readable instructions stored on a non-transitory computer readable storage medium, that may be configured to generate a list of one or more relative vendors, or servicers, or manufacturers, also comprising communication protocols wherein a list of one or more relative selectable product publications of an e-commerce product data store is generated in the identifying of a plurality of keywords by extracting keywords from each of the plurality of content items, further identifying a subset of the plurality of keywords by determining a set of unique keywords within the plurality of keywords; generating a search link including at least one keyword of the subset of keywords, and causing the generated search link to be displayed on the said virtual control panel, the generated search link configured to provide the results of a keyword query of one or more e-commerce context vector data stores using the at least one keyword of the subset of keywords, the at least one keyword displayed on the client computing device as an item of a search string and capable of selection by a user of the said virtual environment, a user of a master account according to a configuration of computer readable instructions, wherein content items that may or may not include product images that may be cut out via said integrated or interoperating background removal computer product, background subtractor or pattern recognition algorithms, and translated onto a said interactive virtual design environment, representing a said real property improvement, a said real property appurtenance, or a said real world furnishing item, wherein the actuation of one or more order submission technologies, object fabrication technology, product procurement technology, or a product shipment tracking technology, that may be implemented in the subsequent physical placement or installation of a said appurtenance item, or real property improvement item of the said virtualized representation, at the respective remote real-world location represented by the rendition of the said interactive virtual design environment at according to various configurations of computer readable instructions.

13) A method of claim 1L wherein the method comprises:
the programmable implementation and/or integration of a machine learning, cloud computable, virtual design environment further comprising a virtual fencing agent wherein a configuration of computer readable instructions stored on a non-transitory computer readable storage medium may enable a first user of a master account user interface to apply either a virtual subsector or sectoral overlay onto surface of a virtualized landscape or floor area identifying a first virtual zone, identifying a geographical or locational marker linked to a set of geo-located or geotagged informational datasets, or relational spatial data structures, or informational datasets of a geographic geography information system module, that are either associated to points or to octree nodes, or a combination thereof inside the virtual zone of the virtual fencing agent, or enabling the said first user to apply either a virtual subsector or sectoral overlay onto a virtualized floor area of a virtual environment, a virtual environment representing a real-world environment, wherein at least one rule, including metadata, wherein the defining of the fencing of a spatial allocation via at least one programmable input device, may actuate the publication of a real-world commercial space availability item or auction lot item of a said virtual commercial space environment, whereby the said metadata data structure can be configured to define a said commercial space availability's attributes related to a hash value or further related to a variable by which it may become a subject to either the assignment of a bid weighting factor, or to other data by which it may become a subject of a dataset valuation pricing model, or a combination thereof by the said first user via non-transitory computer readable instructions the publication within a said interoperating commercial space marketplace environment, which may cause a computer to perform a method for receiving a plurality of bids, or payments, or other cryptographic transactions, or a combination thereof from one or more second users of a master account user interface, second user profile criterion related to a hash value, or may further enable the structuring of a decentralized graph learning cryptographic virtual marketplace setting for the trade of a said commercial space marketplace environment wherein identifying at least one rule, or at least one metadata content descriptor, or at least one unique keyword, or a plurality of keywords, of a search string configured via computer readable instructions stored on a non-transitory computer readable storage medium by a said second user, causing the generated search link configured to provide the results, either one or more of said metadata content descriptors, one or more of said unique keywords, one or more of a said plurality of key words, or a combination thereof, of the said fencing agent's data stores within a said virtual commercial space marketplace environment the program being operable to provide instructions to the computer processor including receiving said second user input via the at least one input device, or the at least one query string, wherein the said second user input underspecifies a command for a virtual agent within the virtual environment of a said commercial space marketplace publication to use in moving at least one target virtualized object in the said virtual environment; interfacing with the said virtual environment via a virtual agent, sensing by the virtual agent, the at least one virtualized object representing a said real-world object or product item in the said virtual environment of a said virtual commercial space marketplace environment publication, and finding at least one valid location for the virtual agent to place the at least one virtualized object in the said virtual environment wherein determining at least on one valid location includes retrieving a computational linguistic placement constraint according to datasets or points inside the said virtual zone of the said virtual fencing agent, identifying the virtual agent's intent for a target object, identifying a placement preference for the virtual agent, determining one or more said virtualized object properties of the target virtualized object and determining candidate placement surfaces for placement of the target object, the placement of which may thereby further the placement or translations of scaled virtualizations or virtual representations of real-world objects such as but not limited to one of branding items, commercial tents, kiosks, prefabricated construction units, modified shipping container units, modular construction units, mobile popup shops, mobile food trucks, a truss, concession stand, fixtures, appurtenances, novelty items, novelty construction items, a unit of a repository or storage medium of a repurposing recommendation system or marketplace, or products of a product repository, an online product image of one or a plurality of online product storage mediums for real-world products, or a combination thereof placed onto a virtual setting of a said interactive virtual design environment, via either a said integrated or interoperating background removal computer product, or via a said background subtractor mechanism, or via a pattern recognition algorithm, the placement of which onto the said candidate placement surface thereby facilitating remote interactions between a plurality of client systems and a server system over a communication network within communication protocols of computer readable instructions stored on a non-transitory computer readable storage medium, that may be configured by the said second user to actuate one or more order placement technologies, or drop shipping technologies, or shipment tracking technologies, of a combination thereof for the placement, installation or respective real-world items, at the respective said real-world location of a said virtual environment.

14) A method of claim 1M wherein the method comprises:
the programmable implementation and/or integration of a machine learning, cloud computable, interactive virtual design environment wherein a fencing agent of computer readable instructions stored on a non-transitory computer readable storage medium may enable a first user, a first user of a master account, to apply either a virtual subsector or a virtual sectoral overlay onto either a virtualized shelving item, or a virtualized shelving fixture, or a virtualized shelving product, of a said interactive virtual design environment, a virtual environment representing a real-world environment wherein at least one rule, including metadata, the metadata defining fencing of a spatial allocation that may actuate the publication of a said real-world shelf space availability item publication within an interoperating virtual shelf space marketplace environment, whereby the said metadata data structure can be configured to define a said shelf space availability's attributes related to either a hash value or data values, or a combination thereof by which it may become a subject of either a bid weighting factor, or of a dataset valuation pricing model, or a combination thereof by the said first user via non-transitory computer readable instructions, the publication within a said interoperating virtual shelf space marketplace environment, which may cause a computer to perform a method for receiving one of a plurality of bids, or of payments, or of information, or of other cryptographic transactions, or a combination thereof from one or more second users of a master account user interface, second user identifier criterion related to a hash value, or may further enable the structuring of a decentralized graph learning cryptographic virtual marketplace setting for the trade of a said shelf space availability or auction lot item, a virtual shelf space marketplace environment wherein identifying at least one rule, or at least one metadata content descriptor, or at least one unique keyword, or a plurality of keywords, of a search string or of at least one input device configured via computer readable instructions stored on a non-transitory computer readable storage medium by a said second user, causing the generated search link configured to provide the results at least one of said metadata content descriptors, or at least one said unique keywords, or at least one of a said plurality of key words of the said fencing agent's data stores, the said virtual shelf space marketplace environment wherein identifying at least one rule, or at least one metadata content descriptor, or at least one unique keyword, or a plurality of keywords, of a search string or of at least one input device configured via computer readable instructions stored on a non-transitory computer readable storage medium by a said second user, causing the generated search link configured to provide the results of at least one said metadata content descriptors, or of at least one of said unique keywords, or of at least one of a said plurality of key words, relating to a said fencing agent's data stores further relating to a shelf space availability publication within a said virtual shelf space marketplace environment, the program being operable to provide instructions to the computer processor including receiving said second user input via the at least one input device, wherein the said second user input underspecifies a command for a virtual agent within the virtual environment of a said commercial space marketplace to use in moving at least one target virtualized object in the said virtual environment; interfacing with the said virtual environment via a virtual agent, sensing by the virtual agent, the at least one virtualized object representing a said real-world object or product item in the said virtual environment of a virtual shelf space marketplace environment, and finding at least one valid location for the virtual agent to place the at least one virtualized object in the said virtual environment wherein determining at least on one valid location includes retrieving a computational linguistic placement constraint, identifying the virtual agent's intent for a target object, identifying a placement preference for the virtual agent, determining one or more said virtualized object properties of the target virtualized object and determining candidate placement surfaces for placement of the target object, the placement of which may thereby further the placement or translations of the scaled virtualized object, the said scaled virtualized target object representing at least one virtualized branding items, or at least one scaled virtualized product items of an inventory product repository of a said second user, scaled according to product inventory metadata or uploaded criterion such as but not limited to product sizing or dimensions of virtualized branding items, or inventory products of a product inventory repository, or archive, or product metadata storage medium or product image storage medium associated with a registered business of a master account of a said second user, for the placement or translation of at least one said scaled branding item or at least one said inventory products of a said product repository, onto a virtual shelf or a surface of a said virtual environment, a said virtual environment further relating to a said shelf space availability publication of a said shelf space marketplace environment, the placement thereof via either a said integrated or interoperating background removal computer product, or via a background subtractor mechanism or a pattern recognition algorithm, or a combination thereof, the virtual item placement thereby facilitating remote interactions between a plurality of client systems and a server system over a communication network within communication protocols of computer readable instructions stored on a non-transitory computer readable storage medium, that may be configured by the said second user to actuate shipment pricing calculation devices, or further actuate one or more order placement technologies, drop shipping technologies, or shipment tracking technologies or a combination thereof, for either the stocking, or shelving, or the subsequent placement of at least one real-world inventory product of a said product repository, or of at least one real-world branding item, or of at least one real-world online product of a product repository, at a said respective real-world location, a real-world location of a said virtual design environment's rendition, the said shelf space virtual marketplace environment further comprising a datasets visualization module comprising an interactive display of a retail floor plan or patronage layout further comprising dataset object scores for dataset objects such as but not limited to at least one of shelf positioning, or at least one of brand blocking, or at least one brand adjacency, or at least one of shelving flow, or at least one of shelf mate product purchase pairing rate, or a combination thereof.

15) A method of claim 1N wherein the method comprises:
the programmable implementation and/or integration of a machine learning, cloud computable, mixed-reality interior design and land development virtual environment and path planning computer product, wherein computer readable instructions stored on a non-transitory computer readable storage medium, may enable a user, a user of a non-master account holder user interface for either a mixed-reality application, or a neurotechnology application, or a hyper-reality application or a combination thereof, in a remote real-world environment, a real-world environment represented by a virtual rendition of an interactive virtual design environment for receiving interior design recommendations, or for receiving land development recommendations, or for receiving landscaping recommendations, or for receiving a combination thereof, a said interactive virtual design environment of a master account holder user interface, transmitting to device representing a second user of an employee user account, the said second user commissioned via configurations of computer readable instructions within a first user master account user interface, the said employee account holder second user commissioned by a smart contract of a said first user master account user interface, to service a said remote real-world location, a real-world location of the said virtual environment, via computer readable instructions actuating an integrated or interoperating recruitment service technology, whereby a said second user becomes authorized to receive via a mobile device or via either a mixed-reality device, or a neurotechnology device, or via a hyper-reality device, or a combination thereof, receiving within a storage module either real-world interior design instructions, or landscaping design instructions, or land development instructions, or real-world object placement instructions, or path planning instructions, or a combination thereof, of a pattern recognition computer generated perceptual programming storage medium, wherein visualized information or real-world object virtualizations are superimposed or overlaid onto the display of a real-time image processing device, a real-time video display, or a static image display of the said real-world environment in a composite view of the said real-world environment, the said real-world environment represented in a rendition of the said interactive virtual design environment wherein a first user master profile relative configuration of computer readable instructions may enable the generation of path planning metadata within a storage medium, metadata drafted by the virtual placement or orientation, by a virtual agent, of a scaled virtualized inventory product of a product repository or storage medium, or of a virtualized object, or of a virtualized appurtenance, or of a virtualized real property improvement object, or of a virtualized fixture, or of a virtualized construction object, or of a virtualized furnishing item, onto a virtual surface of a said interactive virtual design environment via a configuration of computer readable instructions, the said metadata may further comprise information regarding design characteristics of the said real-world interior area or of the real-world landscape, corresponding to the said interactive virtual design environment, or may include one or more rules regarding at least one of fit, a location, or a compatibility, of at least one real-world object, of at least one real-world inventory product of a product repository or storage medium, of at least one real-world appurtenance, of at least one real-world real property improvement object, of at least one real-world furnishing item, of at least one real-world construction object, or at least one real-world fixture, represented by virtualization thereof within a said mix-reality information overlay or, a said object virtualization superimposition of a said real-time image processing device in a composite display, or a said real-time video in a composite video display, or of a said static image in a composite display, wherein a processor coupled to a memory storing the virtual model comprising a said virtualized object, and a said virtualized inventory product of a product repository or storage medium, and a said virtualized appurtenance, and a said virtualized real property improvement object, and a said virtualized furnishing item, and a said virtualized fixture, and a said virtualized construction object, of a said interactive virtual design environment representing the said real-world environment, thereby identifies geometric parameters of a real-world object, of a real-world inventory product object of a product repository or storage medium, of a real-world appurtenance, of a real world fixture, of a real world construction object, of a real-world real property improvement object, of a real-world furnishing object, wherein the real-world object, the real-world inventory product of a product repository or storage medium, the real-world appurtenance, the real-world real property improvement object, the real-world construction object, the real-world fixture, the real-world furnishing object corresponds to the metadata of the said interactive virtual design environment's virtualization thereof, thereby calculating an image based positional difference between at least one predefined point on the said virtualization thereof and a least one corresponding point on the respective real-world item, to configure the said real-world composite image, of a said real-time image processing device, or real-time video, or static image, a superimposition or an overlaid visualization of information display of said metadata at least one of text, or of an image virtualization, by which a respective real-world item's location or orientation may be corrected by the said second user according to non-transitory computer readable instructions further comprising of a real-time feedback channel that may enable a said first user to receive within a storage medium, tasks completion update data visualizations relative to said metadata storage information of the said interactive virtual design environment; the said pattern recognition computer generated perceptual programming storage medium may, or may not, further comprise correlative metadata translations of an octree spatial data structure optimized for the computable calculations of viewing angles within the said interactive virtual design environment, wherein each octant node or set of nodes representing a topographic geographical dataset of a geographic geography information system module within the virtual rendition of a real-world environment of the said interactive virtual design environment, the nodes further corresponding to the said interactive virtual design environment including the geometric parameters of foreground objects, the nodes or octants may further generate an acyclic graph for spatiotemporal querying via hybrid octree-plane point cloud geometry mixed-reality or hyper-reality programming whereby computer readable pattern recognition object placement or design recommendation task completion is verified according to the real-time image processing and the proximal alignment of real-world object parameters and predetermined estimated points of virtual object parameters relative to octree node or octant metadata of object virtualizations of the said interactive virtual design environment, thereby creating one or more copies of at least a portion of a tree data indexing structure generating a block timestamp or hash value, or thereby generating a block timestamp or hash value of a simplified payment verification (SPV) system, a block represented by one or a plurality of either BMAT leaf nodes, or a hybrid octree plane leaf nodes or octants of a real-time image processing storage medium, wherein a leaf-node or octant may further represent a timestamped verification of a real-world object's geometric proximal parameter alignment with the virtual positioning of a correlative superimposed object's virtualization within the said composite display of a real-time image processing device, real-time video composite display, or static imagery composite display, thereby further generating datastores within a storage medium of the said real-time feedback channel, the either BMAT tensor field, or the hybrid octree plane further comprising edges, or hyperstreamlines that may represent either path planning spatial data, or Euclidean distance path planning calculations, at least in part according to point of view, viewer height criterion represented by the root node or a vector axion schema.

16) A method of claim 1O wherein the method comprises:
the programmable implementation and/or integration of a machine learning, cloud computable, payroll and personnel planning data system (PPDS), personnel administrations system of an accounting service technology and SPV computer product, wherein the method comprises spatiotemporal querying and the transactional electronic disbursing of an employee payment amount from via computer readable instructions that may enable the issuance of payments from a master account holder user interface SPV payments environment, to a remote second user, a second user of a non-master account employee user interface, disbursements occurring each time that the said second user earns the employee payment amount during work hours that are logged via the programmable implementation or integration of a location based tracking device wherein either spatiotemporal queries, or temporal queries, or input requesting data associated with a specified geographic location of a said second user within the geographic region of a real-world environment, or a combination thereof, transmits to a remote storage location, a request for data objects captured by the mobile device of a said second user associated with a real-world geographic location, thereby receiving from the remote storage location, at least one data object associated with the said real-world geographic location, wherein the at least one data object is at least one of a said real-world image data object, or at least one of a metadata object, or at least one of a video data object, or a text data object, or at least one of a query method, or a combination thereof wherein the at least one data object was captured by the said second user's mobile device, or the at least one metadata object, or the at least one of a video data object, or the at least one of a text data object, or the at least one query method, or a combination thereof associated with the said second user's geographic location is thereby logging work hours according to onsite arrival or departure, via a verification process wherein the personnel administration work hour log, lists a plurality of network interactions between the mobile device of the said second user, and the at least one wireless access point in order for the said second user's mobile device to access the wireless network, the plurality of network interactions each corresponding to a single computer readable personnel administration work hour schedule; storing the personnel administration work hour log at a data intake and query system; processing, by the data intake and query system, a query for a subset of the plurality of worklog events corresponding to a mobile device of a said commissioned user or employee; receiving, by a processor, external data from a second data source, the second data source excluding the at least one wireless access point; determining, by the processor and based on the plurality of interactions, at least one geographic position and at least one corresponding time interval of the said second user's mobile device at the at least one geographic position, wherein determining the at least one geographic position further comprises determining that an onsite arrival event in the plurality of events is recording an initial access request to access the wireless network using a particular wireless access point; determining that an onsite departure event in the plurality of events is recording a termination access request to stop access the wireless network using the particular wireless access point; determining, by the data intake and query system, a duration of time that the mobile device is connected to a particular wireless access point based on a time difference between a time of the onsite arrival event and a time of the onsite departure event as recorded in the said personnel administration work hour log; and correlating, by the processor, the at least one geographic position and the at least one time interval with the external data to obtain a metric, the query system may, or may not, further comprise a DAG block-lattice data architecture wherein a stochastic model of either wireless network topology, or of street network topology, or a combination thereof provides a memoryless probabilistic tracking model of the said second user's mobile device, wherein a hash value is associated with either an IP location or timestamp of a temporal or spatiotemporal query, or SPV payment transaction, or a combination thereof.

17) A method of claim 1P wherein the method comprises:
the programmable implementation and/or integration of a machine learning, cloud computable, event planning mechanism and autonomous or non-autonomous vehicle route alignment system computer product, wherein computer readable instructions stored on a non-transitory computer readable storage medium may enable a user of a master user account user interface, to construct a schedule database of potential tasks for either a mobile popup shop or for a food truck autonomous or non-autonomous vehicle routing and management operations, via either an interactive GIS or an interactive GIS data visualization map wherein a vehicle route is configured via computer readable instructions of a master account user interface, a vehicle route containing interactive georeferencing indicators that denote an event entry of an interoperating or integrated network site having content relating to an event of a geographic location, a georeferencing indicator that may further represent a vehicle route stop, a vehicle route comprising of a hybrid delivery model for real-world products of a product inventory repository or storage medium, wherein a storage medium stores the task relating to the event in a said task schedule database having a plurality of entries, including at least one of said metadata entries of an interactive virtual design environment, or at least one of a virtual shelf space marketplace environment, each entry having either a task description field for receiving a description of a given task, or a tag comprising a description field, or a combination thereof, for receiving in either a mixed-reality device, or a neurotechnology device, or a hyper-reality device, or a mobile device comprised of a real-time image processor, a composite display of real-world images or a superimposition of one or more tags associated with the given task, comprising inventory product placement recommendations or orientation instructions of a pattern recognition computer generated perceptual programming storage medium, wherein visualized information relating to either a respective inventory product real-world item virtualization, or to a respective furnishing real-world item virtualization, or to a respective fixture real-world item virtualization, or a combination thereof, are superimposed or overlaid onto the display of a real-time image processing device, of either a real-time video display, or of a static image display of a real-world environment, in a composite view of the said real-world environment, the said real-world environment as represented in a volumetric design virtual rendition of a mobile popup shop or food truck unit of interactive virtual design environment wherein a first user master profile configuration of computer readable instructions may enable the generation of inventory product placement metadata within a storage medium, metadata drafted by the virtual placement or orientation, by a virtual agent, of either a scaled virtualized inventory product of a product repository or storage medium, or of a scaled virtualized object, further generating a vendor package field for receiving one or more vendor packages having service details associated with the given task a digital processing device comprising at least one processor, an operating system configured to perform executable instructions, a memory, and a computer program including instructions executable by the at least one processor to create a hybrid delivery model application for either real-world inventory products of a said product repository or storage medium, or for a real world modified construction units of a repurposing recommendation marketplace or storage medium, or a combination thereof, further comprising geocode database datasets denoting at least one vehicle route loading station, at least one delivery territory, a delivery territory represented by a said event entry, an event entry of a said interoperating or integrated network site having content relating to an event of a geographic location, a plurality of real-world products of a said inventory repository or storage medium, and one or more food truck autonomous or non-autonomous vehicles, or one or more said mobile popup shop autonomous or non-autonomous vehicles, each vehicle comprising of at least one real-world product inventory case of a said inventory repository or storage medium, the said real-world products subject to regulation imposing an upper regulated inventory case value threshold and a respective vehicle or plurality of vehicles configured to operate in either of a dynamic delivery model and a batch delivery model and optionally switch between models along a given route, setting the delivery model for the respective vehicle or plurality of vehicles, receiving orders for delivery of either one or more construction units of a repurposing recommendation marketplace or storage medium, or of one or more of the real-world product inventory shipments of a said product inventory repository or storage medium within the at least one delivery territory via interior design metadata stores of a said interactive virtual design environment, providing the dynamic delivery model, wherein a content of the inventory case is determined based at least in part on predicted demand datasets of an integrated or interoperating statics module and the upper regulated inventory case value threshold, and wherein one or more of the received orders are assigned, based at least on routing efficiency comprising distance and estimated delivery time between scheduled vehicle route stops, as they are received to one or more vehicles operating in the dynamic delivery model and providing the batch delivery model, wherein a content of the inventory case is determined based at least in part on a plurality of automated order placements received via said interior design metadata stores and the upper regulated inventory case value threshold, and wherein the plurality of the received orders are batched, based at least in part on said vehicle routing efficiency comprising distance and estimated delivery time, and assigned to a vehicle operating in the batch delivery model, the said interactive virtual design environment wherein computer readable instructions of a mobile unit volumetric design therein is further configured to facilitate remote interactions between a modified shipping container archiving and repurposing recommendation marketplace system, or to facilitate remote interactions between a plurality of client systems and server systems over a communication network within a communication protocol of computer readable instructions stored on a non-transitory computer readable storage medium, that may be configured to generate a list of one or more relative vendors, servicers, or manufacturers, or a combination thereof, a said task schedule database further configured to transmit said vehicle route data to a scheduling controller platform for the deployment of at least one or a plurality of autonomous vehicles identifying an autonomous vehicle transportation provider in a geocoded area, identifying a database for providing shipping container associated information including at least information about shipping container location, shipping container unique identifiers each comprising a machine readable code, the scheduling controller further comprising service data comprising at least one of pick-up data, the pick-up data indicating a geographical location of a shipping container unit of a shipping container information database, the said dynamic delivery module further comprising either a spatiotemporal querying method, or a temporal querying method, or a stochastic model of a DAG block-lattice data architecture, or a combination thereof wherein a stochastic model of one or a combination of wireless network topology, or of street network topology provides a memoryless probabilistic tracking model of a second user's mobile device, or an onboard technology system of an autonomous vehicle, wherein a hash value is associated with either an IP location or a timestamp of a temporal query method, or spatiotemporal query method, or a SPV payment transaction, or a combination thereof.

18) A method of claim 1Q wherein the method comprises:
the programmable implementation and/or integration of a machine learning, cloud computing, SPV or smart wallet payments environment computer product, wherein a plurality of activity engines determining a plurality of candidate transactions including a computer-readable medium for verifying a plurality of remote non-master account holder user identities of a consumer user interface or of an employee user interface, metadata defining the said user's identity either associated with a block header or hash value, the said payments environment computer products further comprising instructions stored thereon for adding to a spatiotemporal local block-lattice, determining via each activity engine of the plurality of activity engines, that payment information received by the network device satisfies or does not satisfy a threshold associated with the activity engine, or a spatiotemporal consensus protocol associated with the activity engine; grouping the candidate transactions into one or more transaction groups and tagging, via each activity engine of the plurality of activity engines, the payment information with an identifier associated with a spatiotemporal local block-lattice of the activity engine, wherein each identifier indicates that the payment information satisfied or did not satisfy the threshold associated with the activity engine, wherein the transactional request comprises an indication of at least one application function to be executed using the operating system instruction, and characteristic data associated with the operating system instruction, associating the one or more transaction groups respectively with the one or more copies of the Merkle block space index data structure of the latest block of the spatiotemporal local block-lattice, authentication of the transactional request in the distributed network of temporal graph nodes based on authentication data associated with the transactional request, wherein the authentication data comprises an identity or a IP location of the requesting user device; in response to authenticating the transactional request, evaluate the spatiotemporal local block-lattice to locate one or more scripts for executing the at least one application function, wherein the one or more scripts are associated with the transactional request and are stored in at least one directed acyclic structure (DAG) block of the spatiotemporal local block-lattice, executing the one or more scripts to generate, in accordance with the characteristic data, an executed operating system instruction in the one or more blocks space indexes of a local block-lattice, an activity engine of a local block-lattice that may or may not further comprise of either a geotargeted or spatiotemporal game terminal of a proximal computer generated perceptual programming module for mixed-reality or hyper-reality interactive gaming content, or a module for the cryptographic exchange of tokenized monetary units, whereby tokens may either be exchanged amongst players, or within a SPV payments environment for the computer readable purchase of real-world products of a product inventory repository storage medium, or of an inventory case load, a product item of a relative, geographically proximal popup up shop storefront location or popup event, according to a configuration of computer readable instructions, wherein said payments or token exchanges are associated with a timestamped hash value, the local block-lattice further comprising either spatiotemporal query or temporal query permissioned access or consensus protocols.

19) A method of claim 1R wherein the method comprises:
the programmable implementation and/or integration of a machine learning, cloud computable, popup retail storefront, or popup event proximity based selective content dissemination and ticketing system computer product for directing an autonomous or a non-autonomous vehicle for hire, wherein an inventorial product profile of either a product repository or storage medium, or of criterial data of business registration criteria, or of datasets of a master account holder user profile, or of data entries of an event planning network storage medium, or a combination thereof is related to dataset objects of a target market, a said target market as defined by said dataset objects of a statics module, datasets further acquired via the integration or interoperation of either data mining technologies or data engineering technologies one or a combination of such but not limited to, opensource distributed computing frameworks, cloud-based geostatistics technology, geospatial demographics engineering technology, cloud-based data analytics technology, cloud-based API data engineering technology, cookie compliance technology, campaign management analytics technology, social graph technology, user statistics technology, conversation tracking technology, demography data engineering technology, serosurveillance technology, biometric surveillance technology, sentinel surveillance technology, relative predictive modeling technology, spatiotemporal data engineering technology, footfall data engineering technology, consumer behavior tracking technology, web scrapping technology, or joint probability distribution data engineering technology, whereby a potential product or a potential business of interest is identified in relation to a target market that is profiled or defined by one or more of said dataset objects, interest defined by computer generated or computer readable dataset correlations, a product or a business of a proximally located popup retail storefront location, or a popup event location, proximal to an individual subject of a said target market, an individual of a said target market of a MRF model or stochastic model wherein a GPS enabled mobile device is indicative of an individual subject of the said target market and is represented in variable as nodes in a lattice of a graph learning model, each node in the lattice corresponding to a geographic area, each variable representing a number or a GPS enabled mobile device being used in a geographic area, GPS enabled mobile devices representing individuals of a said target market, a geographic area of a said popup retail storefront's or popup event's relatively proximal location represented as an interactive geographic referencing dataset data layer or map overlay of either an interactive geospatial data map, or an interactive spatiotemporal data map, or an interactive gravity based spatial interaction data map, or an interactive demographic information data map, or an interactive real-time spatiotemporal density map, or an interactive real-time memoryless topographic stochastic probability distribution data map, or an interactive cloud-based API real-time data engineering technology data map, or a combination thereof, of a data visualization module, a data visualization module comprising at least one input device, or at least one filtering device, whereby computer readable instructions stored on a non-transitory computer readable storage medium, may enable the configuration of a master account holder user interface model to generate said interactive target market dataset data layers or map overlays in a said data visualization module, indicating areal market share, or indicating probabilities of consumer footfall at one or more popup retail storefronts or popup events that are represented by said geographic referencing dataset layers or overlays of a said interactive geospatial data map, or a said interactive spatiotemporal data map, or a said interactive gravity based spatial interaction data map, or a said interactive demographic information data map, or a said interactive real-time spatiotemporal density data map, or a said interactive real-time memoryless topographic stochastic probability distribution data map, or a said interactive cloud-based API real-time data engineering technology data map, one or a combination thereof, wherein the cells define regions on the map and are non-overlapping, or are overlapping, and wherein each cell of the plurality of cells has the same predefined dimensions for each cell of the plurality of cells the aggregate value for the cell, calculated at least in part upon the selected attribute and zero or more said target market dataset objects associated with the selected attribute and locations within the region defined by the cell, thereby determining the shading for each of the cells to generate a visual overlay of data layers for rendering a heatmap of the said interactive maps of the said data visualization module, the said data visualization module further configured to receive rideshare cost datasets from at least one rideshare technology services offered by a plurality of application platforms of third party rideshare service providers, within a database aggregation unit configured to receive geo-radial, or areal location inputs, or geocode inputs, or location inputs, one or a combination thereof, said inputs of a master account first user interface representing a proximal location of a popup shop storefront or popup event, further configured to receive and store data from a plurality of third-party rideshare technology service provider databases each of said third party rideshare technology service provider databases containing data sufficient to perform services of one of said corresponding third-party mobile application platforms, wherein a processor configured to parse said service request for at least one said rideshare technology services from a first user of, a said master account user interface, based on data stored in said database aggregation unit, the processor assembling at least one combination of at least one or more said rideshare technology services, based on a coordination of an optimized combination of one or more said rideshare technology services based on time and cost of a stochastic model so as to allow, said first user of a master account user interface, to select and initiate a corresponding request for one or more of said third party rideshare technology service providers, to a provide a service for a plurality of remote non-master account holder second users of a said target market dataset, said second users represented by said nodes of a said MRF model, the said data visualization module further comprised of a database for storing marketing content provided by a content creator, a content creator of a said master account first user interface, storing digital marketing content in a storage medium for accepting proximal geographic location inputs, proximal geographic location inputs relative to a said popup retail storefront or popup event location, location inputs as vertices of a said MRF node expressed as a dataset data layer of an interactive polygonal overlay, an interactive polygonal overlay of a said heatmap defining boundaries of a geographic region, a geographic region of a said geographic referencing dataset, receiving geotargeted digital content within an image processing medium or within a computer generated perceptual programming medium of either a GPS enabled mobile device, or of either a mobile device pairable or a GPS enabled hyper-reality device, or of either a mobile device pairable or a GPS enabled neurotechnology device, or of either a mobile device pairable or a GPS enabled mixed-reality device, or a combination thereof, a said GPS enabled mobile device a MRF node associated with said a geographic region of a data visualization module, transmitting the said content associated with the geographic region to the said GPS enabled mobile device of a second user belonging to a said target audience population, a target market population of a geographic region indicated by a said data visualization dataset, a target market population of proximal relativity to a said popup retail storefront location, or popup event location, wherein the said content comprises computer readable instructions stored on a non-transitory computer readable storage medium whereby access to a ridesharing network that invites a plurality of riders of a shared geographic proximity to join the network is provided via the said processor configured to parse said service request for at least one said rideshare technology services of a ridesharing network for receiving a predetermined location, a predetermined location of a said popup retail storefront location of a said popup storefront, or popup event location, a said location of a location data criteria entry of a proximity based selective content dissemination module, the said processor configured to parse said service request for at least one said rideshare technology services, further comprising a ticketing system module whereby the computer readable acceptance of a discounted or complementary rideshare service of a said proximity based selective content dissemination module by a target market device node, may serve as a ticketing method, or as an event admissions method of an issue tracking system, wherein a rider represented by a relatively proximal said target market GPS enabled device node is provided with a computer readable access code for consumer participation at a said popup retail storefront location, or at a popup event location, the ticketing system module configured to accept second user geographic location inputs upon the computer readable acceptance of the said discounted or complementary rideshare service of a said proximity based selective content dissemination module, the proximity based selective content dissemination module further comprising a dataset valuation pricing module of a payments environment or a cryptographic SPV payments environment wherein a stochastic model providing memoryless predictive data, data based at least in part upon dataset objects such as but not limited to one or a combination of hyperbolic positioning, multilateration of radio signals, wi-fi positioning systems, Bluetooth technology, crowdsourced hotspot technology, mobile phone mast locations, street network topology, the spatiotemporality of second user nodes, the spatiotemporality of rideshare ride vehicle nodes, and popup shop or popup event location nodes, whereby a calculated estimate of target market nodes of a proximal market share, or of estimated footfall generate a cumulative cost including selective content dissemination marketing campaign pricing and quantitative rideshare service cost, the said pricing module may or may not further include an escrow processor of a payments environment or of a cryptographic SPV payments environment, for the deference or allocation of rideshare service discounting or concessions payment dispersal, according to configurations of computer readable instructions, whereby an escrowed transaction of a cryptographic SPV payment represented within a storage medium as an unpocketed or pending block of a transaction state where a block sending funds is published and confirmed by either a graph learning hypernetwork metagraph, or a nested metagraph of a block-lattice, wherein labeled hyperedges and labeled metavertices are organized according to mathematical logic models such as but not limited to set theory, or machine learning processing models such as but not limited to natural language, or user behavioral models, one or a combination thereof whereby a node vector for a node's representation is calculated, vector nodes of said individual subjects of target market dataset objects, vector nodes of said rideshare vehicles, vector nodes of said master account holder users, or vector nodes of said a popup shop or popup event location of a geographic region, wherein hyperedges may represent either connective or relational dataset objects or geographic proximities, or a combination thereof as probabilistic layers added to the said graph learning hypernetwork according to datasets of said data engineering mediums or of said data mining mediums for data such as but not limited to geocode database data, demography data engineering data, gravity based spatiotemporal interaction data engineering data, population density data engineering data, geographic topology data, street network topographic data, or rideshare technology service vehicle locations data, one or a combination thereof.

20) A method of claim 1S wherein the method comprises:
the programmable implementation and/or integration of a machine learning, cloud computable, computer product for geotargeting computer generated perceptual programming advertisement content by dynamically detecting geographically dense collections of GPS enabled mobile devices, wherein a computer readable storage medium for storing advertisement content provided by a content creator of a master user profile, and a said content manager for accepting geographic location inputs as vertices of a said polygon defining boundaries of a said heatmap overlay, a said heatmap overlay of an interactive map where advertisement content is associated with a geographic region of a relative population density, a relative population density of a target market, a target market as defined by datasets of a statistics module, datasets further acquired via the integration or interoperation of either data mining technologies or data engineering technologies one or a combination of such but not limited to, opensource distributed computing frameworks, cloud-based geostatistics technology, geospatial demographics engineering technology, cloud-based data analytics technology, cloud-based API data engineering technology, cookie compliance technology, campaign management analytics technology, social graph technology, user statistics technology, conversation tracking technology, demography data engineering technology, serosurveillance technology, biometric surveillance technology, sentinel surveillance technology, relative predictive modeling technology, spatiotemporal data engineering technology, footfall data engineering technology, consumer behavior tracking technology, web scrapping technology, or joint probability distribution data engineering technology, joint probability distribution data configured in the graphical display of areal indications of a MRF model wherein each node in the lattice corresponding to a geographic area such that neighboring nodes correspond to neighboring geographic areas, and each state space or state variable representing an estimate of a number of mobile devices currently being used in a corresponding geographic area based on said dataset objects describing mobile devices being used in the geographic area, applying, by a computer processor, an observation of a number of mobile devices currently within the geographic area to the MRF model to produce an estimate of a number of mobile devices currently being used within the geographic area, and storing the estimated number of mobile devices currently being used within the geographic area in a computer-readable storage medium, and selectively transmitting the advertisement content to the GPS enabled mobile devices denoting a said individual subject of said target audience associated with a geographic region, or selectively transmitting the advertisement content to either a mobile device pairable or a GPS enabled hyper-reality device, or of either a mobile device pairable or a GPS enabled neurotechnology device, or of either a mobile device pairable or a GPS enabled mixed-reality device, or a combination thereof, a said GPS enabled mobile device a MRF node associated.

21) A method of claim 1T wherein the method comprises:
the programmable implementation and/or integration of a cloud computable, machine learning, selective digital content dissemination, or computer generated perceptual programming selective digital content dissemination computer product comprised of a virtual goods repository wherein a virtual good is a non-physical virtual object, a virtual good repository of a computerized virtual goods trading system that may include an interface to receive a virtual goods package from the seller, a said seller of a non-master account holder user interface, the virtual goods package of the said interface further comprising a processor for supplemental content to be added to a virtual good, the metadata content of a seller's account profile regarding computer generated or computer readable user behavior data dataset objects or conversation tracking data dataset objects of one or more said seller account user profile associated social media website profiles, user behavior data dataset objects, or conversation tracking data dataset objects representing said seller social media profile online constituencies, or followers, or relative users as computer generated or computer readable dataset objects that may be further associated with either a dataset valuation model of a pricing module, or may provide the variables of a virtual goods dataset valuation pricing model of a graph learning social hypergraph blockchain ledger, or a combination thereof, a graph learning social hypergraph wherein an inventorial product profile of a product repository or storage medium of a master account user interface, or criterial datasets of business registration criteria of a master account user interface, or criterial datasets of a master account holder user profile is connected via labeled hyperedges to dataset objects of a target market represented as graph nodes or metavertices indicative of individual subjects of a target market or indicative of a target market geographic referencing dataset, master account users represented as buyer graph nodes or metavertices, labeled graph hyperedges indicative of a shared audience further connecting a buyer node to a said seller, sellers represented as nodes or metavertices, the graph learning model further implementing probabilistic layers to the graph learning social hypergraph of an MRF model, the said target market datasets further acquired via the integration or interoperation of either data mining technologies or data engineering technologies one or a combination of such but not limited to, opensource distributed computing frameworks, cloud-based geostatistics technology, geospatial demographics engineering technology, cloud-based data analytics technology, cloud-based API real-time data engineering technology, cookie compliance technology, campaign management analytics technology, social graph technology, user statistics technology, conversation tracking technology, demography data engineering technology, serosurveillance technology, biometric surveillance technology, sentinel surveillance technology, relative predictive modeling technology, spatiotemporal data engineering technology, footfall data engineering technology, consumer behavior tracking technology, web scrapping technology, or joint probability distribution data engineering technology, the said datasets related to a said master account represented as a buyer further related to the said seller, the said virtual good of the said virtual goods repository being either a static image, videography content, an image template, or a videography template containing the seller's likeness, or a combination thereof, generating within a processor either a scaled two-dimensional or three-dimensional image for selective content dissemination, receiving within a storage medium that corresponds with a virtual marketplace environment wherein the medium is configured to deliver a virtual good from a said seller to a said buyer, a virtual marketplace environment wherein a said virtual goods repository interface including a processor for supplemental content to be added to a virtual good, the supplemental content of product criteria entries, product criteria of a product repository or storage medium associated with a master account profile representing a said buyer, the generated supplemental content including either a computerized three-dimensional or two-dimensional clothing model reconstruction of captured product image information, or captured SKU information, or captured product metadata generating a clothing model comprising one of geometry information, or one of texture information, or one of color information, or a combination thereof, further generating a seller's virtual good, virtual wardrobe change based on the clothing type suitable for the seller's image type of a virtual good candidate selection option of a said virtual marketplace environment, the computer readable selection of a virtual good by a respective said buyer resulting in the storage of virtual goods as part of digital content of a content storage medium and content manager for accepting geographic locations expressed as a dataset data layer of an interactive polygonal overlay, an interactive polygonal overlay of a heatmap defining boundaries of a geographic region, a geographic region of a geographic referencing dataset, as an interactive geographic referencing dataset data layer or map overlay of either an interactive geospatial data map, or an interactive spatiotemporal data map, or an interactive gravity based spatial interaction data map, or an interactive demographic information data map, or an interactive real-time spatiotemporal density data map, or an interactive real-time memoryless topographic stochastic probability distribution data map, or an interactive cloud-based API real-time data engineering technology data map, or a combination thereof, of a data visualization module, a data visualization module comprising at least one input device, and at least one filtering device, whereby computer readable instructions stored on a non-transitory computer readable storage medium, may enable the configuration of a master account holder user interface model to generate said interactive target market dataset data layers or map overlays in the said data visualization module, indicating areal market share, or indicating probabilities of consumer footfall, wherein configurations of computer readable instructions may allow the said buyer to selectively disseminate computer generated perceptual programming content, or digital content of a said virtual good containing a said seller's likeness, receiving the geotargeted digital content of the said buyer's virtual good procurement within an image processing medium, or within a computer generated perceptual programming medium or processor of either a mobile device pairable or a GPS enabled mix-reality device, or of either a mobile device pairable or a GPS enabled hyper-reality device, or of either a mobile device pairable or a GPS enabled neurotechnology device, or within a GPS enabled mobile device, or within a combination thereof, a said GPS enabled device of a target market MRF node associated with said a geographic region of a data visualization module, transmitting the said content associated with the geographic region to the said GPS enabled device node of a third user representing an individual subject of a said target audience population of a computer readable geotargeted geographic referencing dataset.

22) A method of claim 1U wherein the method comprises:
The programmable implementation and/or integration of a machine learning, cloud computable modified shipping container archiving and repurposing recommendation system or marketplace environment comprising, a storage medium of units for a food truck modified shipping container construction unit, a mobile popup shop modified shipping container conduction unit, or popup retail modified shipping container storefront construction unit or a combination thereof, a storage medium of a virtual marketplace environment interface module or unit archiving storage system for receiving modified shipping container unit information, a shipping container tracking location module configured to identify a travel route, a number of destinations and a number of travel connections corresponding to the modified shipping container construction unit metadata of an unit archiving storage medium, metadata including size, or style based identifiers, a tracking location analysis engine, a modified shipping container construction identifier module configured to receive a modified shipping container construction style identifier criterial input, a said modified shipping container archiving system and repurposing recommendation marketplace environment, the said marketplace environment interface module comprising at least one input device configured to receive criteria of a buyer, a buyer of a master account user interface, or further configured to receive unit item criteria of a seller, a seller of a master account user interface, the repurposing recommendation unit archiving engine configured to generate a recommendation of the archived modified shipping container construction item in either the said marketplace environment or unit archiving system based on the modified shipping container identifier inputs or criterion a of virtual agent storage medium of either a said interactive virtual design environment, or of a said virtual fencing agent storage medium, or of a said commercial space virtual marketplace input device, or of computer readable query items, or entry items of at least one input device, the said repurposing recommendation marketplace environment or unit archiving system may or may not further comprise of a graph learning hypernetwork wherein computer readable user behavioral models are implemented in the calculation of vector node representations of buyers and sellers, the said archived shipping container construction unit identifier metadata further calculating a vector node for a said archived modified shipping container unit and hyperedges connecting the said archived modified shipping container vector node to a said seller vector node, hyperedges further generated according to said shipping container location tracking data connecting a said shipping container vector node to a said buyer vector node according to computer readable geocode data indicative of a prospective shipping container drop off location, the said travel route data and the said number of destinations or number of travel connections corresponding to the metadata of a modified shipping container construction unit candidate selection option of the said modified shipping container archiving and repurposing system adding a probabilistic layer to the said graph learning hypernetwork that may be further configured to allow spatiotemporal querying or temporal querying of vector nodes calculated to represent modified shipping container transportation servicers that are further represented by a GPS enabled mobile device or modified shipping container transportation servicer's GPS enabled onboard technology, the hypernetwork may or may not further comprise of a SPV module configured to allow cryptographic transactions between said vector nodes.

23) A method of claim 1V wherein the method comprises:
the programmable implementation and/or integration of a computer generated perceptual programming content creation medium computer product, wherein a configuration of computer readable instructions enables the indication of either a virtualized foreground object representing a real-world object or a background object representing a real-world object, the object indication within an interactive virtual design environment, whereby the relative indication actuates a storage module for integrated or an interoperating augmented reality content creation medium or an augmented reality software development kit API, wherein the storage module is configured to accept hypervoxel volumetrics such as but not limited to, 3D dataset voxelizations, hypertextures, volume hypervoxels, or multi-scale voxel hashing, managed by either a hyperoctree data manager, or a multidimensional tensor field data manager, or a hybrid data indexing structure of a said interactive virtual design environment for generating density slicing thresholds of critical angle dataset objects, reflection angle dataset objects, refraction angle dataset objects, shadow depth datasets objects, datasets of remote sensing data extractions, temporal resolution data extractions, or terrain mapping data extractions, for receiving within a remote computer generated perceptual programming content and real-time image processor device or mixed reality device, via either a computer readable permissioned access of a spatiotemporal or temporal querying medium, or via a ticketing technology service, or a combination thereof, said access that enables real-world object image recognition according to metadata of a corresponding geometric parameters of an object virtualization of the said interactive virtual design environment, thereby actuating either an augmented reality, or mixed reality, or hyper-reality composite display relative to elements of a real-world environment according to translations of the said content creation medium, augmented reality spatiotemporal data structure may or may not include either a hypervoxel data structure generator of a hybrid hypervoxel-plane point cloud geometry multidimensional data indexing module of a real-time image processor of either a GPS enabled mobile device, or of either a mobile device pairable or GPS enabled mixed-reality device, or of either a mobile device pairable or GPS enabled hyper-reality device, or of either a mobile device pairable or GPS enabled neurotechnology device, or a combination thereof, generating either a BMAT data indexing manager for the algorithmic split-and-merge of hierarchical multidimensional tensor cube segmentation and compression in the approximate reformulation of stored geospatial data in relation to content of a composite display, or a hyper-octree manager for 3D semantic segmentation and voxel relationship classification, further generating a root hypernode vector representing a viewer, the said root hypernode further representing hyperspace of n-dimensions, wherein the fourth dimension is color or pixel depth calculations of dataset objects such as but not limited to said critical angle dataset objects, said reflection angle dataset objects, said refraction angle dataset objects, said shadow depth datasets objects, said datasets of remote sensing data extractions, or said temporal resolution data extractions, wherein 3D augmented reality virtual object rotation angles are calculated according a fixed reference point of a real-world object, further generating point-of-view or line-of-sight hyperedges, or further generating hyperstreamlines of an eigenfunction relating to viewer height criterion that may represent a vector axiom schema or a variable in Euclidean distance calculations, one or a combination thereof.

24) A method of claim 1W wherein the method comprises:
The programmable implementation and/or integration of a machine learning, cloud computable, decentralized blockchain ARAS marketplace and gaming terminal wherein a processor identifies one or more dataset object descriptors or user profile characteristics of a first player of a master account, automatically identifying one or more actions performed by the said first player determining at least a first criterion of a first play user profile, based at least in part on the one or more dataset object descriptors or user profile characteristics of one or more second players, second players of a master account, identifying one or more said user profile characteristics of one or more said second players automatically identifying one or more actions of actions performed by the one or more said second players, associating one or more said second player master account user profile criterion with the said first player, analyzing the first criterion and the one or more second criterion and determining one or more relationships between the first criterion and the second criterion to form a single virtual game session wherein in the game is a finance-based, trading themed game of a marketplace and gaming environment having a player interface wherein a player may participate in an ARAS virtual trading marketplace, trading virtual goods, first virtual goods geotagged to a prospective geophysical ARAS location according various spatial datasets from a data mining system, or a data engineering system, or a statistics module, or a data visualization system determining within a dataset valuation pricing module, a dataset valuation of monetary units for a plurality of predefined spatial areas from the retrieved data based on a set of target market dataset association rules applied to the predefined spatial areas, determining spatial area values calculating a weight ranking the predefined spatial areas according to varying degrees of target audience dataset object data correlations, the processor configured to receive collectable data structures of one or more data files from a said data mining system, or a said data engineering system, or a said statics module, or a said data visualization system, a module operative for tokenizing flat currency monetary units according to a dataset valuation model or according to a relative price valuation model, one or a combination thereof, a module operative to create either a hash value, or a timestamp, or a combination thereof, for each element of each dataset of a said first virtual good, a module operative to upload each hash1 value into a private blockchain structure of a said first virtual good, computer readable instructions for obtaining a first virtual good enabling a player to acquire or develop a second virtual good, the second virtual good having a starting value or hash value of a blockchain structure, or a tokenized value according to the relative size of a virtual good, the relative size of the second virtual good further representing the range, the reach, the coverage, or the areal radius of an augmented reality advertisement selective content dissemination within a said first virtual good's geotagged geophysical location, computer readable instructions for obtaining a second virtual good enabling player access to a database for storing content provided by a said player and content creator in an electric memory, and a content manager for accepting geographic location inputs of the said predefined spatial areas of a said first virtual item's geotagged geophysical location, selectively transmitting interactive augmented reality content to GPS enabled computing devices, real-time image processing devices one of either a mobile device pairable or a GPS enabled mixed-reality device, or of either a mobile device pairable or a GPS enabled hyper-reality device, or of either a mobile device pairable or a GPS enable neurotechnology, or a combination thereof, a said GPS enabled device relating to a vector node representing an individual subject of a target audience or target market, based on dataset object descriptors of user behavior, or of stochastic probability, or of geographic proximity to a said predetermined ARAS location, one or a combination thereof.

25) A method of claim 1X wherein the method comprises:
the programmable implementation and/or integration of a machine learning, cloud computable, virtual environment computer product for creating architectural schematics of a real-world interactive modular high-rise or midrise smart building within an interactive virtual design environment, wherein features are specified in various virtual building floor level floorplans at least in part by generating a sectorization grid virtual fencing tool for obtaining varying steel module configurations of one or more building floor level floorplans, the sectorization grid virtual fencing tool comprising a plurality of nodes and edges that defines the perimeter of the floor and ceiling of each module cell of a real-world steel frame wherein each module is configured to provide a part of the floor plan of a respective floor level, a floor level of a prospective modular high-rise or midrise building, the said computer product further comprising a steel module unit space auction scheduling and commercial space virtual marketplace environment storage medium, wherein floor level steel module unit commercial space auction cycles are scheduled according to sensor data transmissions of a sensor network, a sensor network wherein steel module frames may be fitted with a module sensor of a said sensor network for the scheduling of steel frame module cell vacancies and occupancies by a modular construction unit, the said virtual environment for creating architectural schematics of a modular high-rise or midrise building further configured to transmit either rendering data or mixed-reality rendering data, to either a CAD system processor, or to a mixed-reality processor, of a building information modelling software technology, or to a mix-reality device, wherein either the said mixed-reality device processor renders the mixed-reality schematics building information modelling data within an interactive virtual environment, or wherein the said CAD system of a building information modelling software technology renders building schematics information and modelling data, wherein the command further comprises computer readable path planning instruction data transmissions of an automated crane database or storage medium, or of a robotic crane database or storage medium, or an autonomous crane database or storage medium, path planning instructions that are generated at least in part via the said steel module sensor network data, or the said auction scheduling and commercial space virtual marketplace environment storage medium, or the said sectorization grid virtual fencing tool storage medium, by which a path score for each of a plurality of module configurations is determined for the emplacement or extraction of a modular construction unit of a said steel frame module cell, processing parameters in position and direction of the moveable parts, the said sectorization grid virtual fencing tool further comprising computer readable instructions configured to receive content data from a content provider of a master account, content for grouping said sectorization grid virtual fencing tool cell units into an auction lot group the nodes and edges of the said sectorization grid virtual fencing tool further defining a modular construction unit type for the optimization of construction unit product selection options or of unit type selection options of a programmable interoperating or integrated modified shipping container archiving and repurposing recommendation marketplace system, or of a product repository, the starting auction price of the digital content set according to criterion of a blockchain pricing module, said pricing modules may include a bid factor weighting pricing module, or a dataset valuation pricing model of a pricing module using data obtained from a statistics module, the computer readable dataset valuation pricing model including bidder or buyer relative target market dataset objects, the said bidder or buyer represented by a master account, the said buyer's or bidder's master account criterion and relative target market dataset objects further associated with dataset valuation criterion of a said auctioning bid factor weighting data storage medium, the blockchain module grouping the candidate transactions into one or more transaction groups associated to criterion of a said bid factor weighting pricing module storage medium, creating one or more copies of at least a portion of a state tree data structure of a latest block of the blockchain wherein the data layer is configured to store validated transactions in a blockchain, a single auction period receiving via a computer network, bids submitted by a plurality of bidders, bidders of a master account user interface with master account dataset objects or relative criterion correlations with the respective auctioneer of a master account user interface, or with current or perspective module unit occupants, occupants of a master profile, configuring a permissioned access to the said auction blockchain, the said auction marketplace further comprising an interactive bid submission display that may or may not include an interactive module unit design virtualization of a module unit type matching a steel module configuration of a floor level module space availability of a said sectorization grid virtual fencing tool storage medium, each bid or said bidder subject to a valuation model a of a said bid factor weighting pricing module criterion entry, the computer readable conclusion of an auction period further actuating a scheduling controller platform for the deployment of a plurality of autonomous vehicles, or a dispatch platform for non-autonomous truck, identifying at least one autonomous vehicle transportation service provider, or identifying at least one vehicle transportation service provider in a geocoded area, identifying a database for providing shipping container associated information including at least information about shipping container location, shipping container unique identifiers each comprising a machine readable code, the scheduling controller, or the said dispatch platform further comprising service data at least one of pick-up data or drop-off data, the pick-up data indicating a geographical location of a shipping container unit or modular unit of a said database, the drop-off data indicating a geographical coordinates establishing a loading area for the transferring of shipping containers or modular units onto and off of autonomous transportation vehicles or non-autonomous transportation vehicles via said robotic crane, or said autonomous crane, at the respective modular high-rise real world development site, or the close of an auction period configuring computer readable instructions to facilitate remote interactions between a plurality of client systems and server systems over a communication network within an communication protocols of computer readable instructions stored on a non-transitory computer readable storage medium, that may be configured to generate a list of one or more trucking services, transmitting said pick-up and drop-off data either to a computer readable order submission form, or to a cargo tracking technology service system, or a combination thereof, the said computer readable close of an auction period further configured to generate criterion or criterial entry fields for a product order or a product order submission, products of a product repository or product storage medium, or further generating criterion or criterial entry fields of a service request form or a service request form submission, or further generating criterion or criterial entry fields for a recruitment service technology submission form, or a recruitment service technology form submission.

26) A method of claim 1Y wherein the method comprises:
the programmable implementation and/or integration of a machine learning, cloud computable, a combined system enrollment or ticketing computer product for a decentralized smart wallet cloud or SPV payment environment and a peer-to-peer spatiotemporal query processing medium, or peer-to peer temporal query processing medium of a local blockchain, or of a local block-lattice, comprising the user authentication of a computer generated perceptual programming controlled environment or game terminal, a computer generated perceptual programming controlled environment or game terminal of a proximity geotargeting content storage medium and selective content dissemination content manager for accepting geographic location inputs of a popup event or popup retail location and for accepting opensource gaming platform content, wherein a unique device identifier activated by an enrollment processor grants a non-master account holder user node of a consumer user interface, geographic areal or proximal permissioned access according to either a cloud computable threshold, or according to computer readable threshold, or according to wireless fidelity (wi-fi) device communicative threshold, or according to a GPS enabled device processor readable threshold of geophysical location, or a combination thereof, whereby receiving within a server a request to enroll a user via user identification authentication in association with either a sentinel surveillance system unique identifier, a serosurveillance system unique identifier, a user node unique identifier, a unique device identifier, a biotechnology system unique identifier, or a biometrics system unique identifier, or enrollment system datastores, or a combination thereof, provides authentication of a user via one or a combination of, a GPS enabled mobile device, or unique identification reader device, or generates a computer processible access code for collecting personal or biometric data during an enrollment session, further generating a non-transitory decentralized smart wallet or a SPV consumer user interface of a cloud payment environment whereby computer readable instructions initiating a spatiotemporal augmented reality game session, or spatiotemporal game session between a plurality of said non-master account holder users or a consumer user interface represented by a user node that is within a geographic proximity, a game session in communication with a session spatiotemporal local block-lattice or local blockchain that stores gaming information determining whether a real-time status of proximal user activities requires updates to the session spatiotemporal local block-lattice or blockchain and associate a current user status to a tokenized value according to the controlled local payment environment of the said popup event, storing in a non-transitory smart wallet or SPV cloud payment environment datastore a redemption code and verification code in association to a said tokenized value, producing respective activation statues to verify the use of at least one redemption code in a plurality of proximal mobile device nodes representing an employee at the said popup event or popup retail location of which the non-transitory foundation of a smart wallet cloud payment environment of a popup event is composed, a spatiotemporal local block-lattice or local blockchain further comprised of Merkle-tree spatial indexing integrations including a computer-readable medium for verifying a said non-master account holder consumer user's identity, metadata defining a said non-master account holder user's identity associated with either a hash value or block header, wherein geographical positioning of a user's GPS enabled mobile device represents a node within a block-DAG architecture.

27) A method of claim Z wherein the method comprises:
the programmable implementation and/or integration of a machine learning, cloud computable decentralized blockchain or block-lattice ARAS marketplace environment computer product, wherein a processor identifies one or more characteristics or dataset objects of a user profile, dataset objects a least in part representing a target market, the processor further determining relationships between the said one or more characteristics or dataset objects, dataset objects of either an interoperated or integrated geostatistics module, statics module, data mining system, or data engineering module, or a combination thereof, of a virtual ARAS marketplace environment wherein the virtual marketplace environment is a public blockchain or block-lattice domain having a user interface wherein a configuration of computer readable instructions may enable a plurality of users of a master account user interface, to purchase or trade ARAS within the said ARAS virtual marketplace environment, ARAS geographic location dataset objects of data extracted from either a said data mining system, or a said data engineering system, or a said statistics module, or a combination thereof, may be assigned to criterion of one or a combination of a dataset valuation pricing model, or of a relative valuation pricing mode of a pricing module, the marketplace environment further comprising an interactive data visualization system including at least one input device for accepting geographic locations thereby indicating in data overlays or data layers, one or more dataset objects or one or more input criteria items relative geographic areas on an interactive GIS data visualization map from the retrieved data based on a set of target market dataset association rules applied to the spatial areas generating a geographic referencing dataset display, further comprising a content creator storing digital marketing content in a storage medium for accepting geographic location inputs, geographic location inputs relative to a dataset object, location inputs as vertices of an MRF node expressed as a dataset data layer of an interactive polygonal overlay, an interactive polygonal overlay of a heatmap defining boundaries of a geographic region, a geographic region of a said geographic referencing dataset, receiving transmitted geotargeted digital content within an image processing medium or within a computer generated perceptual programming medium of either a GPS enabled mobile device, or of either a mobile device pairable or GPS enabled mix-reality device, or of either a mobile device pairable or GPS enabled hyper-reality device, or of a mobile device pairable or GPS enabled neurotechnology device, or a combination thereof, a said GPS enabled mobile device of a MRF node associated with said a geographic region of a data visualization module, transmitting the said content associated with the geographic region to the said GPS enabled mobile device or a mixed-reality device of a second user belonging to a said target audience population, a target market population of a geographic region indicated by a said data visualization dataset object or input criterion item.

28) A machine learning, cloud computing, non-transitory, volumetric design and image analysis computer product for generating a virtual environment for popup event modeling or development, comprising any variation or combination of the following methods:
wherein land development design recommendations or development recommendations are received within a storage medium at least in part according to real-world environment geophysical datasets, the said virtual environment further comprising computer readable instructions that enable three-dimensional modeling for an improved virtual reality experience, real-world geophysical datasets acquired via the programmable interoperation or integration of one or more MLS databases, or via the programmable interoperation or integration of physical geography geographic information modules, or of data mining technologies or of data engineering technologies one or a combination of such but not limited to satellite terrain mapping technology, or satellite surveying technology, or remote-sensing, or satellite topology data engineering, or pattern recognition technology, or satellite imagery incorporated in the building of a three-dimensional graphical computer model dataset directory, datasets defining one or more natural characteristics of the said landscape area to be implemented in the virtual rendition of a said virtual environment representing the landscape of the said real-world environment, wherein the directory comprises information regarding various locations within the landscape of the said real-world environment, the information based on natural characteristics of each of the various locations within the landscape of said real-world environment wherein the three-dimensional graphical computer model comprises active tree nodes of either a BMAT, or of an octree data structure that are optimized for viewing angles according to critical angle calculations of reflectance or refraction attributes of lighting according to viewer high criterion, or virtualized object shadow depths according to said real-world landscape's geophysical characteristics, shadow depths and critical angle viewing angel attributes translating to pixel depths or virtual object rotation transmitted to a mix-reality device, the said storage medium further receiving via non-transitory computer readable instructions information about a said popup event concept items or products of criterion entries which may include one or more appurtenances, or one or more amusement appurtenances, or one or more amusement fixtures, or one or more fixtures, or one or more real property improvements, or one or more real property construction items, or a combination thereof, said popup event concept items incorporated into the said virtual environment as a scaled virtualized objects representing real-world objects to be subsequently incorporated into the respective the real-world landscape area, the said real-world area represented by the said virtual environment, said real property construction items of a popup concept such as but not limited to, a truss, or a customizable commercial tent, or a commercial stand, or a modified shipping container construction unit, or a modular shipping container construction unit, or a prefabricated construction, or a novelty construction item, a novelty construction item represented by a static image cutout virtual object, or a modified construction unit, or a mobile construction, or a commercial kiosk, or an amusement appurtenance, recommended at least in part on the matching criterial inputs, or at least in part by information about the natural characteristics of one of the various locations of the said real-world landscape represented by the said virtual environment, further comprising of a said control panel, or at least one input device, a device wherein computer readable instructions stored on a non-transitory computer readable storage medium may enable the use of at least one input device adapted to receive at least one space, gesture, text, a said static imagery cutout of a background removal computer product, and touchscreen inputs, wherein a computer processor adapted to execute a program stored in a computer memory, the program being operable to provide instructions to the computer processor including receiving user input via the at least one input device, wherein the user input underspecifies a command for a virtual agent within the said virtual environment to use in moving at least one target virtualized object in the said virtual environment; interfacing with the said virtual environment via a virtual agent, sensing by the virtual agent, the at least one said virtualized object representing a said real-world object or product item in the said virtual environment, and finding at least one valid location for the virtual agent to place the at least one said virtualized object in the said virtual environment wherein determining at least on one valid location includes retrieving a computational linguistic placement constraint, identifying the virtual agent's intent for a target object, identifying a placement preference for the virtual agent, determining one or more said virtualized object properties of the target virtualized object and determining candidate placement surfaces for placement of the target object, the placement of which may thereby be further configured to receive criterion or query inputs, or configured to receive rendering data transmissions facilitating remote interactions between a plurality of client systems and a server system over a communication network within an API, opensource, or an integrative programming communication protocol with one or more, merchant websites, e-commerce platforms, recruitment service technologies, or order placement technologies, or order fulfillment technologies, or a combination thereof that may appear as selectable options within a list of one or more search return items such as but not limited to at least one of relative products, or at least one of manufactures, or at least one of vendors, or at least one of contractors, or at least one of suppliers, or at least one of architects, or at least one of freelancers, or at least one of three-dimensional print construction companies, or at least of a modified shipping container archiving and repurposing recommendation marketplace system, or a combination thereof.

29) A machine learning, cloud computable, non-transitory, commercial space virtual marketplace environment for retail commercial space trading, the methods comprising any variation or combination of the following steps:
wherein a fencing agent of computer readable instructions stored on a non-transitory computer readable storage medium may enable a first user of a first user interface to apply either a virtual subsector or a sectoral overlay onto a virtualized landscape of a virtual environment representing a real-world environment, or may enable the criterial input unput of geometric parameters or sizing dimensions identifying a first virtual zone, or identifying a geographical maker linked to a set of geo-located information inside virtual zone, information of a geographic geography information system module, or enabling the first user to apply either a virtual subsector or sectoral overlay onto a virtualized floor area of a virtual environment, a virtual environment representing a real-world environment, wherein at least one rule, including metadata, wherein the defining of the fencing of a spatial allocation may actuate the publication of a real-world commercial space availability product or lot item of a said virtual marketplace environment for commercial space trading, whereby a metadata data structure can be configured to define a said commercial space availability's attributes related to either a hash value or a variable by which it may become a subject to the assignment of a bid factor weighting criteria of a bid factor weighting module, or may become a subject of a dataset object of a dataset valuation pricing model module of a blockchain system, one or a combination thereof, by the said first user via non-transitory computer readable instructions, the said space availability publication within a said interoperating commercial space marketplace environment, which may cause a computer to perform a method for receiving a plurality of bids from one or more second users, second user profile identifiers related to a hash value, the said second user profile criterion or related datasets may be assigned to criterion of a dataset valuation pricing model of a pricing module, or of relative valuation pricing model or a relative valuation pricing module, or assigned to a bid factor of a bid factor weighting model of a bid factor weighting module, one or a combination thereof, or may further enable the structuring of a decentralized or blockchain marketplace architecture for the trade of commercial space within a said virtual marketplace environment wherein identifying at least one rule, or at least one metadata content descriptor, or at least one unique keyword, or a plurality of keywords, of a search string or of at least one input device configured via computer readable instructions stored on a non-transitory computer readable storage medium by a said second user, causing the generated search link configured to provide the results of at least one said metadata content descriptors, or of at least one of said unique keywords, or at least one of a said plurality of key words, or a combination thereof, of the said fencing agent's data stores within a said virtual commercial space marketplace environment the program being operable to provide instructions to the computer processor including receiving said second user input via the at least one input device, wherein the said second user input underspecifies a command for a virtual agent within the said commercial space virtual marketplace environment to use in moving at least one target virtualized object in the said virtual environment, interfacing with the said virtual environment via a virtual agent, sensing by the virtual agent, the at least one virtualized object representing a said real-world object or product item in the said virtual environment of a said virtual commercial space marketplace environment, and finding at least one valid location for the virtual agent to place the at least one virtualized object or product in the said virtual environment wherein determining at least on one valid location includes retrieving a computational linguistic placement constraint, identifying the virtual agent's intent for a target object, identifying a placement preference for the virtual agent, determining one or more said virtualized object properties of the target virtualized object and determining candidate placement surfaces for placement of the target object, the placement of which may thereby further the placement or translations of the scaled, virtualized object representing virtualized branding items, or scaled virtualized product items of an inventory product of product inventory repository or storage medium, or a virtualized fixture, or a virtualized furnishing item, or a virtualized shelving item, or a virtualized appurtenance, or a virtualized real property improvement object, or a virtualized volumetric design object, or an online product of a product repository, or a virtualized construction item, one or a combination thereof onto a virtual setting of a said virtual environment, a virtual environment of the said commercial space virtual marketplace environment, via a background subtractor mechanism or a pattern recognition algorithm, thereby facilitating price estimation calculations or further facilitating remote interactions between a plurality of client systems and a server system over a communication network within communication protocols of computer readable instructions stored on a non-transitory computer readable storage medium, that may be configured by the said second user to actuate one or more order placement technologies, drop shipping technologies, or shipment tracking technologies, one or a combination thereof, for the placement or installation of respective real-world items, at the respective said real-world location of a said virtual environment according to a configuration of computer readable instructions.

30) A machine learning, cloud computable, non-transitory, commercial shelf space virtual marketplace environment for in-store retail commercial shelf space trading, the methods comprising any variation or combination of the following steps:
wherein a fencing agent of computer readable instructions stored on a non-transitory computer readable storage medium may enable a first user to apply either a virtual subsector or a virtual sectoral overlay onto one or more of a virtualized shelving item, or a virtualized shelving fixture, or a virtualized shelving product, of a virtual environment, a virtual environment representing a real-world environment wherein at least one rule, including metadata, metadata the defining of the fencing of a spatial allocation that may actuate the publication of a real-world shelf space availability within an interoperating said commercial shelf space virtual marketplace environment, whereby the said metadata data structure can be configured to define a said shelf space availability's attributes related to a criterion by which it may become a subject to either the assignment of a bid weighting factor of a bid factor weighting module, or may become the subject of a dataset object of a dataset valuation pricing model of a dataset valuation pricing module, or may become subject to a relative valuation pricing model of a relative valuation pricing module, or a combination thereof by the said first user, via a configuration of non-transitory computer readable instructions, the said shelf space availability publication within a said interoperating commercial shelf space virtual marketplace environment, which may cause a computer to perform a method for receiving a plurality of bids from one or more second users, second user profile criterion or related dataset objects may be assigned to bid factor weighting criterion of a said bid factor weighting module, or may be assigned to criterion of a dataset valuation pricing model of a pricing module, or may be assigned to criterion of a relative valuation pricing model of a relative valuation pricing module, or a combination thereof, the said second user unique identifier may be assigned to either a hash value, or to a variable, or may further enable the structuring of a decentralized or blockchain marketplace architecture for the trade of a said shelf space availability in a said commercial shelf space virtual marketplace environment wherein identifying at least one rule, or at least one metadata content descriptor, or at least one unique keyword, or a plurality of keywords, of a search string configured via computer readable instructions stored on anon-transitory computer readable storage medium by a said second user, causing the generated search link configured to provide the results of said metadata content descriptors, at least one of said unique keywords, or at least one a said plurality of key words, or at least one of the said fencing agent's data stores, within a said commercial shelf space virtual marketplace environment the program being operable to provide instructions to the computer processor including receiving said second user input via the at least one input device, wherein the said second user input underspecifies a command for a virtual agent within the virtual environment of a said commercial space marketplace to use in moving at least one target virtualized object in the said virtual environment, interfacing with the said virtual environment via a virtual agent, sensing by the virtual agent, the at least one virtualized object representing a said real-world object or product item of a product inventory repository or storage medium, in the said commercial shelf space virtual marketplace environment, and finding at least one valid location for the virtual agent to place the at least one virtualized object in the said virtual environment wherein determining at least on one valid location includes retrieving a computational linguistic placement constraint, identifying the virtual agent's intent for a target object, identifying a placement preference for the virtual agent, determining one or more said virtualized object properties of the target virtualized object and determining candidate placement surfaces for placement of the target object, the placement of which may thereby be further the placement or translations of scaled, the virtualized object representing virtualized branding items, or scaled virtualized product items of a product inventory repository or storage medium, for the placement or translations of scaled, virtualized branding items, or scaled virtualized product items, product items of a product inventory repository or storage medium, onto a virtual shelf or a said virtual environment, via a background subtractor mechanism or a pattern recognition algorithm, thereby facilitating remote interactions between a plurality of client systems and a server system over a communication network within communication protocols of computer readable instructions stored on a non-transitory computer readable storage medium, that may be configured by the said second user to actuate one or more order placement technologies, drop shipping technologies, or shipment tracking technologies, one or a combination thereof for subsequent the stocking, shelving, or placement of a said product or of a said branding item of a said product inventory repository or storage medium, at the said respective real world location of the said virtual environment, according to a configuration of computer readable instructions.

31) A machine learning, cloud computable, non-transitory, event planning mechanism and autonomous or non-autonomous vehicle route alignment system of a volumetric modeling or virtual design environment computer product for developing mobile popup shops or food trucks, the methods comprising any variation or combination of the following steps:
wherein computer readable instructions stored on a non-transitory computer readable storage medium may enable a user of a master user account user interface, to construct a schedule database of potential tasks for a mobile popup shop or for a food truck autonomous or non-autonomous vehicle routing and management operations, via an interactive GIS or an interactive GIS data visualization map wherein a vehicle route is configured via computer readable instructions of a first user interface, a vehicle route containing interactive georeferencing indicators that denote an event entry of an interoperating or integrated network site having content relating to an event of a geographic location, a georeferencing indicator that may further represent a vehicle route stop, a vehicle route comprising of a hybrid delivery model for real-world products of a product inventory repository or storage medium, wherein a storage medium stores the task relating to the event in a said task schedule database having a plurality of entries, including said metadata entries of an interactive virtual design environment, or of a virtual shelf space marketplace environment, each entry having a task description field for receiving a description of a given task, a tag field for receiving with a real-time image processor of either a GPS enabled mobile device, or of either a mobile device pairable or GPS enabled mixed-reality device, or of either a mobile device pairable or GPS enabled hyper-reality device, or of either a mobile device pairable or GPS enabled neurotechnology device, or a combination thereof, a composite display or superimposition of one or more tags associated with the given task, comprising inventory product placement recommendations or orientation instructions of a pattern recognition computer generated perceptual programming storage medium, wherein visualized information or real-world inventory product item, or furnishing item, or fixture item virtualizations are superimposed or overlaid onto the display of a real-time image processing device, a real-time video display, or a static image display of a real-world environment, in a composite view of the said real-world environment, the said real-world environment represented in a volumetric design virtual rendition of a mobile popup shop or food truck unit of interactive virtual design environment wherein a first user master profile configuration of computer readable instructions may enable the generation of inventory product placement metadata within a storage medium, metadata drafted by the virtual placement or orientation, by a virtual agent, of a scaled virtualized inventory product of a product repository or storage medium, or of a virtualized object, further generating a vendor package field for receiving one or more vendor packages having service details associated with the given task a digital processing device comprising at least one processor, an operating system configured to perform executable instructions, a memory, and a computer program including instructions executable by the at least one processor to create a hybrid delivery model application for real-world inventory products of a said product repository or storage medium, or for real world modified construction units of a repurposing recommendation marketplace storage medium, further comprising geocode database datasets denoting at least one vehicle route loading station, at least one delivery territory, a delivery territory represented by a said event entry, an event entry of a said interoperating or integrated network site having content relating to an event of a geographic location, a plurality of real-world products of a said inventory repository or storage medium, and one or more food truck autonomous or non-autonomous vehicles, or one or more said mobile popup shop autonomous or non-autonomous vehicles, each vehicle comprising of at least one real-world product inventory case of a said inventory repository or storage medium, the said real-world products subject to regulation imposing an upper regulated inventory case value threshold and a respective vehicle or plurality of vehicles configured to operate in either of a dynamic delivery model and a batch delivery model and optionally switch between models along a given route, setting the delivery model for the respective vehicle or plurality of vehicles, receiving orders for delivery of one or more construction units of a repurposing recommendation system or marketplace environment storage mediums, or of one or more of the real-world product inventory shipments of a said product inventory repository or storage medium within the at least one delivery territory via interior design metadata stores of a said interactive virtual design environment, providing the dynamic delivery model, wherein a content of the inventory case is determined based at least in part on predicted demand datasets of an integrated or interoperating statics module and the upper regulated inventory case value threshold, and wherein one or more of the received orders are assigned, based at least on routing efficiency comprising distance and estimated delivery time between scheduled vehicle route stops, as they are received to one or more vehicles operating in the dynamic delivery model and providing the batch delivery model, wherein a content of the inventory case is determined based at least in part on a plurality of automated order placements received via said interior design metadata stores and the upper regulated inventory case value threshold, and wherein the plurality of the received orders are batched, based at least in part on said vehicle routing efficiency comprising distance and estimated delivery time, and assigned to a vehicle operating in the batch delivery model, the said interactive virtual design environment wherein computer readable instructions of a mobile unit volumetric design therein is further configured to facilitate remote interactions between a modified shipping container archiving and repurposing recommendation marketplace system, or to facilitate remote interactions between a plurality of client systems and server systems over a communication network within a communication protocol of computer readable instructions stored on a non-transitory computer readable storage medium, that may be configured to generate a list of one or more relative vendors, servicers, or manufacturers, a said task schedule database further configured to transmit said vehicle route data to a scheduling controller platform for the deployment of at least one or a plurality of autonomous vehicles identifying an autonomous vehicle transportation provider in a geocoded area, identifying a database for providing shipping container associated information including at least information about shipping container location, shipping container unique identifiers each comprising a machine readable code, the scheduling controller further comprising service data comprising at least one of pick-up data, the pick-up data indicating a geographical location of a shipping container unit of a shipping container information database, the said dynamic delivery module further comprising a stochastic model of a DAG block-lattice data architecture wherein a stochastic model of either wireless network topology, or street network topology, or a combination thereof provides a memoryless probabilistic tracking model of a second user's GPS enabled mobile device, or a GPS enabled onboard technology system of an autonomous vehicle, wherein a hash value is associated with an IP location or timestamp of a temporal or spatiotemporal query, or SPV payment transaction, or a combination thereof.

32) A machine learning, cloud computable, non-transitory, computer generated perceptual programming proximity geotargeting marketing computer product for generating retail or geographic event foot traffic by directing an autonomous or a non-autonomous vehicle-for-hire comprised of any variation or combination of the following steps:
wherein an inventorial product profile of a product repository or storage medium, or criterial data of business registration criteria or a business registry storage medium, or datasets of a first user profile, or data entries of an event planning network storage medium, is related to dataset objects of a target market profile, a said target market as defined by said dataset objects of a statics module, datasets further acquired via the integration or interoperation of data mining technologies or data engineering technologies one or a combination of such but not limited to, opensource distributed computing frameworks, cloud-based geostatistics technology, geospatial demographics engineering technology, cloud-based data analytics technology, cloud-based API data engineering technology, cookie compliance technology, campaign management analytics technology, social graph technology, user statistics technology, conversation tracking technology, demography data engineering technology, serosurveillance technology, biometric surveillance technology, sentinel surveillance technology, relative predictive modeling technology, spatiotemporal data engineering technology, footfall data engineering technology, consumer behavior tracking technology, web scrapping technology, or joint probability distribution data engineering technology, datasets related as a potential product or a potential business of a target market's interest, interest defined by computer generated or computer readable dataset correlations, a product or a business of a proximally located retail storefront location, or an event location, proximal to an individual subject of a said target market, an individual subject of a said target market of a MRF model or stochastic model wherein a GPS enabled mobile device is indicative of an individual subject of the said target market and is represented in variable as nodes in a lattice of a graph learning model, each node in the lattice corresponding to a geographic area, each variable representing a number or a GPS enabled mobile device being used in a geographic area, GPS enabled mobile devices representing individuals of a said target market, a geographic area of a said retail storefront's or a said event's relatively proximal location represented as an interactive geographic referencing dataset data layer or map overlay of an interactive geospatial data map, or an interactive spatiotemporal data map, or an interactive gravity based spatial interaction data map, or an interactive demographic information data map, or an interactive real-time spatiotemporal density map, or an interactive real-time memoryless topographic stochastic probability distribution data map, or an interactive cloud-based API real-time data engineering technology data map, one or a combination thereof, of a data visualization module, a data visualization module comprising at least one input device, and at least one filtering device, whereby computer readable instructions stored on a non-transitory computer readable storage medium, may enable the configuration of a first user interface model to generate said interactive target market dataset data layers or map overlays in a said data visualization module, indicating areal market share, or indicating probabilities of consumer footfall at one or more retail storefronts or events that are represented by said geographic referencing dataset layers or overlays of a said interactive geospatial data map, or a said interactive spatiotemporal data map, or a said interactive gravity based spatial interaction data map, or a said interactive demographic information data map, or a said interactive real-time spatiotemporal density data map, or a said interactive real-time memoryless topographic stochastic probability distribution data map, or a said interactive cloud-based API real-time data engineering technology data map, wherein the cells define regions on the map and are non-overlapping, or are overlapping, and wherein each cell of the plurality of cells has the same predefined dimensions for each cell of the plurality of cells the aggregate value for the cell, calculated at least in part upon the selected attribute and zero or more said target market dataset objects associated with the selected attribute and locations within the region defined by the cell, thereby determining the shading for each of the cells to generate a visual overlay of data layers for rendering a heatmap of the said interactive maps of the said data visualization module, the said data visualization module further configured to receive rideshare cost datasets from at least one rideshare technology services offered by a plurality of application platforms of third party rideshare service providers, within a database aggregation unit configured to receive geo-radial, or areal location inputs, or geocode inputs, or location inputs, of a combination thereof, said inputs of a first user interface representing a proximal location of a retail shop storefront or event, further configured to receive and store data from a plurality of third-party rideshare technology service provider databases each of said third party rideshare technology service provider databases containing data sufficient to perform services of one of said corresponding third-party mobile application platforms, wherein a processor configured to parse said service request for at least one said rideshare technology services from a first user of, a said first user interface, based on data stored in said database aggregation unit, the processor assembling at least one combination of at least one or more said rideshare technology services, based on a coordination of an optimized combination of one or more said rideshare technology services based on time and cost of a stochastic model so as to allow, said first user of a said first user interface, to select and initiate a corresponding request for one or more of said third party rideshare technology service providers, to a provide a service for a plurality of remote second users of a said target market dataset, said second users represented by said nodes of a said MRF model, the said data visualization module further comprised of a database for storing marketing content provided by a content creator, a content creator of a said first user interface, storing digital marketing content in a storage medium for accepting proximal geographic location inputs, proximal geographic location inputs relative to a said retail storefront or event location, location inputs as vertices of a said MRF node expressed as a dataset data layer of an interactive polygonal overlay, an interactive polygonal overlay of a said heatmap defining boundaries of a geographic region, a geographic region of a said geographic referencing dataset, receiving geotargeted digital content within an image processing medium or within a computer generated perceptual programming medium of either a GPS enabled mobile device that may or may not be paired with a mix-reality device, or hyper-reality device, the said GPS enabled mobile device a MRF node associated with said a geographic region of a said data visualization module, transmitting the said content associated with the geographic region to the said GPS enabled mobile device, or a paired mix-reality device, or a paired hyper-reality device of a second user belonging to a said target audience population, a target market population of a geographic region indicated by a said data visualization dataset, a target market population of proximal relativity to a said retail storefront location, or event location, wherein the said content comprises computer readable instructions stored on a non-transitory computer readable storage medium whereby access to a ridesharing network that invites a plurality of riders of a shared geographic proximity to join the network is provided via the said processor configured to parse said service request for at least one said rideshare technology services of a ridesharing network for receiving a predetermined location, a predetermined location of a said retail storefront location of a said retail storefront, or an event location, a said location of a location data criteria entry of a proximity based selective content dissemination module, the said processor configured to parse said service request for at least one said rideshare technology services, further comprising a ticketing system module whereby the computer readable acceptance of a discounted or complementary rideshare service of a said proximity based selective content dissemination module by a target market device node, may serve as a ticketing method, or as an event admissions method of an issue tracking system, wherein a rider represented by a relatively proximal said target market GPS enabled device node is provided with a computer readable access code for consumer participation at a said retail storefront location, or at an event location, the ticketing system module configured to accept second user geographic location inputs upon the computer readable acceptance of the said discounted or complementary rideshare service of a said proximity based selective content dissemination module, the proximity based selective content dissemination module further comprising a dataset valuation pricing module of a payments environment or a cryptographic SPV payments environment wherein a stochastic model providing memoryless predictive data, data based at least in part upon dataset objects such as but not limited to hyperbolic positioning, multilateration of radio signals, wi-fi positioning systems, Bluetooth technology, crowdsourced wi-fi hotspot technology, mobile phone mast locations, street network topology, the spatiotemporality of second user nodes, the spatiotemporality of rideshare ride vehicle nodes, and retail store or event location nodes, whereby a calculated estimate of target market nodes of a proximal market share, or of estimated footfall generate a cumulative cost including selective content dissemination marketing campaign pricing and quantitative rideshare service cost, the said pricing module may or may not further include an escrow processor of a payments environment or of a cryptographic SPV payments environment, for the deference or allocation of rideshare service discounting or concessions payment dispersal, according to configurations of computer readable instructions, whereby an escrowed transaction of a cryptographic SPV payment represented within a storage medium as an unpocketed or pending block of a transaction state where a block sending funds is published and confirmed by a graph learning hypernetwork metagraph, or nested metagraph of a block-lattice, wherein labeled hyperedges and labeled metavertices are organized according to mathematical logic models such as but not limited to set theory, or machine learning processing models such as but not limited to natural language, or user behavioral models whereby a node vector for a node's representation is calculated, vector nodes of said individual subjects of target market dataset objects, vector nodes of said rideshare vehicles, vector nodes of first users, or vector nodes of said a retail storefront or event location of a geographic region, wherein hyperedges may represent connective or relational dataset objects or geographic proximities, probabilistic layers added to the said graph learning hypernetwork according to datasets of data engineering mediums or data mining mediums for data such as but not limited to geocode database data, demography data engineering data, gravity based spatiotemporal interaction data engineering data, population density data engineering data, geographic topology data, street network topographic data, or rideshare technology service vehicle locations data, one or a combination thereof.

33) A cloud computable, machine learning, non-transitory, likeness virtual goods marketplace environment and selective content dissemination computer product comprised of any combination or variation of the following steps:
A virtual goods repository, wherein a virtual good is a non-physical virtual object, a virtual good repository of a computerized virtual goods trading system that may include an interface to receive a virtual goods package from the seller, a said seller of a second user interface, the virtual goods package of the said interface further comprising a processor for supplemental content to be added to a virtual good, the metadata content of a seller's account profile regarding computer generated or computer readable user behavior data dataset objects or conversation tracking data dataset objects of one or more said seller account profile associated social media website profiles, user behavior data dataset objects, or conversation tracking data dataset objects representing said seller social media profile online constituencies, followers, or relative users as computer generated or computer readable dataset objects that may be further associated with a dataset valuation model of a dataset valuation pricing module, or may provide the variables of a virtual goods dataset valuation pricing model of a graph learning social hypergraph blockchain ledger, a graph learning social hypergraph wherein an inventorial product profile of a product repository or storage medium of a first user interface, or criterial datasets of business registration criteria of a first user interface, or criterial datasets of a first user profile is connected via labeled hyperedges to dataset objects of a target market represented as graph nodes or metavertices indicative of individual subjects of a target market or indicative of a target market geographic referencing dataset, first users represented as buyer graph nodes or metavertices, labeled graph hyperedges indicative of a shared audience further connecting a buyer node to a said seller, sellers represented as nodes or metavertices, the graph learning model further implementing probabilistic layers to the graph learning social hypergraph of an MRF model, the said target market datasets further acquired via the integration or interoperation of data mining technologies or data engineering technologies one or a combination of such but not limited to, opensource distributed computing frameworks, cloud-based geostatistics technology, geospatial demographics engineering technology, cloud-based data analytics technology, cloud-based API real-time data engineering technology, cookie compliance technology, campaign management analytics technology, social graph technology, user statistics technology, conversation tracking technology, demography data engineering technology, serosurveillance technology, biometric surveillance technology, sentinel surveillance technology, relative predictive modeling technology, spatiotemporal data engineering technology, footfall data engineering technology, consumer behavior tracking technology, web scrapping technology, or joint probability distribution data engineering technology, the said datasets related to a said first user profile represented as a buyer further related to the said seller, the said virtual good of the said virtual goods repository being one of a static image, videography, an image template, a videography template containing the seller's likeness, or a combination thereof, generating within a processor a scaled two-dimensional or three-dimensional image for selective content dissemination, receiving within a storage medium that corresponds with a virtual marketplace environment wherein the medium is configured to deliver a virtual good from a said seller to a said buyer, a virtual marketplace environment wherein a said virtual goods repository interface including a processor for supplemental content to be added to a virtual good, the supplemental content of product criteria entries, product criteria of a product repository or storage medium associated with a first user profile representing a said buyer, the generated supplemental content including a computerized three-dimensional clothing model reconstruction of captured product image information, or captured SKU information, or captured product metadata generating a clothing model comprising geometry information, or texture information, or color information, one or a combination thereof further generating a seller's virtual good, virtual wardrobe change based on the clothing type suitable for the seller's image type of a virtual good candidate selection option of a said virtual marketplace environment, the computer readable selection of a virtual good by a respective said buyer resulting in the storage of virtual goods as part of digital content of a content storage medium and content manager for accepting geographic locations expressed as a dataset data layer of an interactive polygonal overlay, an interactive polygonal overlay of a heatmap defining boundaries of a geographic region, a geographic region of a geographic referencing dataset, as an interactive geographic referencing dataset data layer or map overlay of an interactive geospatial data map, or an interactive spatiotemporal data map, or an interactive gravity based spatial interaction data map, or an interactive demographic information data map, or an interactive real-time spatiotemporal density data map, or an interactive real-time memoryless topographic stochastic probability distribution data map, or an interactive cloud-based API real-time data engineering technology data map, one or the combination thereof, of a data visualization module, a data visualization module comprising at least one input device, and at least one filtering device, whereby computer readable instructions stored on a non-transitory computer readable storage medium, may enable the configuration of a first user interface model to generate said interactive target market dataset data layers or map overlays in the said data visualization module, indicating either areal market share, or indicating probabilities of consumer footfall, or a combination thereof wherein configurations of computer readable instructions may allow the said buyer to selectively disseminate computer generated perceptual programming content, or digital content of a said virtual good containing a said seller's likeness, receiving the geotargeted digital content of the said buyer's virtual good procurement within an image processing medium, or within a computer generated perceptual programming medium or processor of either a GPS enabled mobile device, or of either a mobile device pairable or GPS enabled mix-reality device, or of either a mobile device pairable or GPS enabled hyper-reality device, or of a mobile device pairable or a GPS enabled neurotechnology device, or a combination thereof, a said GPS enabled device of a target market MRF node associated with said a geographic region of a data visualization module, transmitting the said content associated with the geographic region to the said GPS enabled device node of a third user representing an individual subject of a said target audience population of a computer readable geotargeted geographic referencing dataset.

34) A machine learning, cloud computable, non-transitory, modified shipping container archiving and repurposing recommendation marketplace system for popup event development comprising any variation of combination of the following steps:
wherein a popup retail modified shipping container storefront construction unit marketplace interface module for receiving shipping container information, a shipping container tracking location module configured to identify a travel route, a number of destinations and a number of travel connections corresponding to the modified shipping container construction unit size and style based identifiers, a tracking location analysis engine, a modified shipping container construction identifier module configured to receive a modified shipping container construction style identifier criterial input, a transaction detection engine configured to detect a second transaction where a buyer of a user profile of a primary account identified in the first transaction is identified as the seller in the second transaction, and the repurposing recommendation engine configured to generate a recommendation of the used archived modified shipping container for the second transaction of the said marketplace system based on the modified shipping container identifier inputs of virtual environment representing a real-world location's landscaping, or topology.

35) A cloud computable, machine learning, non-transitory, computer generated perceptual programming popup event or popup retail proximity digital or augmented reality content selective content dissemination computer product comprising any combination or variation of the following steps:
wherein a database for storing content provided by a content creator of a first user, user interface, and a content manager for accepting geographic location inputs representing a relatively remote popup shop or popup event location, whereby a second user interface may be actuated within a proximal area of the said remote geographic location, according to computer readable instructions of GIS data visualization device that may enable a said first user interface to indicate a proximal areal location for selective content dissemination, a said second user interface comprising computer readable instructions for capturing a real-time video stream using a GPS enabled mobile device, or using either a mobile device pairable or GPS enabled mixed-reality device, or using either mobile device pairable or GPS enabled hyper-reality device, or using either a mobile device pairable or GPS enabled neurotechnology device, or using a combination thereof, wherein the real-time video-stream comprises a physical object of a pattern recognition storage medium, analyzing a physical object via pattern recognition programming of a computing device processor, further configured to identify the physical object in the real-time video stream with one or more markers to determine a match to said physical object geometric parameter metadata of a content storage medium, extracting one or more data associated with the physical object from the real-time video, wherein one or more datastores comprises a reference image of a said content of a computer generated perceptual programming perceptual programming content creator storage medium, displaying the image in an interactive augmented reality environment or in a composite display of a computer generated perceptual computer programming image processing device node of a relatively proximal second user interface.

36) A machine learning, cloud computable, non-transitory, decentralized blockchain ARAS marketplace and gaming terminal comprising any combination or variation of the following steps:
wherein a processor identifies one or more characteristics of a first player of a user account, automatically identifying one or more actions performed by the said first player determining at least a first criterion of a first play user profile, based at least in part on the one or more characteristics of one or more second players, second players of a user account, identifying one or more characteristics of one or more said second players automatically identifying one or more actions of actions performed by the one or more said second players, associating one or more said second player user profile criterion with the said first player, analyzing the first criterion and the one or more second criterion and determining one or more relationships between the first criterion and the second criterion to form a single game session wherein in the game is a finance-based, trading themed marketplace environment game having a player interface wherein a player may participate in an ARAS virtual trading marketplace trading virtual goods, first virtual goods geotagged to a prospective geophysical ARAS location according various geographic datasets from a data mining system, or a data engineering system, or a statistics module, via configurations of a data visualization system comprising at least one put device, determining dataset price values or blockchain hash values for a plurality of predefined spatial areas from the retrieved data based on a set of target market dataset association rules applied to the predefined spatial areas, determining spatial area values calculating a weight ranking the predefined spatial areas according to varying degrees of target audience dataset correlations, a weight that may be assigned to criterion of a dataset valuation pricing model of a pricing module, the processor configured to receive collectable data structures of one or more data files from a said data mining system, or a said data engineering system, or a said statics module, or a said data visualization system inputs, a module operative for tokenizing flat currency, a module operative to create a hash1 value for each element of each dataset of a said first virtual good, a module operative to upload each hash value into a blockchain structure of a said first virtual good, computer readable instructions for obtaining a first virtual good enabling a player to acquire or develop a second virtual good, the second virtual good having a starting price value, or token value, or hash value of a blockchain structure according to the relative size or type of the said second virtual good, the relative size of the second virtual good determining the range, the reach, the coverage, or the areal radius of an ARAS within a said geotagged geophysical location, computer readable instructions for obtaining a second virtual good enabling player access to a database for storing content provided by a said player and content creator in an electric memory, and a content manager for accepting geographic location inputs of the said predefined spatial areas, selectively transmitting interactive augmented reality content either to GPS enabled mobile computing devices, or to mobile device pairable or GPS enabled mixed-reality devices, or to either a mobile device pairable or GPS enabled hyper-reality device, or to either a mobile device pairable or GPS enabled neurotechnology device, or a combination thereof, a said GPS enabled device representing an individual subject of a target market based on geographic proximity to a said predetermined ARAS location

37) A machine learning, cloud computable, non-transitory, pricing module for applying a dataset valuation model wherein a decimal currency unit's value equates to a proportional per centum of a target market's general population density or spatiotemporal population density of a geographic location or may equate to a numeric value representing a target market dataset object.

38) A machine learning, cloud computable, non-transitory local blockchain or local block-lattice gaming terminal or game terminal plugin of a computer-generated perceptual programming selective content dissemination module and spatiotemporal querying system for receiving within a processor, interactive gaming content, comprising computer readable instructions that may enable cryptocurrency mining or tokenized currency trading between active nodes.
